(19) United States
(12) Patent Application Publication
(10) Pub. No.: US 2024/0202725 A1
(43) Pub. Date: Jun. 20, 2024

(54) COMPUTER IMPLEMENTED TECHNIQUES FOR FACILITATING KYC AND JURISDICTIONAL REGULATORY COMPLIANCE VERIFICATIONS OF PSEUDONYMIZED OR ANONYMIZED USERS

(71) Applicant: EVLINE, SAUSALITO, CA (US)

(72) Inventors: Marios Anapliotis, SAUSALITO, CA (US); Panagiotis Kokkinakis, Nea Smirni (GR); Shawn Borsky, Fullerton, CA (US)

(73) Assignee: EVLINE, SAUSALITO, CA (US)

(21) Appl. No.: 18/540,831

(22) Filed: Dec. 14, 2023

Related U.S. Application Data
(60) Provisional application No. 63/432,379, filed on Dec. 14, 2022.

(51) Int. Cl. G06Q 20/40; G06Q 20/38

(52) U.S. Cl. CPC G06Q 20/4014; G06Q 20/3825; G06Q 20/4015

(57) ABSTRACT

Various aspects described or referenced herein are directed to techniques for facilitating KYC and jurisdictional regulatory compliance verifications of pseudonymized and/or anonymized users accessing regulated and/or non-regulated services provided by one or more service providers. One aspect disclosed herein is directed to the issuance of dynamic SmartPass Tokens certifying that an identified, anonymous or pseudonymous SmartPass user satisfies all the jurisdictional and regulatory compliance requirements for permitting that user to access a specific service provided by specific service provider, enabling SmartPass users to anonymously or pseudonymously access various types of regulated and non-regulated online services while maintaining user anonymity, and providing service providers with desirable regulatory compliance certifications that each SmartPass user accessing the service provider's services satisfies the minimum regulatory compliance requirements for permitting users to access the service provider's services.

### RELATED APPLICATION DATA

The present application claims benefit, pursuant to the provisions of 35 U.S.C. § 119, of U.S. Provisional Application Ser. No. 63/432,379 (Attorney Docket No. MARIOSP001PUS), titled “SMARTPASS WALLET TECHNICAL DOCUMENTATION”, naming Anapliotis et al. as inventors, and filed Dec. 14, 2022, the entirety of which is incorporated herein by reference for all purposes.

### BACKGROUND

In the domain of regulated online services like online gambling, adult content, alcohol and cannabis-related websites, the implementation of geographic, jurisdictional, and regulatory compliance verifications is a multifaceted and intricate process. This procedure is designed to ensure that the services adhere to various legal standards, including Know Your Customer (KYC), Anti-Money Laundering (AML), Counter-Terrorism Financing (CTF), and the General Data Protection Regulation (GDPR). The first step in this process is the verification of the user's geographic location and jurisdiction. This is crucial to confirm that the user is accessing the service from a region where it is legally permitted. Typically, this is achieved through IP address monitoring, but the increasing use of Virtual Private Networks (VPNs) has made this more challenging. VPNs can mask a user's true location, making it difficult to accurately enforce geographic restrictions.

Following geographic verification, the KYC process is initiated to establish the identity of users. This is a critical step, particularly for services involving financial transactions, as it helps prevent fraud and identity theft. Users are typically required to submit personal identification documents, which are verified for authenticity. However, the KYC process can be cumbersome and time-consuming, leading to a potential drop in user engagement. Furthermore, the verification of documents from various countries, each with its own set of identification standards, adds to the complexity.

AML and CTF regulations necessitate service providers to monitor and report suspicious activities. This involves screening users against global watchlists and tracking unusual transaction patterns. The challenge here lies in the balance between effective monitoring and respecting user privacy. In addition, service providers must adapt to continually evolving AML and CTF guidelines, requiring constant updates to their compliance systems.

The GDPR imposes additional layers of complexity, particularly concerning user data protection and privacy. Online service providers must ensure that user data is collected, processed, and stored in compliance with GDPR requirements. This includes obtaining explicit user consent for data processing and providing users with access to their data. The GDPR also grants users the “right to be forgotten,” meaning they can request the deletion of their personal data. Implementing these requirements can be technically challenging and resource-intensive.

Another significant issue is the technological arms race against advanced methods used by individuals to bypass restrictions, such as sophisticated VPNs and proxy services. Detecting and preventing access through these means requires advanced technology and continuous system updates, which can be costly and resource-intensive. Furthermore, these measures can sometimes inadvertently block legitimate users, impacting service accessibility and user satisfaction.

In conclusion, the procedures for geographic, jurisdictional, and regulatory compliance verifications in regulated online services are complex and fraught with challenges. These include accurately determining user location in the face of VPN usage, implementing thorough yet user-friendly KYC processes, adhering to evolving AML and CTF regulations, complying with GDPR requirements, and managing the technological aspects of preventing unauthorized access. Each of these areas presents unique difficulties, requiring a delicate balance between compliance, user experience, and operational efficiency. As the digital landscape continues to evolve, these challenges will necessitate ongoing innovation and adaptation from service providers.

### BRIEF DESCRIPTION OF THE DRAWINGS

FIG. 1 illustrates a simplified block diagram of a specific example embodiment of a portion of a computerized data network.

FIG. 2 shows an example data network architecture embodiment of a Data Network 200.

FIG. 3 is a simplified block diagram of an exemplary client system Mobile Device 300 in accordance with a specific embodiment.

FIG. 4 illustrates an example embodiment of a System Server 480 which may be used for implementing various aspects/features described herein.

FIG. 5 illustrates an example of a functional block diagram of a SmartPass Platform Server System 500 in accordance with a specific embodiment.

FIG. 6 shows an example systems interaction diagram of a new SmartPass user onboarding process.

FIG. 7 shows an example systems interaction diagram of a SmartPass User Location Update process.

FIG. 8 shows an example systems interaction diagram of a SmartPass User-Service Provider Login/Pairing process.

FIG. 9 shows an example systems interaction diagram of a SmartPass User-Service Provider Regulatory Compliance Verification process.

FIG. 10 shows an example systems interaction diagram of a SmartPass User Optional Sharing of PII Info process.

FIG. 11 shows an example systems interaction diagram of a SmartPass Add Crypto Funds process.

FIG. 12 shows an example systems interaction diagram of a SmartPass Add Fiat Funds process.

FIG. 13 shows an example systems interaction diagram of a SmartPass Transfer Funds to Service Provider process.

FIG. 14 shows an example systems interaction diagram of a SmartPass Transfer Crypto Funds to Service Provider process.

FIG. 15 shows an example systems interaction diagram of a SmartPass Transfer Funds from Service Provider to Wallet process.

FIG. 16 shows an example systems interaction diagram of a SmartPass Transfer Crypto Funds from Provider to Wallet process.

FIG. 17 shows an example systems interaction diagram of a SmartPass Transfer Funds from One SmartPass User to Another (Proximity Handler) process.

FIG. 18 shows an example systems interaction diagram of a SmartPass Regulator Authority Records Search/Regulatory Audits process.

FIG. 19 shows an example systems interaction diagram of a SmartPass Location Pattern Engine process.

FIG. 20 shows an example systems interaction diagram of a SmartPass Identify SmartPass Criteria Data Change process.

FIG. 21 shows an example systems interaction diagram of a SmartPass Data Criteria Update process.

FIG. 22 shows an example systems interaction diagram of an Extend SmartPass Token Expiration process.

FIG. 23 shows an example systems interaction diagram of a SmartPass Device Lost/Stolen process.

FIG. 24 shows an example systems interaction diagram of a SmartPass Token Issuance on Blockchain process.

### DETAILED DESCRIPTION OF EXAMPLE EMBODIMENTS

### Overview

Various aspects described or referenced herein are directed to different methods, systems, and computer program products for facilitating KYC and jurisdictional regulatory compliance verifications of pseudonymized and/or anonymized users accessing regulated and/or non-regulated services provided by one or more service providers.

According to different embodiments, a SmartPass Platform is configured or designed to provide a sophisticated technology ecosystem designed to offer secure, anonymous, and pseudonymous authentication and transaction capabilities for users engaging with online services, especially those regulated by authorities. This platform is particularly significant for its approach in enabling users to comply with KYC and/or other regulatory compliance verification requirements while at the same time allowing such users to keep desired portions of their Personal Identifiable Information (PII) private or unrevealed. In at least one embodiment, the SmartPass Platform offers a robust solution for secure, anonymous online service access and transactions, balancing user privacy with regulatory compliance.

A distinctive feature of the SmartPass Platform is the issuance of dynamic SmartPass Tokens certifying that an identified, anonymous or pseudonymous SmartPass user satisfies all the jurisdictional and regulatory compliance requirements for permitting that user to access a specific service provided by specific service provider. In this way, SmartPass Token functions as digital regulatory compliance certification “visas”, enabling SmartPass users to anonymously or pseudonymously access various types of regulated and non-regulated online services while maintaining user anonymity, and providing service providers with desirable regulatory compliance certifications that each SmartPass user accessing the service provider's services satisfies the minimum regulatory compliance requirements for permitting users to access the service provider's services.

According to different embodiments, service providers may utilize SmartPass tokens for user certification and compliance with regulatory standards; SmartPass users benefit from anonymous access to regulated and nonregulated services; and regulatory authorities are able to utilize the SmartPass Platform to perform regulatory compliance monitoring and enforcement activities.

One aspect disclosed herein is directed to different methods, systems, and computer program products relating to a New SmartPass user onboarding process. This process integrates geolocation data, identity verification, and regulatory compliance checks. Users initiate onboarding via the SmartPass mobile application, where they provide personal identification information and documents. The system calculates the user's approximate location, encrypts personal data, and checks against AML/KYC databases. Upon successful validation, a unique user identifier is generated, facilitating the creation of a custodial Blockchain-based wallet linked to the user's profile, ensuring secure, compliant, and user-specific onboarding.

Another aspect disclosed herein is directed to different methods, systems, and computer program products relating to a SmartPass User Location Update process. This feature continuously monitors and updates user location data, utilizing geolocation and unique identifiers. Significant location changes trigger automatic updates in the user's profile. The system cross-references the updated location against issued SmartPass tokens, invalidating any that are out of the approved geographic bounds. This process ensures compliance with regulatory requirements specific to user locations, enhancing the platform's security and reliability.

Another aspect disclosed herein is directed to different methods, systems, and computer program products relating to a SmartPass User-Service Provider Login/Pairing process. This process enables users to securely log into or pair with service provider applications using SmartPass credentials. The method involves generating a short-lived token, authenticated via digital signatures, to initiate pairing. User's personal information is verified against the provider's requirements and regulations, ensuring only eligible users gain access. This process enhances security and regulatory compliance while providing a streamlined access experience for users.

Another aspect disclosed herein is directed to different methods, systems, and computer program products relating to a SmartPass User-Service Provider Regulatory Compliance Verification process. This process ensures that user access to services via the SmartPass platform adheres to specific legal and regulatory requirements. It involves iterating over user data and service provider rules, cross-referencing them to confirm compliance. Non-compliant scenarios result in the rejection of user access, while compliant scenarios proceed with service access facilitation. This automated process significantly improves regulatory adherence efficiency.

Another aspect disclosed herein is directed to different methods, systems, and computer program products relating to a SmartPass User Optional Sharing of PII Info process. This optional feature allows users to share personal identifiable information (PII) with service providers and regulatory authorities. The sharing mechanism is user-initiated, with explicit consent and incentives. Rejection or approval of PII sharing is communicated to relevant entities, ensuring user control over personal data and compliance with privacy regulations.

Another aspect disclosed herein is directed to different methods, systems, and computer program products relating to a SmartPass Add Crypto Funds process. This feature allows users to add cryptocurrency funds, specifically USDC tokens, to their SmartPass wallets. The process involves card details input, fiat-to-crypto conversion, and secure transaction execution. The system updates the user's crypto balance and informs regulatory authorities of the transaction, ensuring transparency and regulatory compliance in crypto-fund management.

Another aspect disclosed herein is directed to different methods, systems, and computer program products relating to a SmartPass Add Fiat Funds process. This process enables users to add fiat currency to their SmartPass wallets. It supports multiple payment gateways, including cards and bank accounts. The system processes these transactions, updating the fiat balance in the user's wallet and notifying regulatory authorities. This feature enhances the platform's versatility in managing diverse financial sources.

Another aspect disclosed herein is directed to different methods, systems, and computer program products relating to a SmartPass Transfer Funds to Service Provider process. This process facilitates the transfer of fiat funds from a user's SmartPass wallet to a service provider. Users initiate the transfer, which is executed after balance checks and regulatory verifications. The successful transaction updates the user's balance with the service provider, and regulatory authorities are informed, ensuring financial transparency and compliance.

Another aspect disclosed herein is directed to different methods, systems, and computer program products relating to a SmartPass Transfer Crypto Funds to Service Provider process. This feature enables users to transfer cryptocurrency from their SmartPass wallets to a service provider. The process involves transaction execution, balance verification, and regulatory compliance checks. Successful transactions update the user's crypto balance with the provider, with transaction details communicated to regulatory authorities for transparency and adherence to regulations.

Another aspect disclosed herein is directed to different methods, systems, and computer program products relating to a SmartPass Transfer Funds from Service Provider to Wallet process. This process allows users to transfer fiat funds from a service provider back to their SmartPass wallets. It includes validation of transaction details, regulatory compliance checks, and updates to the user's wallet balance. The transparent process ensures regulatory oversight and user convenience in managing funds between service providers and personal wallets.

Another aspect disclosed herein is directed to different methods, systems, and computer program products relating to a SmartPass Transfer Crypto Funds from Provider to Wallet process. Users may transfer cryptocurrency funds from a service provider back to their SmartPass wallet. The process ensures the authenticity of transaction details, compliance with regulatory standards, and updates the user's crypto balance in the SmartPass wallet. This feature enhances the platform's flexibility in handling cryptocurrency transactions while maintaining regulatory compliance.

Another aspect disclosed herein is directed to different methods, systems, and computer program products relating to a SmartPass Transfer Funds from One SmartPass User to Another (Proximity Handler) process. This innovative feature enables peer-to-peer fund transfers between SmartPass users in close proximity. Utilizing Bluetooth Low Energy (BLE) and secure socket connections, the process facilitates secure and efficient fund transfers, strengthened with AML/KYC checks. This proximity-based transfer system enhances user convenience and fosters a secure, community-driven financial ecosystem.

Another aspect disclosed herein is directed to different methods, systems, and computer program products relating to a SmartPass Regulator Authority Records Search/Regulatory Audits process. This process enables regulatory authorities to access and audit user transaction records within their jurisdiction. It employs encrypted record retrieval, ensuring secure access and compliance with regulatory standards. The process allows for comprehensive oversight by regulatory bodies, ensuring platform integrity and adherence to legal requirements.

Another aspect disclosed herein is directed to different methods, systems, and computer program products relating to a SmartPass Location Pattern Engine process. This advanced feature employs machine learning models to validate user location authenticity. It analyzes location data against established movement patterns, identifying potential anomalies indicative of location fraud. This process enhances the platform's security, prevents fraudulent activities, and ensures compliance with location-based regulations.

Another aspect disclosed herein is directed to different methods, systems, and computer program products relating to a SmartPass Identify SmartPass Criteria Data Change process. This feature monitors for changes in data criteria associated with SmartPass tokens. Any alteration in user data triggers an evaluation of the token's validity. This dynamic process ensures continuous compliance with the initial criteria set for token issuance, enhancing security and regulatory adherence.

Another aspect disclosed herein is directed to different methods, systems, and computer program products relating to a SmartPass Data Criteria Update process. This process involves the constant monitoring and updating of user data criteria. Changes in data prompt an assessment of active SmartPass tokens, with invalidation of those not aligning with the updated criteria. This ensures ongoing compliance and security of the platform by adapting to evolving user data and regulatory requirements.

Another aspect disclosed herein is directed to different methods, systems, and computer program products relating to an Extend SmartPass Token Expiration process. This process allows for the extension of SmartPass token expiration periods, subject to user consent. It includes checks for data changes and regulatory compliance, ensuring the renewed token remains valid under updated conditions. This feature provides flexibility in token management while maintaining security and compliance standards.

Another aspect disclosed herein is directed to different methods, systems, and computer program products relating to a SmartPass Device Lost/Stolen process. This feature addresses scenarios where a user's device, running the SmartPass application, is reported lost or stolen. It immediately invalidates access keys and SmartPass tokens associated with the user, preventing unauthorized access. The process includes re-onboarding for users with new devices, ensuring continuous security and user access control in case of device loss or theft.

Another aspect disclosed herein is directed to different methods, systems, and computer program products relating to a SmartPass Token Issuance on Blockchain process. This innovative process involves storing SmartPass tokens on a Blockchain, providing immutable and transparent record-keeping. The Blockchain-based storage increases security and verifiability of token status, making the SmartPass platform robust against unauthorized alterations and enhancing trust among users and regulatory entities.

In at least one embodiment, various method(s), system(s) and/or computer program product(s) may be operable to cause at least one processor to execute a plurality of instructions stored in non-transient memory for: Accessing, by a first server system, a first portion of validated Personal Identifiable Information (PII) data relating to a first user; Receiving, by the first server system, a first user request to authorize the first user's access to the first regulated service; Identifying, by the first server system, a first set of regulatory compliance requirements for permitting user access to the first regulated service; Analyzing, by the first server system, the first portion of validated PII data and the first set of regulatory compliance requirements to determine if the first user satisfies the regulatory compliance requirements for permitting first user access to the first regulated service; Generating, by the first server system in response to determining that the first user satisfies the regulatory compliance requirements, a first unique digital SmartPass token certifying that the first user satisfies the regulatory compliance requirements for permitting first user access to the first regulated service, wherein the first SmartPass token does not include unencrypted PII data relating to the first user; Transmitting, by the first server system, a cryptographically signed version of the first SmartPass token to the first service provider certifying that the first user satisfies the regulatory compliance requirements for permitting first user access to the first regulated service; Facilitating, by the first server system using the first SmartPass token, the first user with regulatory compliant access to the first regulated service.

Additional method(s), system(s) and/or computer program product(s) may be further operable to cause at least one processor to execute additional instructions for generating and transmitting, by the first server system, a first user certification message to the first service provider, certifying that the user associated with a first anonymized identifier satisfies the regulatory compliance requirements for permitting first user access to the first regulated service of the first service provider; wherein the certification is achieved in a manner which obfuscates or hides the first user's PII data from the first service provider, and wherein the certification is achieved without providing first user's PI data to the first service provider.

Additional method(s), system(s) and/or computer program product(s) may be further operable to cause at least one processor to execute additional instructions for generating and transmitting, by the first server system, a first user certification message to the first service provider, certifying that the first user's age satisfies the minimum regulatory age requirements for permitting first user access to the first regulated service without disclosing the user's age or birth date to the first service provider.

Additional method(s), system(s) and/or computer program product(s) may be further operable to cause at least one processor to execute additional instructions for generating and transmitting, by the first server system, a first user certification message to the first service provider, certifying that the first user's nationality satisfies the regulatory nationality requirements for permitting first user access to the first regulated service without disclosing the user's nationality to the first service provider.

Additional method(s), system(s) and/or computer program product(s) may be further operable to cause at least one processor to execute additional instructions for generating and transmitting, by the first server system, a first user certification message to the first service provider, certifying that the first user's current geographic location satisfies the regulatory requirements for permitting first user access to the first regulated service without disclosing the user's current location to the first service provider.

Additional method(s), system(s) and/or computer program product(s) may be further operable to cause at least one processor to execute additional instructions for generating and transmitting, by the first server system, a first user certification message to the first service provider, certifying that the first user's identity satisfies the regulatory KYC requirements for permitting first user access to the first regulated service, without disclosing the user's identity to the first service provider; and assigning a first anonymized identifier to represent the identity of the first user; wherein the certification is achieved in a manner which anonymizes first user's PI data from the first service provider.

In at least one embodiment, various method(s), system(s) and/or computer program product(s) may be operable to cause at least one processor to execute a plurality of instructions stored in non-transient memory for: Initiating, by a first server system, a SmartPass onboarding process by receiving a request to create a new SmartPass wallet account from a user through a SmartPass mobile application; Receiving, by the first server system, user location data including latitude and longitude from the SmartPass mobile application; Calculating, by the first server system, an approximate user location based on the received user location data; Encrypting, by the first server system, the approximate user location using a one-way encryption algorithm and storing it in a database; Requesting, by the first server system, the upload of the user's identity documents, mobile number, email, and a live 3D capture of the user's face to an identity validator; Processing, by the identity validator, the user's identity credentials and determining approval or rejection of the user's identity; In case of approval, retrieving, by the first server system, the user's Personally Identifiable Information (PII) and allowing the user's onboarding; Encrypting, by the first server system, the user's PI using a two-way encryption algorithm and storing it in the database; Generating, by the first server system, a unique identifier for the user based on the user's PII; Conducting, by the first server system, Anti-Money Laundering (AML) and Know Your Customer (KYC) checks based on the user's unique identifier; Sending, by the first server system, the user's PII, unique identifier, and encrypted location data to a regulator authority for monitoring; Creating, by the first server system, a crypto wallet on behalf of the user for storing crypto tokens; Generating, by the first server system, a set of private and public keys for signing communication between the SmartPass mobile application and the first server system, and storing the public key in the user's profile in the database; Approving, by the first server system, the user's onboarding and transmitting a communication private key to the SmartPass mobile application; and Storing, by the SmartPass mobile application, the user's private key locally and unlocking the SmartPass mobile application for the user.

Another aspect disclosed herein is directed to different methods, systems, and computer program products for facilitating user location updates and monitoring in a regulatory compliant manner. In at least one embodiment, various method(s), system(s) and/or computer program product(s) may be operable to cause at least one processor to execute a plurality of instructions stored in non-transient memory for: Receiving, by a first server system, a user location update from a SmartPass mobile application, the update including user location data (ULD) comprising latitude and longitude coordinates and a unique user identifier; Calculating, by the first server system, a user approximate location (UAL) based on the ULD; Encrypting, by the first server system using BCrypt, the UAL in a one-way encryption process and storing the encrypted UAL in a database; Sending, by the first server system, the user's unique identifier and ULD to a Location Pattern Monitor Engine; Processing, by the Location Pattern Monitor Engine, the user's ULD and building a user's profile movement pattern; Determining, by the Location Pattern Monitor Engine, if the user location movement pattern is fake or real based on the new user's coordinates; In case of a fake movement pattern, invalidating all issued SmartPass tokens, temporarily blocking the user's access to the SmartPass mobile application, and informing the user to contact support; Reporting, by the first server system, the incident of fake location movement pattern along with the user's unique identifier to a SmartPass Regulator Authority Monitoring; Encrypting, by the Regulator Authority Monitoring, the incident report using a two-way encryption algorithm and storing the report in a database using the user's unique identifier; Informing, by the first server system, the service provider about SmartPass token invalidation due to fake location pattern; In case of a real movement pattern, returning the calculated UAL to the SmartPass mobile application and invalidating any SmartPass tokens violated based on the new location; Checking, by the first server system, for active issued SmartPass tokens that should be invalidated given the location change; Sending, by the first server system, the user's unique identifier, ULD, UAL, and invalidated SmartPass tokens to the Regulator Authority for compliance monitoring; Encrypting, by the Regulator Authority, the user's ULD, UAL, and invalidated SmartPass tokens using a two-way encryption algorithm and storing them in the database using the user's unique identifier; and Removing, by the first server system, all unencrypted user data to maintain security and privacy.

Another aspect disclosed herein is directed to different methods, systems, and computer program products for facilitating user login and pairing with a service provider service. In at least one embodiment, various method(s), system(s) and/or computer program product(s) may be operable to cause at least one processor to execute a plurality of instructions stored in non-transient memory for: Receiving, by a first server system, a user login or registration request from a SmartPass mobile application; Sending, by the first server system, a provider authentication request including a timestamp, provider ID, and signature to a service provider; Generating, by the service provider, a time-limited token for initiating pairing including a timestamp, expiration, provider ID, session ID, and signature; Responding, by the service provider, to the provider authentication request and sending the time-limited token to the SmartPass mobile application; Initiating, by the first server system, a secure WebSocket connection between the first server system and the service provider; Publishing, by the service provider, a QR code generated for pairing, displaying it to the SmartPass mobile application for scanning; Scanning, by the SmartPass mobile application, the QR code and reading the data contained within, including a unique token; Requesting, by the SmartPass mobile application, pairing by sending user's Personal Identifiable Information (PII), User Location Data (ULD), User Approximate Location (UAL), Unique Identifier, and the scanned token to the first server system, all unencrypted and signed using a private key; Matching, by the first server system, session ID with the authentication request and user pairing request; Requesting, by the first server system, regulatory compliance regulations based on provider ID and UAL from a SmartPass Jurisdiction Regulation Database; Processing, by the Jurisdiction Regulation Database, the request and retrieving regulatory compliance regulations based on provider ID and UAL; Returning, by the Jurisdiction Regulation Database, requested regulatory compliance regulations; Determining, by the first server system, if the user's pairing request is approved or rejected based on validity checks; If approved, generating, by the first server system, a SmartPass token and storing it in a database under the user's account; and Informing, by the first server system, the service provider and the SmartPass Regulator Authority Monitoring of the approval or rejection, with details of the pairing request and the user's unique identifier.

Another aspect disclosed herein is directed to different methods, systems, and computer program products for facilitating age-restricted retail purchases while maintaining user privacy and adhering to regulatory compliance. In at least one embodiment, various method(s), system(s) and/or computer program product(s) may be operable to cause at least one processor to execute a plurality of instructions stored in non-transient memory for: Integrating, by a first server system, SmartPass technology with a retail store's sales system to prompt for age verification upon selection of age-restricted products like alcohol; Receiving, by the first server system, an initial communication from a user's SmartPass Mobile Application when attempting to purchase an age-restricted product, the communication including details of the product and the need for age verification; Determining, by the first server system, compliance restrictions based on the product details and the user's current location to ascertain regional and legal age requirements for the purchase; Verifying, by the first server system, the user's compliance with these regulations using encrypted Personal Identifiable Information (PII) and geolocation data to confirm legal age requirement satisfaction; Generating, by the first server system, a SmartPass token upon successful verification, certifying the user's eligibility for the purchase without revealing exact age or other PII; Transmitting, by the first server system, a computer-readable code representing the SmartPass token to the user's SmartPass App; Presenting, by the user through the SmartPass App, the computer-readable code to the retail store cashier for scanning and initiating the verification process; Validating, by the first server system, the SmartPass token in communication with the retail store's system to confirm the token's authenticity and compliance with age verification requirements; Approving, by the first server system, the user's transaction based on the validated SmartPass token for a smooth purchasing experience; and Reporting, by the first server system, the usage event of the SmartPass token and transaction details to the Regulator Authority database, storing the data using two-way encryption with the Regulator Authority's public key for regulatory monitoring and legal age requirement adherence.

Another aspect disclosed herein is directed to different methods, systems, and computer program products for enabling automated vending machine transactions involving age-restricted products while ensuring regulatory compliance and user privacy. In at least one embodiment, various method(s), system(s) and/or computer program product(s) may be operable to cause at least one processor to execute a plurality of instructions stored in non-transient memory for: Integrating, by a first server system, SmartPass technology into an automated vending machine to enable age verification for the purchase of age-restricted products like tobacco, ensuring compliance with legal age restrictions; Receiving, by the first server system, initial communication from a user's SmartPass Mobile Application when the user selects an age-restricted product from the vending machine, the communication including product details and the necessity of age verification as per tobacco sale regulations; Determining, by the first server system, specific regional and legal age requirements for the tobacco purchase based on the user's location and product details to ensure adherence to local laws; Verifying, by the first server system, the user's compliance with regulatory age requirements using verified Personal Identifiable Information (PII) and geolocation data, confirming the user's legal age for purchasing tobacco while maintaining user privacy; Generating, by the first server system, a customized SmartPass token upon successful age verification and securely transmitting a representation of the SmartPass token to the SmartPass Mobile Application, thereby certifying the user's eligibility for the purchase without revealing personal details; Presenting, by the user through the SmartPass Mobile Application, a computer-readable code representing the SmartPass token to the vending machine's reader for proceeding with the purchase; Validating, by the first server system, the SmartPass token in communication with the vending machine to confirm the token's validity and compliance with age verification requirements; Approving, by the first server system, the user's transaction post successful verification of the SmartPass token, enabling the vending machine to process the purchase and dispense the cigarettes; and Reporting, by the first server system, the transaction involving the user's SmartPass token, along with the purchase details, to the Regulator Authority database, storing the data using two-way encryption with the Regulator Authority's public key for regulatory monitoring and ensuring legal compliance in age-restricted product sales.

Another aspect disclosed herein is directed to different methods, systems, and computer program products for facilitating access to gambling services in compliance with regulatory age restrictions while maintaining user privacy. In at least one embodiment, various method(s), system(s) and/or computer program product(s) may be operable to cause at least one processor to execute a plurality of instructions stored in non-transient memory for: Integrating, by a first server system, SmartPass technology into a casino's slot machines and gambling systems to ensure that only patrons meeting legal age requirements can access gambling services; Receiving, by the first server system, an initial communication from a user's SmartPass Mobile Application when the user attempts to use a slot machine, the communication requesting age verification to comply with gambling age laws; Assessing, by the first server system, specific gambling regulations including age requirements based on the casino's location to ensure compliance with local legal standards for gambling access; Verifying, by the first server system, the user's eligibility for gambling using verified Personal Identifiable Information (PII) and geolocation data, confirming the user meets the legal gambling age while maintaining user privacy; Generating, by the first server system, a customized SmartPass token upon successful age verification, and securely transmitting a representation of the SmartPass token to the SmartPass Mobile Application, certifying the user's eligibility for gambling without disclosing exact age or other PI; Presenting, by the user through the SmartPass Mobile Application, a computer-readable code representing the SmartPass token to the slot machine for scanning and initiating the verification process; Validating, by the first server system, the SmartPass token in communication with the slot machine to confirm the token's authenticity and compliance with age verification requirements; Approving, by the first server system, the user's access to gambling services following successful token verification, enabling the slot machine to allow the user to engage in gambling activities; and Reporting, by the first server system, the use of the user's SmartPass token along with anonymized gambling activity data to the Regulator Authority database, ensuring regulatory oversight and compliance with gambling laws, while protecting patron privacy.

Various objects, features and advantages of the various aspects described or referenced herein may become apparent from the following descriptions of its example embodiments, which descriptions may be taken in conjunction with the accompanying drawings.

### Specific Example Embodiments

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described, or reference herein will sometimes be described in singular form for clarity. However, it should be noted that particular embodiments include multiple iterations of a technique or multiple instantiations of a mechanism unless noted otherwise.

Moreover, it will be appreciated that, via the use of specifically configured computer hardware and software, the problems which are solved and/or overcome by the various SmartPass Platform features and functionality described herein are necessarily rooted in computer technology in order to overcome problems specifically arising in the realm of computer networks and Blockchain networks. For example, specifically configured Blockchain network-based computer hardware and software components (e.g., smart contracts, cryptographic wallets, etc.) are utilized in order to implement one or more of the SmartPass Platform features and functionality described herein on one or more Blockchain networks such as the Ethereum Blockchain network, for example. Such problems and limitations specifically arise in the realm of computer networks, and the solutions to these SmartPass Platform environment problems and limitations (e.g., as described herein) are necessarily rooted in computer technology.

Servers and/or gateways may include one or more processors executing instructions that configure the servers to receive and transmit data over a network such as the Internet. Or, a client and server may be connected over a local intranet or a virtual private network.

Information may be exchanged over a network between the clients and servers. To this end and for security, servers and/or clients may include firewalls, load balancers, temporary storages, and proxies, and other network infrastructure for reliability and security. One or more servers may form an apparatus that implement methods of providing a secure community such as an online social website to network members.

As used herein, instructions refer to computer-implemented steps for processing information in the system. Instructions may be implemented in software, firmware or hardware and include any type of programmed step undertaken by components of the system.

A processor may be any conventional general-purpose single- or multi-chip processor that may execute logic by means of various lines such as address lines, data lines, and control lines and registers and shift registers.

Software modules described by way of the flow charts and user interfaces herein may include various sub-routines, procedures, etc. Without limiting the disclosure, logic stated to be executed by a particular module may be redistributed to other software modules and/or combined together in a single module and/or made available in a shareable library.

Present principles described herein may be implemented as hardware, software, firmware, or combinations thereof; hence, illustrative components, blocks, modules, circuits, and steps are set forth in terms of their functionality.

The functions and methods described below, when implemented in software, may be written in an appropriate language such as but not limited to Java, TypeScript, JavaScript, C# or C++, and may be stored on or transmitted through a computer-readable storage medium such as a random access memory (RAM), read-only memory (ROM), electrically erasable programmable read-only memory (EEPROM), compact disk read-only memory (CD-ROM) or other optical disk storage such as digital versatile disc (DVD), magnetic disk storage or other magnetic storage devices including removable thumb drives, etc. A connection may establish a computer-readable medium. Such connections may include, as examples, hard-wired cables including fiber optics and coaxial wires and digital subscriber line (DSL) and twisted pair wires. Such connections may include wireless communication connections including infrared and radio.

Further to what has been alluded to above, logical blocks, modules, and circuits described below may be implemented or performed with a general-purpose processor, a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor may be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in those art. Where employed, the software instructions may be embodied in a non-transitory device such as a hard disk drive, CD ROM or Flash drive. The software code instructions may also be downloaded over the Internet.

Components included in one embodiment may be used in other embodiments in any appropriate combination. For example, any of the various components described herein and/or depicted in the Figures may be combined, interchanged or excluded from other embodiments.

In an aspect, an article of manufacture includes at least one computer storage that is not a transitory signal and that in turn includes instructions executable by at least one processor to access a data structure containing information related to non-monetary content, and to access at least a first Blockchain containing information related to ownership of content represented in the data structure. The instructions are executable to use the information in the Blockchain and data structure to obtain content represented in the data structure.

In some examples, the instructions may be executable to access a Blockchain containing information related to publishers of content in the data structure, and to use the information related to publishers of content to obtain content represented in the data structure. Example instructions may be further executable to access a Blockchain containing information related to retailers of content in the data structure, and to use the information related to retailers of content to obtain content represented in the data structure. Still further, example instructions may be executable to access a Blockchain containing information related to distribution rights related to content in the data structure, and to use the information related to distribution rights to obtain content represented in the data structure. In some implementations, the Blockchain containing information related to publishers, the Blockchain containing information related to retailers, and the Blockchain containing information related to distribution rights are implemented by a single third Blockchain. In other implementations, the Blockchain containing information related to publishers, the Blockchain containing information related to retailers, and the Blockchain containing information related to distribution rights are implemented by respective separate third, fourth, and fifth Blockchains. The data structure representing content may be a Blockchain such as the first Blockchain or a second Blockchain different from the first Blockchain.

In another aspect, a system includes a processor-executed rule module that includes instructions about how a processor-accessible ownership Blockchain and a processor-accessible data structure (such as a content Blockchain) are added to and how the validity of the Blockchains is verified. The instructions also include a type of content information that may be stored in the content Blockchain. The system includes the processor-accessible ownership Blockchain, which includes a chain of ownership blocks having information related to ownership of content in the processor-accessible content Blockchain. The information related to ownership of content includes information of a type of content indicated in the content Blockchain that is owned. The system further includes the processor-accessible content Blockchain with information about the content for which the system may track ownership as reflected in a series of content blocks.

In examples, content ownership indicated in the ownership Blockchain indicates particular pieces of content. In other examples, content ownership indicated in the ownership Blockchain indicates units of a particular type of content.

In non-limiting embodiments content ownership indicated in the ownership Blockchain indicates ownership for fractional units of content.

If desired, the instructions in the processor-executed rule module provide a mapping of a new value to a type that it is assigned. The mapping of a new value to a type may be based at least in part on weightings of plural respective types so that statistically over time a number of new values created of a given type is proportional to that type's respective weighting. In some examples, the mapping may be executed at least in part based on a modulo of an identification of a new value and mapping different types to modulo values depending on their respective weightings.

Content represented in the processor-accessible content Blockchain may include one or more of: video game objects, video games, video content, audio content. In another aspect, a method includes independently tracking ownership of content using an ownership Blockchain, independently tracking, using a content data structure such as a content Blockchain, content related to ownership of content indicated in the ownership Blockchain, and managing alteration of the Blockchains using a rule module.

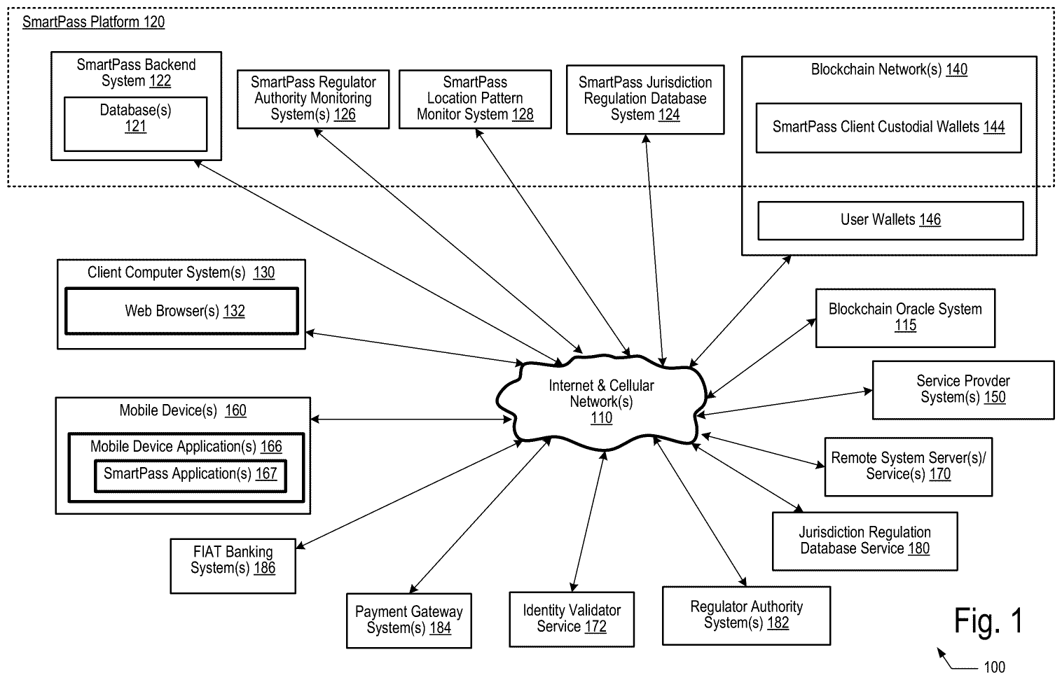

FIG. 1 illustrates a simplified block diagram of a specific example embodiment of a portion of a computerized data network which includes specifically configured network-based computer hardware and software components for facilitating, enabling, initiating, and/or performing one or more of the SmartPass Platform features and functionality described and/or referenced herein. According to different embodiments, the Data Network portion 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Data Network may comprise various types of systems, components, devices, databases, services, etc., as described below.

### SmartPass Technology Platform 120 (Herein “SmartPass Platform”)

According to different embodiments, the SmartPass Platform provides a sophisticated technology ecosystem designed to offer secure, anonymous, and pseudonymous authentication and transaction capabilities for users engaging with online services, especially those regulated by authorities. This platform is particularly significant for its approach in enabling users to comply with KYC and/or other regulatory compliance verification requirements while at the same time allowing such users to keep desired portions of their Personal Identifiable Information (PII) private or unrevealed. In at least one embodiment, the SmartPass Platform offers a robust solution for secure, anonymous online service access and transactions, balancing user privacy with regulatory compliance. It leverages Blockchain technology, user-centric data management, and a comprehensive ecosystem involving various stakeholders, making it a versatile platform for modern digital authentication/authorization and transaction needs.

The SmartPass Platform 120 presents an innovative approach in the realm of online service accessibility, combining user privacy with regulatory compliance. A significant aspect of its functionality is the empowerment of users to manage their Personal Identifiable Information (PII) with high precision and privacy. This is facilitated through the SmartPass mobile application, which stores the user's PI securely on their device.

One notable aspect of the platform's functionality is the unique way it handles Know Your Customer (KYC) and Geofencing and regulatory compliance verification. SmartPass allows compliance with these requirements while keeping PI private. This is particularly advantageous for users who may require anonymity but need to access services that are heavily regulated. The platform's approach to anonymous transactions further underscores this advantage. Users may engage in transactions with service providers using wallet credits, which may be in the form of real-world currency or crypto tokens such as USDC, without revealing their identity.

A distinctive feature of the SmartPass Platform is the issuance of dynamic SmartPass Tokens certifying that an identified, anonymous or pseudonymous SmartPass user satisfies all the jurisdictional and regulatory compliance requirements for permitting that user to access a specific service provided by specific service provider. In this way, SmartPass Token functions as digital regulatory compliance certification “visas”, enabling SmartPass users to anonymously or pseudonymously access various types of regulated and non-regulated online services while maintaining user anonymity, and providing service providers with desirable regulatory compliance certifications that each SmartPass user accessing the service provider's services satisfies the minimum regulatory compliance requirements for permitting users to access the service provider's services.

The platform also introduces an innovative concept of user consent for PI sharing. Users have the option to share their PII with service providers, potentially in exchange for incentives, thereby creating a value proposition for sharing personal data. This feature adds a layer of user empowerment, as it places the control of data sharing squarely in the hands of the user.

Furthermore, the SmartPass Platform 120 caters to a diverse range of entities, including service providers, users, regulators, and verification authorities. Each entity plays a distinct role within the SmartPass Platform ecosystem, contributing to its holistic functionality. Service providers, for example, may utilize SmartPass tokens for user certification and compliance with regulatory standards, users benefit from anonymous access to services, and regulatory authorities are able to utilize the SmartPass Platform to perform regulatory compliance monitoring and enforcement activities. From a technological standpoint, the platform is robust, featuring decentralized system components such as the Service Provider Library, SmartPass Mobile App, Backend Services, and a Blockchain network. The integration of these components ensures a seamless and secure operation of the platform.

The advantages of the SmartPass Platform are numerous. It enhances privacy and security through decentralized data storage and Blockchain technology. The platform ensures regulatory compliance for both users and service providers, streamlining adherence to governmental regulations. It offers flexible and user-centric identity management through its wallet and SmartPass system. The integration with service provider applications is seamless, thanks to the Service Provider Library, and real-time location verification ensures compliance with geographical restrictions. The SmartPass Technology Platform 120 is a versatile and secure ecosystem that harmonizes the need for privacy and regulatory compliance in the digital world. Its ability to manage and protect user PII, provide anonymous transaction capabilities, and ensure regulatory compliance positions it as a pioneering solution in the realm of online service accessibility. The SmartPass Platform technology provides a comprehensive solution that uniquely blends user privacy, security, and regulatory compliance verification in online environments. This platform is significant for its approach to handling Personal Identifiable Information (PII), its innovative user onboarding, and its service provider integration processes.

As described in greater detail herein, the SmartPass Platform technology provides and/or enables a range of functionalities, features, and benefits, primarily centered around enhancing online authentication and authorization and transactional security while maintaining user anonymity and data privacy. Described below are various features, functionalities, benefits and/or advantages of the SmartPass Platform technology. Example Functionalities and Features of the SmartPass Platform may include, but are not limited to, one or more of the following (or combinations thereof):
User-Managed Personal Identifiable Information (PII): In at least one embodiment, the SmartPass Platform includes a SmartPass mobile application which stores a user's PI on the user's mobile device or trusted storage. The user's stored PII is managed solely by the user via the SmartPass mobile application. This approach allows verification of user eligibility for services without sharing PII with service providers, unless explicitly approved by the user.
Anonymous Know Your Customer (KYC) and Regulatory Compliance Verification: The SmartPass Platform enables users to comply with KYC and/or other regulatory compliance verification requirements of online service providers, and in a manner which allows such users to keep desired portions of their Personal Identifiable Information (PII) private or unrevealed.
Anonymous Transactions: The SmartPass Platform enables users to transact anonymously with service providers using wallet credits, which may be real-world currency, crypto tokens, or coins like USDC.
Dynamic SmartPass Tokens: The SmartPass Platform is configured or designed to include functionality for dynamically issuing anonymized SmartPass Tokens for a given user, which act as regulatory compliance “visas” for enabling the user to access various online services. In at least one embodiment, SmartPass Tokens may be automatically and/or dynamically generated after external verification and are configured or designed to maintain user anonymity. According to different embodiments, at least one SmartPass Token may be automatically and dynamically generated and configured by the SmartPass Platform Backend System (“SmartPass Backend System”), where at least one SmartPass Token is individually configured with its own customized set of SmartPass Token configuration criteria specifying various user-related details, permissions and/or restrictions relating to the use of that SmartPass Token. Examples of such SmartPass Token configuration criteria may include, but are not limited to, one or more of the following (or combinations thereof):
   SmartPass Token expiration date/time
   User's current physical geographic location
   Service Provider criteria
   Session ID
   User Verified to be at least X years of age
   User ID documentation validated
   User Citizenship confirmed
   SmartPass Token ID
   Mobile number valid
   Valid SS #
   Valid ID document
   Email address valid
   VAT ID valid
   SmartPass Token issuing date/time
   Service Provider ID
   Service Provider Type
   Gender confirmed
   Special Facial Characteristics confirmed i.e. face mole etc
   Driver's license number confirmed
   Credit/Debit card numbers confirmed
   Bank account numbers confirmed
   Passport number confirmed
   Health related information confirmed
   Biometric data confirmed
   Account credentials confirmed
   Employment/Occupation information confirmed
   Vehicle registration number confirmed
   Criminal record confirmed
   Social media information confirmed
   Education info/records confirmed
   Family information confirmed
   Sexual orientation confirmed
   Certifications confirmed
   Degree and/or education confirmed
   Senior citizen confirmed
   Legal voter confirmed
User Consent for PI Sharing: Users have the option to share their PII with service providers in exchange for rewards or bonuses, ensuring user control and consent in data sharing.
SmartPass Token for Anonymous Access: Users accessing SmartPass-powered services, like regulated ones, receive a notification that data may be verified by SmartPass and an external authority. An anonymized, short-lived public token called SmartPass is issued, acting as a passport to access the service provider's service.
Credit Management: The platform handles credits which may be in the form of real-world currency, crypto tokens, or coins like USDC. Users may pay for services anonymously using these credits, with options to convert between crypto and fiat currencies.

Example Advantages and Benefits of the SmartPass Platform technology may include, but are not limited to, one or more of the following (or combinations thereof):
Enhanced Privacy and Security: By storing PII on user devices and using Blockchain technology, SmartPass ensures high levels of data security and user privacy.
Regulatory Compliance: Designed to align with governmental regulations, SmartPass Platform facilitates compliance for both users and service providers.
Flexible User Identity Management: The platform's approach to user identity, via a wallet and SmartPass, provides flexibility and control to users over their personal data.
Seamless Integration with Service Providers: Through its Service Provider Library, SmartPass facilitates easy integration with service provider applications, enhancing user experience and operational efficiency.
Real-Time Location Verification: The platform employs advanced algorithms for real-time and accurate location verification of SmartPass users, helpful for services with geographical restrictions.
Transparent and Immutable Transaction Records: Utilizing Blockchain technology ensures that transactions are transparent, immutable, and secure.
Versatile Payment Options: Supports various forms of currencies, including crypto, providing users with versatile payment options.
Comprehensive User Onboarding: The onboarding process is thorough, covering aspects like wallet creation, identity verification, and regulatory compliance.

In at least one embodiment, the SmartPass Platform may comprise different types of specialized systems and components, including, for example:
SmartPass Backend System 122
SmartPass Regulator Authority Monitoring System(s) 126
SmartPass Location Pattern Monitor System 128
SmartPass Jurisdiction Regulation Database System 124
SmartPass Client Custodial Wallets 144
SmartPass Application(s) 167

### SmartPass Backend System 122

The SmartPass Backend System (122) is a sophisticated, secure, and scalable solution, playing a supportive role in the functionality of the SmartPass Platform. It effectively unifies user data management, Blockchain interactions, robust security measures, and regulatory compliance, offering a comprehensive backend solution for the platform. As it continuously evolves to align with changing user needs and regulatory landscapes, the SmartPass Backend System remains a desirable component of the SmartPass Platform's infrastructure.

In at least one embodiment, the SmartPass Backend System forms the backbone of the SmartPass Platform, delivering a suite of functionalities supportive to the platform's operation. Its primary role involves managing user data, interfacing with Blockchain networks, integrating various system components, and maintaining stringent security protocols. The system is designed with scalability and reliability at its core, ensuring it may handle fluctuating operational demands while providing consistent performance.

At the heart of the SmartPass Backend System lies its user data management functionality. This feature meticulously handles and processes user-related information while strictly adhering to privacy and regulatory standards. The system facilitates the entire user onboarding journey, which encompasses registration, verification, and authentication and authorization processes. This comprehensive approach ensures a seamless and secure user experience from the outset.

An integral aspect of the SmartPass Backend System is its Blockchain network interface. This functionality facilitates processing transactions and maintaining Blockchain records. It is responsible for the creation, validation, and recording of Blockchain transactions, thereby ensuring the integrity and security of data on the Blockchain.

The system also excels in integrating and communicating with other components of the SmartPass Platform and external services. This includes managing interactions with payment gateways, service providers, and other necessary integrations. The seamless data processing and service requests handled by the system are desirable for the platform's efficient operation.

Security is a cornerstone of the SmartPass Backend System. It incorporates advanced encryption methods, secure data storage techniques, and regular security audits to maintain high data integrity and confidentiality. These measures protect the system against various cyber threats, thereby ensuring the safety of user data and platform operations.

Another notable feature of the SmartPass Backend System is its hosting on the cloud. This choice of infrastructure supports the SmartPass Application, particularly the mobile app, by managing its business logic and securing information transmission. The cloud hosting also contributes to the system's scalability and reliability.

The connection protocols used by the system are a testament to its commitment to security and efficiency. It employs HTTPS for RESTful APIs and WebSockets Secure (WSS) for WebSocket connections, ensuring secure and effective communication between the SmartPass Backend and other system components.

The user flow support provided by the SmartPass Backend System is comprehensive. It includes processes such as user onboarding, real-time location evaluation, identity verification, and the issuance and revocation of SmartPass tokens. The system's integration with Know Your Customer (KYC) partner providers for identity validation provides a supportive aspect of this functionality.

The Blockchain communication feature of the SmartPass Backend System is particularly noteworthy. It manages real-time communication with the Blockchain through the SmartPass Platform's Blockchain contract. This includes managing the issuance and revocation of Provider branded SmartPass tokens and handling token transfers.

In terms of data encryption and storage, the SmartPass Backend System goes above and beyond to ensure privacy compliance. It encrypts and securely stores users' Personally Identifiable Information (PII) and other necessary data, maintaining regulatory compliance by making this data available for regulator requests.

One of the significant use cases of the SmartPass Backend System is the issuance of Service Provider-specific regulatory compliance visas. This process ensures compatibility with government regulations and leverages verification authorities for SmartPass issuance. The system also adeptly manages SmartPass tokens, facilitating their invalidation upon violation of regulations and enabling users to revoke or cancel their SmartPass record.

The benefits and advantages of the SmartPass Backend System are manifold. It offers unparalleled security and compliance, ensuring adherence to regulatory requirements and building trust among users and regulatory bodies. Its scalability and flexibility allow it to adapt to varying operational demands without compromising service quality. The system's integration and interoperability capabilities enhance the user experience and expand service offerings. Finally, its commitment to data integrity and confidentiality safeguards user information, enhancing the platform's credibility and reliability.

### SmartPass Application 167/SmartPass Mobile Application 370

SmartPass Applications 167 are software solutions developed to facilitate interaction between users and the SmartPass Platform. These applications serve as the front-end interface, providing tools and functionalities for accessing platform services. They are designed to cater to various stakeholders, including individual users, service providers, and regulatory authorities. The applications offer user authentication and authorization and identity verification services, ensuring secure access to the platform. They come equipped with features for managing digital assets, such as viewing asset portfolios, initiating transactions, and tracking asset performance. The applications also provide tools for compliance management, assisting users in navigating the regulatory aspects of digital asset handling.

SmartPass Applications 167 include communication features that enable users to interact with service providers and platform support. They offer customized dashboards and reporting tools, allowing users to monitor their activities and manage their accounts effectively. The applications are built with a focus on user experience, offering an intuitive and responsive design for ease of use.

SmartPass Mobile Applications 370 are specialized mobile SmartPass Application software designed to extend the functionalities of the SmartPass Platform to mobile devices. These applications allow users to access and manage their digital assets and transactions on the go. They are optimized for mobile interfaces, providing a seamless and user-friendly experience on smartphones and tablets.

The mobile applications feature capabilities for managing digital wallets, enabling users to store, send, and receive digital currencies and assets. They support real-time notifications and alerts, keeping users updated on their account activities and market movements. The applications also facilitate mobile-based authentication, enhancing security and convenience for users accessing the platform.

In addition to asset management, SmartPass Mobile Applications offer geolocation services, relevant for services that are sensitive to user location. They integrate with the device's hardware features, such as cameras and biometric sensors, to provide enhanced functionality like QR code scanning and biometric authentication/authorization.

The applications are regularly updated to incorporate the latest security measures, ensuring the protection of user data and assets. They are designed to work seamlessly with the backend systems of the SmartPass Platform, ensuring data synchronization and real-time access to platform services.

The SmartPass Application preferably offers the tools needed to certify that a user is eligible to use a Provider service based on the restrictions applied by at least one controlling authority. The tools include but not limited to geo location tools, Know Your Customer (KYC) tools. SmartPass Application is built with “User's Privacy First” approach without jeopardizing the principles enforced by the regulator or other authorities.

In at least one embodiment, the SmartPass Application may store user's PI securely on user's mobile device and may only share with the SmartPass Backend the information needed to confirm that the user is eligible to access Provider's services. Shared information may be stored in memory only and used only temporarily by the SmartPass Backend during the confirmation process and is preferably destroyed when the confirmation process ends.

The SmartPass Application may communicate with the SmartPass Backend and the Blockchain to Onboard users, calibrate and identify their current location and retrieve and store locally the anonymized and time-limited public SmartPass token tokens that constitute a passport to use Providers' online services. It may also present and manage the user's wallet and handle financial or crypto transactions from SmartPass Application to Provider and vice versa.

The SmartPass Application may also be responsible to monitor user's location in real time and possible other user's activities and revoke generated SmartPass tokens that may be violated by the user's new location.

In at least one embodiment, the SmartPass Application may never store user's PI on the chain (encrypted or not). It may only save a SmartPass unique ID, a timestamp, country and state and other required metadata, so the verification process may be performed. In some embodiments, the SmartPass Application pays all gas fee and other fees related to the management of SmartPass entities on the Blockchain side.

Below is a description of various features, functionalities, use cases, benefits and advantages of the SmartPass Application(s).

User Interface and Accessibility: The SmartPass Application, a native mobile application, is meticulously designed to provide a seamless user experience on personal devices. The application's user interface is crafted to prioritize user-friendliness, ensuring that even those with minimal technical expertise may navigate its features with ease. It focuses on making the process of holding and sharing user wallets straightforward, thus catering to a broad range of users. This approach to design not only enhances the accessibility of the application but also promotes its widespread adoption. By emphasizing simplicity and ease of use, the SmartPass Application positions itself as a reliable and convenient tool for users, aligning with the modern-day expectation of technology that is both functional and user-friendly.

Secure Storage of Personal Information (PII): The SmartPass Application places a high emphasis on the security and confidentiality of Personal Identifiable Information (PII). It ensures that PII is securely stored on the user's mobile device, adopting a robust approach to data protection. The transfer of information to the SmartPass Backend is meticulously controlled, limiting it exclusively to situations where eligibility confirmation for accessing provider services is required. This selective sharing of data underscores the application's commitment to privacy, as it only utilizes user information temporarily and ensures its destruction post-confirmation. Such security measures instill confidence among users regarding the safeguarding of their sensitive data, thereby enhancing trust in the SmartPass ecosystem.

Communication and Onboarding: The SmartPass Application establishes a dynamic communication channel with the SmartPass Backend System and the Blockchain network to facilitate user onboarding. This process involves precise identification and calibration of the user's current location, a supportive step for ensuring the legitimacy and accuracy of user data. Post-location calibration, the application efficiently retrieves and locally stores time-limited, anonymized public SmartPass token tokens. These SmartPasses facilitate user access to various provider services, streamlining the onboarding process. By integrating these functionalities, the SmartPass Application not only ensures a smooth onboarding experience but also lays the foundation for secure and compliant access to a range of services.

Wallet Management and Transaction Handling: The SmartPass Application adeptly manages user wallets, encompassing both financial and crypto transactions. It acts as a bridge between users and service providers, ensuring fluid financial interactions. This management includes the facilitation of transactions, maintaining the integrity and security of at least one transaction. The application's ability to handle a diverse range of transactions, be it fiat currency or cryptocurrency, positions it as a versatile tool for modern financial management. Its capability to seamlessly integrate with various service providers further enhances its utility, making it an indispensable asset for users in the digital financial ecosystem.

Real-Time Location Monitoring: Incorporating real-time location monitoring, the SmartPass Application offers a supportive feature for maintaining compliance with geographical restrictions. It continuously tracks the user's location and has the capability to revoke SmartPass tokens if the user's new location breaches predefined conditions. This functionality facilitates adhering to the legal and regulatory requirements specific to different regions and services. By ensuring that users only access services permissible in their current location, the SmartPass Application upholds regulatory compliance, thereby protecting both the user and the service providers from potential legal repercussions.

Certification and Compliance Tools: The SmartPass Application is equipped with an array of tools designed for certifying user eligibility in compliance with service restrictions set by authorities. It integrates advanced geolocation and Know Your Customer (KYC) tools, striking a balance between meeting regulatory requirements and preserving user privacy. These tools may be configured or designed to include functionality for verifying user identities and ensuring that access to services is granted only to eligible users. This adherence to regulatory norms not only bolsters the legitimacy of the SmartPass platform but also fortifies user trust, knowing that their interactions are within the bounds of legal and regulatory frameworks.

Blockchain Interaction: The SmartPass Application's interaction with Blockchain technology is meticulously designed to ensure user privacy. While it engages with the Blockchain for various functionalities, it is programmed never to store user PII on the Blockchain. Instead, it handles desirable metadata supportive for verification processes, demonstrating a well-thought-out balance between transparency and privacy. Additionally, the application manages Blockchain-related expenses, such as gas fees, which is a significant aspect of Blockchain interactions. This management alleviates the user from the complexities associated with Blockchain transactions, thereby enhancing the user experience.

Asset Management Features: The application offers a comprehensive suite of asset management features. These features enable users to view their digital asset portfolios and initiate transactions with ease. Additionally, the application provides tools to track asset performance, aiding users in making informed decisions regarding their digital assets. This holistic approach to asset management caters to the evolving needs of modern users, who seek a unified platform that not only facilitates transactions but also provides insights into asset performance.

Communication and Reporting Tools: The SmartPass Application facilitates effective communication between users and service providers, as well as platform support. It offers customized dashboards and reporting tools, empowering users with efficient account management capabilities. These tools are designed to provide users with a comprehensive view of their account activities, thereby enhancing their ability to make informed decisions and manage their accounts effectively.

Mobile Optimization: The SmartPass Mobile Applications are specifically tailored for mobile devices, offering a user-friendly experience on smartphones and tablets. The application leverages the capabilities of mobile devices, integrating with their hardware for advanced functionalities like QR scanning and biometric authentication/authorization. This optimization ensures that users enjoy a seamless and intuitive experience, regardless of their device type.

Security and Updates: Security is a paramount concern for the SmartPass Application, which is why it undergoes regular updates to incorporate the latest security measures. The application is designed to work seamlessly with backend systems, ensuring data synchronization and real-time access to services. This approach not only enhances the security of the application but also ensures that users always have access to the most current features and functionalities.

Geolocation Services: The Geolocation Services feature of the SmartPass Application may be configured or designed to include functionality for ensuring user compliance with geographical restrictions and regulatory requirements. This feature is integrated into the SmartPass Mobile Applications, extending its functionalities to mobile devices. The application utilizes the device's hardware capabilities, such as GPS, to provide real-time tracking of the user's location. This geolocation tracking facilitates services that are sensitive to the user's physical location, ensuring that access to various digital services is granted only when the user is within the permissible geographical boundaries.

In at least one embodiment, the SmartPass Application's geolocation services are designed to monitor the user's location in real time. This continuous monitoring is desirable for maintaining compliance with legal and regulatory norms specific to different regions and services. When the application detects that a user has moved to a new location that violates the predefined conditions of their SmartPass tokens, it has the capability to revoke these SmartPasses automatically. This feature is particularly important for service providers who need to adhere to strict geographical service restrictions.

Furthermore, the application's geolocation services are integral to the onboarding process. During user calibration and identification, the application determines the user's current location, which is then used to retrieve and store locally the time-limited public SmartPass token tokens (also referred to herein as “SmartPass tokens” or “Regulatory Compliance Visas”. These SmartPasses enable users to access online services offered by various providers, making location accuracy an important component of the application's functionality.

Enhanced Functionalities: The application supports real-time notifications and alerts, keeping users informed and engaged. It also facilitates mobile-based authentication/authorization, enhancing the overall security of user interactions with the platform. These enhanced functionalities contribute significantly to the user experience, ensuring that the SmartPass Application remains at the forefront of technological advancements.

User Experience Focus: The SmartPass Application is built with a strong focus on user experience. It features an intuitive design that simplifies user interactions, making it easy for users to navigate and utilize the application's features. This focus on user experience is fundamental to the application's design philosophy, ensuring that users have a positive and efficient interaction with the platform.

Compliance Management Tools: The application assists users in navigating the complex landscape of digital asset management, particularly in terms of regulatory compliance. It ensures that users adhere to relevant laws and regulations, thereby safeguarding them from potential legal issues. This feature is especially important in a landscape where digital asset regulations are constantly evolving.

Asset Synchronization: Ensuring consistent synchronization with the SmartPass Platform, the application provides real-time service access. This synchronization facilitates maintaining the accuracy and timeliness of the information and services provided to the user, thereby enhancing the overall reliability and efficiency of the SmartPass ecosystem.

Advantages and Benefits: The SmartPass Application offers a multitude of advantages and benefits including, for example:
Security: It prioritizes the protection of user data with secure storage and controlled data sharing mechanisms.
User Convenience: The application streamlines financial transactions and asset management through an intuitive mobile interface.
Regulatory Compliance: It ensures that users comply with relevant regulations, including geolocation restrictions.
Real-Time Updates: Users are kept informed about account activities and market movements.
Enhanced Accessibility: The platform extends its functionalities to mobile users, offering flexibility and mobility.

### Service Provider System(s) 150:

In at least one embodiment, a Service Provider is an organization that is offering a service a user wants to access and use. Service Providers may desire to make sure that their users are certified and fulfill the restrictions applied by the regulator authorities or other entities who are controlling the access to this service. Service Providers may utilize the SmartPass Platform technology to handle this certification and compliance process.

Service Provider Systems are a diverse group of entities offering various online services that are significantly regulated and monitored for compliance with jurisdictional rules and regulations. Below are different examples of such services, at least one with an explanation of how SmartPass Tokens, functioning similarly to passport visas, may ensure proper compliance.
Online Gambling and Betting Platforms: These platforms offer services like poker, sports betting, and casino games. They are heavily regulated to prevent underage gambling and ensure fair play. SmartPass Tokens may be used to verify the age and location of users, ensuring they are within jurisdictions where gambling is legal. At least one token may represent a user's eligibility to participate in specific gambling activities, updated based on real-time regulatory changes.
Financial Trading Platforms: Services include stock trading, forex, and cryptocurrency exchanges. Regulations focus on preventing fraud, insider trading, and money laundering. SmartPass Tokens may act as a certification of a user's qualification and understanding of trading risks, as well as adherence to anti-money laundering (AML) standards.
Telemedicine Services: These platforms provide online health consultations and prescriptions. They are regulated for patient privacy (HIPAA compliance in the U.S.) and proper medical conduct. SmartPass Tokens may certify a user's geographical location to ensure the provider is licensed in that region and confirm the user's identity for privacy protection.
Video Streaming Services Offering Restricted Content: These include services that offer movies and shows with age-restricted content. Regulations ensure that underage viewers cannot access inappropriate material. SmartPass Tokens may be used to verify a user's age before granting access to certain content categories.
Online Education Platforms with Certification Programs: These platforms offer courses that end with certifications or degrees. Regulations ensure the educational content meets certain standards. SmartPass Tokens may represent a user's progress and completion of regulatory requirements for certification.
Online Pharmacies: These platforms sell prescription and over-the-counter drugs. Regulations are in place to ensure the legality and safety of drugs sold. SmartPass Tokens may verify a user's prescription validity and medical history, ensuring compliance with drug dispensation laws.
E-Commerce Platforms Selling Age-Restricted Products: This includes the sale of items like alcohol, tobacco, or vape products, which have age restrictions. SmartPass Tokens may be used to confirm a buyer's age and location, ensuring that sales comply with local laws.
Ride-Sharing and Transportation Services: These platforms connect drivers with passengers. Regulations often involve driver certification and vehicle safety standards. SmartPass Tokens may certify a driver's legal status to operate a vehicle and adherence to safety inspections.
Online Dating Services: Especially those with age restrictions or targeting specific demographics. Regulations focus on user safety and preventing fraud. SmartPass Tokens may verify users' ages and the authenticity of their profiles, ensuring safer interactions.
Online Real Estate and Rental Services: These platforms list properties for sale or rent. Regulations involve fair housing laws and accurate property descriptions. SmartPass Tokens may verify a user's eligibility for specific housing programs and confirm adherence to fair housing regulations.

In at least one of these services, SmartPass Tokens function as digital visas, granting or restricting access based on compliance with jurisdictional rules and regulations. When a user registers on a regulated service platform, the SmartPass system verifies their eligibility based on the service's regulatory requirements. This verification process involves checking the user's location, age, and other criteria as dictated by the regulation governing that service.

For instance, in online gambling, a SmartPass Token is issued only after verifying that the user is of legal gambling age and is accessing the service from a location where gambling is legal. Similarly, for financial trading platforms, the token may certify that the user has passed necessary financial literacy tests and is not part of any watchlist for financial fraud.

These tokens are dynamic and may be updated or revoked based on changes in a user's status or in regulatory laws. For example, if a user relocates to a jurisdiction where a service is no longer legal, the relevant SmartPass Token may be automatically adjusted to restrict access, maintaining compliance.

Moreover, SmartPass Tokens facilitate a streamlined user experience. Once a user is verified and granted a token, they don't need to undergo repeated checks for at least one session or transaction, as their compliance status is encapsulated within the token. This process also aids service providers by simplifying the compliance verification process, reducing administrative burden, and ensuring a higher level of accuracy in adherence to regulations.

For Service Providers Providing multiple different regulative services such as gambling and access to adult content for example, in one embodiment separate SmartPass tokens may be issued to allow users to perform at least one of those activities individually under at least one individual SmartPass token.

Users may access the SmartPass Platform via Internet & Cellular Network(s) 110. In at least one embodiment, a User maybe be an individual or an organization or other that access or uses a service provided by a Service Provider 150, for example a regulated service, offered by a Service Provider and at the same time preserve anonymity. Users are worrying about their PII and want to be in control of when, where, why, how and by whom this data is being used.

Moreover, they may need a way to keep their data secure on a safe place they own and share with any regulated service they intent to access avoiding performing the KYC or other signup processes again and again.

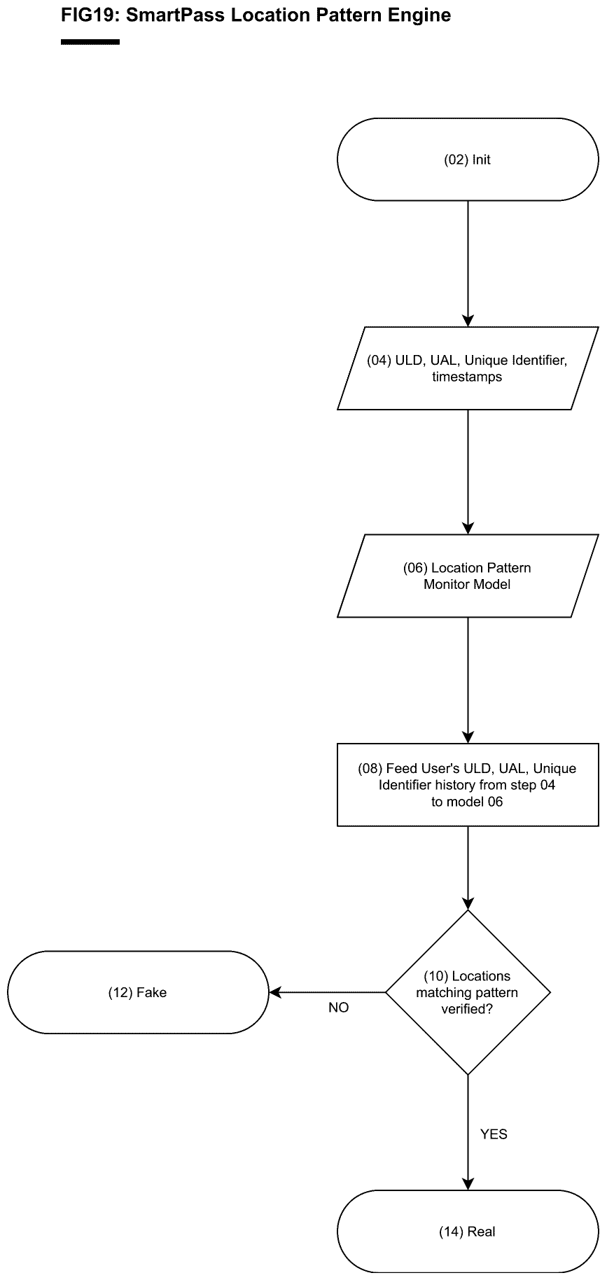

Other components, systems, and/or entities of the Data Network 100 of FIG. 1 may include, but are not limited to, one or more of the following (or combinations thereof):
SmartPass Regulator Authority Monitoring System(s) 126: SmartPass Regulator Authority Monitoring System(s) 126 are integrated within the SmartPass Platform to ensure adherence to regulatory standards. These systems continuously monitor and analyze transactions and user activities for compliance with relevant laws and regulations. They are equipped with tools for reporting, alerting, and auditing functions, providing oversight on compliance matters. These systems are supportive in maintaining the legal integrity of the SmartPass Platform's operations, ensuring that all activities are within the bounds of regulatory requirements.
SmartPass Location Pattern Monitor System 128: The SmartPass Location Pattern Monitor System 128 is designed to track and analyze the geographical movement patterns of users within the SmartPass Platform. This system uses geolocation data to ensure compliance with location-based regulations and services. It may detect anomalies or non-compliant user behavior based on location data, providing insights and alerts to the platform administrators. This system is particularly relevant in services where user location provides a supportive factor for regulatory or operational reasons. In at least one embodiment, SmartPass Location Pattern Monitor System may be deployed as an entity which utilizies a machine learning model pre-trained on human movement patterns in and out a jurisdiction. For example to get in Nevada jurisdiction you may either fly in an airport from another airport or drive through the state borders. The objective is to identify and report the possibility of fake location report (Fake Address Reporting). More details may be found with respect to FIG. 19.
SmartPass Jurisdiction Regulation Database System 124: The SmartPass Jurisdiction Regulation Database System 124 stores and manages a comprehensive collection of regulatory and legal information applicable to various jurisdictions. This system is responsible for maintaining up-to-date data on laws, rules, and restrictions relevant to the services offered by the SmartPass Platform. It enables the retrieval and updating of this information to ensure that services provided are in compliance with the regulatory framework of different regions. This system facilitates the adaptation of services to regional legal requirements and aids in maintaining regulatory adherence for the SmartPass Platform.
Database(s) 121: Database(s) 121 within the SmartPass Platform are structured systems for storing, managing, and retrieving data efficiently. They hold important information needed for the platform's operations, including user data, transaction records, and operational metadata. These databases are designed to facilitate quick and secure data retrieval, support data integrity and consistency, and ensure the security and confidentiality of the stored information.
Regulator Authority System(s) 182: Regulator Authority Systems 182 are specialized systems designed to oversee and enforce compliance with regulations within specific sectors or regions. These systems are equipped to monitor, analyze, and report on the activities of entities under their jurisdiction to ensure adherence to legal and regulatory standards. Example features include the ability to audit transactions, review compliance reports, and enforce regulatory actions. They are typically used by government agencies or authorized regulatory bodies to supervise financial transactions, data privacy, and other regulatory aspects supportive to the operation of businesses and services. In at least one embodiment, Authority Regulators may include entities that constitute an autonomous enforcing body, typically created by a governmental body to oversee and enforce regulations regarding financial crime and fraud. In at least one embodiment, a Regulator Authority (also referred to as a “Regulator”), is an authorized entity trusted by service providers to authenticate, authorize, and/or regulate access to their services. In one embodiment, the SmartPass Platform may provide all the necessary tools and mechanisms to ensure that user's PII and their service transactions are available for Regulatory Authority review and audit upon request.
Jurisdiction Regulation Database Service 180: The Jurisdiction Regulation Database Service 180 provides a comprehensive repository of regulatory and legal information across different jurisdictions. This service is responsible for compiling, updating, and maintaining a detailed database of laws, rules, and guidelines pertinent to various regions and sectors. It enables users, particularly service providers and businesses, to access current regulatory information relevant to their operations. This service is instrumental in ensuring that businesses and services are in compliance with regional legal requirements and standards. In one embodiment, Jurisdiction Regulation Database Service may include entities that hold service providers' law/rules/restrictions based on provider type and user's physical location.
Identity Validator Service 172: The Identity Validator Service 172 is a security feature of the SmartPass Platform, responsible for verifying the identities of users. This service uses various authentication/authorization methods, including biometric verification, document validation, and other identity verification techniques. Its primary function is to ensure that users accessing the platform or conducting transactions are accurately identified, thereby enhancing the security and integrity of the platform. This service facilitates preventing fraud, ensuring user authenticity, and maintaining trust in the platform's transactions and interactions. In at least one embodiment, an Identity Validator Service may include an entity that is authorized by regulatory authorities or others, to identify users that want to access and use the provider services. The Verification Authority may technologically rely on SmartPass Application to verify users and at the same time help them preserve anonymity. After user's verification, a Verification Authority may issue an anonymized and time-limited public SmartPass token that may be checked by Providers to authenticate the user and allow him/her to use their restricted service.
FIAT Banking System(s) 186: FIAT Banking Systems 186 encompass the traditional financial infrastructure and services for managing fiat currencies. They offer various banking services, including account management, fund transfers, loans, and currency exchange. These systems integrate with digital platforms for transactions involving fiat-to-crypto conversions, playing a supportive role in bridging traditional and digital financial systems. May include Fiat to Crypto Exchange 1101 is a 3rd party entity that is responsible to convert fiat currency crypto currency (USDC).
Payment Gateway System(s) 184: Payment Gateway Systems 184 facilitate online transactions by securely processing payments from various methods, including credit cards, bank transfers, and digital wallets. They encrypt sensitive payment information, ensuring secure and efficient financial transactions between buyers, sellers, and service providers. In one embodiment, a Payment Gateway may be a 3rd party entity that is responsible to accept payments using any channel e.g. card, bank account, Paypal, Stripe etc and transfer funds to SmartPass bank account.
Blockchain Network(s) 140. Blockchain Networks comprise decentralized, distributed ledgers that record transactions across multiple computers. These networks ensure data integrity, transparency, and security through cryptographic techniques. They support various Blockchain protocols and smart contracts, enabling automated, trustless transactions and record-keeping. Blockchain networks are foundational for cryptocurrencies, NFTs, and decentralized applications, providing a secure and immutable platform for digital asset management and transactions. According to different embodiments, various components of the Blockchain Network(s) may include, but are not limited to, one or more of the following (or combinations thereof):
User Wallet(s) 146: Digital wallets used by participants of the network to store and manage their NFTs and cryptocurrencies. In at least one embodiment, User Wallets 146 are personal digital wallets used by individuals to store, manage, and transact with their digital assets and cryptocurrencies. They provide users with control over their assets, offering features like private supportive management, transaction signing, and direct Blockchain interactions. These wallets are desirable for engaging in Blockchain-based transactions and asset management.
SmartPass Client Custodial Wallets 144: SmartPass Client Custodial Wallets 144 are digital wallets managed by the SmartPass Platform on behalf of its users. These wallets store and secure users' digital assets and cryptocurrencies. Supportive functionalities include executing transactions on users' behalf, maintaining records of transactions, and ensuring the security of the assets. These custodial wallets are designed to simplify the management of digital assets for users by providing a centralized and secure platform for handling their cryptocurrencies and tokens.
Blockchain Oracle System 115: The Blockchain Oracle System bridges Blockchain networks with external data sources. It enables smart contracts to interact with and respond to real-world data, which is necessary for their execution. The system sources data from external APIs and data feeds, providing accurate and timely information to the Blockchain, thereby allowing smart contracts to function based on real-world events and data.
Client Computer System(s) 130: Client Computer Systems 130 are personal computing devices like desktops and laptops. They typically run operating systems like Windows, macOS, or Linux and are equipped with software applications for various tasks. These systems are used for accessing internet services, running software applications, data processing, and storage. They interface with peripherals like keyboards, mice, and monitors and connect to networks for data exchange and communication.
Web Browser(s) 132: Web Browsers 132 are software applications for accessing and displaying content on the World Wide Web. They render web pages from HTML, CSS, and JavaScript, providing features like tabbed browsing, bookmarks, and security tools. Browsers are desirable for navigating the internet, accessing web-based services, and ensuring secure and user-friendly online experiences.
Mobile Device(s) 160: Mobile Devices 160, including smartphones and tablets, offer portable computing and communication capabilities. They feature touchscreens, internet connectivity, cameras, and various sensors. These devices run on operating systems like iOS and Android, supporting a wide range of applications for communication, entertainment, productivity, and more. They are designed for on-the-go use, offering users continuous access to digital services and connectivity.
Mobile Device Application(s) 166: Mobile Device Applications 166 are software programs developed for mobile operating systems like iOS and Android. They provide user interfaces for various services and functionalities, including personal data management, financial transactions, and location-based services. These applications often integrate with device hardware like GPS and cameras to enhance functionality. They connect to backend systems for data processing and storage, offering a portable platform for users to interact with services like the SmartPass Platform.
Internet & Cellular Network(s) 110: Internet and Cellular Networks 110 provide digital communication and data exchange services. The Internet network uses technologies like fiber optics, satellite, and DSL for global connectivity. Cellular networks offer wireless communication through technologies such as LTE, 4G, and 5G. These networks enable services like web browsing, email, streaming, VoIP, and online transactions. They connect various devices and systems, facilitating data exchange and communication across different geographical locations.
Remote System Server(s)/Service(s) 170. Remote System Servers and Services 170 provide additional computational resources, data storage, and specialized services. They support cloud-based applications, content delivery, and data backup, offering scalability and redundancy for various online services and applications. In at least one embodiment, these are off-site servers or services that support the SmartPass Platform, providing additional computational resources, storage, or specialized functionalities. Examples of various remote system server(s)/service(s), may include, but are not limited to, one or more of the following (or combinations thereof):
Content provider servers/services
   Media Streaming servers/services
   Database storage/access/query servers/services
   Financial transaction servers/services
   Payment gateway servers/services
   Electronic commerce servers/services
   Event management/scheduling servers/services
   Etc.
Service Provider Library: SmartPass Application may need to integrate with Provider app to exchange the required system data to perform user authentication/authorization and transfer credits, crypto tokens or crypto currencies or real-world currency to be used on Provider's platform. To speed up the integration process, SmartPass Application may offer an integration library or other technical means of integration. This integration is preferably capable of undertaking all the required steps to pair a user's device, retrieve the user's SmartPass bound with the provider and request/retrieve PII if user explicitly consents.
Etc.

In at least one embodiment, Data Network portion 100 integrates various components, including Blockchain technology, smart contracts, databases, user interfaces (both web and mobile), and remote services, to create a comprehensive ecosystem for NFT minting, trading, and buyback operations.

Blockchain technology offers many advantages that exploited by the SmartPass Platform ecosystem; it is completely decentralized and provide security, anonymity and immutability to data stored on a block. By using smart contracts technology, SmartPass Platform may read and write blocks on the chain and timestamp at least one transaction, providing the necessary mechanisms to issue, revoke and validate a Partner branded SmartPass. Mainly for the SmartPass validation process, data stored on the chain is unanimous in the sense that all network participants agree to the validity of at least one of the blocks, so the SmartPass validation process cannot be disputed As described in greater detail herein, different embodiments of Data Networks may be configured, designed, and/or operable to provide various different types of operations, functionalities, and/or features generally relating to SmartPass Platform technology. Further, as described in greater detail herein, many of the various SmartPass Platform features and functionality disclosed herein may provide may enable or provide different types of advantages and/or benefits to different entities interacting with the Data Network(s).

According to different embodiments, at least some SmartPass Platform component(s) may be configured, designed, and/or operable to provide a number of different advantages and/or benefits and/or may be operable to initiate, and/or enable various different types of operations, functionalities, and/or features, such as, for example, one or more of those described and/or referenced herein. According to different embodiments, at least a portion of the various functions, actions, operations, and activities performed by one or more SmartPass Platform component(s) may be initiated in response to detection of one or more conditions, events, and/or other criteria satisfying one or more different types of minimum threshold criteria, such as, for example, one or more of those described and/or referenced herein. According to different embodiments, at least a portion of the various types of functions, operations, actions, and/or other features provided by at least one SmartPass Platform component may be implemented at one or more client systems(s), at one or more mobile device(s), at one or more System Servers (s), and/or combinations thereof.

According to different embodiments, the Data Network portion 100 may include a plurality of different types of components, devices, modules, processes, systems, etc., which, for example, may be implemented and/or instantiated via the use of hardware and/or combinations of hardware and software. For example, as illustrated in the example embodiment of FIG. 1, the Data Network may include one or more types of systems, components, devices, processes, etc. (or combinations thereof) described and/or referenced herein.

In at least one embodiment, the SmartPass Platform component(s) may be operable to utilize and/or generate various different types of data and/or other types of information when performing specific tasks and/or operations. This may include, for example, input data/information and/or output data/information. For example, in at least one embodiment, the SmartPass Platform component(s) may be operable to access, process, and/or otherwise utilize information from one or more different types of sources, such as, for example, one or more local and/or remote memories, devices and/or systems. Additionally, in at least one embodiment, the SmartPass Platform component(s) may be operable to generate one or more different types of output data/information, which, for example, may be stored in memory of one or more local and/or remote devices and/or systems. Examples of different types of input data/information and/or output data/information which may be accessed and/or utilized by at least one SmartPass Platform component may include, but are not limited to, one or more of those described and/or referenced herein.

According to specific embodiments, multiple instances or threads of at least one SmartPass Platform component may be concurrently implemented and/or initiated via the use of one or more processors and/or other combinations of hardware and/or hardware and software. For example, in at least some embodiments, various aspects, features, and/or functionalities of at least one SmartPass Platform component may be performed, implemented and/or initiated by one or more of the various systems, components, systems, devices, procedures, processes, etc., described and/or referenced herein.

In at least one embodiment, a given instance of at least one SmartPass Platform component may access and/or utilize information from one or more associated databases. In at least one embodiment, at least a portion of the database information may be accessed via communication with one or more local and/or remote memory devices. Examples of different types of data which may be accessed by at least one SmartPass Platform component may include, but are not limited to, one or more of those described and/or referenced herein.

According to different embodiments, various different types of encryption/decryption techniques may be used to facilitate secure communications between one or more devices, systems, and/or components of the Data Network.

Examples of the various types of security techniques which may be used may include, but are not limited to, one or more of the following (or combinations thereof): random number generators, SHA (Secured Hashing Algorithm), MDS, DES (Digital Encryption Standard), 3DES (Triple DES), RC4 (Rivest Cipher), ARC4 (related to RC4), TKIP (Temporal Key Integrity Protocol, uses RC4), AES (Advanced Encryption Standard), RSA, DSA, DH, NTRU, and ECC (elliptic curve cryptography), PKA (Private Key Authentication), Device-Unique Secret Key and other cryptographic key data, SSL, etc. Other security features contemplated may include use of well known hardware-based and/or software-based security components, and/or any other known or yet to be devised security and/or hardware and encryption/decryption processes implemented in hardware and/or software.

According to different embodiments, one or more different threads or instances of at least one SmartPass Platform component may be initiated in response to detection of one or more conditions or events satisfying one or more different types of minimum threshold criteria for triggering initiation of at least one instance of at least one SmartPass Platform component. Various examples of conditions or events which may trigger initiation and/or implementation of one or more different threads or instances of at least one SmartPass Platform component may include, but are not limited to, one or more of those described and/or referenced herein.

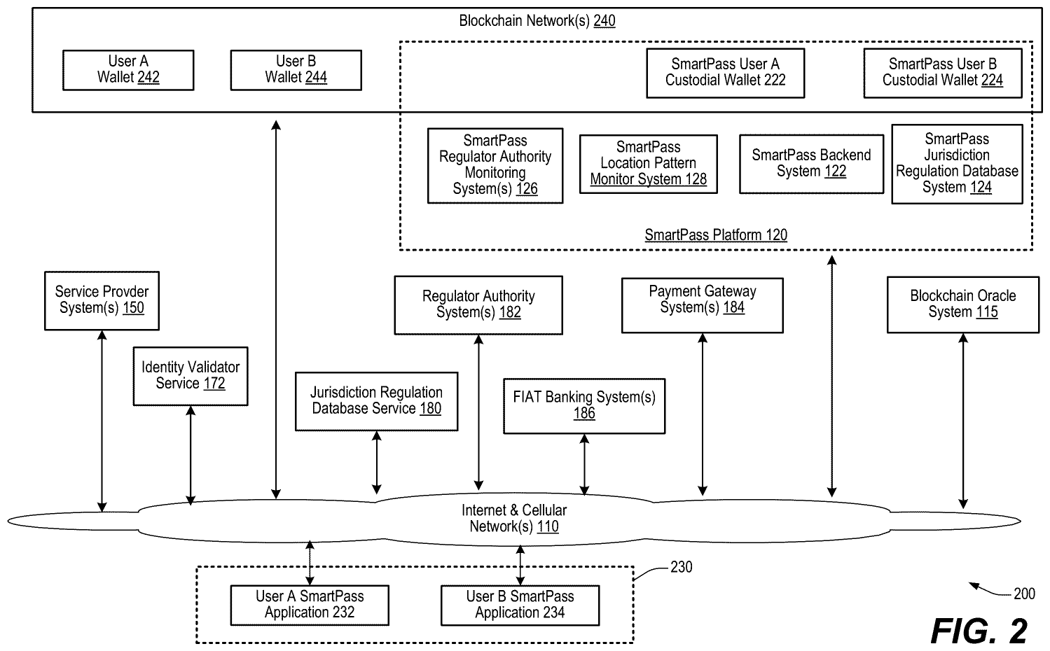

FIG. 2 shows an example data network architecture embodiment of a Data Network 200 which may be utilized for facilitating, enabling, initiating, and/or performing one or more of the SmartPass Platform features and functionality described and/or referenced herein. As illustrated in the example embodiment of FIG. 2, the Data Network 200 may include a plurality of different types of components, devices, modules, processes, systems, etc., which, for example, may be implemented and/or instantiated via the use of hardware and/or combinations of hardware and software. For example, as illustrated in the example embodiment of FIG. 2, the Data Network may comprise various types of systems, components, devices, databases, services, etc., as described below. It is noted that many of the systems and components illustrated in FIG. 2 have been described previously with respect to FIG. 1, and therefore their descriptions may not be reiterated.
Identity Validator Service 172
SmartPass Location Pattern Monitor System 128
SmartPass Regulator Authority Monitoring System(s) 126
SmartPass Jurisdiction Regulation Database System 124
Jurisdiction Regulation Database Service 180
Regulator Authority System(s) 182
Payment Gateway System(s) 184
Service Provider System(s) 150
FIAT Banking System(s) 186
User B SmartPass Application 234 which, for example, may be a SmartPass Mobile Application running on User B's mobile device.
User A SmartPass Application 232 which, for example, may be a SmartPass Mobile Application running on User A's mobile device.
SmartPass User A Custodial cryptographic wallet 222.
SmartPass User B Custodial cryptographic wallet 224
User B cryptographic wallet 244
User A cryptographic wallet 242
Blockchain Oracle System 115
SmartPass Platform 120
SmartPass Backend System 122
Blockchain Network(s) 240
Internet & Cellular Network(s) 110

In at least one embodiment, User cryptographic wallets 242, 244, are digital tools that securely store and manage cryptographic assets and credentials, primarily for handling digital currencies like Bitcoin or Ethereum. A cryptographic wallet operates by generating and maintaining private and public cryptographic keys, which are desirable for authorizing transactions in a Blockchain network. These wallets enable users (who have access to the private cryptographic keys) to send, receive, and monitor their digital currency holdings with ease. Additionally, it provides a high level of security, ensuring that the user's assets are protected from unauthorized access.

The SmartPass User Custodial Cryptographic Wallets 222, 224 are user-associated cryptographic wallets which operate under the Custodial Crypto Wallet Architecture, ensuring enhanced security and privacy for the user's digital assets. These wallets securely store the private keys associated with the user's cryptocurrency holdings. These keys are safeguarded under at least one user's profile within the SmartPass system. To ensure robust security, the private keys are encrypted using a 2-way encryption mechanism protected by RSA cryptographic algorithm and PKI infrastructure.

In at least one embodiment, the SmartPass Application may be configured or designed to include functionality which provides support for both user-controlled cryptographic wallets (e.g., 242, 244) and custodial cryptographic wallets (e.g., 222, 224).

In at least one embodiment, a user may be an individual or an organization or other entity that desires to access or use one or more services provided by one or more service providers (e.g., online service providers). In some embodiments, the services to be accessed may include regulated services such as, for example, online gambling services, online adult content services, cannabis related services, banking services, etc. An important concern for many of these users is maintaining their anonymity while utilizing these services. They are particularly cautious about the handling of their Personally Identifiable Information (PII), seeking assurance over the circumstances under which this data is utilized—including the who, when, where, why, and how of its usage. Additionally, there's a pronounced need among users for a mechanism that allows them to securely store their data in a location they control. This capability is desirable to facilitate seamless interaction with regulated services without the repetitive need for completing Know Your Customer (KYC) or other onboarding processes multiple times. This approach not only enhances user convenience but also reinforces the privacy and security of their sensitive information.

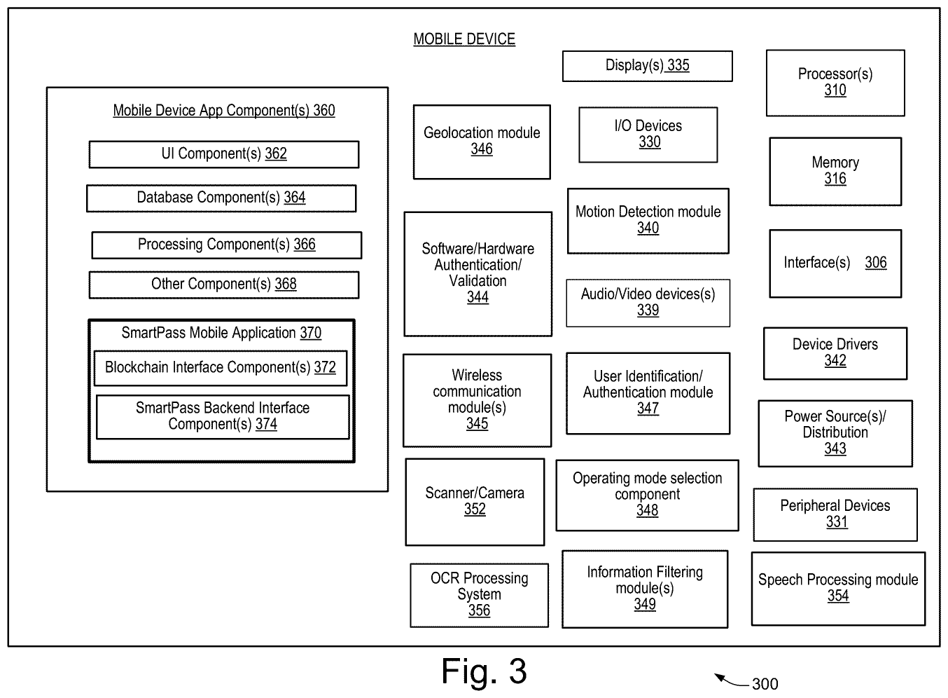

FIG. 3 is a simplified block diagram of an exemplary client system Mobile Device 300 in accordance with a specific embodiment. As illustrated in the example of FIG. 3 Mobile Device 300 may include a variety of components, modules and/or systems for providing various functionality. For example, as illustrated in FIG. 3, Mobile Device 300 may include Mobile Device Application components (e.g., 360), which, for example, may include, but are not limited to, one or more of the following (or combinations thereof):
UI Components 362 such as those illustrated, described, and/or referenced herein.
Database Components 364 such as those illustrated, described, and/or referenced herein.
Processing Components 366 such as those illustrated, described, and/or referenced herein.
Other Components 368 which, for example, may include components for facilitating and/or enabling the Mobile Device to perform and/or initiate various types of operations, activities, functions such as those described herein.

In at least one embodiment, the client system may include Mobile Device App Component(s) which support communications and interactions with one or more Blockchain networks. In at least one embodiment, the Mobile Device Application component(s) 360 may also be operable to perform and/or implement various types of SmartPass Platform related functions, operations, actions, and/or other features such as, for example, one or more of those described and/or referenced herein.

According to specific embodiments, multiple instances or threads of the Mobile Device Application component(s) may be concurrently implemented and/or initiated via the use of one or more processors and/or other combinations of hardware and/or hardware and software. For example, in at least some embodiments, various aspects, features, and/or functionalities of the Mobile Device Application component(s) may be performed, implemented and/or initiated by one or more systems, components, systems, devices, procedures, processes, etc. (or combinations thereof) described and/or referenced herein.

According to different embodiments, one or more different threads or instances of the Mobile Device Application component(s) may be initiated in response to detection of one or more conditions or events satisfying one or more different types of minimum threshold criteria for triggering initiation of at least one instance of the Mobile Device Application component(s). Various examples of conditions or events which may trigger initiation and/or implementation of one or more different threads or instances of the Mobile Device Application component(s) may include, but are not limited to, one or more types of conditions and/or events described or referenced herein.

In at least one embodiment, a given instance of the Mobile Device Application component(s) may access and/or utilize information from one or more associated databases. In at least one embodiment, at least a portion of the database information may be accessed via communication with one or more local and/or remote memory devices. Examples of different types of data which may be accessed by the Mobile Device Application component(s) may include, but are not limited to, one or more different types of data, metadata, and/or other information described and/or referenced herein.

According to different embodiments, Mobile Device 300 may further include, but is not limited to, other types of components, modules and/or systems such as, for example, one or more of the following (or combinations thereof):
SmartPass Mobile Application 370: The SmartPass Mobile Application functions as a comprehensive mobile interface for SmartPass users. It integrates various components like UI (362), database (364), processing (366), geolocation (346), user identification/authentication (347), Blockchain Interface Component(s) (372), SmartPass Backend Interface Component(s) (374), and/or other hardware/software components of the mobile device. In at least one embodiment, the SmartPass Mobile Application may be configured or designed to include functionality which provides support for both user-controlled cryptographic wallets and SmartPass custodial cryptographic wallets.
Blockchain Interface Component(s) 372: Blockchain Interface Components (372) facilitate seamless integration and communication with Blockchain networks. These components are supportive for executing and verifying Blockchain transactions, ensuring secure data exchange between the SmartPass platform and Blockchain networks. They play a role in maintaining the integrity and security of Blockchain interactions, transactions and cryptographic processes within the SmartPass ecosystem. The interface components are designed to support various Blockchain protocols, ensuring compatibility and flexibility in handling diverse Blockchain-related operations.
SmartPass Backend Interface Component(s) 374: The SmartPass Backend Interface Components (374) serve as the bridge between the SmartPass Mobile Application and the SmartPass Backend System. They ensure smooth data flow, processing requests, and responses between the mobile application and the SmartPass Backend. These components are configured or designed for handling user requests, processing transactions, and managing data securely. They support various functionalities, including authentication, data retrieval, and transaction processing, making them integral to the overall functionality and efficiency of the SmartPass Platform.
At least one processor 310. In at least one embodiment, the processor(s) 310 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 316, which, for example, may include volatile memory (e.g., RAM), non-volatile memory (e.g., disk memory, FLASH memory, EPROMs, etc.), unalterable memory, and/or other types of memory. In at least one implementation, the memory 316 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the client system and/or other information relating to the functionality of the various SmartPass Platform features and functionality described herein. The program instructions may control the operation of an operating system and/or one or more applications, for example. The memory or memories may also be configured to store data structures, metadata, timecode synchronization information, audio/visual media content, asset file information, keyword taxonomy information, advertisement information, and/or information/data relating to other features/functions described herein. Because such information and program instructions may be employed to implement at least a portion of the SmartPass Platform features and functionality described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 306 which, for example, may include wired interfaces and/or wireless interfaces. In at least one implementation, the interface(s) 306 may include functionality similar to at least a portion of functionality implemented by one or more computer system interfaces such as those described herein and/or generally known to one having ordinary skill in the art. For example, in at least one implementation, the wireless communication interface(s) may be configured or designed to communicate with selected electronic game tables, computer systems, remote servers, other wireless devices (e.g., PDAs, cell phones, player tracking transponders, etc.), etc. Such wireless communication may be implemented using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Device driver(s) 342. In at least one implementation, the device driver(s) 342 may include functionality similar to at least a portion of functionality implemented by one or more computer system driver devices such as those described herein and/or generally known to one having ordinary skill in the art.
At least one power source (and/or power distribution source) 343. In at least one implementation, the power source may include at least one mobile power source (e.g., battery) for allowing the client system to operate in a wireless and/or mobile environment. For example, in one implementation, the power source 343 may be implemented using a rechargeable, thin-film type battery. Further, in embodiments where it is desirable for the device to be flexible, the power source 343 may be designed to be flexible.
Geolocation module 346 which, for example, may be configured or designed to acquire geolocation information from remote sources and use the acquired geolocation information to determine information relating to a relative and/or absolute position of the client system.
Motion detection component 340 for detecting motion or movement of the client system and/or for detecting motion, movement, gestures and/or other input data from user. In at least one embodiment, the motion detection component 340 may include one or more motion detection sensors such as, for example, MEMS (Micro Electro Mechanical System) accelerometers, that may detect the acceleration and/or other movements of the client system as it is moved by a user.
User Identification/Authentication module 347. In one implementation, the User Identification module may be adapted to determine and/or authenticate the identity of the current user or owner of the client system. For example, in one embodiment, the current user may be required to perform a log in process at the client system in order to access one or more features. Alternatively, the client system may be adapted to automatically determine the identity of the current user based upon one or more external signals such as, for example, an RFID tag or badge worn by the current user which provides a wireless signal to the client system for determining the identity of the current user. In at least one implementation, various security features may be incorporated into the client system to prevent unauthorized users from accessing confidential or sensitive information.
One or more display(s) 335. According to various embodiments, such display(s) may be implemented using, for example, LCD display technology, OLED display technology, and/or other types of conventional display technology. In at least one implementation, display(s) 335 may be adapted to be flexible or bendable. Additionally, in at least one embodiment the information displayed on display(s) 335 may utilize e-ink technology (such as that available from E Ink Corporation, Cambridge, MA, www.eink.com), or other suitable technology for reducing the power consumption of information displayed on the display(s) 335.
One or more user I/O Device(s) 330 such as, for example, keys, buttons, scroll wheels, cursors, touchscreen sensors, audio command interfaces, magnetic strip reader, optical scanner, etc.
Audio/Video device(s) 339 such as, for example, components for displaying audio/visual media which, for example, may include cameras, speakers, microphones, media presentation components, wireless transmitter/receiver devices for enabling wireless audio and/or visual communication between the client system 300 and remote devices (e.g., radios, telephones, computer systems, etc.). For example, in one implementation, the audio system may include componentry for enabling the client system to function as a cell phone or two-way radio device.
Other types of peripheral devices 331 which may be useful to the users of various client systems, such as, for example: PDA functionality; memory card reader(s); fingerprint reader(s); image projection device(s); social networking peripheral component(s); etc.
Information filtering module(s) 349 which, for example, may be adapted to automatically and dynamically generate, using one or more filter parameters, filtered information to be displayed on one or more displays of the mobile device. In one implementation, such filter parameters may be customizable by the player or user of the device. In some embodiments, information filtering module(s) 349 may also be adapted to display, in real-time, filtered information to the user based upon a variety of criteria such as, for example, geolocation information, contextual activity information, and/or other types of filtering criteria described and/or referenced herein.
Wireless communication module(s) 345. In one implementation, the wireless communication module 345 may be configured or designed to communicate with external devices using one or more wireless interfaces/protocols such as, for example, 802.11 (WiFi), 802.15 (including Bluetooth™), 802.16 (WiMax), 802.22, Cellular standards such as CDMA, CDMA2000, WCDMA, Radio Frequency (e.g., RFID), Infrared, Near Field Magnetics, etc.
Software/Hardware Authentication/validation components 344 which, for example, may be used for authenticating and/or validating local hardware and/or software components, hardware/software components residing at a remote device, game play information, wager information, user information and/or identity, etc. Examples of various authentication and/or validation components are described in U.S. Pat. No. 6,620,047, titled, “ELECTRONIC GAMING APPARATUS HAVING AUTHENTICATION DATA SETS,” incorporated herein by reference in its entirety for all purposes.
Operating mode selection component 348 which, for example, may be operable to automatically select an appropriate mode of operation based on various parameters and/or upon detection of specific events or conditions such as, for example: the mobile device's current location; identity of current user; user input; system override (e.g., emergency condition detected); proximity to other devices belonging to same group or association; proximity to specific objects, regions, zones, etc. Additionally, the mobile device may be operable to automatically update or switch its current operating mode to the selected mode of operation. The mobile device may also be adapted to automatically modify accessibility of user-accessible features and/or information in response to the updating of its current mode of operation.
Scanner/Camera Component(s) (e.g., 352) which may be configured or designed for use in scanning identifiers and/or other content from other devices and/or objects such as for example: mobile device displays, computer displays, static displays (e.g., printed on tangible mediums), etc.
Blockchain Interface Component(s) 372 which may be configured or designed to include functionality for enabling the Mobile Device to communicate with, and initiate transactions on one or more Blockchain networks.
OCR Processing Engine (e.g., 356) which, for example, may be operable to perform image processing and optical character recognition of images such as those captured by a mobile device camera, for example.
Speech Processing module (e.g., 354) which, for example, may be operable to perform speech recognition, and may be operable to perform speech-to-text conversion.
Etc.

According to a specific embodiment, the mobile device may be adapted to implement at least a portion of the features associated with the mobile game service system described in U.S. patent application Ser. No. 10/115,164, which is now U.S. Pat. No. 6,800,029, issued Oct. 5, 2004, (previously incorporated by reference in its entirety). For example. in one embodiment, the mobile device may be comprised of a hand-held game service user interface device (GSUID) and a number of input and output devices. The GSUID is generally comprised of a display screen which may display a number of game service interfaces. These game service interfaces are generated on the display screen by a microprocessor of some type within the GSUID. Examples of a hand-held GSUID which may accommodate the game service interfaces are manufactured by Symbol Technologies, Incorporated of Holtsville, New York.

The game service interfaces may be used to provide a variety of game service transactions and gaming operations services. The game service interfaces, including a login interface, an input/output interface, a transaction reconciliation interface, a ticket validation interface, a prize services interfaces, a food services interface, an accommodation services interfaces, a gaming operations interfaces, a multi-game/multi-denomination meter data transfer interface, etc. At least one interface may be accessed via a main menu with a number of sub-menus that allow a game service representative to access the different display screens relating to the particular interface. Using the different display screens within a particular interface, the game service representative may perform various operations needed to provide a particular game service. For example, the login interface may allow the game service representative to enter a user identification of some type and verify the user identification with a password. When the display screen is a touch screen, the user may enter the user/operator identification information on a display screen comprising the login interface using the input stylus and/or using the input buttons. Using a menu on the display screen of the login interface, the user may select other display screens relating to the login and registration process. For example, another display screen obtained via a menu on a display screen in the login interface may allow the GSUID to scan a finger print of the game service representative for identification purposes or scan the finger print of a game player.

The user identification information and user validation information may allow the game service representative to access all or some subset of the available game service interfaces available on the GSUID. For example, certain users, after logging into the GSUID (e.g. entering a user identification and a valid user identification information), may be able to access a variety of different interfaces, such as, for example, one or more of: input/output interface, communication interface, food services interface, accommodation services interface, prize service interface, gaming operation services interface, transaction reconciliation interface, voice communication interface, gaming device performance or metering data transfer interface, etc.; and perform a variety of services enabled by such interfaces. While other users may be only be able to access the award ticket validation interface and perform EZ pay ticket validations. The GSUID may also output game service transaction information to a number of different devices (e.g., card reader, printer, storage devices, gaming machines and remote transaction servers, etc.).

In addition to the features described above, various embodiments of mobile devices described herein may also include additional functionality for displaying, in real-time, filtered information to the user based upon a variety of criteria such as, for example, geolocation information, casino data information, player tracking information, etc.

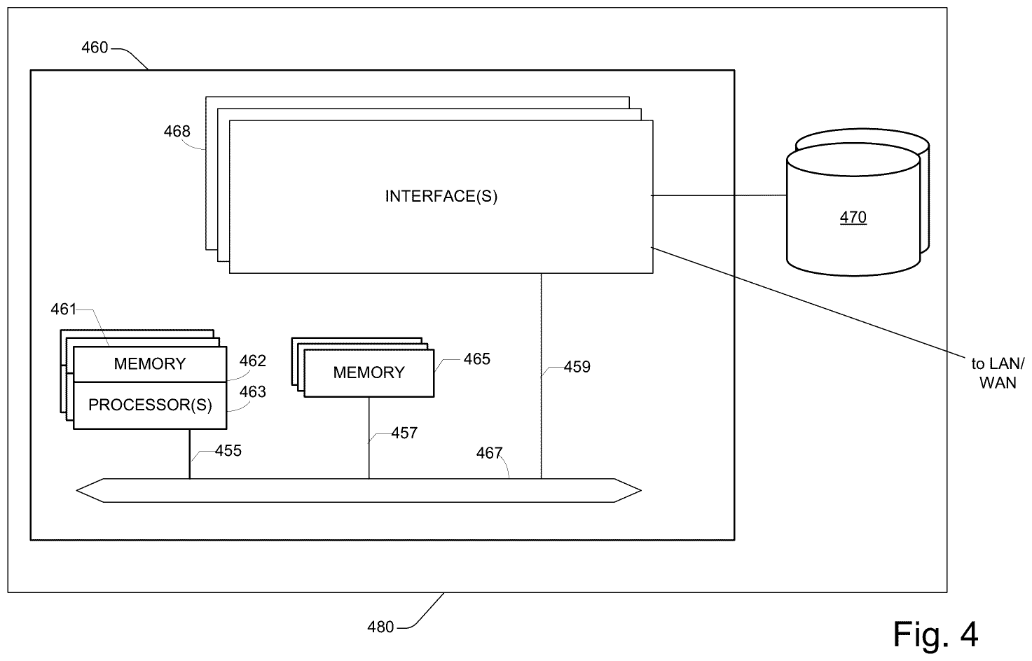

FIG. 4 illustrates an example embodiment of a System Server 480 which may be used for implementing various aspects/features described herein. In at least one embodiment, the System Server 480 includes at least one network device 460, and at least one storage device 470 (such as, for example, a direct attached storage device).

In one embodiment, System Server 480 may be suitable for implementing at least some of the SmartPass Platform features and functionalities described herein.

In according to one embodiment, network device 460 may include a master central processing unit (CPU) 462, interfaces 468, and a bus 467 (e.g., a PCI bus). When acting under the control of appropriate software or firmware, the CPU 462 may be responsible for implementing specific functions associated with the functions of a desired network device. For example, when configured as a server, the CPU 462 may be responsible for analyzing packets; encapsulating packets; forwarding packets to appropriate network devices; instantiating various types of virtual machines, virtual interfaces, virtual storage volumes, virtual appliances; etc. The CPU 462 preferably accomplishes at least a portion of these functions under the control of software including an operating system (e.g. Linux), and any appropriate system software (such as, for example, AppLogic™ software).

CPU 462 may include one or more processors 463 such as, for example, one or more processors from the AMD, Motorola, Intel and/or MIPS families of microprocessors. In an alternative embodiment, processor 463 may be specially designed hardware for controlling the operations of System Server 480. In a specific embodiment, a memory 461 (such as non-volatile RAM and/or ROM) also forms part of CPU 462. However, there may be many different ways in which memory may be coupled to the system. Memory block 461 may be used for a variety of purposes such as, for example, caching and/or storing data, programming instructions, etc.

The interfaces 468 may be typically provided as interface cards (sometimes referred to as “line cards”). Alternatively, one or more of the interfaces 468 may be provided as on-board interface controllers built into the system motherboard. Generally, they control the sending and receiving of data packets over the network and sometimes support other peripherals used with the System Server 480. Among the interfaces that may be provided may be FC interfaces, Ethernet interfaces, frame relay interfaces, cable interfaces, DSL interfaces, token ring interfaces, Infiniband interfaces, and the like. In addition, various very high-speed interfaces may be provided, such as fast Ethernet interfaces, Gigabit Ethernet interfaces, ATM interfaces, HSSI interfaces, POS interfaces, FDDI interfaces, ASI interfaces, DHEI interfaces and the like. Other interfaces may include one or more wireless interfaces such as, for example, 802.11 (WiFi) interfaces, 802.15 interfaces (including Bluetooth™), 802.16 (WiMax) interfaces, 802.22 interfaces, Cellular standards such as CDMA interfaces, CDMA2000 interfaces, WCDMA interfaces, TDMA interfaces, Cellular 4G interfaces, etc.

Generally, one or more interfaces may include ports appropriate for communication with the appropriate media. In some cases, they may also include an independent processor and, in some instances, volatile RAM. The independent processors may control such communications intensive tasks as packet switching, media control and management. By providing separate processors for communication intensive tasks, these interfaces allow the master microprocessor 462 to efficiently perform routing computations, network diagnostics, security functions, etc.

In at least one embodiment, some interfaces may be configured or designed to allow the System Server 480 to communicate with other network devices associated with various local area network (LANs) and/or wide area networks (WANs). Other interfaces may be configured or designed to allow network device 460 to communicate with one or more direct attached storage device(s) 470.

Although the system shown in FIG. 4 illustrates one specific network device described herein, it is by no means the only network device architecture on which one or more embodiments may be implemented. For example, an architecture having a single processor that handles communications as well as routing computations, etc. may be used. Further, other types of interfaces and media may also be used with the network device.

Regardless of network device's configuration, it may employ one or more memories or memory modules (such as, for example, memory block 465, which, for example, may include random access memory (RAM)) configured to store data, program instructions for the general-purpose network operations and/or other information relating to the functionality of the various SmartPass Platform features and functionality described herein. The program instructions may control the operation of an operating system and/or one or more applications, for example. The memory or memories may also be configured to store data structures, and/or other specific non-program information described herein.

Because such information and program instructions may be employed to implement the systems/methods described herein, one or more embodiments relates to machine readable media that include program instructions, state information, etc. for performing various operations described herein. Examples of machine-readable storage media include, but are not limited to, magnetic media such as hard disks, floppy disks, and magnetic tape; optical media such as CD-ROM disks; magneto-optical media such as floptical disks; and hardware devices that may be specially configured to store and perform program instructions, such as read-only memory devices (ROM) and random access memory (RAM). Some embodiments may also be embodied in transmission media such as, for example, a carrier wave traveling over an appropriate medium such as airwaves, optical lines, electric lines, etc. Examples of program instructions include both machine code, such as produced by a compiler, and files containing higher level code that may be executed by the computer using an interpreter.

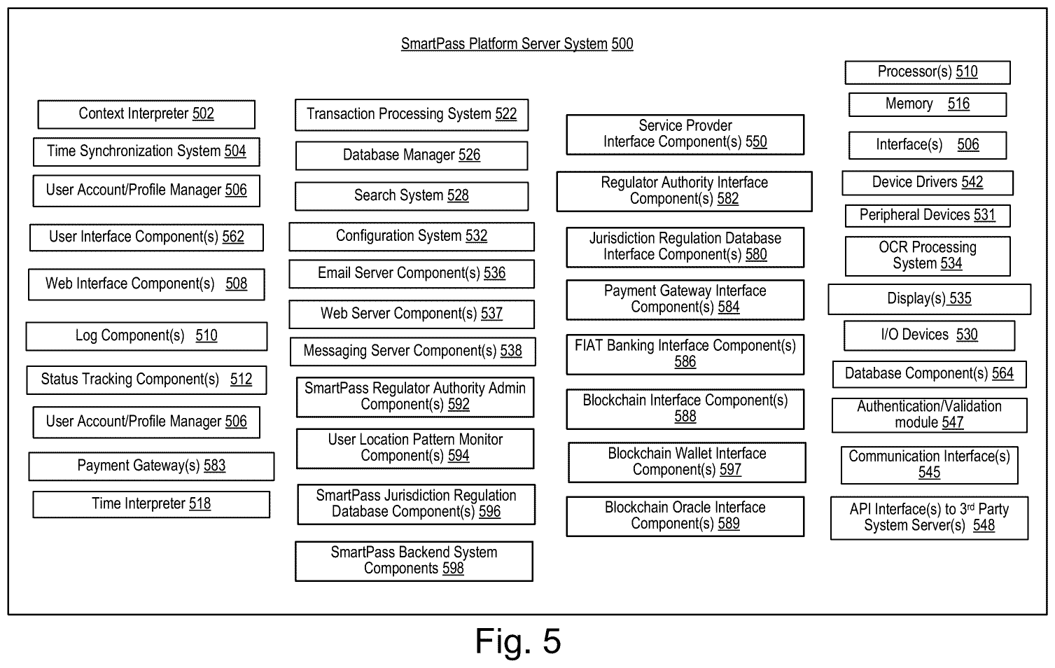

FIG. 5 illustrates an example of a functional block diagram of a SmartPass Platform Server System 500 in accordance with a specific embodiment. In at least one embodiment, the Server System may be operable to perform and/or implement various types of functions, operations, actions, and/or other features, such as, for example, one or more of those described and/or referenced herein.

In at least one embodiment, the Server System may include a plurality of components operable to perform and/or implement various types of functions, operations, actions, and/or other features such as, for example, one or more of the following (or combinations thereof):
SmartPass Regulator Authority Monitoring Component(s) 592: The SmartPass Regulator Authority Monitoring Components 592 are integral parts of the SmartPass system responsible for ensuring compliance with regulatory authority requirements. These components actively monitor transactions and user activities within the SmartPass Platform to ensure they align with the stipulated regulatory frameworks. They facilitate real-time surveillance and auditing capabilities, generating compliance reports and alerting system administrators to potential regulatory breaches. Additionally, they manage the documentation and evidence necessary for regulatory review and audits, ensuring the platform adheres to legal standards.
User Location Pattern Monitor Component(s) 594: User Location Pattern Monitor Components 594 are designed to track and analyze the geolocation patterns of users within the SmartPass system. These components utilize geolocation data to ensure user activities comply with location-based regulations and service requirements. They are capable of identifying irregular or non-compliant user movements and may trigger alerts or actions based on predefined geofencing rules. This system is particularly desirable in services where access and activities are restricted or varied based on the user's geographical location.
SmartPass Jurisdiction Regulation Database Component(s) 596: The SmartPass Jurisdiction Regulation Database Components 596 manage and maintain a database of regulatory information across various jurisdictions. These components are responsible for storing, updating, and retrieving legal and regulatory data relevant to the operations of the SmartPass Platform. They ensure the platform's services are continuously updated with the latest regulatory changes and compliant with regional legal requirements. This component may be configured or designed to include functionality for adapting platform services to conform to the legal landscapes of different regions.
SmartPass Backend System Components 598: SmartPass Backend System Components 598 constitute the core infrastructure that powers the SmartPass Platform. These components handle the platform's central processing, data management, and operational logistics. They are responsible for executing the platform's business logic, managing secure data transactions, and storing operational data. These components ensure efficient handling of user data, support user onboarding processes, facilitate transaction processing, and maintain the overall integrity and performance of the SmartPass system.
Regulator Authority Monitoring/Enforcement Interface Component(s) 582: The Regulator Authority Monitoring/Enforcement Interface Components 582 serve as the liaison between the SmartPass Platform and various regulatory authorities. These components facilitate the exchange of compliance-related information, submission of regulatory reports, and receipt of regulatory directives. They enable the platform to demonstrate compliance with legal standards, respond to regulatory inquiries, and implement enforcement actions as directed by regulatory bodies. These components are desirable for maintaining transparent and accountable relations with regulatory authorities.
Jurisdiction Regulation Database Interface Component(s) 580: The Jurisdiction Regulation Database Interface Components 580 provide the interface through which the SmartPass Platform interacts with the Jurisdiction Regulation Database. These components allow for the querying, retrieval, and updating of regulatory information stored within the database. They enable the platform to access up-to-date legal and regulatory requirements across different jurisdictions, ensuring that the platform's services are compliant with the current legal standards. This interface facilitates managing and navigating the complex regulatory landscapes that the platform operates within.
Blockchain Oracle Interface Component(s) 589: The Blockchain Oracle Interface Components 589 are designed to facilitate the integration of external data into the Blockchain environment. These components act as intermediaries that connect Blockchain networks with off-chain data sources. They are responsible for fetching, authenticating, and transmitting external data to smart contracts on the Blockchain. This functionality enables smart contracts to execute based on real-world events and information that are not natively available on the Blockchain. The oracle interface components ensure data accuracy and reliability, providing data inputs for decentralized applications.
Blockchain Interface Component(s) 588: Blockchain Interface Components 588 serve as the primary conduit for interaction between the SmartPass Platform and various Blockchain networks. These components are responsible for managing Blockchain transactions, including the creation, signing, and broadcasting of transactions to the Blockchain. They facilitate the platform's integration with different Blockchain protocols, ensuring seamless interaction with decentralized ledgers. These components also handle the synchronization of Blockchain states and data retrieval, enabling the platform to maintain up-to-date Blockchain information.
FIAT Banking Interface Component(s) 586: The FIAT Banking Interface Components 586 provide a bridge between traditional banking systems and the SmartPass Platform. They enable the platform to interact with conventional financial institutions, facilitating transactions involving fiat currencies. These components manage the processes of fund transfers, currency conversions, and reconciliation of banking transactions. They may be configured or designed to include functionality for enabling the seamless exchange of fiat currencies to digital assets and vice versa, supporting the platform's financial operations within the traditional banking framework.
Payment Gateway Interface Component(s) 584: Payment Gateway Interface Components 584 are responsible for processing online payments within the SmartPass Platform. These components facilitate secure financial transactions by connecting the platform to various payment gateway services. They handle the encryption and transmission of payment data, ensuring secure and efficient transaction processing. These components support multiple payment methods, including credit cards, bank transfers, and digital wallets, providing a versatile payment processing solution for the platform's users.
Service Provider Interface Component(s) 550: Service Provider Interface Components 550 enable integration and communication between service providers and the SmartPass Platform. These components facilitate the exchange of data and services between the platform and various external service providers. They manage authentication, authorization, and service delivery, ensuring that users may access and utilize services offered by the providers. The interface components support various functionalities such as user verification, service activation, and transaction processing, enhancing the platform's service offering capabilities.
Blockchain Wallet Interface Component(s) 597: Blockchain Wallet Interface Components 597 are designed to manage interactions between the SmartPass Platform and users' Blockchain wallets. These components enable users to connect their digital wallets to the platform, facilitating transactions involving cryptocurrencies and digital assets. They provide functionalities for balance queries, transaction history, and asset transfers. The wallet interface components ensure secure and efficient wallet operations, supporting various Blockchain protocols and wallet types, thereby enhancing the platform's cryptocurrency transaction capabilities.
Blockchain Interface Component(s) 588: This component acts as a bridge between the server system and various Blockchain networks. It facilitates interactions with different Blockchains, enabling the platform to execute transactions, retrieve data, and maintain sync with Blockchain states. This component is helpful for ensuring that the platform's activities remain consistent with the decentralized ledger.
Blockchain Wallet Interface Component(s) 597: This interface component manages interactions with user Blockchain wallets. It enables users to connect their wallets to the platform, initiate transactions, and check balances.

This component plays a helpful role in ensuring secure and efficient wallet operations for transactions on the platform.
Blockchain Oracle Interface Component(s) 589: This component serves as a link between the SmartPass Platform and external data sources or oracles. It fetches real-time data from these oracles, which may be used to make informed decisions within smart contracts. This interface is helpful for scenarios where off-chain data is needed for on-chain execution.
Context Interpreter (e.g., 502) which, for example, may be operable to automatically and/or dynamically analyze contextual criteria relating to a detected set of event(s) and/or condition(s), and automatically determine or identify one or more contextually appropriate response(s) based on the contextual interpretation of the detected event(s)/condition(s). According to different embodiments, examples of contextual criteria which may be analyzed may include, but are not limited to, one or more of the following (or combinations thereof):
   location-based criteria (e.g., geolocation of client device, geolocation of agent device, etc.)
   time-based criteria
   identity of user(s)
   user profile information
   transaction history information
   recent user activities
   proximate business-related criteria (e.g., criteria which may be used to determine whether the client device is currently located at or near a recognized business establishment such as a bank, gas station, restaurant, supermarket, etc.)
   etc.
Time Synchronization Engine (e.g., 504) which, for example, may be operable to manages universal time synchronization (e.g., via NTP and/or GPS)
Search Engine (e.g., 528) which, for example, may be operable to search for transactions, logs, items, accounts, options in one or more System databases
Configuration Engine (e.g., 532) which, for example, may be operable to determine and handle configuration of various customized configuration parameters for one or more devices, component(s), system(s), process(es), etc.
Time Interpreter (e.g., 518) which, for example, may be operable to automatically and/or dynamically modify or change identifier activation and expiration time(s) based on various criteria such as, for example, time, location, transaction status, etc.
Authentication/Validation Component(s) (e.g., 547) (password, software/hardware info, SSL certificates, cryptographic keys, etc.) which, for example, may be operable to perform various types of authentication/validation tasks such as, for example, one or more of the following (or combinations thereof):
   Verifying/authenticating devices,
   Verifying passwords, passcodes, SSL certificates, biometric identification information, and/or other types of security-related information
   Verify/validate activation and/or expiration times
   Etc.
   In one implementation, the Authentication/Validation Component(s) may be adapted to determine and/or authenticate the identity of the current user or owner of the mobile client system. For example, in one embodiment, the current user may be required to perform a log in process at the mobile client system in order to access one or more features. In some embodiments, the mobile client system may include biometric security components which may be operable to validate and/or authenticate the identity of a user by reading or scanning the user's biometric information (e.g., fingerprints, face, voice, eye/iris, etc.). In at least one implementation, various security features may be incorporated into the mobile client system to prevent unauthorized users from accessing confidential or sensitive information.
Transaction Processing Engine (e.g., 522) which, for example, may be operable to handle various types of transaction processing tasks such as, for example, one or more of the following (or combinations thereof):
   Identifying/determining transaction type
   Determining which payment gateway(s) to use
   Associating databases information to identifiers
   Etc.
   Payment Gateway Component(s) 583
   Asset Management Component(s) 584
OCR Processing Engine (e.g., 534) which, for example, may be operable to perform image processing and optical character recognition of images such as those captured by a mobile device camera, for example.
Database Manager (e.g., 526) which, for example, may be operable to handle various types of tasks relating to database updating, database management, database access, etc. In at least one embodiment, the Database Manager may be operable to manage TISS databases, Device Application databases, etc.
Log Component(s) (e.g., 510) which, for example, may be operable to generate and manage transactions history logs, system errors, connections from APIs, etc.
Status Tracking Component(s) (e.g., 512) which, for example, may be operable to automatically and/or dynamically determine, assign, and/or report updated transaction status information based, for example, on the state of the transaction. In at least one embodiment, the status of a given transaction may be reported as one or more of the following (or combinations thereof): Completed, Incomplete, Pending, Invalid, Error, Declined, Accepted, etc.
Gateway Component(s) (e.g., 514) which, for example, may be operable to facilitate and manage communications and transactions with external Payment Gateways.
Web Interface Component(s) (e.g., 508) which, for example, may be operable to facilitate and manage communications and transactions with computerized data network web portal(s).
API Interface(s) (e.g., 546) which, for example, may be operable to facilitate and manage communications and transactions with API Interface(s) to one or more other components of the computerized data network.
API Interface(s) to 3rd Party System Server(s) (e.g., 548) which, for example, may be operable to facilitate and manage communications and transactions with API Interface(s) to 3rd Party System Server(s)
OCR Processing Engine (e.g., 534) which, for example, may be operable to perform image processing and optical character recognition of images such as those captured by a mobile device camera, for example.
At least one processor 510. In at least one embodiment, the processor(s) 510 may include one or more commonly known CPUs which are deployed in many of today's consumer electronic devices, such as, for example, CPUs or processors from the Motorola or Intel family of microprocessors, etc. In an alternative embodiment, at least one processor may be specially designed hardware for controlling the operations of the mobile client system. In a specific embodiment, a memory (such as non-volatile RAM and/or ROM) also forms part of CPU. When acting under the control of appropriate software or firmware, the CPU may be responsible for implementing specific functions associated with the functions of a desired network device. The CPU preferably accomplishes all these functions under the control of software including an operating system, and any appropriate applications software.
Memory 516, which, for example, may include volatile memory (e.g., RAM), non-volatile memory (e.g., disk memory, FLASH memory, EPROMs, etc.), unalterable memory, and/or other types of memory. In at least one implementation, the memory 516 may include functionality similar to at least a portion of functionality implemented by one or more commonly known memory devices such as those described herein and/or generally known to one having ordinary skill in the art. According to different embodiments, one or more memories or memory modules (e.g., memory blocks) may be configured or designed to store data, program instructions for the functional operations of the mobile client system and/or other information relating to the functionality of the various Mobile Transaction techniques described herein. The program instructions may control the operation of an operating system and/or one or more applications, for example. The memory or memories may also be configured to store data structures, metadata, identifier information/images, and/or information/data relating to other features/functions described herein. Because such information and program instructions may be employed to implement at least a portion of the SmartPass Platform techniques described herein, various aspects described herein may be implemented using machine readable media that include program instructions, state information, etc. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.
Interface(s) 506 which, for example, may include wired interfaces and/or wireless interfaces. In at least one implementation, the interface(s) 506 may include functionality similar to at least a portion of functionality implemented by one or more computer system interfaces such as those described herein and/or generally known to one having ordinary skill in the art.
Device driver(s) 542. In at least one implementation, the device driver(s) 542 may include functionality similar to at least a portion of functionality implemented by one or more computer system driver devices such as those described herein and/or generally known to one having ordinary skill in the art.
One or more display(s) 535. According to various embodiments, such display(s) may be implemented using, for example, LCD display technology, OLED display technology, and/or other types of conventional display technology. In at least one implementation, display(s) 535 may be adapted to be flexible or bendable. Additionally, in at least one embodiment the information displayed on display(s) 535 may utilize e-ink technology (such as that available from E Ink Corporation, Cambridge, MA, www.eink.com) or other suitable technology for reducing the power consumption of information displayed on the display(s) 535.
Email Server Component(s) 536, which, for example, may be configured or designed to provide various functions and operations relating to email activities and communications.
Web Server Component(s) 537, which, for example, may be configured or designed to provide various functions and operations relating to web server activities and communications.
Messaging Server Component(s) 538, which, for example, may be configured or designed to provide various functions and operations relating to text messaging and/or other social network messaging activities and/or communications.
Etc.

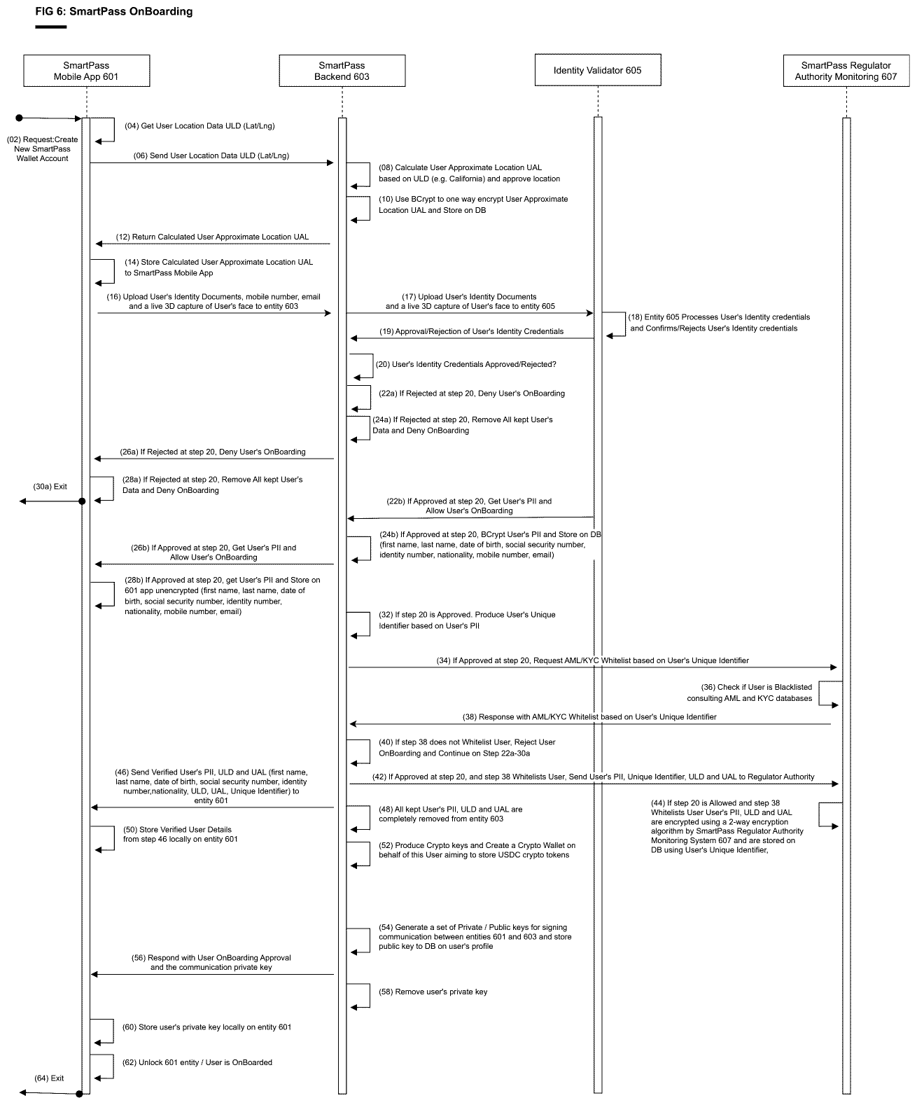

FIG. 6 shows an example systems interaction diagram of a new SmartPass user onboarding process, demonstrating a sequence of various actions, communications and data exchanges which are performed between various system entities of a data network as part of the execution of this procedure.

FIG. 6 illustrates an example embodiment of a SmartPass onboarding process for a new user, encompassing a series of meticulously structured steps aimed at ensuring user identity verification, regulatory compliance, and data security. Beginning with the SmartPass Mobile App (Entity 601) in a locked state, the process involves collecting and verifying user's geolocation (ULD and UAL), identity documents, and other personal information (PII) through secure communications with the SmartPass Backend (Entity 603) and a third-party Identity Validator (Entity 605). In at least one embodiment, this process may include the encryption of user data using BCrypt and SHA3-512 algorithms, consulting AML/KYC databases for user validation, and the creation of a custodial or non-custodial crypto wallet. The process concludes with the secure storage of cryptographic keys for user-app-backend communications, ultimately unlocking the app's full functionality for the verified user, signifying successful onboarding. This comprehensive procedure underscores the platform's commitment to maintaining high standards of security, privacy, and adherence to regulatory requirements. Below is a description of the processes and procedural flows illustrated in FIG. 6.

SmartPass Mobile App (601) entity is a native mobile application that may be downloaded from Apple store and Google play. 601 entity holds all user's PII unencrypted (first name, last name, date of birth, social security number, email, mobile number). On one or more transaction, entity 601 sends all PII unencrypted to entity 603 so verifications may take place compared with the BCrypted data that are stored on 601 entity DB.

SmartPass Backend System (603) entity is a backend layer deployed on the cloud. This entity holds user's PII BCrypted data. Identity Validator (3rd party) (605) entity is a 3rd party KYC Provider. Entity 601 uploads identity documents and a live 3D capture of user's face to entity 604 through entity 603, so user's real identity may be verified. Entity 603 is capable of cooperating with any 3rd party KYC provider like IDology, Jumio etc.

Identity Validator System (605) entity is a 3rd party KYC Provider. Entity 601 uploads identity documents and a live 3D capture of user's face to entity 604 through entity 603, so user's real identity may be verified. Entity 603 is capable of cooperating with any 3rd party KYC provider like IDology, Jumio etc.

SmartPass Regulator Authority Monitoring System (607) is an engine accessible to Regulator Authorities. Provided with public keys for encrypting all transactions to reveal all private data. Performs scans for AML/KYC. Entity 607 only has public keys stored. The private keys are stored on removable media off-cloud and are not available to SmartPass staff members or founders. Regulator Authorities have their own set of private/public keys.

(02) Request: Create New SmartPass Wallet Account: At this stage, the user initiates the process of creating a new SmartPass Wallet Account using the SmartPass Mobile App (Entity 601). This request is the first active user interaction within the app, signaling the start of the onboarding process. The app may present the user with a form or interface to collect initial information, such as consent to proceed or basic identification details. Initially, the SmartPass Mobile App (Entity 601) begins in a restricted mode with limited functionality. This state ensures security and regulatory compliance by preventing unauthorized access or operations within the app before the user's identity and other relevant credentials are verified. The app displays a user interface with minimal options, primarily geared towards initiating the onboarding process.

(04) Get User Location Data ULD (Lat/Lng): The SmartPass Mobile App (Entity 601) gathers the user's geolocation data, specifically the latitude and longitude (ULD). This data collection is desirable for complying with jurisdictional regulatory requirements. The app may use the device's GPS feature or other geolocation services to obtain precise coordinates of the user's current physical location.

(06) Send User Location Data ULD (Lat/Lng): The SmartPass Mobile App (Entity 601) sends the collected User Location Data (ULD) to the SmartPass Backend (Entity 603). This transfer facilitates determining the user's eligibility based on their geographical location. The communication may be facilitated through a secure API call, ensuring the data's integrity and confidentiality during transmission.

(08) Calculate User Approximate Location UAL based on Regulator needs: The SmartPass Backend (Entity 603) calculates the User's Approximate Location (UAL) based on the received ULD. This calculation facilitates aligning with specific regulatory requirements, such as determining if the user is in a region where the service is permitted. For example, for users in the USA, it may determine the state, while for European users, it may identify the country. This step includes logic to handle scenarios where certain locations are excluded, leading to potential denial of onboarding.

(08) Calculate User Approximate Location UAL based on ULD (e.g., California) and approve location: The SmartPass Backend (Entity 603) uses the ULD to estimate the user's location more accurately, such as identifying the specific state or region (e.g., California). This refined location data is used to determine service availability and compliance with local regulations. If the location is approved, the onboarding process proceeds; otherwise, it may trigger a denial of service. In at least one embodiment, this step may involve refining the user's location data to include specific geographic identifiers like city, state, region, and country. This detailed location information, processed by the SmartPass Backend (Entity 603), facilitates complying with jurisdiction-specific regulations and for providing localized services.

In at least one embodiment, the User's Approximate Location may be requested as first step because the system may need to deny access to specific locations or countries. In that case, the system may jump to step (22a): The SmartPass Backend (Entity 603) prioritizes the determination of the user's approximate location as an initial step to ascertain regulatory compliance. If the user's location falls within restricted areas or non-serviceable countries, the system may redirect to step (22a) to deny onboarding, emphasizing the platform's adherence to geo-specific regulatory constraints.

(10) Use BCrypt to one way encrypt User Approximate Location UAL and Store on DB: The SmartPass Backend (Entity 603) employs BCrypt, a one-way hashing algorithm, to encrypt the User Approximate Location (UAL). This encrypted data is then stored in the database, ensuring enhanced security and privacy of sensitive location information. This step facilitates protecting the integrity and confidentiality of user data.

(12) Return Calculated User Approximate Location UAL: After processing, the SmartPass Backend (Entity 603) returns the calculated User Approximate Location (UAL) to the SmartPass Mobile App (Entity 601). This return of data may be used by the app for further processing or user interface updates, ensuring the user is aware of their service eligibility based on location.

(14) Store Calculated User Approximate Location UAL to SmartPass Mobile App: The SmartPass Mobile App (Entity 601) stores the received User Approximate Location (UAL) data. This stored information may be used for subsequent operations within the app, such as tailoring the user experience based on geographic location or for regulatory compliance purposes.

(16) Upload user's driving license or identity or passport, mobile number, email and a live 3D capture of user's face. Submission of User's email and mobile number is optional: In this supportive step, the user is prompted by the SmartPass Mobile App (Entity 601) to upload identity verification documents such as a driving license, passport, and a live 3D capture of their face. Additionally, the user has the option to provide their mobile number and email. This step facilitates Know Your Customer (KYC) compliance and identity verification.

(16) Upload User's Identity Documents, mobile number, email and a live 3D capture of User's face to entity 603: The SmartPass Mobile App (Entity 601) transmits the collected identity documents, mobile number, email, and the 3D facial capture to the SmartPass Backend (Entity 603). This transfer is desirable for further processing and verification of the user's identity, forming a foundational step in the secure onboarding process.

(17) Upload User's Identity Documents and a live 3D capture of User's face to entity 605: The SmartPass Backend (Entity 603) forwards the user's identity documents and live 3D facial capture to the Identity Validator (Entity 605), a third-party KYC provider. This step facilitates external validation of the user's identity, ensuring an additional layer of security and compliance with KYC regulations.

(18) Entity 605 Processes User's Identity credentials and Confirms/Rejects User's Identity credentials: The Identity Validator (Entity 605) processes the received identity documents and live 3D facial capture. This entity evaluates the authenticity of the documents and the legitimacy of the user's identity. Based on this analysis, it either confirms or rejects the user's identity, playing a supportive role in safeguarding against identity fraud.

(19) Approval/Rejection of User's Identity Credentials: At this decision point, the outcome of the identity verification process is determined. If the Identity Validator (Entity 605) approves the user's credentials, the onboarding process moves forward; if rejected, it triggers a denial of service. This step facilitates maintaining the integrity of the user base and preventing unauthorized access.

(20) Entity 605 gets User's identity data uploaded from step 16, processes and confirms user's validity. Entity 605 may also consult government sources to verify user's identity and search against Anti Money Laundering AML databases. Based on the outcome of this search, user's request to create a new SmartPass Account may be denied: In this step, the Identity Validator (Entity 605) not only processes the uploaded identity data but may also consult external government sources for additional verification. It checks against AML databases to ensure the user's compliance with financial regulations. The result of these comprehensive checks determines whether the user may proceed with the account creation.

(20) User's Identity Credentials Approved/Rejected?: This decision point facilitates the onboarding process. The system assesses whether the Identity Validator (Entity 605) has approved or rejected the user's identity credentials. A positive outcome leads to further steps in the account creation process, while a negative outcome results in the denial of the SmartPass account creation.

(22a) If Rejected at step 20, Deny User's OnBoarding: If the user's identity credentials are rejected at step (20), the SmartPass Backend (Entity 603) triggers a denial of onboarding. This step is desirable for maintaining platform security and regulatory compliance, ensuring only verified users may access the platform's services.

(22b) If Approved at step 20, Get User's PII and Allow User's OnBoarding: Upon approval of the user's identity credentials at step (20), the SmartPass Backend (Entity 603) proceeds to retrieve the user's Personally Identifiable Information (PII) and allows the continuation of the onboarding process. This step marks the transition from identity verification to further account setup activities.

(24a) If Rejected at step 20, Remove All kept User's Data and Deny OnBoarding: In case of rejection at step (20), the SmartPass Backend (Entity 603) takes action to remove all stored data related to the user's attempted onboarding. This step ensures the security and privacy of the user's data by eliminating any information from the system, following a failed verification process.

(24b) If Approved at step 20, BCrypt User's PII and Store on DB (first name, last name, date of birth, social security number, identity number, nationality, mobile number, email): After the approval of the user's identity credentials, the SmartPass Backend (Entity 603) uses the BCrypt algorithm to encrypt the user's Personally Identifiable Information (PII). This encrypted data, including details like the user's name, date of birth, social security number, and contact information, is then securely stored in the database. This step facilitates ensuring that sensitive user data is stored in a secure, non-reversible format, enhancing privacy and security.

In at least one embodiment, User PI data is encrypted using BCrypt algorithm, and encrypted data stored at 603. When the user's PII is approved, the SmartPass Backend (Entity 603) encrypts this data using the BCrypt algorithm. This encrypted data is then securely stored within the backend's database. This process facilitates protecting sensitive user information while maintaining data integrity and confidentiality.

(26a) If Rejected at step 20, Deny User's OnBoarding: This step is activated if the user's identity credentials are rejected at step 20. In this scenario, the SmartPass Backend (Entity 603) proceeds to deny the user's onboarding. This decision is significant in maintaining the integrity of the platform by ensuring that only users with verified and approved credentials may access and use the SmartPass services.

(26b) If Approved at step 20, Get User's PII and Allow User's OnBoarding: Following the approval of the user's identity credentials at step 20, the SmartPass Backend (Entity 603) retrieves the user's Personally Identifiable Information (PII) and proceeds with the onboarding process. This step marks a supportive transition, where the user moves closer to gaining full access to the SmartPass services, underlining the importance of thorough identity verification.

(28a) If Rejected at step 20, Remove All kept User's Data and Deny OnBoarding: In the event of a rejection at step 20, the SmartPass Backend (Entity 603) ensures that all data related to the user's onboarding attempt is removed. This action provides a supportive privacy and security measure, eliminating any personal information from the system to maintain confidentiality and data integrity following a failed onboarding attempt.

(28b) If Approved at step 20, get User's PI and Store on 601 app unencrypted (first name, last name, date of birth, social security number, identity number, nationality, mobile number, email): When the user's identity credentials are approved at step 20, the SmartPass Mobile App (Entity 601) retrieves and stores the user's PII unencrypted. This information, including sensitive details such as the user's name, birth date, and social security number, is kept locally on the app. This step facilitates providing the user with access to their personal data within the app interface, reflecting the balance between user accessibility and data security.

In at least one embodiment, unencrypted user PI is stored on user's mobile device in encrypted form. Even though the user's Personally Identifiable Information (PII) is stored unencrypted on the SmartPass Mobile App (Entity 601) for ease of access and user interface interaction, it is stored in an encrypted format on the user's mobile device. This encryption facilitates protecting the user's sensitive data, ensuring that it remains secure and confidential, especially if the device is lost or compromised.

(30a) Exit: This step represents the termination or exit point of a specific process flow within the SmartPass system. It is typically reached when a particular operation or series of operations have been completed or when a user is denied further progression in the onboarding process. The exit step is desirable for maintaining the flow and integrity of the system's processes.

(32) User's Unique Identifier is produced using the following details: <user's first name><user's last name><user's date of birth><user's social security number><user's identity number><user's nationality>the string above is then encrypted using the SHA3-512. The base64 representation of SHA3-512 output is the User's Unique Identifier: In this step, the SmartPass Backend (Entity 603) generates a unique identifier for the user. This identifier is created by concatenating key pieces of the user's PI, including their name, date of birth, social security number, identity number, and nationality. The concatenated string is then encrypted using the SHA3-512 algorithm. The result is a base64-encoded string that serves as a unique and secure identifier for the user within the SmartPass system, playing a supportive role in user identification and data management.

(32) If step 20 is Approved. Produce User's Unique Identifier based on User's PII: Upon approval at step 20, the SmartPass Backend (Entity 603) proceeds to generate a unique identifier for the user. This identifier is derived from the user's PII, ensuring a distinct and secure way of identifying at least one user within the system. The production of this unique identifier is a fundamental aspect of the user's profile and is used in various processes within the SmartPass platform.

(34) If Approved at step 20, Request AML/KYC Whitelist based on User's Unique Identifier: Following the approval of the user's identity at step 20, the SmartPass Backend (Entity 603) initiates a request for the user to be whitelisted based on Anti-Money Laundering (AML) and Know Your Customer (KYC) criteria. This request uses the user's unique identifier to cross-check against relevant databases. This step facilitates compliance with financial regulations and for ensuring that the platform is not used for illicit activities.

(36) Check if User is Blacklisted consulting AML and KYC databases: In this step, the SmartPass Backend (Entity 603) checks if the user is blacklisted by consulting AML and KYC databases. This check is based on the user's unique identifier and is desirable for ensuring that the user is compliant with financial regulatory standards. A positive match in these databases may lead to the denial of services to the user, highlighting the platform's commitment to regulatory compliance and financial security.

(38) Response with AML/KYC Whitelist based on User's Unique Identifier: After consulting the AML and KYC databases, the SmartPass Backend (Entity 603) responds with the outcome regarding the user's whitelisting status. This response is based on the user's unique identifier and indicates whether the user has passed the necessary checks to be considered compliant with AML/KYC regulations. This step facilitates determining the user's eligibility to continue with the SmartPass services.

(40) If step 38 does not Whitelist User, Reject User OnBoarding and Continue on Step 22a-30a: If the user is not whitelisted in the AML/KYC check at step 38, the SmartPass Backend (Entity 603) proceeds to reject the user's onboarding. This decision leads to a sequence of steps (22a-30a) which may involve denying service, removing user data, and other necessary actions to conclude the process. This step underscores the system's adherence to regulatory standards and its commitment to maintaining a secure and compliant user base.

(42) If Approved at step 20, and step 38 Whitelists User, Send User's PII, Unique Identifier, ULD and UAL to Regulator Authority: Following the approval of the user's identity at step 20 and the successful whitelisting at step 38, the SmartPass Backend (Entity 603) sends the user's Personally Identifiable Information (PII), unique identifier, User Location Data (ULD), and User Approximate Location (UAL) to the Regulator Authority (Entity 607). This step is desirable for regulatory reporting and compliance, ensuring that the authority has the necessary data to oversee and audit user activities within the platform.

(44) User's PII, ULD and UAL are encrypted using entity's 607 public key with a 2-way encryption algorithm and are stored as a transaction on DB: In this step, the SmartPass Regulator Authority Monitoring System (Entity 607) encrypts the user's PII, ULD, and UAL using a public key and a 2-way encryption algorithm. This encrypted data is then stored in the database as a part of a transaction record. The use of public key encryption ensures that only authorized entities with the corresponding private key may access and decrypt this sensitive information, enhancing data security and privacy.

(44) If step 20 is Allowed and step 38 Whitelists User User's PII, ULD and UAL are encrypted using a 2-way encryption algorithm by SmartPass Regulator Authority Monitoring System 607 and are stored on DB using User's Unique Identifier: Once the user's identity is approved at step 20 and they are whitelisted at step 38, the SmartPass Regulator Authority Monitoring System (Entity 607) encrypts the user's PII, ULD, and UAL using a 2-way encryption algorithm. This encrypted data is then stored in the database, linked to the user's unique identifier. This process ensures the secure and confidential handling of sensitive user data, aligning with privacy and security protocols.

(46) Send Verified User's PII, ULD and UAL (first name, last name, date of birth, social security number, identity number, nationality, ULD, UAL, Unique Identifier) to entity 601: The SmartPass Regulator Authority Monitoring System (Entity 607) sends the verified user's PII, ULD, and UAL back to the SmartPass Mobile App (Entity 601). This information includes key personal details and location data, securely transmitted to enable further processing within the app. This step facilitates syncing the verified user information between the regulatory system and the mobile app, facilitating a seamless user experience.

(48) All kept User's PII, ULD and UAL are completely removed from entity 603: After the successful processing and verification of the user's Personally Identifiable Information (PII), User Location Data (ULD), and User Approximate Location (UAL), the SmartPass Backend (Entity 603) removes all these data elements from its system. This step provides a supportive privacy measure, ensuring that sensitive user information is not stored longer than necessary, thereby reducing the risk of unauthorized access or data breaches.

(50) Store Verified User Details from step 46 locally on entity 601: The SmartPass Mobile App (Entity 601) stores the verified user details received from step 46. This includes the user's PII, ULD, and UAL. Storing this information locally is important for quick access and for enhancing the user experience, as it allows the app to personalize and streamline future interactions based on the verified user data.

(50) Unencrypted data stored on user's mobile device in encrypted form: Despite being stored in an unencrypted format for user interface purposes, this data is actually encrypted when stored on the user's mobile device. This encryption facilitates protecting the user's sensitive information from unauthorized access, especially in scenarios where the mobile device may be lost or compromised.

(52) Produce Crypto keys and Create a Crypto Wallet on behalf of this User aiming to store USDC crypto tokens: In this step, the SmartPass Backend (Entity 603) generates cryptographic keys and creates a cryptocurrency wallet for the user, specifically for storing USDC crypto tokens. The SmartPass Application is linked to the user's profile, and its creation is a significant step in enabling financial transactions within the SmartPass ecosystem, highlighting the platform's integration with digital currency technologies.

(52) SmartPass implements the Custodial Crypto Wallet Architecture. In Principle this means that the Crypto Wallet's private keys are stored securely under User's profile on SmartPass. Crypto Wallet private keys are stored on entity's 603 DB securely using a 2-way encryption. The SmartPass system adopts a custodial crypto wallet architecture, where the private keys of the user's crypto wallet are securely stored under the user's profile in the SmartPass Backend (Entity 603). These keys are encrypted with a two-way encryption method using SmartPass' public key, ensuring the security and confidentiality of the user's financial assets within the platform.

(52) SmartPass is also capable of dealing with non-Custodial Crypto Wallet management. In that case, step 52 stores the encrypted Wallet information without keys: Besides the custodial wallet architecture, SmartPass also supports non-custodial crypto wallet management. In this scenario, the wallet information is encrypted and stored without the private keys, giving users more control over their crypto assets. This flexibility in wallet management caters to different user preferences for security and control over their digital currencies.

(54) Generate a set of Private/Public keys for signing communication between entities 601 and 603 and store public key to DB on user's profile: The SmartPass system generates a pair of private and public keys for securing communication between the SmartPass Mobile App (Entity 601) and the SmartPass Backend (Entity 603). The public key is stored in the database associated with the user's profile. This cryptographic measure ensures that communications between the mobile app and the backend are securely encrypted, enhancing data security and integrity.

(54) These keys used for authentication between 601 and 603. Example encryption algo: RSA-4096: The generated private and public keys are used for authentication purposes between the SmartPass Mobile App (Entity 601) and the SmartPass Backend (Entity 603). An example of the encryption algorithm used in this process is RSA-4096, known for its strong cryptographic security. This step is fundamental in establishing a secure communication channel between the two entities, ensuring that data transmissions are protected against interception and unauthorized access.

(56) Respond with User OnBoarding Approval and the communication private key: Upon successful completion of the previous steps, the SmartPass Backend (Entity 603) sends a response to the SmartPass Mobile App (Entity 601), indicating the approval of the user's onboarding. This response also includes the communication private key, which is used for future secure communications between the mobile app and the backend. This step marks the conclusion of the onboarding process, signifying that the user is now a verified member of the SmartPass platform with secure communication capabilities.

(58) Public Key kept in backend database: The public key generated in step 54 is stored in the SmartPass Backend's (Entity 603) database. This key is available for cryptographic operations related to the user's account and is used to encrypt communications sent to the user's mobile app. The storage of the public key in the backend database facilitates maintaining a secure environment for ongoing interactions between the user and the SmartPass system.

(58) Remove users private key: In this step, the user's private key, which is used for secure communications and cryptographic operations, is removed from active storage or memory. This action is a security measure to ensure that the private key is not exposed or vulnerable to unauthorized access, particularly in scenarios where the backend systems may be compromised.

(60) Store user's private key locally on entity 601: The SmartPass Mobile App (Entity 601) securely stores the user's private key on the local device. This storage is desirable for enabling the user to authenticate and encrypt communications sent from the mobile app to the SmartPass Backend (Entity 603). Storing the key locally ensures that it is readily available for encryption operations, while also keeping it secure from external threats.

(60) These keys used for authentication between 601 and 603: The private and public keys generated in earlier steps are utilized for authentication purposes between the SmartPass Mobile App (Entity 601) and the SmartPass Backend (Entity 603). This use of cryptographic keys is a fundamental aspect of securing communications and data exchanges within the SmartPass platform, ensuring that all interactions are confidential and tamper-proof.

(62) Unlock 601 entity/User is OnBoarded: After the successful completion of the onboarding process, the SmartPass Mobile App (Entity 601) transitions from its initial locked state to an unlocked state, granting the user full access to the app's features and functionalities. This unlocking indicates that the user is now officially onboarded and may fully engage with the SmartPass platform, having passed all necessary verification and security checks.

(64) Exit: The exit step signifies the completion of the current procedural sequence within the SmartPass system. It is reached when all necessary actions and verifications for a specific process, such as user onboarding, have been successfully completed.

In at least some embodiments, only entities 601 and 607 have access to PII data. SmartPass staff and officers cannot acquire access to User's unencrypted PII data.

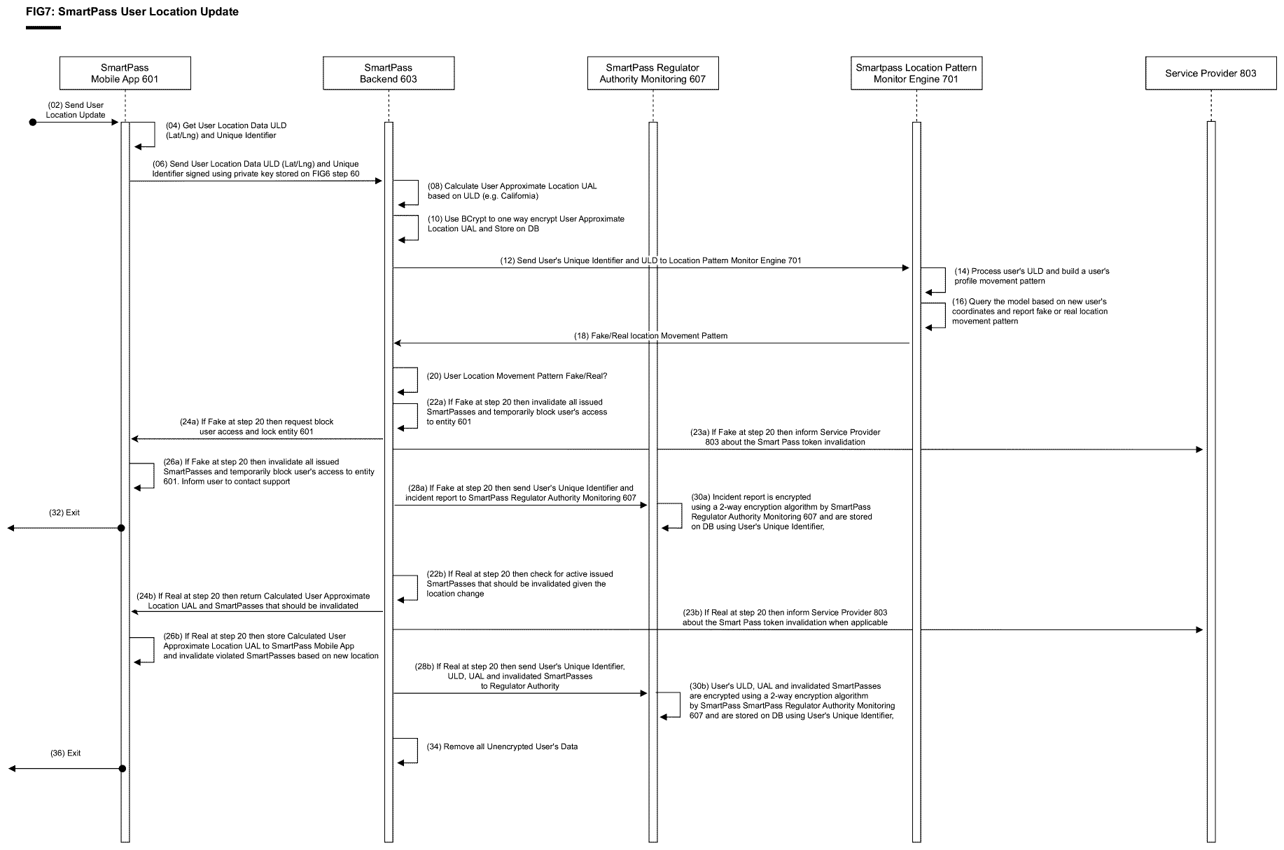

FIG. 7 shows an example systems interaction diagram of a SmartPass User Location Update process, demonstrating a sequence of various actions, communications and data exchanges which are performed between various system entities of a data network as part of the execution of this procedure.

The SmartPass User Location Update process, as illustrated in FIG. 7, involves a series of intricate steps executed by various system entities to manage and monitor user location data effectively. This process begins with the SmartPass Mobile App (Entity 601) continuously tracking and periodically updating the user's location to the SmartPass Backend (Entity 603). The backend then processes this data, encrypts it for security, and works in conjunction with the Location Pattern Monitor Engine (701) to analyze the authenticity of the user's movement patterns. Based on these analyses, the system makes supportive decisions, such as invalidating SmartPass tokens and communicating with service providers and regulatory authorities. The process ensures that all SmartPass tokens remain valid and compliant with geographic restrictions, and it incorporates robust security measures, including data encryption and regulatory reporting, to maintain system integrity and user privacy. The overall workflow is designed to dynamically respond to changes in user location, ensuring compliance with regional regulations and safeguarding against fraudulent activities. Below is a description of the processes and procedural flows illustrated in FIG. 7.

SmartPass Location Pattern Monitor Engine (701). Location Pattern Monitor Engine 701 is an entity that is using a machine learning model pre-trained on human movement patterns in and out a jurisdiction. For example to get in Nevada jurisdiction you may either fly in an airport from another airport or drive through the state borders. The objective is to identify and report the possibility of fake location report by entity 601 (Fake Address Reporting). More info may be found on FIG. 19.

Service Provider (803). Service Provider 803 is an entity providing regulated and/or non regulated services to users e.g. gambling services, gaming services, adult content streaming services, etc.

(02) Entity 601 periodically checks device location and provides location updates to Entity 603: The SmartPass Mobile App (Entity 601) continuously monitors the device's location using geolocation technologies like GPS. It periodically checks for any significant changes in the user's location. When such changes are detected, the app updates the location data, which may include latitude and longitude coordinates (ULD), and sends this information to the SmartPass Backend (Entity 603). This step facilitates maintaining up-to-date user location data, which may be desirable for services requiring location-based authentication or regulatory compliance.

(02) Send User Location Update: This step involves the SmartPass Mobile App (Entity 601) actively sending a location update to the SmartPass Backend (Entity 603). The update includes the user's current location data, which is desirable for the SmartPass system to provide location-sensitive services. The location data sent in this step is used by the SmartPass Backend to make decisions on the user's access to services based on their current location, ensuring compliance with geographic restrictions or regulations.

(02) Entity 601 continuously monitors user's location and reports any significant change to entity 603: The SmartPass Mobile App (Entity 601) is responsible for continuously monitoring the user's location. This constant surveillance ensures that any significant change in the user's location is promptly detected and reported to the SmartPass Backend (Entity 603). This monitoring facilitates maintaining the integrity of location-based services and for ensuring that the SmartPass system remains compliant with regional regulatory requirements.

(04) Get User Location Data ULD (Lat/Lng) and Unique Identifier: In this step, the SmartPass Mobile App (601) retrieves the user's location data, including latitude and longitude (ULD), along with the user's unique identifier. This action is fundamental for accurately identifying the user's current position. The unique identifier facilitates associating the location data with the specific user within the SmartPass system, ensuring that location-based services and restrictions are correctly applied to the right user.

(06) Send User Location Data ULD (Lat/Lng) and Unique Identifier signed using private key stored on FIG. 6 step 60: This step involves the SmartPass Mobile App (601) sending the user's location data (ULD) and unique identifier to the SmartPass Backend (603). The data is securely signed using a private key, ensuring the authenticity and integrity of the transmitted information. This secure transmission facilitates maintaining user privacy and for the system to reliably use this data for location-based services and compliance purposes.

(06) In at least one embodiment, all requests from entity 601 to entity 603 are sent over a secure channel unencrypted in JWT format signed by user's private key stored locally on entity 601 on FIG. 6 step 60: In this step, all communications from the SmartPass Mobile App (601) to the SmartPass Backend (603), including location updates, are sent in JSON Web Token (JWT) format. These JWTs are signed using a private key stored on the user's device, as per FIG. 6 step 60. This method ensures the security and integrity of the data being transmitted, as JWTs provide a compact and self-contained way of securely transmitting information between parties.

(08) Calculate User Approximate Location UAL based on ULD (e.g., California): The SmartPass Backend (603) takes the user's location data (ULD) received from the SmartPass Mobile App (601) and calculates the user's approximate location (UAL). For instance, if the ULD indicates the user is in Los Angeles, the UAL may be generalized to “California.” This step facilitates determining the jurisdictional constraints applicable to the user and for ensuring that services are provided in compliance with regional regulations.

(10) Use BCrypt to one way encrypt User Approximate Location UAL and Store on DB: After determining the user's approximate location (UAL), the SmartPass Backend (603) uses the BCrypt hashing algorithm to encrypt this data. This one-way encryption ensures that the UAL is securely stored in the database, protecting the user's privacy and location data. Storing encrypted location data facilitates security and for maintaining the integrity of the user's location-based service permissions within the SmartPass ecosystem.

(12) Send User's Unique Identifier and ULD to Location Pattern Monitor Engine 701: The SmartPass Backend (603) sends the user's unique identifier and unprocessed location data (ULD) to the Location Pattern Monitor Engine (701). This engine utilizes machine learning models to analyze human movement patterns, evaluating the authenticity of the reported location. The ULD is used to feed the model, allowing it to detect potential anomalies or fake location reporting, which facilitates maintaining the system's integrity against fraudulent activities.

(14) Gets user's UDL as raw coordinates (Lat/Lng) and feeds the ML model: The Location Pattern Monitor Engine (701) receives the user's raw location data (ULD), comprising latitude and longitude coordinates, from the SmartPass Backend (603). This raw data is then fed into a machine learning (ML) model designed to analyze and interpret human movement patterns. The model assesses whether the user's movements are consistent with normal behavior, helping to detect any irregularities or potential falsification of location data.

(14) Process user's ULD and build a user's profile movement pattern: In this step, the Location Pattern Monitor Engine (701) processes the user's location data (ULD) received from the SmartPass Backend (603) to construct a movement pattern profile for the user. This involves analyzing the sequence and timing of the user's movements to identify typical patterns and behaviors. The constructed profile is instrumental in understanding the user's normal movement patterns, which may be used for various purposes, including enhancing user experience and detecting anomalies.

(16) Query the model based on new user's coordinates and report fake or real location movement pattern: Here, the Location Pattern Monitor Engine (701) queries its machine learning model with the user's latest coordinates to determine the authenticity of the reported location movement pattern. The model evaluates if the new coordinates align with the user's established movement profile, categorizing the pattern as either ‘real’ (authentic) or ‘fake’ (suspicious). This step facilitates identifying potential fraud or misuse of the system, such as fake location reporting.

(18) Fake/Real location Movement Pattern: This decision point in the SmartPass User Location Update process involves determining the authenticity of the user's location movement pattern. Based on the analysis conducted by the Location Pattern Monitor Engine (701), the pattern is classified as either ‘fake’ or ‘real.’ A ‘fake’ designation indicates suspicious or abnormal movement patterns, potentially signaling fraudulent activity, while a ‘real’ designation confirms the user's movement aligns with their typical behavior. This decision facilitates triggering subsequent steps in the location monitoring process.

(20) User Location Movement Pattern Fake/Real?: This provides a supportive decision point where the system evaluates whether the user's location movement pattern, as analyzed by the Location Pattern Monitor Engine (701), is fake or real. If the pattern is determined to be ‘fake,’ it suggests potential fraudulent activity or error in location reporting. Conversely, a ‘real’ pattern indicates normal and expected user movement. This determination facilitates the next course of action in the SmartPass system, such as invalidating SmartPass tokens or maintaining current user access.

(22a) If Fake at step 20 then invalidate all issued SmartPass tokens and temporarily block user's access to entity 601: In this scenario, if the user's location movement pattern is determined to be fake at step 20, the SmartPass Backend (603) takes immediate action to invalidate all SmartPass tokens issued to the user. Additionally, the user's access to the SmartPass Mobile App (601) is temporarily blocked. This step provides a supportive security measure to prevent potential misuse or fraudulent activity within the SmartPass system.

(22b) If Real at step 20 then check for active issued SmartPass tokens that may be invalidated given the location change: When the user's location movement pattern is deemed real at step 20, the SmartPass Backend (603) proceeds to review all active SmartPass tokens issued to the user. The objective is to identify any SmartPass tokens that no longer meet the criteria due to the user's location change. This step ensures that all SmartPass tokens remain valid and compliant with the geographic restrictions or regulations associated with the services they enable.

(23a) If Fake at step 20 then inform Service Provider 803 about the SmartPass token invalidation: In case the user's location movement pattern is identified as fake at step 20, the SmartPass Backend (603) communicates with the relevant Service Provider (803) to inform them of the SmartPass token invalidation. This notification facilitates the service provider to update their records and restrict the user's access to their services, thereby maintaining the integrity and security of the service provision.

(23b) If Real at step 20 then inform Service Provider 803 about the SmartPass token invalidation when applicable: If the user's location movement pattern is classified as real at step 20, the SmartPass Backend (603) still may need to inform the Service Provider (803) about the invalidation of certain SmartPass tokens. This step is relevant in scenarios where the user's change in location necessitates the deactivation of specific SmartPass tokens, even though the overall movement pattern is authentic.

(24a) If Fake at step 20 then request block user access and lock entity 601: Upon determining the user's location movement pattern to be fake at step 20, the SmartPass Backend (603) takes the stringent action of blocking the user's access to the SmartPass Mobile App (Entity 601). This lockout provides a supportive security measure to prevent further potential fraudulent use of the SmartPass system by the user in question.

(24b) If Real at step 20 then return Calculated User Approximate Location UAL and SmartPass tokens that may be invalidated: When the user's location movement pattern is confirmed as real at step 20, the SmartPass Backend (603) proceeds to calculate the user's approximate location (UAL) based on the updated location data. In conjunction, it identifies any SmartPass tokens that need to be invalidated due to the location change. This step ensures that the user's SmartPass tokens are in line with the current geographic location and compliance requirements, thus maintaining the accuracy and relevance of the SmartPass services.

(26a) If Fake at step 20 then invalidate all issued SmartPass tokens and temporarily block user's access to entity 601. Inform user to contact support: In this situation, if the user's location movement pattern is identified as fake at step 20, the SmartPass Backend (603) invalidates all SmartPass tokens issued to the user and temporarily blocks their access to the SmartPass Mobile App (601). Additionally, the user is instructed to contact support for further assistance. This step is a safety measure to prevent misuse of the system while providing a pathway for the user to resolve any potential issues or misunderstandings.

(26b) If Real at step 20 then store Calculated User Approximate Location UAL to SmartPass Mobile App and invalidate violated SmartPass tokens based on new location: When the location movement pattern is deemed real at step 20, the SmartPass Backend (603) updates the SmartPass Mobile App (601) with the newly calculated user approximate location (UAL). Concurrently, it evaluates and invalidates any SmartPass tokens that are no longer valid due to the user's new location. This step ensures that all active SmartPass tokens reflect the current, valid status based on the user's location.

(26b) SmartPass App and/or Backend may also send notification of invalid SPTs to affected service providers: In addition to updating the SmartPass Mobile App (601) with the new user location, the SmartPass Backend (603) may also communicate with affected service providers about any SmartPass tokens (SPTs) that have been invalidated due to the user's location change. This notification helps service providers update their records and enforce access restrictions as necessary, ensuring compliance with location-based regulations.

(28a) If Fake at step 20 then send User's Unique Identifier and incident report to SmartPass Regulator Authority Monitoring 607: In the event that the user's location movement pattern is determined to be fake at step 20, the SmartPass Backend (603) sends a report to the SmartPass Regulator Authority Monitoring (607). This report includes the user's unique identifier and details of the incident. The transmission of this information facilitates regulatory oversight and potential investigation into the suspicious activity.

(28b) If Real at step 20 then send User's Unique Identifier, ULD, UAL, and invalidated SmartPass tokens to Regulator Authority: If the user's location movement pattern is assessed as real at step 20, the SmartPass Backend (603) communicates with the regulatory authority (Entity 607), providing the user's unique identifier, the updated location data (ULD and UAL), and details of any SmartPass tokens that have been invalidated. This step ensures that the regulatory authority has up-to-date information regarding the user's location and the status of their SmartPass tokens for compliance and monitoring purposes.

(30a) Incident report is encrypted using a 2-way encryption algorithm by SmartPass Regulator Authority Monitoring 607 and are stored on DB using User's Unique Identifier: When an incident report is created, particularly in cases of detected fraudulent activity, the SmartPass Regulator Authority Monitoring (607) encrypts the report using a two-way encryption algorithm. This encryption facilitates protecting the confidentiality and integrity of the sensitive data contained in the report. The encrypted report, along with the user's unique identifier, is then securely stored in the database, ensuring that the information is accessible only to authorized personnel for review and further action.

(30b) System looks up all active SmartPass tokens associated with User ID, and re-evaluates at least one active SPT to see if any need to be invalidated based on updated info. In some embodiments, the backend may automatically invalidate all of the users issued or active SmartPass tokens if it detects any change in any of the initial criteria which was used to generate the SmartPass: This step involves the SmartPass Backend (603) conducting a thorough review of all active SmartPass tokens linked to the user's ID. It re-assesses at least one token to determine if any changes in the user's status or location necessitate invalidation of these tokens. In certain scenarios, the system may opt to automatically invalidate all issued or active SmartPass tokens for a user if significant changes in the initial criteria for token issuance are detected, such as changes in location, compliance status, or other supportive factors.

(30b) User's ULD, UAL, and invalidated SmartPass tokens are encrypted using a 2-way encryption algorithm by SmartPass SmartPass Regulator Authority Monitoring 607 and are stored on DB using User's Unique Identifier: In this step, the SmartPass Backend (603), after determining any SmartPass tokens that need to be invalidated, encrypts the user's location data (ULD and UAL) and details of the invalidated tokens using a two-way encryption algorithm.

This encryption is managed by the SmartPass Regulator Authority Monitoring (607) to ensure data security. The encrypted information, along with the user's unique identifier, is then securely stored in the database, preserving the confidentiality and integrity of the data.

(32) Exit: This step signifies the end of the particular sequence of actions in the SmartPass User Location Update process. It indicates that all necessary checks, updates, and communications have been completed, and the system may now exit this particular workflow. This closure is desirable for system efficiency and ensures that the process does not consume resources beyond its functional requirement.

(34) Remove all Unencrypted User's Data: In the final phase of the SmartPass User Location Update process, the SmartPass Backend (603) ensures the removal of all unencrypted user data from its systems. This step facilitates maintaining data privacy and security, as it ensures that sensitive user information is not left unprotected in the system, thereby reducing the risk of unauthorized access or data breaches.

(36) Exit: Similar to step (32), this step also marks the conclusion of a specific sequence within the SmartPass User Location Update process. It indicates the completion of all relevant actions and the system's readiness to terminate this particular workflow. This step is important for maintaining the operational efficiency of the system and ensuring that resources are optimally utilized.

Step 22b in the SmartPass Platform's process flow addresses the enforcement of geographical boundary constraints on SmartPass Tokens. These tokens, issued to users for accessing various services, are bound by location-specific rules and regulations. The SmartPass Backend (Entity 603) may be configured or designed to include functionality for monitoring users' compliance with these geographical boundaries and takes appropriate actions when violations are detected.

In at least one embodiment, all issued SmartPass Tokens have location boundaries that may not be violated: In this scenario, if the SmartPass Backend (Entity 603) validates the user's location pattern as legitimate in step (20), it then checks all active SmartPass Tokens issued to the user to ensure they comply with the location boundaries. These boundaries are predefined limits within which the user may use the services associated with their SmartPass Tokens. If the user's current location violates these boundaries, the SmartPass Backend automatically invalidates the relevant SmartPass Tokens. This step ensures that users adhere to the geographical constraints associated with various services, which may be influenced by regulatory or provider-specific requirements.

Step 22b of the SmartPass Platform may be configured or designed to include functionality for maintaining the integrity and regulatory compliance of services accessed through SmartPass Tokens. It involves the SmartPass Backend (Entity 603) actively monitoring and enforcing the geographical boundaries of these tokens. This step ensures that users access services within the permitted jurisdictions, adhering to local and international regulations. The examples provided illustrate the platform's complex mechanism of handling various user scenarios based on geographic location changes.

### Example Scenario 1: User Travels from Athens to Thessaloniki

In this scenario, a user in Athens, who has been issued a SmartPass for accessing gambling services in Greece, travels to Thessaloniki. Greek regulations allow the use of gambling services nationwide, meaning the SmartPass is valid anywhere within Greece. Upon the user's arrival in Thessaloniki, the SmartPass Backend (Entity 603) detects the change in the user's location. The system then assesses whether this new location violates the geographical boundaries set for the gambling service. Since Thessaloniki is within Greece and complies with the national scope of the service, the SmartPass remains valid. This example showcases the system's ability to recognize and validate the user's location within the national jurisdiction, ensuring uninterrupted access to services while adhering to regulatory constraints.

### Example Scenario 2: User Travels from Athens to Rome

In this example, the same user holding a SmartPass for Greek gambling services travels from Athens to Rome, Italy. Upon entering Rome, the SmartPass Backend (Entity 603) detects a location change that falls outside the jurisdiction of Greek gambling regulations. The movement from Greece to Italy represents a violation of the geographical boundaries set for the Greek gambling SmartPass. Consequently, the SmartPass Backend automatically invalidates the gambling SmartPass. This automatic invalidation provides a supportive feature, reflecting the system's adherence to regulatory compliance. By invalidating the SmartPass, the system prevents the user from accessing services outside the legal jurisdiction, aligning with international regulatory standards and preventing potential legal issues.

### Example Scenario 3: User with Dual SmartPass Tokens Travels from Athens to Rome

In this more complex scenario, the user has two SmartPass tokens: one for Greek gambling services and another for an EU-regulated gaming provider. When the user travels from Athens to Rome, the SmartPass Backend (Entity 603) evaluates the user's new location against the constraints of both SmartPass tokens. For the Greek gambling SmartPass, the move to Rome is outside the permissible Greek jurisdiction, leading to its invalidation. However, for the gaming provider SmartPass, the EU regulations allow for service accessibility throughout EU member states, including Italy. Therefore, while the Greek gambling SmartPass is invalidated due to the boundary violation, the gaming provider SmartPass remains valid. This scenario highlights the platform's sophisticated capability to differentiate between various regulatory frameworks and apply them accurately based on the user's location. It underscores the system's flexibility in managing multiple tokens with different jurisdictional boundaries and the intricacy of its compliance mechanisms.

FIG. 7 showcases a sophisticated interplay between technology, regulatory compliance, and user experience. By diligently monitoring and enforcing geographical boundaries of service accessibility, the platform not only adheres to legal requirements but also instills trust and reliability among its users. The examples underscore the platform's capability to navigate complex scenarios involving multiple jurisdictions and regulatory environments, highlighting its robustness and adaptability in a dynamically regulated digital landscape.

Below is a description of various features relating to the SmartPass Backend's proactive monitoring and enforcing of user geographic locations and geographical boundaries of SmartPass tokens.
Geolocation Tracking: The SmartPass Backend employs advanced geolocation tracking to continuously monitor the user's physical location. This feature facilitates ensuring that services are accessed within legal boundaries.
Dynamic Response to Location Changes: The system's capability to immediately respond to location changes is integral. It involves real-time data processing and decision-making based on pre-set regulatory criteria.
Regulatory Compliance: The platform's adherence to local and international regulations is a cornerstone of its design. Different services are subject to varying legal frameworks, which the SmartPass Platform meticulously respects.
Token Validation and Invalidity Protocols: The SmartPass Backend is equipped with protocols to validate or invalidate tokens based on user location. This process is automated, reducing the need for manual intervention and enhancing the system's efficiency.
User Notification and Support: Upon invalidation of a SmartPass, the user is typically notified, and support mechanisms are activated. This ensures transparency and aids users in understanding the reasons behind token invalidation.
Data Security and Privacy: While monitoring user locations, the platform ensures data security and user privacy. Data encryption and secure transmission methods are employed to protect sensitive information.
Cross-Jurisdictional Service Accessibility: For services like gaming, which fall under broader EU regulations, the platform demonstrates its capability to adapt to multi-jurisdictional rules, offering a seamless user experience across national borders.
System Updates and Regulatory Changes: The SmartPass Platform is designed to adapt to changes in regulations. This adaptability ensures long-term viability and compliance with evolving legal landscapes.
Real-Time Geolocation Monitoring: The SmartPass Backend's ability to detect and process location changes in real-time is paramount in these scenarios. It may require sophisticated geolocation tracking technologies integrated within the mobile app and backend systems.
Automated Compliance Checks: The platform performs automated checks against predefined regulatory constraints for at least one service tied to a SmartPass. This automation facilitates prompt and accurate responses to location changes.
Data Privacy and Security: Handling sensitive geolocation data demands stringent data protection measures. The platform may ensure the security and confidentiality of this data while processing it for regulatory compliance.
User Communication and Support: Effective communication with users regarding the status of their SmartPass tokens, especially when invalidated. Providing clear reasons for invalidation and guidance on resolving issues enhances user experience and trust.
Regulatory Updates and Adaptability: The platform is adaptable to changes in regulations. This adaptability facilitates maintaining compliance in dynamic regulatory environments, as seen in the diverse scenarios.

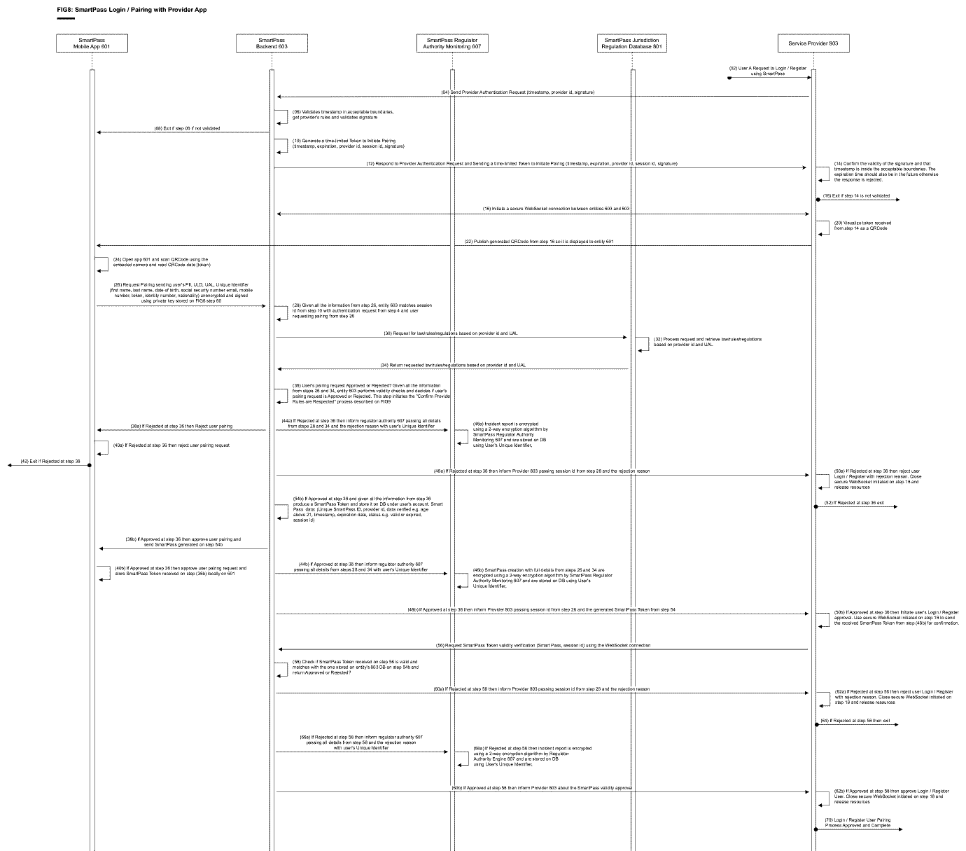

FIG. 8 shows an example systems interaction diagram of a SmartPass User-Service Provider Login/Pairing process, demonstrating a sequence of various actions, communications and data exchanges which are performed between various system entities of a data network as part of the execution of this procedure.

The SmartPass Login/Pairing process with a Provider App, as depicted in FIG. 8, is a comprehensive, multi-step procedure that ensures secure user authentication and regulatory compliance in accessing service provider applications. The process begins with a preliminary registration where service providers receive unique IDs and cryptographic keys for secure communications with the SmartPass Backend. Users initiate login or registration requests through the SmartPass mobile app, followed by a series of validations and data exchanges involving user data, service provider rules, and jurisdiction-specific regulations. This includes the generation and scanning of a dynamic QR code, or alternatively, an interactive mobile interface for seamless user experience. The SmartPass Backend may be configured or designed to include functionality for validating user credentials, generating and verifying SmartPass Tokens, and maintaining secure WebSocket connections for real-time communication. Rejections at any step result in the termination of the process and relevant notifications to service providers and regulatory authorities, while approvals lead to the successful login of the user, granting them access to the service provider's offerings. This detailed process underscores the system's commitment to security, regulatory adherence, and user convenience. Below is a description of the processes and procedural flows illustrated in FIG. 8.

SmartPass Jurisdiction Regulation Database 801. Entity 801 holds providers' law/rules/restrictions based on provider type and user's physical location. Service Provider 803 is an entity providing regulated or non-regulated services to users e.g. Gambling services, Gaming services, adult content services, etc.

(01) A separate registration process (not illustrated in FIG. 8) is performed between SmartPass Backend and Service Provider where Service provider registers with SmartPass Backend and receives a unique service provider ID and a private key using an encrypted algorithm such as RSA-4096: This step entails a preliminary registration process, supportive for the integration of a service provider (803) with the SmartPass system. During this process, the service provider establishes a secure and unique identity within the SmartPass Backend (603). The use of RSA-4096, an asymmetric encryption algorithm, ensures that the service provider is issued a private key that remains confidential, while a corresponding public key is shared with the SmartPass Backend. This mechanism is foundational for secure, encrypted communications between the service provider and the SmartPass system, safeguarding sensitive data transfers.

(02) User A Request to Login/Register using SmartPass: In this step, a user (referred to as User A) initiates a request to log in or register using the SmartPass application (601). This action is the first step in the user's interaction with the SmartPass system for accessing services provided by a service provider (803). The request signifies the user's intention to use the SmartPass system for authentication and potentially for other regulatory compliance activities. The user's action may be triggered through the SmartPass mobile app interface, where the user selects the option to log in or register for a specific service.

(02-22) Steps 02-22 relate to registration process between the Service Provider and SmartPass to obtain a QR Code that users may scan to log into the Service Provider's website/app using SmartPass: This sequence of steps (02-22) describes the comprehensive process from the initiation of a login/register request by a user (step 02) to the generation of a QR code by the service provider (step 22). This QR code provides a supportive element in the SmartPass system, enabling users to securely authenticate and gain access to the service provider's website or app. The process involves various interactions between the SmartPass mobile app (601), the SmartPass backend (603), and the service provider (803), ensuring that at least one step adheres to security and regulatory compliance standards.

(04) Each provider entity 803 is authorized to use SmartPass and has an ID on entity's 603 DB. Also entity 603 has entity's 803 public key. Entity 803 signs all authentication requests with their public key and entity 603 confirms the validity of the signature before the authentication request is accepted: This step is integral for maintaining the security and integrity of the SmartPass system. Each service provider (803) is pre-authorized and registered with the SmartPass Backend (603), which includes storing the service provider's unique ID and public key in the SmartPass Backend's database. When a service provider initiates an authentication request, it is signed using their public key. The SmartPass Backend, upon receiving this request, verifies the signature's validity using the stored public key. This verification ensures that the request is indeed from a legitimate and registered service provider, thereby safeguarding the system against unauthorized access attempts.

(04) Send Provider Authentication Request (timestamp, provider ID, signature): In this step, the service provider (803) sends an authentication request to the SmartPass Backend (603). This request includes supportive elements such as a timestamp, the unique provider ID, and a digital signature. The timestamp ensures the timeliness of the request, the provider ID identifies the specific service provider within the SmartPass system, and the signature, created using the provider's private key, guarantees the authenticity of the request. This authentication request is a key step in establishing a secure communication channel between the service provider and the SmartPass system.

(06) Based on step 4, entity 603 verifies the signature and loads provider's rules and restrictions from DB based on the given provider ID. Timestamp may be within the allowed boundaries e.g. less that x mins otherwise the request may be rejected: After receiving the authentication request from the service provider (803), the SmartPass Backend (603) conducts a two-fold verification process. First, it verifies the digital signature to confirm the request's authenticity. This facilitates preventing any fraudulent access attempts. Second, it checks the timestamp against a predefined time window (e.g., less than x minutes) to ensure the request's promptness and relevance. Post-verification, the SmartPass Backend loads specific rules and restrictions applicable to the service provider from its database. These rules are desirable for tailoring the user experience according to the service provider's regulatory and operational requirements.

(06) Validates timestamp in acceptable boundaries, get provider's rules and validates signature: This step involves the SmartPass Backend (603) ensuring the timestamp attached to the provider's authentication request falls within the acceptable time range. If the timestamp is too old (outside the predefined boundaries), it indicates a potential security risk, and the request is rejected. Once the timestamp is validated, the SmartPass Backend retrieves the specific rules and restrictions for the service provider from its database, based on the provider's ID included in the request. This retrieval is contingent upon successful validation of the provider's digital signature, which provides a supportive security measure to confirm the request's legitimacy.

(08) Exit if step 06 if not validated: This decision point provides a supportive security measure within the SmartPass system. If the SmartPass Backend (603) finds any discrepancies in the authentication request from the service provider (803) during step 06—such as an invalid signature or an unacceptable timestamp—it terminates the process. This immediate exit strategy is employed to safeguard against unauthorized or potentially malicious access attempts, ensuring that only valid and timely requests proceed further in the authentication and pairing process.

(10) Token generated on step 10 is signed using entity's 603 private key and entity 803 is able to verify and confirm the validity of the response based on entity's 603 public key. These keys have been exchanged offline/async during the Provider's (803) OnBoarding process: In this step, the SmartPass Backend (603) generates a token to facilitate the pairing process with the service provider (803). This token is digitally signed using the private key of the SmartPass Backend, ensuring its authenticity and integrity. The service provider, having the public key of the SmartPass Backend (obtained during their initial onboarding process), may verify the validity of this signed token. This use of asymmetric cryptography (public and private key pairs) enhances the security of the token exchange, ensuring that the token has not been tampered with and is indeed from a trusted source.

(10) Generate a Time-limited Token to Initiate Pairing (timestamp, expiration, provider ID, session ID, signature): The SmartPass Backend (603) generates a short-lived token for the purpose of initiating pairing with the service provider (803). This token contains supportive information like a timestamp (indicating the time of token generation), an expiration time (denoting the token's validity period), the provider's ID (linking the token to a specific service provider), a session ID (for tracking the individual session), and a digital signature (for ensuring the token's authenticity). The short lifespan of this token is a security measure to minimize the risk of unauthorized use or replay attacks.

(12) Respond to Provider Authentication Request and Sending a Time-limited Token to Initiate Pairing (timestamp, expiration, provider ID, session ID, signature): In this step, the SmartPass Backend (603) responds to the service provider's (803) authentication request by sending the newly generated short-lived token. This token, carrying important information like the timestamp, expiration, provider ID, and session ID, along with a signature, serves as a secure means for the service provider to validate the SmartPass Backend's acknowledgment and proceed with the user pairing process. The token's structure and content are designed to facilitate secure, authenticated, and time-bound interactions between the SmartPass system and the service provider.

(12) Token generated is in JWT format having a signed payload containing (timestamp, expiration, provider ID, session ID, signature): The token mentioned in step 12 is formatted as a JSON Web Token (JWT), a widely recognized standard for securely transmitting information between parties as a JSON object. This JWT contains a payload that is digitally signed, encapsulating supportive data such as the timestamp (marking the token generation time), expiration (defining the token's validity duration), provider ID (identifying the specific service provider), session ID (for session tracking), and a digital signature (for verifying the token's authenticity). The use of JWT facilitates seamless and secure data transmission in web environments, ensuring that the token contents are protected from tampering and forgery.

(14) Confirm the validity of the signature and that timestamp is inside the acceptable boundaries. The expiration time may also be in the future otherwise the response is rejected: At this step, the service provider (803) performs a validation check on the token received from the SmartPass Backend (603). The provider confirms the token's authenticity by verifying the digital signature using the public key of the SmartPass Backend. Additionally, the provider checks that the timestamp is within acceptable limits and that the token's expiration time is set in the future. If any of these conditions are not met (e.g., an outdated timestamp, expired token, or invalid signature), the response is rejected to maintain security and data integrity.

(16) Exit if step 14 is not validated: This step acts as a supportive security checkpoint in the SmartPass system. If the service provider (803) finds any discrepancies in the token received from the SmartPass Backend (603) during step 14—such as an invalid signature, an expired token, or an outdated timestamp—the process is immediately terminated. This step ensures that only tokens meeting all the required security criteria are accepted, thereby safeguarding the integrity of the pairing process and protecting against potential security breaches.

(18) Initiate a secure WebSocket connection between entities 603 and 803: This step involves the establishment of a secure WebSocket connection between the SmartPass Backend (603) and the service provider (803). WebSockets provide a full-duplex communication channel over a single, long-lived connection, allowing real-time data exchange. This connection is secured, through protocols like TLS (Transport Layer Security), to ensure that all data transferred between the SmartPass Backend and the service provider is encrypted and protected from eavesdropping or tampering. This secure channel is desirable for the subsequent steps of the pairing and authentication process, where sensitive data, including potentially personally identifiable information (PII) and other supportive details, are transmitted.

(20) Generate a dynamic QR code rendering and cause to be displayed on User A screen: This step involves the generation of a dynamic computer scannable code, such as a QR code, by the SmartPass Backend (603), which is then displayed on the user's (User A's) screen. This QR code is a visual representation of the short-lived token and other relevant data necessary for pairing with the service provider. The QR code's dynamic nature means it is generated in real-time and may have a limited validity period, enhancing security by preventing reuse or unauthorized access. User A may use the SmartPass mobile app to scan this QR code, further advancing the authentication and pairing process.

(20) Visualize token received from step 14 as a QR code: In this step, the service provider (803) visualizes the token received from the SmartPass Backend (603) as a QR code. This visualization typically occurs within the service provider's interface, where the QR code is rendered and displayed. The token, which contains desirable pairing information, is encoded into the QR code format, making it easily scannable by the user's mobile device. This step facilitates facilitating a seamless and user-friendly authentication process, where the user may simply scan the QR code using their SmartPass mobile app to complete the pairing.

(22) Publish generated QR code from step 18 so it is displayed to entity 601: Following the generation of the QR code, this step involves publishing or displaying the QR code so that it is visible to the SmartPass mobile app (Entity 601). This may be implemented via a web interface, an app screen, or any other medium accessible to the user. The displayed QR code is ready to be scanned by the user's mobile device, carrying forward the authentication process. The QR code's visibility to the user is a key interaction point, bridging the service provider's system and the user's SmartPass application.

(24) If user is using if all activity is on the user's mobile device then in some embodiments the QR code may not be displayed but there may be some type of interactive display where the user may interact with the display on the user's phone which causes the information of relating to that QR code to be passed to the smart SmartPass application mobile application and then the system proceeds from there. Rotating QR code preferred: In cases where the user's interaction is confined to a mobile device, this step adapts the authentication process. Instead of displaying a QR code, an interactive element is presented on the user's mobile screen. This interaction may directly pass the required information (akin to the data encoded in the QR code) to the SmartPass application. Such a design choice enhances user experience by streamlining the process and is particularly useful in scenarios where scanning a physical QR code is not feasible or practical. The use of a rotating QR code, if implemented, adds an additional layer of security by constantly updating the encoded information.

(24) Open app 601 and scan QR code using the embedded camera and read QR code data (token): In this step, the user opens the SmartPass mobile app (601) and uses the app's embedded camera functionality to scan the QR code displayed by the service provider (803). The QR code contains data encoded within it, typically in the form of a token or other identifiers necessary for the authentication process. The mobile app decodes this QR code, retrieving the embedded data which is then used for further steps in the authentication and pairing process.

(26) All requests from entity 601 to entity 603 are sent unencrypted over a secure channel in JWT format signed by user's private key stored locally on entity 601 on FIG. 6 step 60: This step describes the protocol for communication between the SmartPass mobile app (601) and the SmartPass Backend (603). All requests, including sensitive data, are sent in an unencrypted JSON Web Token (JWT) format. However, these JWTs are signed using a private key uniquely assigned to and stored securely within the user's app (601). The signature ensures the authenticity and integrity of the requests, even though the content is not encrypted. This approach balances security with efficient data transmission.

(26) Request Pairing sending user's PII, ULD, UAL, Unique Identifier (first name, last name, date of birth, social security number, email, mobile number, token, identity number, nationality) unencrypted and signed using private key stored on FIG. 6 step 60: In this step, the SmartPass mobile app (601) sends a pairing request to the SmartPass Backend (603). This request includes the user's Personally Identifiable Information (PII) such as name, date of birth, social security number, email, mobile number, as well as User Location Data (ULD), User Approximate Location (UAL), and other unique identifiers. Although the data is sent unencrypted over a secure channel, it is signed with the user's private key, ensuring the authenticity of the request. This step facilitates establishing the user's identity and eligibility for the services provided by the service provider (803).

(28) Given all the information from step 26, entity 603 matches session ID from step 10 with authentication request from step 4 and user requesting pairing from step 26: In this step, the SmartPass Backend (603) processes the pairing request received from the SmartPass mobile app (601). It involves matching the session ID, which was part of the short-lived token generated in step 10, with the authentication request initiated by the service provider in step 4 and the user's pairing request from step 26. This matching facilitates ensure that the user attempting to pair is the one intended by the service provider, thereby maintaining the integrity of the user authentication process.

(28) On this step, entity 603 matches Provider with Session ID and User requesting to login: This step involves the SmartPass Backend (603) cross-referencing the session ID from the authentication process with the user's login request. It is a validation step to ensure that the user attempting to log in or register is aligned with the ongoing session initiated by the service provider (803). This matching provides a supportive component of the authentication process, linking the user's actions on their app with the service provider's request, thereby facilitating a seamless and secure login or registration experience.

(32) This step produces data structured in JSON format containing the minimum age that allows user to use the service, the physical location boundaries that service is allowed, the number of last digits of user's social security number and anything else that may be requested by the provider or the regulator authority and may be enforced by SmartPass application and submitted to entity 607: In this step, the SmartPass Backend (603) generates a JSON-formatted data package that includes specific user-related requirements as per the service provider's rules and regulatory obligations. This data package may include criteria like minimum age for service eligibility, geographical boundaries within which the service may be accessed, and partial social security number information. This step facilitates ensuring that the user meets all necessary criteria set forth by the service provider and regulatory authorities, thereby upholding compliance and operational standards.

(30) Request for law/rules/regulations based on provider ID and UAL: This step involves the SmartPass Backend (603) requesting detailed law, rules, and regulations pertinent to the service provider (803) based on the provider's ID and the User Approximate Location (UAL). This request is directed towards the SmartPass Jurisdiction Regulation Database (801), a repository that maintains an up-to-date record of regulatory requirements and restrictions based on different jurisdictions and provider types. The information obtained in this step is desirable for ensuring that the user's interaction with the service provider adheres to all applicable legal and regulatory standards.

(32) Process request and retrieve law/rules/regulations based on provider ID and UAL: In this step, the SmartPass Backend (603) processes the request for the specific laws, rules, and regulations applicable to the service provider (803). This involves retrieving information from the SmartPass Jurisdiction Regulation Database (801) based on the provider's ID and the user's approximate location. The retrieval of these tailored regulations ensures that the service provider operates within the legal framework of their jurisdiction and that users are provided with services that comply with local laws and regulations.

By way of example illustration: Provider ID: 1234; Service Category ID=Online gambling; Requirements: Age=21+; Location=Nevada; Last 4 of SS; Regulatory Authority ID: This example illustrates the type of information the SmartPass Backend (603) retrieves from the SmartPass Jurisdiction Regulation Database (801). It includes specific criteria like the service category (e.g., online gambling), age requirements, allowed locations (e.g., Nevada), and other details like the last four digits of the user's social security number. These details are tailored to the specific service provider, identified by their unique provider ID. This information facilitates ensuring that the services provided are in compliance with jurisdiction-specific regulations and that users meet the necessary criteria to access these services.

(34) Return requested law/rules/regulations based on provider ID and UAL: The SmartPass Backend (603) completes the retrieval process by returning the specific laws, rules, and regulations associated with the service provider's ID and User Approximate Location (UAL) to the appropriate entity, which may be either the service provider (803) or the SmartPass mobile app (601). This data facilitates ensuring that the services offered by the provider comply with the legal and regulatory requirements specific to the user's location. The returned information aids in the subsequent decision-making process, ensuring that the user's access to the service provider's offerings aligns with these stipulated rules.

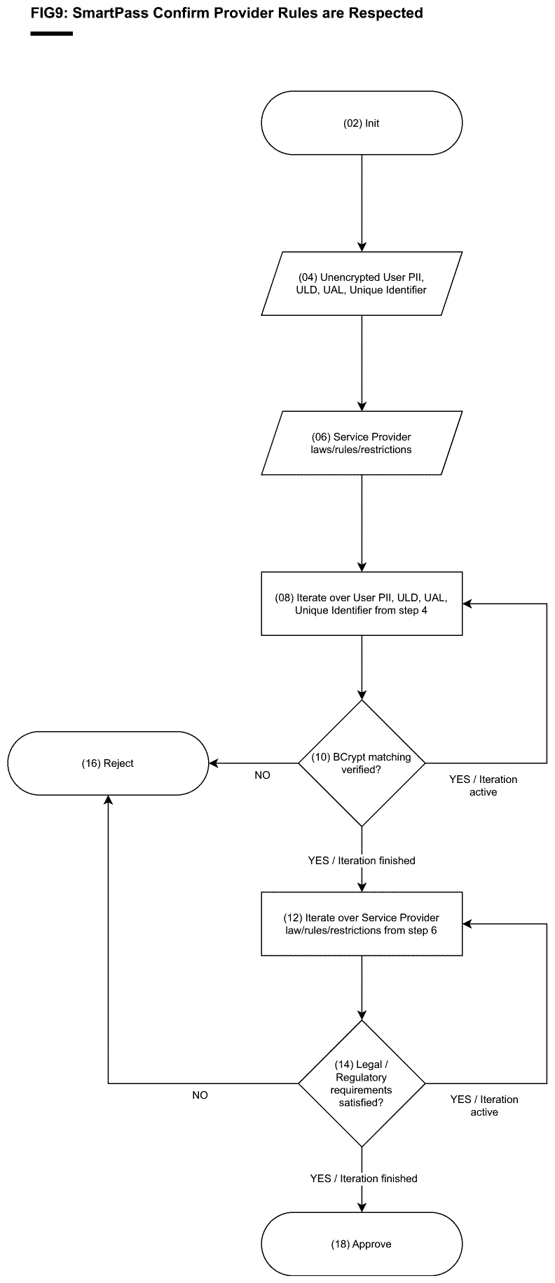

(36) Due to the complexity of this step the actual process is described on FIG. 9: Confirm Provider Rules are Respected: This notation indicates that the step involves a complex procedure detailed in another part of the documentation, specifically FIG. 9 titled “Confirm Provider Rules are Respected.” This process involves verifying that all the rules and regulations applicable to the service provider (803), as determined in the previous steps, are respected and adhered to in the context of the user's request to access the service. The complexity arises from the need to cross-reference various regulatory requirements with user data and service provider specifics.

(36) User's pairing request Approved or Rejected? Given all the information from steps 26 and 34, entity 603 performs validity checks and decides if user's pairing request is Approved or Rejected. This step initiates the “Confirm Provider Rules are Respected” process described on FIG. 9: At this juncture, the SmartPass Backend (603) assesses the user's pairing request, utilizing the information received in steps 26 (user data and request specifics) and 34 (laws, rules, and regulations). The decision hinges on whether the user's data and the requested service align with the regulatory framework and the service provider's specific rules. If the criteria are met, the pairing request is approved; otherwise, it is rejected. This decision point is desirable for maintaining regulatory compliance and ensuring that the user's access to services is legitimate and lawful.

(38a) If Rejected at step 36 then Reject user pairing: In the event the user's pairing request is rejected in step 36 due to non-compliance with the requisite criteria, this step formalizes the rejection. The SmartPass Backend (603) communicates this decision, effectively halting the user's attempt to pair with the service provider (803). This step underscores the system's commitment to regulatory compliance and the integrity of the service access process.

(38b) If Approved at step 36 then approve user pairing and send SmartPass generated on step 54b: Conversely, if the user's pairing request is approved in step 36, the SmartPass Backend (603) proceeds to formally approve the pairing. Subsequently, the Backend sends the SmartPass, which was generated as per the process detailed in step 54b, to the relevant parties. This SmartPass serves as a digital token or credential, enabling the user to access the service provider's (803) offerings in compliance with all assessed rules and regulations.

(40a) If Rejected at step 36 then reject user pairing request: This step involves the SmartPass Backend (603) taking action following the rejection decision in step 36. The Backend formally rejects the user pairing request, thereby preventing the user from proceeding further in the process of accessing the service provider's (803) services. This step provides a supportive control measure, ensuring that only users who meet all the necessary criteria are allowed to proceed.

(40b) If Approved at step 36 then approve user pairing request and store SmartPass Token received on step (38b) locally on 601: Following the approval in step 36, this step involves the SmartPass Backend (603) not only approving the user pairing request but also storing the SmartPass Token, received as a result of the approval in step 38b, within the SmartPass mobile app (601). This storage provides the user with the necessary credentials, stored locally on their device, to access the service provider's (803) services.

(42) Exit if Rejected at step 36: This step acts as a termination point in the process if the user's pairing request is rejected in step 36. If the request does not meet the necessary criteria for approval, the process is halted, and no further actions are taken in the pairing sequence. This exit step facilitates maintaining the system's integrity and ensuring that only compliant and valid requests proceed.

(44a) If Rejected at step 36 then inform regulator authority 607 passing all details from steps 28 and 34 and the rejection reason with user's Unique Identifier: In the event of a rejection at step 36, this step may require the SmartPass Backend (603) to notify the relevant regulatory authority (607) of the decision. The notification includes comprehensive details from the user's request and the provider's regulations (steps 28 and 34), along with the specific reasons for rejection and the user's unique identifier. This step facilitates regulatory compliance, ensuring transparency and accountability in the user access control process.

(44b) If Approved at step 36 then inform regulator authority 607 passing all details from steps 28 and 34 with user's Unique Identifier: Conversely, if the user's request is approved in step 36, the SmartPass Backend (603) informs the regulatory authority (607) of this decision. The communication includes details from the user's request and the provider's regulations (steps 28 and 34), alongside the user's unique identifier. This notification serves to keep the regulatory authority informed about user access approvals, contributing to the system's overall regulatory compliance and transparency.

(46a) Incident report is encrypted using a 2-way encryption algorithm by SmartPass Regulator Authority Monitoring 607 and are stored on DB using User's Unique Identifier: Following a rejection (as noted in step 44a), this step involves the creation of an incident report by the SmartPass Regulator Authority Monitoring (607). The report, detailing the rejection and its reasons, is encrypted using a two-way encryption algorithm, ensuring its confidentiality and integrity. This encrypted report is then stored in the database, tagged with the user's unique identifier. This process facilitates maintaining a secure and traceable record of all incidents, aiding in future audits or reviews.

(46b) SmartPass creation with full details from steps 26 and 34 are encrypted using a 2-way encryption algorithm by SmartPass Regulator Authority Monitoring 607 and are stored on DB using User's Unique Identifier: In the case of an approval (as noted in step 44b), this step involves encrypting the full details of the SmartPass creation process (including information from steps 26 and 34) using a two-way encryption algorithm. This encryption, performed by the SmartPass Regulator Authority Monitoring (607), ensures the security and confidentiality of the information. The encrypted data is then stored in the database, associated with the user's unique identifier. This step facilitates safeguarding sensitive information and maintaining a secure record of approved accesses.

(48a) If Rejected at step 36 then inform Provider 803 passing session ID from step 28 and the rejection reason: If the user's request is rejected in step 36, this step involves informing the service provider (803) of the rejection. The notification includes the session ID from step 28 and the reasons for the rejection. This communication ensures that the service provider is aware of the outcome of the user's request and understands the basis for the rejection, maintaining clarity and transparency in the service access process.

(48b) If Approved at step 36 then inform Provider 803 passing session ID from step 28 and the generated cryptographically signed SmartPass Token from step 54: In case of approval in step 36, this step may require notifying the service provider (803) of the approval, providing them with the session ID from step 28 and the SmartPass Token generated in step 54. This notification enables the service provider to recognize the user's authenticated status and grants them access to the services, based on the received SmartPass Token.

(50a) If Rejected at step 36 then reject user Login/Register with rejection reason. Close secure WebSocket initiated on step 18 and release resources: Following a rejection decision in step 36, this step involves the SmartPass Backend (603) formally rejecting the user's login or registration attempt, citing the specific reasons for rejection. Additionally, the secure WebSocket connection established in step 18 is closed, and any allocated resources are released. This closure is a desirable step in maintaining the security and efficiency of the system by ensuring that only valid and approved sessions remain active.

(50b) If Approved at step 36 then Initiate user's Login/Register approval. Use secure WebSocket initiated on step 18 to send the received SmartPass Token from step (48b) for confirmation: Upon approval in step 36, the SmartPass Backend (603) initiates the finalization of the user's login or registration process. This involves using the secure WebSocket connection established in step 18 to transmit the SmartPass Token (received in step 48b) to the relevant entity for confirmation. This step facilitates completing the user's access process, allowing them to log in or register successfully with the service provider (803), using the verified SmartPass Token as their authenticated credential.

(52) If Rejected at step 36 exit: This step signifies a termination point in the process flow, occurring if there is a rejection decision in step 36. The exit at this juncture ensures that no further actions or processes are undertaken following a rejection, thereby maintaining the integrity and security of the overall system.

(54) In at least one embodiment, SmartPass tokens may be implemented as JWT tokens stored on entity's 603 DB and are signed by entity's 603 private key so it may be verified at any time by any stakeholder using entity's 603 public key: SmartPass tokens, supportive for user authentication and access, are stored as JWT (JSON Web Tokens) in the database of the SmartPass Backend (603). These tokens are digitally signed using the private key of entity 603. This signature ensures the authenticity and integrity of the tokens, allowing any stakeholder, such as service providers or regulatory authorities, to verify them using the corresponding public key of entity 603. The secure storage and verification mechanism of these SmartPass tokens facilitates maintaining the trust and security of the SmartPass system.

(54b) If Approved at step 36 and given all the information from step 36 produce a SmartPass Token and store it on DB under user's account. SmartPass data: (Unique SmartPass ID, provider ID, data verified e.g. age above 21, timestamp, expiration date, status e.g. valid or expired, session ID): Upon approval of the user's pairing request at step 36, this step involves the generation and storage of a SmartPass Token in the SmartPass Backend (603) database, under the user's account. The token includes important information such as a unique SmartPass ID, the service provider's ID, verified user data (like age), a timestamp marking the generation time, an expiration date indicating the token's validity period, the status of the token (valid or expired), and the session ID. This comprehensive data set within the SmartPass Token ensures that the user's access to the service provider's offerings is securely managed and recorded.

(56) Request SmartPass Token validity verification (SmartPass, session ID) using the WebSocket connection: In this step, a request is made to verify the validity of the SmartPass Token using the established secure WebSocket connection (as initiated in step 18). This request includes the SmartPass Token and the session ID. The purpose of this verification is to ensure that the SmartPass Token being used for user authentication is still valid and corresponds to the current session. This step facilitates maintaining the integrity and security of the user authentication process.

(58) Check if SmartPass Token received on step 56 is valid and matches with the one stored on entity's 603 DB on step 54b and return Approved or Rejected?: This step involves checking the validity of the SmartPass Token received in the verification request of step 56. The verification process includes confirming whether the received token matches the one stored in the SmartPass Backend's (603) database from step 54b and whether it is still valid (not expired). Based on this verification, an approval or rejection response is generated. This step facilitates ensuring that only authentic and valid tokens are accepted, thereby maintaining the security of the system.

(60a) If Rejected at step 58 then inform Provider 803 passing session ID from step 28 and the rejection reason: In the event that the SmartPass Token verification in step 58 results in a rejection, this step involves informing the service provider (803) of the rejection. The information communicated includes the session ID from step 28 and the specific reason for the token's rejection. This step ensures that the service provider is kept informed about the status of the user's authentication process, particularly in cases where access is denied.

(60b) If Approved at step 58 then inform Provider 803 about the SmartPass validity approval: Conversely, if the cryptographically signed SmartPass Token is validated in step 58, this step involves notifying the service provider (803) about the successful verification. This notification includes confirmation of the SmartPass Token's validity, signaling to the provider that the user's authentication process has been successfully completed and access may be granted. This step is integral to the flow of information between the SmartPass system and the service provider, facilitating seamless access for authenticated users.

(62a) If Rejected at step 58 then reject user Login/Register with rejection reason. Close secure WebSocket initiated on step 18 and release resources: Following a rejection decision in the SmartPass Token validity check (step 58), this step involves formally rejecting the user's login or registration request. The specific reason for the rejection is communicated, and the secure WebSocket connection, established earlier in step 18, is closed. Additionally, any resources allocated for this process are released. This step ensures that the system's resources are efficiently managed and that only successful authentication processes proceed to the final stages.

(62b) If Approved at step 58 then approve Login/Register User. Close secure WebSocket initiated on step 18 and release resources: If the SmartPass Token verification in step 58 is successful, this step finalizes the user's login or registration approval. Following this approval, the secure WebSocket connection established in step 18 is closed, and any related resources are released. This step marks the completion of the authentication process, allowing the user to proceed with accessing the service provider's offerings. The closing of the WebSocket connection and release of resources signify the end of a successful authentication session.

(64) If Rejected at step 58 then exit: This step marks the termination of the process in the event of a rejection at the SmartPass Token validity check (step 58). The exit at this point indicates that no further actions may be undertaken in this particular user authentication session. This step facilitates maintaining the system's integrity, ensuring that unsuccessful or invalid authentication attempts do not proceed further.

(66a) If Rejected at step 58 then inform regulator authority 607 passing all details from step 58 and the rejection reason with user's Unique Identifier: Following a rejection in the SmartPass Token verification (step 58), this step involves notifying the regulatory authority (607) of the decision. The notification includes comprehensive details from the verification process and the specific reasons for the rejection, tagged with the user's unique identifier. This step facilitates regulatory compliance, ensuring that the authority is informed about the reasons behind access denials, contributing to the transparency and accountability of the system.

(68a) If Rejected at step 58 then incident report is encrypted using a 2-way encryption algorithm by Regulator Authority Engine 607 and are stored on DB using User's Unique Identifier: In case of a rejection in step 58, an incident report is generated and encrypted using a two-way encryption algorithm by the Regulator Authority Engine (607). This encrypted report, detailing the rejection and its reasons, is then securely stored in the database, associated with the user's unique identifier. The encryption of the incident report ensures its confidentiality and integrity, maintaining the security and privacy of sensitive information.

(68a) In one embodiment, Backend may generate Multiple copies of an incident report where at least one copy is encrypted with a different key corresponding to a rate different regulator authority ID and that data may be stored on the SmartPass Regulator Authority Monitoring 607: In certain implementations, the SmartPass Backend may create multiple versions of an incident report, at least one encrypted with a unique key corresponding to different regulator authority IDs. This approach allows for tailored access to the incident reports by various regulatory authorities, at least one able to decrypt and view the report relevant to their jurisdiction or area of responsibility. The data is stored securely within the SmartPass Regulator Authority Monitoring (607), ensuring that at least one authority has access to pertinent information while maintaining data security and privacy.

(68a) Provide an example of How is incident report encrypted in a way to allow different regulators to decrypt and view incident report details?: In this step, an incident report generated following a rejection (as in step 68a) is encrypted in a manner that accommodates decryption by multiple regulatory authorities. For example, the report may be encrypted using different public keys corresponding to at least one regulator authority. At least one authority would use its private key to decrypt the report. This method ensures that while the report remains secure and confidential, it is accessible to all relevant regulatory bodies for compliance and monitoring purposes.

(70) At this point, User is logged into the service provider app/website and permitted to engage in service provider activities: This final step signifies the successful completion of the user's authentication and pairing process. Following the approval of the SmartPass Token and other verification steps, the user is now logged into the service provider's (803) app or website. The user is granted access to engage in the activities and services offered by the provider, having successfully navigated the SmartPass authentication and regulatory compliance process. This step marks the end of the login/register sequence, transitioning the user into the service utilization phase.

In at least one embodiment, for Service Providers providing multiple different regulative services such as gambling and access to adult content for example, in one embodiment separate SmartPass tokens may be issued to allow users to perform at least one of those activities individually under at least one individual smart past.

Additionally, the SmartPass Jurisdiction Regulation Database (801) may be configured or designed to include functionality for this process by holding and providing the necessary laws, rules, and restrictions based on the provider type and user's physical location. Service Provider (803), in turn, offers a range of regulated or non-regulated services, such as gambling, gaming, or adult content services. In scenarios where a service provider offers multiple distinct regulated services, separate SmartPass tokens may be issued for at least one activity, ensuring that users are authenticated and authorized for at least one specific service they wish to access. This modular approach to SmartPass issuance enhances the system's flexibility and adaptability to various regulatory environments and service types.

FIG. 9 shows an example systems interaction diagram of a SmartPass User-Service Provider Regulatory Compliance Verification process, demonstrating a sequence of various actions, communications and data exchanges which are performed between various system entities of a data network as part of the execution of the process of confirming service provider rules and ensuring regulatory compliance for SmartPass users accessing Service Provider services.

The process depicted in FIG. 9 illustrates an example embodiment of a SmartPass regulatory compliance verification procedure. It begins with the initiation of a protocol to confirm adherence to service provider rules and regulations. The SmartPass Backend system plays a central role in this process, gathering extensive user data, including personal identifiers and location information, and cross-referencing it with specific laws, rules, and restrictions applicable to the service provider. This procedure involves iterative checks and cryptographic verifications to ensure that all user data aligns with the required legal and regulatory frameworks. If discrepancies are found, the process results in a failure, indicating non-compliance, whereas successful verification leads to compliance approval.

Additionally, the SmartPass Backend periodically monitors and reevaluates the status of SmartPass tokens, taking appropriate actions to invalidate tokens when necessary and notifying relevant system entities, thereby ensuring ongoing regulatory compliance and system integrity. Below is a description of the processes and procedural flows illustrated in FIG. 9.

(02) Initiate Process “Confirm Provider Rules are Respect”: This step marks the initiation of the process to confirm that the rules, laws, and restrictions imposed on a service provider are respected and adhered to. It involves the SmartPass Backend (Entity 603) starting a sequence of actions to ensure compliance with regulatory requirements. This step facilitates maintaining the integrity of the SmartPass ecosystem, ensuring that service providers operate within legal and regulatory frameworks.

(04) Get all user's PII data, UDL, UAL, Unique Identifier: In this step, the SmartPass Backend (Entity 603) retrieves the user's Personally Identifiable Information (PII), including details such as first name, last name, date of birth, User Location Data (ULD), User Approximate Location (UAL), Unique Identifier, nationality, social security number, email, mobile number, and identity number. This comprehensive data collection is desirable for accurately identifying the user and ensuring that the services provided are tailored to their specific needs and comply with relevant laws and regulations.

(06) Get all laws/rules/restrictions that the Service Provider is enforced to verify to allow a user to gain access to their service: In this phase, the SmartPass Backend (Entity 603) gathers all the relevant laws, rules, and restrictions that a service provider may enforce to grant a user access to their services. This step facilitates ensure that the service provider complies with jurisdiction-specific regulations and maintains legal operation standards.

(08) Iterate over all data from step 4: This step involves iterating over all the user data collected in step 4. It is executed by the SmartPass Backend (Entity 603) and ensures thorough verification of at least one piece of user data against the service provider's requirements. This iteration process facilitates cross-verifying user information with regulatory compliance needs.

(10) BCrypt matching verified?: This decision point involves verifying whether the data from step 4 matches the BCrypt hashed values stored in the SmartPass Backend (Entity 603). It's a supportive security measure to ensure data integrity and prevent unauthorized access or tampering.

(12) Iterate over all data from step 6: This step, executed by the SmartPass Backend (Entity 603), involves iterating over all the laws, rules, and restrictions identified in step 6. It ensures that at least one rule is thoroughly checked against the user's data for compliance purposes.

(14) Legal/Regulatory requirements satisfied?: This decision step evaluates whether the legal and regulatory requirements outlined in step 6 are met based on the user's data retrieved in step 4. The SmartPass Backend (Entity 603) performs this evaluation, which includes checking if the user's age, location, and other factors align with the service provider's operational boundaries and regulatory obligations.

(16) Exit Process and return FAIL: If any of the checks in the previous steps result in non-compliance or discrepancies, this step concludes the process with a failure result. It indicates that the user does not meet the necessary criteria to access the service provider's offerings under current laws and regulations.

(18) Exit Process and return SUCCESS: This step is reached if all the checks and verifications in the previous steps are successfully met, indicating that the user complies with all legal and regulatory requirements to access the service provider's services.

In at least one embodiment, the SmartPass Backend periodically and/or continuously monitors for events or conditions that may alter the status of one or more SmartPass tokens. Upon detecting such changes, the backend identifies the affected tokens and initiates necessary actions to deactivate or invalidate them. It also communicates these changes to other system entities like the SmartPass Mobile Application, SmartPass Regulator Authority Monitoring System, and Service Provider Systems. This ensures that users with invalidated SmartPass tokens are restricted or prevented from accessing the associated service provider services. This feature is desirable for maintaining the security and regulatory compliance of the SmartPass ecosystem.

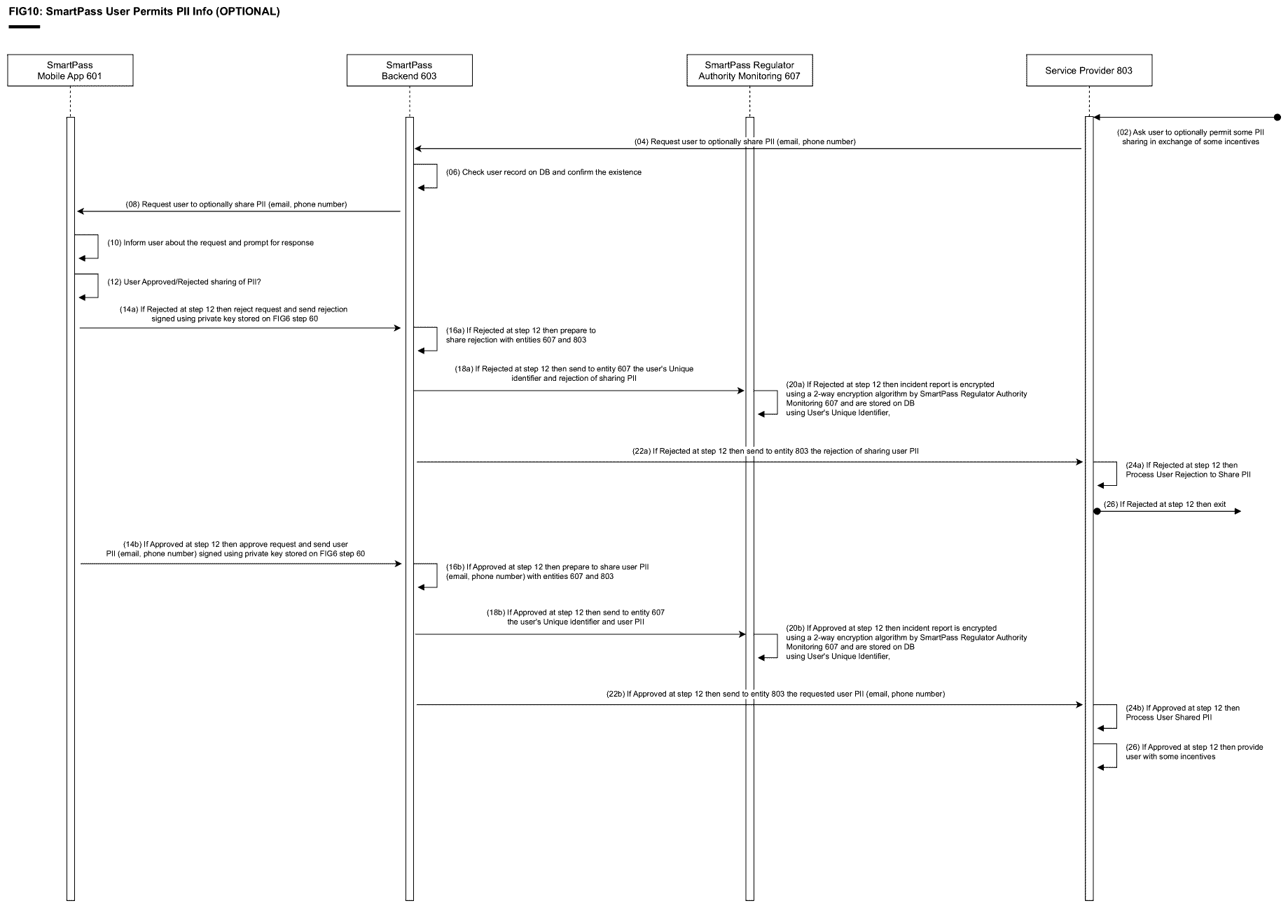

FIG. 10 shows an example systems interaction diagram of a SmartPass User Optional Sharing of PII Info process, demonstrating a sequence of various actions, communications and data exchanges which are performed between various system entities of a data network as part of the execution of this procedure.

FIG. 10 illustrates a specific example embodiment of a SmartPass Platform process providing SmartPass users the option of sharing selected portions of their Personally Identifiable Information (PII) with 3′ party entities, such as one or more Service Providers. Initially, users are prompted by the SmartPass Mobile App (601) to share their PI, such as email and phone number, in exchange for certain incentives, emphasizing the voluntary nature of this action. Upon user consent, the SmartPass Backend (603) facilitates the secure collection and transmission of this data, ensuring its integrity through digital signatures and encryption. The process also involves communicating the user's decision to share or not share their PII to the SmartPass Regulator Authority Monitoring (607) and Service Providers (803), maintaining transparency and regulatory compliance. In cases of user consent, benefits or incentives are provided to the user, whereas a rejection leads to the respectful cessation of the request. This procedure exemplifies a user-centric approach, prioritizing user autonomy and data security in the PII sharing process within the SmartPass ecosystem. Below is a description of the processes and procedural flows illustrated in FIG. 10.

(02) Ask user to optionally permit some PII sharing in exchange of some incentives: In this step, the SmartPass Mobile App (601) presents the user with an option to share their Personally Identifiable Information (PII), such as email and phone number, in exchange for certain incentives. This step facilitates enhancing user engagement and providing personalized services. The incentives may range from enhanced app functionality, access to exclusive features, or other benefits. The app communicates the benefits of PII sharing to the user, emphasizing the optional nature of this action. The user's decision at this juncture influences subsequent steps in the process. The approach used here may be transparent and comply with privacy regulations, ensuring that the user's consent is informed and voluntary.

(04) Request user to optionally share PII (email, phone number): At this step, the SmartPass Backend (603) sends a request to the user through the SmartPass Mobile App (601), asking them to optionally share their PII, specifically their email address and phone number. This step is a direct follow-up to the user being informed about the option to share their PII in exchange for incentives. It involves formulating and displaying a clear, user-friendly request on the app interface, where the user may easily input and submit their email and phone number. The system design may ensure that the user understands that sharing this information is optional and has no mandatory implications on their use of the app. The request is structured to reassure the user of the secure handling of their data.

(06) Check user record on DB and confirm the existence: In this step, the SmartPass Backend (603) performs a verification process by checking the user's record in the database. This verification ensures that the user who has opted to share PII is an existing user of the SmartPass system. The backend accesses the database to confirm the presence of the user's record, including their unique identifier and previously stored PII, if any. This step facilitates data integrity and security, as it prevents unauthorized access or sharing of PII. It involves querying the database with the user's unique identifier or other identifying details and receiving a confirmation of the user's existence in the system.

(08) Request user to optionally share PII (email, phone number): This step is a reiteration or confirmation phase where the SmartPass Mobile App (601) once again requests the user to optionally share their PII (email and phone number). This may be a part of a multi-step verification process to ensure that the user is fully aware of and agrees to the data sharing. This step may include a detailed explanation of how the PII may be used, the benefits to the user, and reassurances about data security and privacy. The app interface would present the user with fields to enter their email and phone number, along with clear instructions on how to submit this information.

(10) Inform user about the request and prompt for response: At this juncture, the SmartPass Mobile App (601) actively informs the user about the PII sharing request. This step involves displaying a notification or a message within the app, clarifying what information is being requested (email and phone number), the purpose of the request, and the nature of the incentives offered in return. The app prompts the user for a response—either to agree to share the requested PII or to decline. This step facilitates ensuring user consent is explicitly obtained, adhering to privacy and data protection standards. The design of this prompt is user-centric, aiming to make the decision process as straightforward and transparent as possible for the user.

(12) User Approved/Rejected sharing of PII?: This is a decision point where the user's response to the PI sharing request is determined. Based on the user interaction with the SmartPass Mobile App (601), the system identifies whether the user approves or rejects the sharing of their personal information. The criteria for this decision are solely based on the user's input. If the user consents to share their PII, the process moves forward to steps involving the handling of this information. Conversely, if the user rejects the request, the process branches to steps dealing with the rejection. This step is significant as it respects the user's autonomy and choice, impacting the subsequent flow of the procedure.

(14a) If Rejected at step 12 then reject request and send rejection signed using private key stored on FIG. 6 step 60: In this step, if the user has rejected the PII sharing request at step (12), the SmartPass Mobile App (601) processes this rejection. The app generates a rejection message, which is then digitally signed using a private key, ensuring the authenticity and integrity of the communication. This private key is securely stored as per the specifications in FIG. 6 step 60, adhering to robust security protocols. The signed rejection message provides a supportive part of the communication, as it provides a verifiable and secure acknowledgment of the user's decision not to share their PII. This step is fundamental in maintaining the trust of the user in the system by respecting their choice and securely handling the response.

(14b) If Approved at step 12 then approve request and send user PII (email, phone number) signed using private key stored on FIG. 6 step 60: Following the user's approval at step (12), this step involves the SmartPass Mobile App (601) processing the consent. The user's PI (email and phone number) is collected and packaged in a secure message. This message is then digitally signed using a private key, as detailed in FIG. 6 step 60, ensuring the authenticity and security of the data being transmitted. This step involves handling sensitive user information. The digital signature adds an extra layer of security, ensuring that the data is not tampered with during transmission. This process highlights the system's commitment to data security and user privacy.

(16a) If Rejected at step 12 then prepare to share rejection with entities 607 and 803: Upon the user's rejection of the PI sharing request, this step involves the preparation by the SmartPass Backend (603) to communicate this decision to other relevant entities in the system, specifically the SmartPass Regulator Authority Monitoring (607) and the Service Provider (803). This preparation includes compiling the rejection information, along with the user's unique identifier, into a report or notification format suitable for transmission. The goal is to keep these entities informed of the user's decision, maintaining transparency and coherence in the system's operation. This step facilitates ensuring that all relevant parties within the SmartPass ecosystem are updated about the user's privacy preferences, aligning with regulatory compliance and service provider requirements.

(16b) If Approved at step 12 then prepare to share user PII (email, phone number) with entities 607 and 803: Following the user's approval to share PII at step (12), the SmartPass Backend (603) initiates the process of sharing this information with the SmartPass Regulator Authority Monitoring (607) and the Service Provider (803). This preparation involves securely packaging the user's PII, ensuring it is encrypted and ready for transmission. The data, along with the user's unique identifier, is formatted for secure sharing, maintaining the integrity and confidentiality of the user's personal information. This step is fundamental in the data-sharing process, as it ensures that the user's PII is handled responsibly and shared only with authorized entities within the SmartPass ecosystem, adhering to data protection regulations and user consent.

(18a) If Rejected at step 12 then send to entity 607 the user's Unique identifier and rejection of sharing PII: In this step, following the user's rejection of PII sharing, the SmartPass Backend (603) communicates this decision to the SmartPass Regulator Authority Monitoring (607). The communication includes the user's unique identifier and the details of the rejection. This step is desirable to maintain regulatory compliance and inform the authority about the user's privacy preferences. The transmission of this data is securely handled, ensuring that the user's decision and their unique identifier are protected during the communication process. This step reinforces the system's adherence to privacy standards and regulatory requirements, ensuring that user decisions are respected and communicated appropriately within the SmartPass ecosystem.

(18b) If Approved at step 12 then send to entity 607 the user's Unique identifier and user PII: Upon user approval for PII sharing at step (12), this step involves the SmartPass Backend (603) transmitting the user's PII along with their unique identifier to the SmartPass Regulator Authority Monitoring (607). This transmission is conducted securely, ensuring the confidentiality and integrity of the user's personal information. The data sent includes the user's email and phone number, alongside their unique identifier, which facilitates identifying the user within the system. This step facilitates regulatory compliance, as it allows the regulator authority to have access to up-to-date user information, necessary for various regulatory and monitoring purposes within the SmartPass ecosystem.

(20a) If Rejected at step 12 then incident report is encrypted using a 2-way encryption algorithm by SmartPass Regulator Authority Monitoring 607 and are stored on DB using User's Unique Identifier: Following the user's rejection of PII sharing, this step involves the SmartPass Regulator Authority Monitoring (607) encrypting the incident report, which includes the user's rejection, using a two-way encryption algorithm. This encrypted report, along with the user's unique identifier, is then securely stored in the database. The use of two-way encryption ensures that the data may be decrypted and accessed only by authorized entities, maintaining the confidentiality and integrity of the user's decision. This step facilitates secure data handling and compliance, as it ensures that sensitive information related to user choices is securely stored and accessible only to authorized personnel within the SmartPass ecosystem.

(20b) If Approved at step 12 then incident report is encrypted using a 2-way encryption algorithm by SmartPass Regulator Authority Monitoring 607 and are stored on DB using User's Unique Identifier: In this step, after the user approves PII sharing at step (12), the SmartPass Regulator Authority Monitoring (607) secures the incident report through encryption. The incident report, containing the user's consent and PII (email, phone number), is encrypted using a robust two-way encryption algorithm. This secure process ensures that the report, along with the user's unique identifier, is stored safely in the database. The two-way encryption safeguards the data from unauthorized access, ensuring that only entities with the appropriate decryption keys may access it. This step is desirable for maintaining the integrity and confidentiality of the user's shared PII within the SmartPass ecosystem.

(22a) If Rejected at step 12 then send to entity 803 the rejection of sharing user PII: When the user rejects the PII sharing request at step (12), this step involves the SmartPass Backend (603) communicating the user's decision to the Service Provider (803). The communication includes the user's decision not to share their PII. This step facilitates ensuring that the service provider is aware of the user's privacy preferences and that no PII is shared without consent. The transmission of this information is executed securely, maintaining the privacy and integrity of the user's decision. This step exemplifies the system's commitment to user privacy and the importance of transparent communication between the SmartPass platform and its service providers.

(22b) If Approved at step 12 then send to entity 803 the requested user PII (email, phone number): In this step, following the user's approval of PI sharing at step (12), the SmartPass Backend (603) transmits the user's PII to the Service Provider (803). This data transmission includes the user's email and phone number, which were shared voluntarily by the user. This step is significant as it facilitates the sharing of PII with service providers, potentially enabling enhanced user experiences or access to specific services. The transmission is conducted with a high level of security, ensuring that the user's PII is protected during the process and only shared with authorized entities within the SmartPass ecosystem.

(24a) If Rejected at step 12 then Process User Rejection to Share PII: In the event of a user rejecting the request to share PI at step (12), this step involves the SmartPass Backend (603) processing this decision. The backend system updates the user's profile to reflect their choice not to share PII. This processing may involve logging the decision for audit purposes, updating user preferences in the database, and ensuring that no future requests for PI sharing are made without revisiting the user's consent. This step is desirable for respecting user autonomy and ensuring that their decisions regarding personal data are accurately reflected and adhered to within the SmartPass system.

(24b) If Approved at step 12 then Process User Shared PII: Upon user approval for PII sharing at step (12), this step by the SmartPass Backend (603) involves processing the shared PII. The user's email and phone number are integrated into their profile and may be used for enhancing their experience or for specific functionalities within the SmartPass ecosystem. This processing may involve updating the database with the new PI, potentially triggering other processes that rely on this information, such as personalized communications or services tailored to the user. This step underscores the system's capability to dynamically update and utilize user information, subject to their consent, for providing a more customized and effective service.

(26) At this point User has received some incentives from Service Provider which are unknown to SmartPass: After the user consents to share their PII at step (12) and the process is completed, this step indicates that the user receives certain incentives from the Service Provider (803). These incentives, which were part of the proposition for sharing PII, may range from access to premium features, discounts, or other benefits. However, the specifics of these incentives are not known to the SmartPass system, indicating a separation of concerns where the SmartPass platform does not track or manage the incentive details provided by the service providers. This step highlights the independent nature of the relationship between the service providers and users within the SmartPass ecosystem, where SmartPass facilitates certain interactions but does not oversee all aspects of the user-service provider engagement.

(26) If Approved at step 12 then provide user with some incentives: Following the user's approval to share PII in step (12), this step involves the SmartPass Mobile App (601) or the Service Provider (803) providing the promised incentives to the user. These incentives are a form of reward or benefit offered to the user for agreeing to share their personal information. The nature of these incentives may vary, including but not limited to, access to exclusive features, discounts, or other rewards. The implementation of this step facilitates maintaining user trust and satisfaction, as it fulfills the promise made to the user in exchange for their PII. It demonstrates the system's commitment to rewarding user participation and consent in data-sharing practices.

(26) If Rejected at step 12 then exit: In the scenario where the user rejects the request to share PII at step (12), this step signifies the termination of this particular process flow. The SmartPass Mobile App (601) or the Backend (603) ceases further actions related to PI sharing for this instance. The user's decision is respected, and no further prompts or requests for PII sharing are made in this context. This step provides a supportive aspect of user-centric design, ensuring that the user's choices are paramount and that their decision to withhold PII leads to an immediate cessation of the related process without any negative repercussions or continued solicitation.

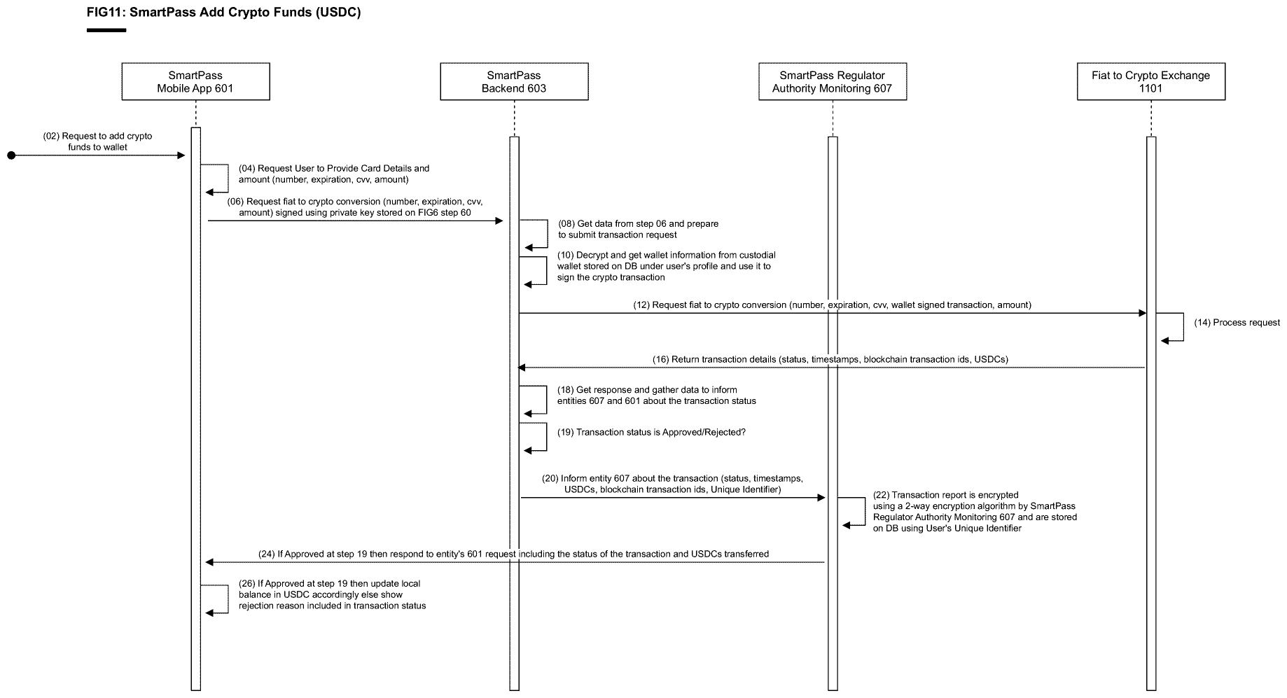

FIG. 11 shows an example systems interaction diagram of a SmartPass Add Crypto Funds process, demonstrating a sequence of various actions, communications and data exchanges which are performed between various system entities of a data network as part of the execution of this procedure.

The process depicted in FIG. 11 outlines an example sequence of steps for adding cryptocurrency (USDC) funds to a user's wallet in the SmartPass system, in accordance with one embodiment. It begins with the user initiating a request to add funds through the SmartPass Mobile App and providing necessary card details for the fiat-to-crypto conversion. The SmartPass Backend facilitates the process, interacting with the Fiat to Crypto Exchange to convert the specified fiat amount into USDC tokens. The transaction details, including success or failure, are communicated back to the user and relevant SmartPass entities. The entire process is designed to be secure, efficient, and compliant with regulatory standards, leveraging encryption for data protection and involving multiple entities within the SmartPass ecosystem for transaction execution and monitoring. Below is a description of the processes and procedural flows illustrated in FIG. 11.

(02) Request to add crypto funds to wallet: In this step, the SmartPass Mobile App (601) initiates a request to add cryptocurrency funds to the user's wallet. This action typically involves the user selecting an option within the app to add funds, which triggers a series of subsequent steps to facilitate the transaction. The user's intent to add funds is communicated to the SmartPass Backend (603) for further processing.

(04) Request User to Provide Card Details and amount (number, expiration, cvv, amount): Here, the SmartPass Platform (601) requests the user to input their card details and the desired amount of funds to add. This step facilitates initiating the fiat-to-crypto conversion process. The user enters their card number, expiration date, CVV, and the amount of fiat currency they wish to convert into cryptocurrency.

(04) SmartPass is also capable of operating also with non-custodial wallets. In that case the crypto transaction signing process happens in step 4: This step highlights the SmartPass Platform's versatility in handling transactions with non-custodial wallets. In scenarios where a non-custodial wallet is used, the process of crypto transaction signing is integrated into this step, ensuring the security and authenticity of the transaction.

(04) SmartPass Platform is also capable of charging bank accounts or other payment gateways like PayPal, Stripe, etc. The flow is the same and is payment gateway agnostic: This step indicates the flexibility of the SmartPass Platform in terms of payment methods. It may charge users through various payment gateways such as bank accounts, PayPal, Stripe, etc., demonstrating its ability to cater to diverse user preferences and financial ecosystems.

(06) Request fiat to crypto conversion (number, expiration, cvv, amount) signed using private key stored on FIG. 6 step 60: In this step, the SmartPass Mobile App (601) sends a request to the SmartPass Backend (603) for fiat-to-crypto conversion. The request includes the user's card details and the amount to be converted. The communication is secured by a digital signature using a private key, as referenced in FIG. 6 step 60, ensuring the integrity and confidentiality of the transaction.

(08) Get data from step 06 and prepare to submit transaction request: Following the receipt of the fiat-to-crypto conversion request, the SmartPass Backend (603) retrieves and processes the data from step 06. This involves preparing the transaction request for the next steps in the conversion process. The backend system validates the provided data and formats it appropriately for the conversion request.

(10) Decrypt and get wallet information from custodial wallet stored on DB under user's profile and use it to sign the crypto transaction: This step involves the SmartPass Backend (603) decrypting and retrieving wallet information from the user's custodial wallet, which is securely stored in the database under the user's profile. The SmartPass Application information is used to sign the crypto transaction, adding a layer of security and ensuring that the transaction is authorized by the rightful wallet owner.

(12) Request fiat to crypto conversion (number, expiration, cvv, wallet signed transaction, amount): In this step, the SmartPass Backend (603) sends a detailed request for fiat-to-crypto conversion to the Fiat to Crypto Exchange (1101). This request includes the user's card details, the signed transaction from the user's custodial wallet, and the specific amount for conversion. The request is formatted to meet the requirements of the Fiat to Crypto Exchange. In at least one embodiment, Fiat to Crypto Exchange 1101 is a 3rd party entity that is responsible to convert fiat currency to crypto currency (e.g., USDC).

(14) In this step entity 1101 checks for available balance and proceeds with fiat to currency conversion by charging user's card. Amount is being converted to USDC tokens that are being transferred to user's custodial wallet kept in SmartPass entity 603: The Fiat to Crypto Exchange (1101) may be configured or designed to include functionality for this step. It checks the user's available balance and, upon verification, proceeds with the fiat-to-crypto conversion. The specified amount is charged from the user's card and converted into USDC tokens. These tokens are then transferred to the user's custodial wallet managed by SmartPass (603).

(14) Process request: This step marks the actual processing of the fiat-to-crypto conversion request by the Fiat to Crypto Exchange (1101). It involves the execution of the conversion transaction based on the details provided in the earlier steps.

(16) Return transaction details (status, timestamps, Blockchain transaction IDs, USDCs): After processing the request, the Fiat to Crypto Exchange (1101) returns the transaction details to the SmartPass Backend (603). These details include the transaction status (success or failure), timestamps, Blockchain transaction IDs, and the amount of USDCs transferred. This information facilitates record-keeping and confirmation of the transaction's success.

(18) Get response and gather data to inform entities 607 and 601 about the transaction status: The SmartPass Backend (603) receives the transaction details from the previous step and compiles the data. This compiled information is then used to inform both the SmartPass Regulator Authority Monitoring (607) and the SmartPass Mobile App (601) about the status and specifics of the transaction. This step ensures that all relevant entities within the SmartPass ecosystem are updated about the transaction's outcome.

(19) Transaction status is Approved/Rejected?: This is a decision point where the SmartPass Backend (603) evaluates the transaction status returned from the Fiat to Crypto Exchange (1101). The criteria for this decision include checking whether the transaction was successfully processed or if there were any issues that led to its rejection. This step determines the subsequent actions to be taken in the transaction process.

(20) Inform entity 607 about the transaction (status, timestamps, USDCs, Blockchain transaction IDs, Unique Identifier): In this step, the SmartPass Backend (603) communicates with the SmartPass Regulator Authority Monitoring (607), providing detailed information about the transaction. This includes the transaction status, timestamps, the amount of USDCs transferred, Blockchain transaction IDs, and the user's unique identifier. This step facilitates regulatory monitoring and compliance purposes.

(22) Transaction report is encrypted using a 2-way encryption algorithm by SmartPass Regulator Authority Monitoring 607 and are stored on DB using User's Unique Identifier: This step involves the encryption of the transaction report using a two-way encryption algorithm by the SmartPass Regulator Authority Monitoring (607). The encrypted report, containing all pertinent transaction details, is then securely stored in the database, tagged with the user's unique identifier. This step ensures the confidentiality and integrity of the transaction data for regulatory and auditing purposes.

(24) If Approved at step 19 then respond to entity's 601 request including the status of the transaction and USDCs transferred: Upon approval of the transaction status in step 19, the SmartPass Backend (603) communicates with the SmartPass Mobile App (601), providing a response to the initial request made in step 02. This response includes confirmation of the transaction's approval and details of the USDCs transferred. This step completes the transaction loop, informing the user of the successful addition of funds.

(24) In this step the transaction status may be positive or negative. Positive means that the transaction was successful and negative that it failed to process. The latter also contains the rejection reason: This step elaborates on the possible outcomes of the transaction status. A positive status indicates a successful transaction, while a negative status signifies a failed process, including details of the reason for failure. This distinction facilitates troubleshooting and user communication.

(26) If Approved at step 19 then update local balance in USDC accordingly else show rejection reason included in transaction status: Depending on the outcome of the transaction approval in step 19, this step involves two possible actions by the SmartPass Mobile App (601). If the transaction is approved, the local balance in USDC is updated accordingly. If the transaction is rejected, the reason for rejection, as included in the transaction status, is displayed to the user. This step ensures transparency and accuracy in the user's account balance representation.

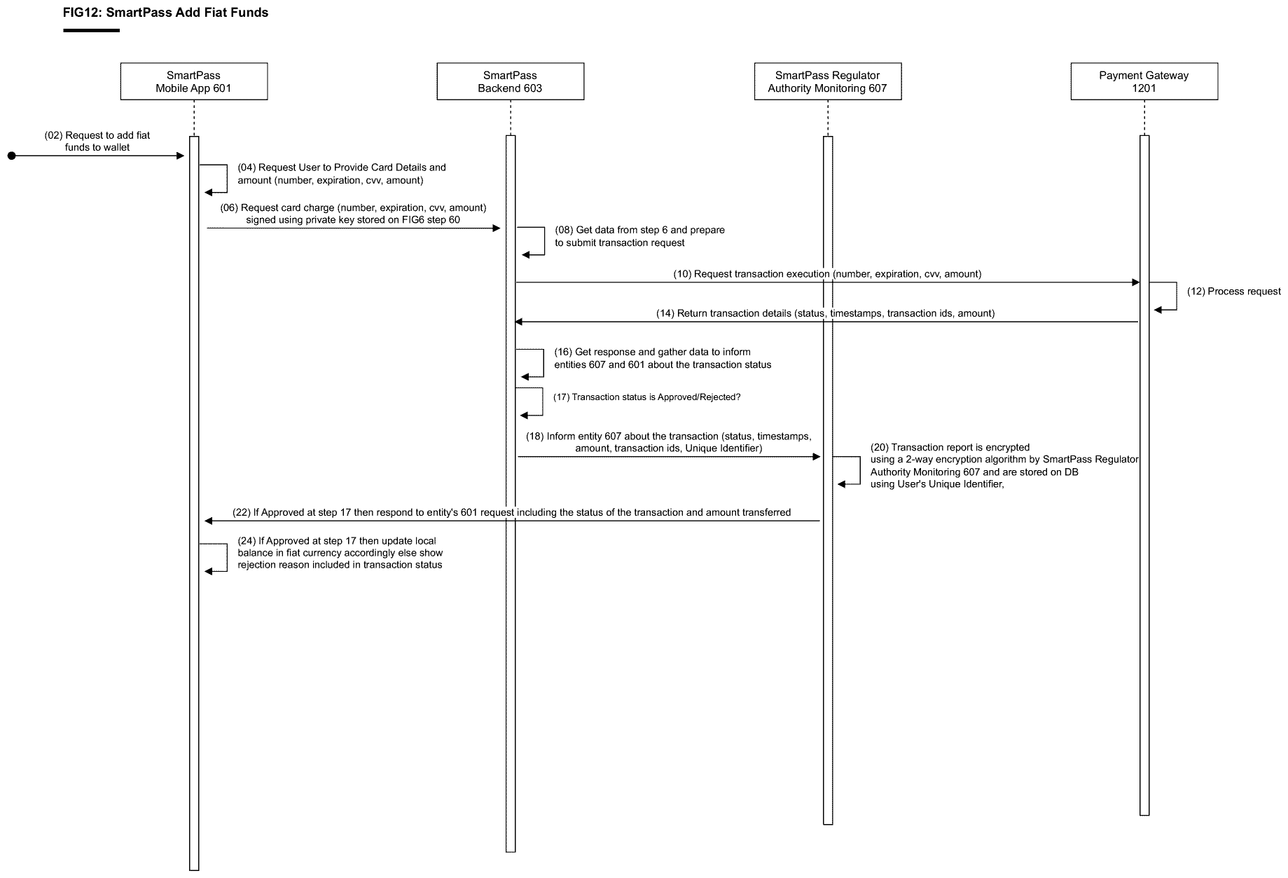

FIG. 12 shows an example systems interaction diagram of a SmartPass Add Fiat Funds process, demonstrating a sequence of various actions, communications and data exchanges which are performed between various system entities of a data network as part of the execution of this procedure.

The process depicted in FIG. 12 of the SmartPass Add Fiat Funds operation involves several steps to securely add traditional currency to a user's SmartPass wallet. It starts with the SmartPass Mobile App (601) requesting the user to add fiat funds and provide payment details. This information is sent to the SmartPass Backend (603), which then communicates with the Payment Gateway (1201) to execute the transaction. The Payment Gateway processes the payment, and upon completion, returns the transaction details to the SmartPass Backend, which in turn updates the SmartPass Mobile App and the SmartPass Regulator Authority Monitoring (607) about the transaction status. If approved, the user's wallet balance is updated; if rejected, the reason for rejection is provided. This process ensures secure, efficient, and user-friendly management of fiat fund transactions within the SmartPass ecosystem. Below is a description of the processes and procedural flows illustrated in FIG. 12.

Payment Gateway 1201. In at least one embodiment, Payment Gateway 1201 is a third-party entity responsible for processing payment transactions within the SmartPass ecosystem. It accepts various payment methods, such as credit/debit cards, bank transfers, and digital wallets like PayPal and Stripe. The gateway securely transfers funds from the user's chosen payment method to the SmartPass bank account, facilitating the addition of fiat funds to the user's SmartPass wallet. Its role facilitates ensuring secure, efficient, and versatile payment processing for SmartPass users.

(02) Request to add fiat funds to wallet: This step involves the SmartPass Mobile App (601) initiating a request to add fiat funds to the user's wallet. The user, via the app interface, selects the option to add fiat currency to their wallet. This action triggers the app to send a request to the SmartPass Backend (603) to initiate the fiat funding process. The request may include user-specific identifiers to ensure the transaction is linked to the correct user account. This step facilitates users who wish to top up their wallet with traditional currency, enabling them to engage in transactions within the SmartPass ecosystem.

(04) Request User to Provide Card Details and amount (number, expiration, cvv, amount): At this stage, the SmartPass Mobile App (601) prompts the user to enter their card details, including the card number, expiration date, CVV, and the amount they wish to add to their wallet. This step is desirable for processing the fiat funding transaction. The app collects this information, which is then used to process the payment through the associated payment gateway. Security measures, such as encryption, are typically employed to protect the user's sensitive financial information during this process.

(04) SmartPass is also capable of charging bank accounts or other payment gateways like PayPal, Stripe, etc. The flow is the same and is payment gateway agnostic: In addition to card payments, the SmartPass system (601 and 603) is designed to be compatible with various payment gateways, such as bank transfers, PayPal, and Stripe. This flexibility allows users to choose their preferred payment method for adding fiat funds. The system's agnostic approach to payment gateways ensures a seamless integration, irrespective of the chosen payment method, maintaining a consistent user experience and transaction flow.

(06) Request card charge (number, expiration, cvv, amount) signed using private key stored on FIG. 6 step 60: The SmartPass Mobile App (601) sends a request to charge the user's card to the SmartPass Backend (603), including the card details and the amount to be charged. This request is digitally signed using a private key, as mentioned in FIG. 6 step 60, ensuring the authenticity and integrity of the transaction request. This security measure facilitates prevent unauthorized access and to ensure that the transaction request is legitimate and has originated from the authenticated user.

(08) Get data from step 6 and prepare to submit transaction request: Once the SmartPass Backend (603) receives the card charge request, it processes the received data, including verifying the digital signature and preparing the transaction request for submission to the Payment Gateway (1201). This step may involve formatting the data according to the specifications of the payment gateway and ensuring all necessary transaction details are included for successful processing.

(10) Request transaction execution (number, expiration, cvv, amount): The SmartPass Backend (603) forwards the transaction execution request to the Payment Gateway (1201). This request includes the card details (number, expiration date, CVV) and the transaction amount. The Payment Gateway is responsible for processing this request, which involves communicating with the card issuer to authorize and process the payment.

(12) In this step entity 1201 checks for available balance and proceeds with transaction by charging user's card. Funds are being transferred to SmartPass bank account: The Payment Gateway (1201) performs a balance check to ensure that the user's card has sufficient funds. Upon successful verification, it proceeds to charge the user's card for the specified amount. This amount is then transferred to the SmartPass bank account, effectively crediting the user's SmartPass wallet with the equivalent fiat funds. This step facilitates ensuring that transactions are only processed when there are adequate funds, thereby avoiding failed transactions or overdrafts.

(12) Process request: Concurrently with the above step, the Payment Gateway (1201) processes the request received from the SmartPass Backend (603). This involves the series of actions necessary to complete the financial transaction, including interfacing with the banking network, handling transaction authorization, and ensuring secure transfer of funds.

(14) Return transaction details (status, timestamps, transaction IDs, amount): After processing the transaction, the Payment Gateway (1201) sends back a response to the SmartPass Backend (603) with detailed transaction information. This information includes the status of the transaction (successful or failed), relevant timestamps, unique transaction IDs for record-keeping, and the transaction amount. This data facilitates tracking, auditing, and confirming the transaction outcome within the SmartPass system.

(16) Get response and gather data to inform entities 607 and 601 about the transaction status: The SmartPass Backend (603) receives the transaction details from the Payment Gateway (1201) and analyzes this information. It then prepares to update relevant system entities about the transaction status. This involves informing both the SmartPass Regulator Authority Monitoring (607) and the SmartPass Mobile App (601) about the outcome of the transaction. This step ensures that all relevant parties within the system are updated with the latest transaction status, which facilitates maintaining accurate and current account balances and transaction histories.

(17) Transaction status is Approved/Rejected?: This is a decision point where the SmartPass Backend (603) assesses the transaction status returned by the Payment Gateway (1201). The criteria evaluated include checking whether the transaction was approved (successful) or rejected (failed). The outcome of this decision influences subsequent steps in the transaction process, such as updating account balances or handling transaction failures.

(18) Inform entity 607 about the transaction (status, timestamps, amount, transaction IDs, Unique Identifier): The SmartPass Backend (603) communicates the transaction details to the SmartPass Regulator Authority Monitoring (607). This communication includes the transaction status (approved or rejected), timestamps indicating when the transaction occurred, the transaction amount, unique transaction IDs for tracking, and the user's Unique Identifier. This step facilitates regulatory compliance and audit purposes, as it allows the regulatory authority to monitor and verify transactions within the SmartPass ecosystem, ensuring adherence to legal and regulatory requirements.

(20) Transaction report is encrypted using a 2-way encryption algorithm by SmartPass Regulator Authority Monitoring 607 and are stored on DB using User's Unique Identifier: After receiving the transaction details, the SmartPass Regulator Authority Monitoring (607) encrypts this information using a robust two-way encryption algorithm. This encrypted transaction report is then securely stored in the database, tagged with the user's Unique Identifier. This step facilitates protecting sensitive financial data and ensuring that only authorized personnel with the correct decryption keys may access this information, thereby maintaining the confidentiality and integrity of the transaction data.

(22) If Approved at step 17 then respond to entity's 601 request including the status of the transaction and amount transferred: In the event that the transaction is approved (as determined in step 17), the SmartPass Backend (603) sends a response to the SmartPass Mobile App (601). This response includes confirmation of the transaction status as approved and the amount that was successfully transferred. This step facilitates updating the user about the successful completion of their request to add fiat funds to their wallet, thereby enhancing user experience and trust in the SmartPass platform.

(22) In this step the transaction status may be positive or negative. Positive means that the transaction was successful and negative that it failed to process. The latter also contains the rejection reason: This step further elaborates on the nature of the transaction status. A positive status indicates a successful transaction, while a negative status signifies a failed transaction. In cases of failure, the reason for rejection is also included. This differentiation is desirable for troubleshooting and customer service, enabling the SmartPass team to address any issues effectively and provide clear explanations to the user regarding the transaction outcome.

(24) If Approved at step 17 then update local balance in fiat currency accordingly else show rejection reason included in transaction status: Based on the transaction approval status from step 17, the SmartPass Mobile App (601) takes appropriate action. If the transaction is approved, the app updates the user's wallet balance with the added fiat funds. Conversely, if the transaction is rejected, the app displays the reason for rejection to the user. This step ensures that the user's wallet balance is accurately and promptly updated following the transaction, and in cases of failure, the user is informed of the cause, maintaining transparency and user trust.

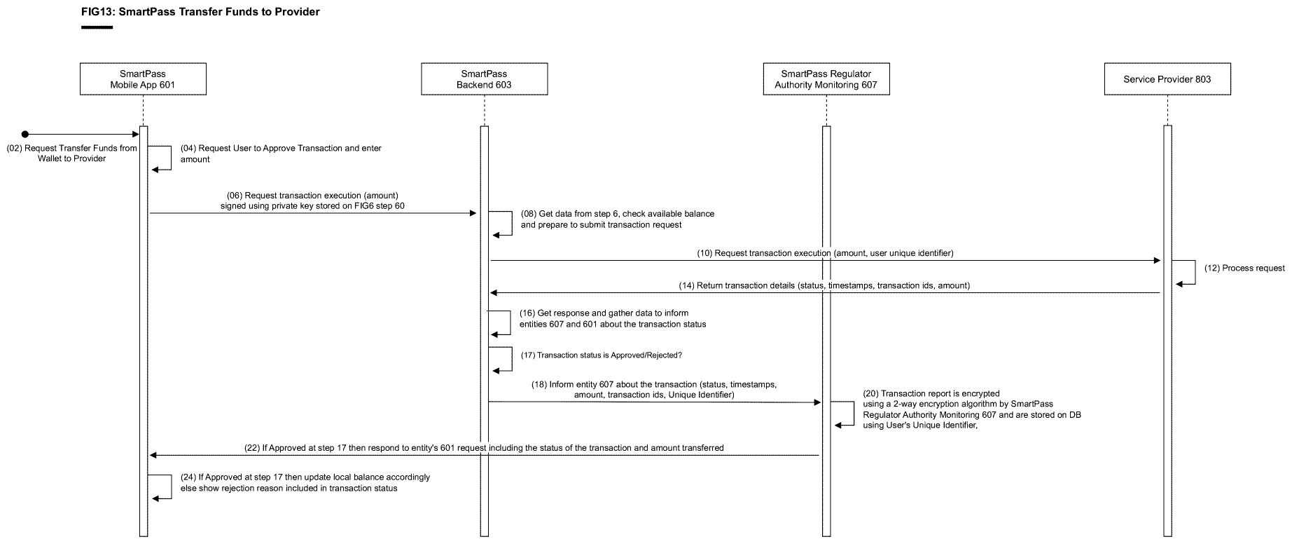

FIG. 13 shows an example systems interaction diagram of a SmartPass Transfer Funds to Service Provider process, demonstrating a sequence of various actions, communications and data exchanges which are performed between various system entities of a data network as part of the execution of this procedure.

FIG. 13 outlines the process of transferring funds from a user's wallet to a service provider. This procedure involves several steps beginning with the SmartPass Mobile App requesting fund transfer and the user approving the transaction and specifying the amount. The SmartPass Backend then processes this request, checking the user's balance and forwarding the transaction details to the Service Provider, who executes the transaction. The status of the transaction is communicated back to the SmartPass Backend and the Mobile App, with regulatory authorities being informed for compliance. The user's local balance is updated based on the transaction outcome. This process exemplifies a secure and regulated transaction flow within the SmartPass ecosystem, ensuring user convenience, regulatory compliance, and transaction security. Below is a description of the processes and procedural flows illustrated in FIG. 13.

(02) Request Transfer Funds from Wallet to Provider: In this step, the SmartPass Mobile App (Entity 601) initiates the fund transfer process by sending a request to the SmartPass Backend (Entity 603). This request signifies the user's intention to transfer funds from their wallet to a service provider. The request includes the user's intention to perform a transaction and may include preliminary information such as the transaction type or a preliminary indication of the amount to be transferred. This step facilitates initiating the transaction flow and sets the stage for subsequent steps involving user authentication and transaction details specification.

(04) Request User to Approve Transaction and enter amount: After the initial request for fund transfer, the SmartPass Mobile App (Entity 601) prompts the user to approve the transaction and enter the specific amount to be transferred. This step involves user interaction, where the user confirms their intent to proceed with the transaction and specifies the exact amount of funds they wish to transfer. The app may display relevant transaction details to the user, including the recipient's details (Service Provider), transaction fees, if any, and other pertinent information to aid the user in making an informed decision.

(06) Request transaction execution (amount) signed using private key stored on FIG. 6 step 60: In this step, the SmartPass Mobile App (Entity 601) formally requests the execution of the transaction from the SmartPass Backend (Entity 603). The request includes the specific transaction amount and is digitally signed using the user's private key (referenced in FIG. 6 step 60) to ensure the authenticity and integrity of the transaction request. The digital signature acts as a secure means of verifying the user's identity and their authorization for the transaction, playing a supportive role in maintaining the security and trustworthiness of the transaction process.

(08) Get data from step 6, check available balance and prepare to submit transaction request: Here, the SmartPass Backend (Entity 603) processes the transaction request received from the SmartPass Mobile App (Entity 601). The backend checks the user's available balance to ensure sufficient funds for the transaction. This step may involve querying the user's account details and verifying the account status and balance. Based on the available balance, the backend prepares to proceed with the transaction, setting up necessary parameters and validations to ensure a smooth transaction process.

(10) Request transaction execution (amount, user unique identifier): The SmartPass Backend (Entity 603) now sends a request to execute the transaction, including the specified amount and the user's unique identifier. This request is directed to an internal system or an external entity responsible for processing financial transactions, such as a banking interface or a payment gateway. The inclusion of the user's unique identifier ensures that the transaction is accurately linked to the correct user account and facilitates tracking and auditing of the transaction.

(12) Process request: In this step, the Service Provider's system (Entity 803) processes the transaction request received from the SmartPass Backend (Entity 603). This involves withdrawing the specified funds from the SmartPass bank account and crediting them to the user's balance within the Service Provider's application. The Service Provider's system performs necessary validations, updates the user's account balance, and prepares to reflect the transaction in the user's service account. This step facilitates ensuring that the funds are correctly transferred and accurately reflected in the user's account with the Service Provider.

(14) Return transaction details (status, timestamps, transaction IDs, amount): Following the processing of the transaction request, the Service Provider's system (Entity 803) returns transaction details to the SmartPass Backend (Entity 603). These details typically include the transaction status (successful or unsuccessful), relevant timestamps (such as transaction initiation and completion times), unique transaction identifiers, and the transaction amount. This information facilitates record-keeping, auditing purposes, and providing transaction confirmation to the user.

(16) Get response and gather data to inform entities 607 and 601 about the transaction status: Upon receiving the transaction details, the SmartPass Backend (Entity 603) analyzes the response. It gathers data to inform the SmartPass Regulator Authority Monitoring (Entity 607) and the SmartPass Mobile App (Entity 601) about the transaction status. This step involves collating information about the transaction outcome and preparing to communicate this information to the relevant entities, ensuring that all parties involved in the transaction are updated about its status.

(17) Transaction status is Approved/Rejected?: This step represents a decision point where the SmartPass Backend (Entity 603) determines the transaction's outcome based on the response received from the Service Provider (Entity 803). The decision criteria involve evaluating whether the transaction was successfully processed (approved) or if it encountered issues (rejected). This decision dictates the subsequent flow of actions, such as updating the user's balance, notifying regulatory authorities, and communicating the outcome to the user.

(18) Inform entity 607 about the transaction (status, timestamps, amount, transaction IDs, Unique Identifier): In this step, the SmartPass Backend (Entity 603) communicates the transaction details to the SmartPass Regulator Authority Monitoring (Entity 607). This communication includes the transaction status, relevant timestamps, the transaction amount, unique transaction identifiers, and the user's Unique Identifier. This step is desirable for regulatory compliance and monitoring purposes, ensuring that the regulatory entity is kept informed about transaction activities within the SmartPass ecosystem.

(20) Transaction report is encrypted using a 2-way encryption algorithm by SmartPass Regulator Authority Monitoring 607 and are stored on DB using User's Unique Identifier: Here, the SmartPass Regulator Authority Monitoring (Entity 607) encrypts the transaction report using a two-way encryption algorithm. The encrypted report is then stored in a database, associated with the user's Unique Identifier. This step facilitates ensuring the confidentiality and security of transaction data, especially considering regulatory and compliance requirements. The use of two-way encryption allows for secure storage and retrieval of transaction information while maintaining the integrity and privacy of user data.

(22) If Approved at step 17 then respond to entity's 601 request including the status of the transaction and amount transferred: In this step, contingent on the transaction being approved (as determined in step 17), the SmartPass Backend (Entity 603) responds to the SmartPass Mobile App (Entity 601) with details of the transaction, including its status and the amount transferred. This response ensures that the user is promptly informed about the transaction outcome through the mobile app, maintaining transparency and providing the user with up-to-date information regarding their transaction.

(24) If Approved at step 17 then update local balance accordingly else show rejection reason included in transaction status: Depending on the transaction's approval status, the SmartPass Mobile App (Entity 601) takes appropriate action. If the transaction is approved, the app updates the user's local balance to reflect the recent transaction. If the transaction is rejected, the app displays the reason for rejection, as included in the transaction status. This step facilitates maintaining accurate account information and providing the user with immediate feedback on the transaction outcome.

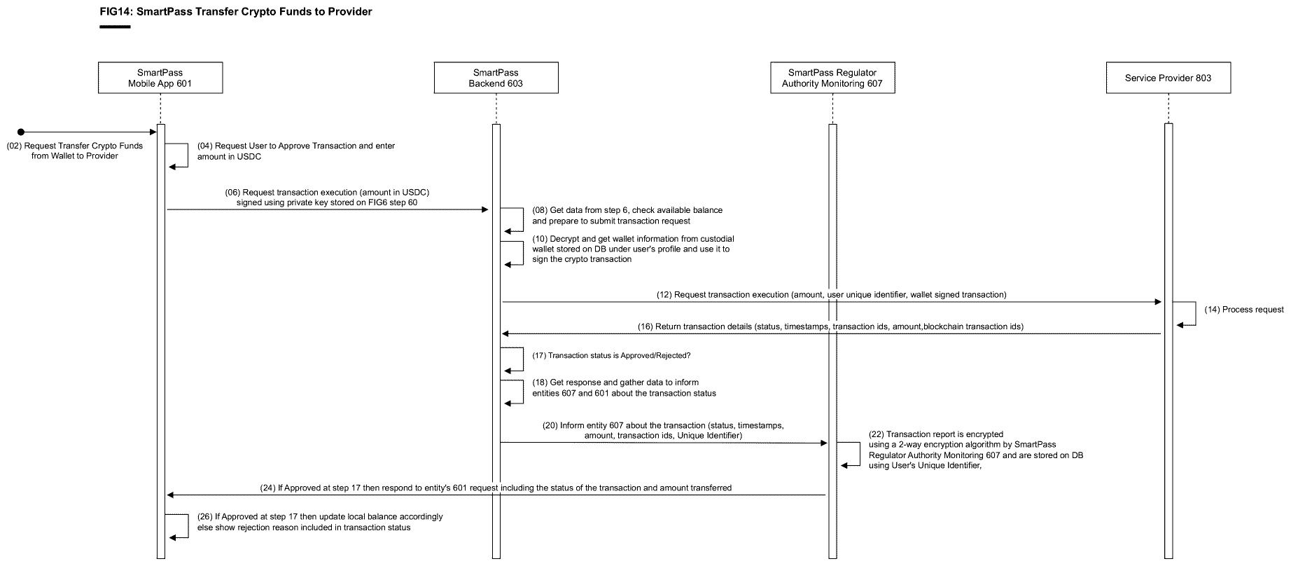

FIG. 14 shows an example systems interaction diagram of a SmartPass Transfer Crypto Funds to Service Provider process, demonstrating a sequence of various actions, communications and data exchanges which are performed between various system entities of a data network as part of the execution of this procedure.

The process of FIG. 14 is a comprehensive sequence of steps that manages the transfer of cryptocurrency funds from a user's wallet to a service provider. This process involves the initiation of the transfer request by the SmartPass Mobile App, user approval of the transaction, and the SmartPass Backend's handling of the transaction, including checking balances, preparing, and executing the transaction. The Service Provider processes the request and returns detailed transaction information. The process involves several checks and balances, including transaction approval status and regulatory reporting, ensuring transaction integrity, user consent, and compliance with regulatory requirements. This detailed and structured approach highlights the SmartPass system's emphasis on security, transparency, and regulatory adherence in cryptocurrency transactions. Below is a description of the processes and procedural flows illustrated in FIG. 14.

(02) Request Transfer Crypto Funds from Wallet to Provider: In this step, the SmartPass Mobile App (601) initiates a request to transfer cryptocurrency funds from the user's wallet to a service provider. This involves the app collecting necessary details such as the amount of funds (in a specified cryptocurrency like USDC) and the intended recipient service provider. This request provides a supportive first step in enabling a financial transaction between the user and the provider, facilitating the use of cryptocurrency for services or goods. The request is formatted in a secure manner, adhering to cryptographic standards to ensure transaction integrity and security.

(04) Request User to Approve Transaction and enter amount in USDC: Here, the SmartPass Mobile App (601) prompts the user to approve the cryptocurrency transaction and enter the specific amount they wish to transfer, denominated in USDC. This step facilitates user consent and to specify the transaction amount. It involves a user interface element where the user may input the amount and confirm the transaction. This step ensures user control over the transaction, providing a layer of security by requiring user interaction to proceed.

(04) SmartPass is also capable of operating also with non-custodial wallets. In that case, the crypto transaction signing process happens in step 04: This indicates that the SmartPass system supports both custodial and non-custodial wallet operations. In scenarios involving non-custodial wallets, the transaction signing process—where the user's approval is authenticated and the transaction is cryptographically signed-occurs in this step. It implies that for non-custodial wallets, where users have direct control over their private keys, the SmartPass app facilitates the signing process directly within the app interface.

(06) Request transaction execution (amount in USDC) signed using private key stored on FIG. 6 step 60: In this step, the SmartPass Mobile App (601) sends a request to execute the transaction, including the specified amount in USDC. This request is digitally signed using a private key, as referenced in FIG. 6 step 60, to ensure the authenticity and integrity of the transaction. The use of the private key for signing underscores the security measures in place to prevent unauthorized transactions, and the reference to FIG. 6 step 60 suggests a linked process where the key was initially secured or utilized.

(08) Get data from step 6, check available balance and prepare to submit transaction request: Here, the SmartPass Backend (603) receives the transaction request data from the previous step. It checks the available balance in the user's wallet to ensure sufficient funds are available for the transaction. This step facilitates validating the feasibility of the transaction. Once the balance is confirmed, the Backend prepares to submit the transaction request to the Blockchain network or the relevant financial entity, proceeding with the actual transfer process.

(10) Decrypt and get wallet information from custodial wallet stored on DB under user's profile and use it to sign the crypto transaction: In this step, the SmartPass Backend (603) decrypts the wallet information stored securely in its database under the user's profile. This decrypted information includes supportive details like the wallet's private key or other credentials necessary for executing cryptocurrency transactions. Using this information, the Backend signs the crypto transaction, thereby authorizing it on behalf of the user. This step highlights the Backend's role in managing and securing sensitive user data, especially in custodial wallet arrangements.

(12) Request transaction execution (amount, user unique identifier, wallet signed transaction): The SmartPass Backend (603) now sends a request to execute the transaction. This request includes the transaction amount, the user's unique identifier (linking the transaction to a specific user), and the transaction details, which have been signed using the wallet's information. This step facilitates initiating the actual transfer of funds, and the inclusion of a unique identifier is important for tracking and auditing purposes.

(14) Process request: This step involves the Service Provider (803) processing the transaction request received from the SmartPass Backend (603). During this processing, the Service Provider's system would typically verify the transaction details, such as checking the validity of the signed request and confirming the transaction amount and recipient details. This step is desirable for ensuring that the transaction request is legitimate and aligns with the provider's protocols before executing the transfer of crypto funds.

(16) Return transaction details (status, timestamps, transaction IDs, amount, Blockchain transaction IDs): After processing the transaction request, the Service Provider (803) sends back a response to the SmartPass Backend (603) with detailed transaction information. This includes the transaction status (successful, pending, or failed), timestamps indicating when the transaction was processed, transaction IDs for internal tracking, the amount transferred, and Blockchain transaction IDs if the transaction was recorded on a Blockchain. This comprehensive data set provides a complete picture of the transaction for both record-keeping and user information purposes.

(17) Transaction status is Approved/Rejected?: This is a decision point step where the SmartPass Backend (603) assesses the transaction status returned by the Service Provider (803). The criteria evaluated here include whether the transaction was successfully executed (Approved) or if there were issues that led to its failure (Rejected). This decision is based on the transaction details provided in the previous step. The outcome of this decision influences subsequent steps, particularly in terms of how the SmartPass system and the user are informed about the transaction's success or failure.

(18) Get response and gather data to inform entities 607 and 601 about the transaction status: In this step, the SmartPass Backend (603) processes the response received regarding the transaction status. It compiles relevant data to inform other system entities, specifically the SmartPass Regulator Authority Monitoring (607) and the SmartPass Mobile App (601). This step ensures that all pertinent parties within the SmartPass ecosystem are updated about the transaction's outcome, maintaining transparency and record-keeping accuracy.

(20) Inform entity 607 about the transaction (status, timestamps, amount, transaction IDs, Unique Identifier): Here, the SmartPass Backend (603) communicates the transaction details to the SmartPass Regulator Authority Monitoring (607). This includes information such as the transaction status, timestamps, the amount transferred, transaction IDs, and the user's Unique Identifier. This communication is desirable for regulatory monitoring and compliance purposes, as it allows the regulatory authority to track and audit transactions within its jurisdiction.

(22) Transaction report is encrypted using a 2-way encryption algorithm by SmartPass Regulator Authority Monitoring 607 and are stored on DB using User's Unique Identifier: In this step, the SmartPass Regulator Authority Monitoring (607) encrypts the transaction report using a 2-way encryption algorithm. This encryption is desirable for ensuring the confidentiality and integrity of the transaction data. Once encrypted, the report is stored in a database, indexed using the User's Unique Identifier. This process not only secures the data but also ensures it may be readily accessed for future reference or regulatory scrutiny, while maintaining user privacy and data security.

(24) If Approved at step 17 then respond to entity's 601 request including the status of the transaction and amount transferred: Conditional upon the approval of the transaction in step 17, the SmartPass Backend (603) responds to the SmartPass Mobile App (601). This response includes confirmation of the transaction's successful status and details of the amount transferred. This step facilitates informing the user (via the app) of the successful completion of their transaction, providing reassurance and clarity on the transaction outcome.

(24) In this step the transaction status may be positive or negative. Positive means that the transaction was successful and negative that it failed to process. The latter also contains the rejection reason: This step elaborates on the nature of the transaction status reported in the previous steps. A positive status indicates a successful transaction, while a negative status denotes a failed transaction, including the reason for such failure. This distinction facilitates troubleshooting and user support, as it helps in understanding why a transaction may not have gone through and what corrective measures may be needed.

(26) If Approved at step 17 then update local balance accordingly else show rejection reason included in transaction status: Depending on the transaction's approval status in step 17, this step involves two potential actions by the SmartPass Mobile App (601). If the transaction is approved, the app updates the user's local balance to reflect the transfer of funds. If the transaction is rejected, the app displays the reason for rejection to the user. This step facilitates maintaining accurate account balance records in the user's app and providing immediate feedback about transaction failures.

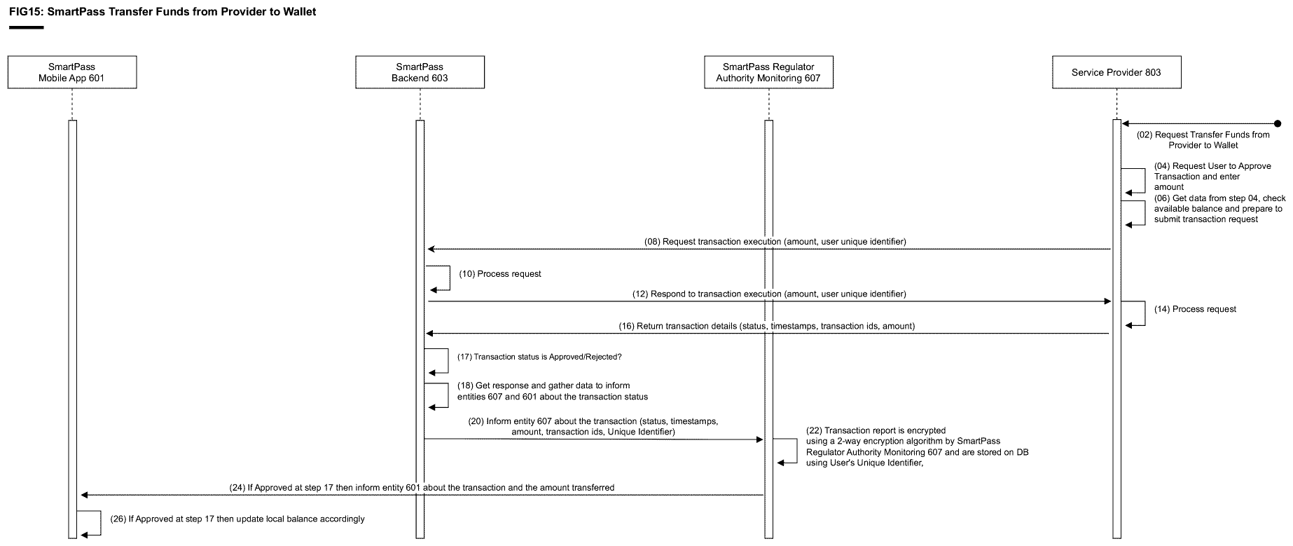

FIG. 15 shows an example systems interaction diagram of a SmartPass Transfer Funds from Service Provider to Wallet process, demonstrating a sequence of various actions, communications and data exchanges which are performed between various system entities of a data network as part of the execution of this procedure.

The process of FIG. 15 is an example embodiment of a sequence of steps involving the transfer of funds from a service provider to a user's wallet within the SmartPass ecosystem. It starts with the Service Provider initiating a transfer request and ends with the updating of the user's wallet balance. Throughout the process, at least one step serves a specific purpose, from seeking user approval to validating transaction details, executing the transfer, and ensuring regulatory compliance. The process involves multiple SmartPass system entities, including the Mobile App, Backend, Regulator Authority Monitoring, and Service Provider, at least one playing a supportive role in the successful completion of the fund transfer. The system's design ensures security, user control, and compliance with regulatory standards at one or more step. Below is a description of the processes and procedural flows illustrated in FIG. 15.

(02) Request Transfer Funds from Provider to Wallet: The Service Provider (803) initiates the fund transfer process by sending a request to transfer funds to the user's wallet. This request provides a supportive starting point for the transaction, indicating the provider's intent to move funds into the user's SmartPass wallet. The request would typically include transaction details such as the amount to be transferred.

(04) Request User to Approve Transaction and enter amount: The SmartPass Mobile App (601) prompts the user to approve the transaction and enter the transaction amount. This step facilitates user consent and verification of the transaction amount, ensuring user control and awareness of the funds being transferred.

(06) Get data from step 04, check available balance and prepare to submit transaction request: The SmartPass Backend (603) receives the transaction details and user approval from the SmartPass Mobile App (601). It then checks the user's available balance to ensure sufficient funds for the transaction and prepares to submit the transaction request for processing.

(08) Request transaction execution (amount, user unique identifier): The SmartPass Backend (603) formally requests the execution of the transaction, providing the transaction amount and the user's unique identifier to ensure accurate and secure processing. This step facilitates initiating the actual fund transfer.

(10) Process request: The SmartPass Backend (603) processes the request received from the Service Provider (803). This involves validating the transaction details, ensuring compliance with regulatory requirements, and preparing the system for fund transfer. This step ensures the integrity and feasibility of the transaction.

(12) Respond to transaction execution (amount, user unique identifier): Upon processing the request, the SmartPass Backend (603) responds to the Service Provider (803), confirming the transaction details. This response includes the transaction amount and the user's unique identifier, providing a receipt-like acknowledgment of the transaction initiation.

(14) In this step entity 803 proceeds with transaction by depositing funds to SmartPass bank account. Funds are being withdrawn from user's balance on Service Provider's application 803. If transaction is successful user's balance on Service Provider 803 app is being updated accordingly: The Service Provider (803) deposits the specified funds into the SmartPass bank account. Concurrently, the corresponding amount is withdrawn from the user's balance on the Service Provider's application. This step actualizes the transfer of funds, updating the user's balance to reflect the transaction.

(16) Return transaction details (status, timestamps, transaction IDs, amount): The SmartPass Backend (603) returns detailed information about the transaction to the Service Provider (803). This includes the transaction status (e.g., successful, pending, failed), timestamps, transaction IDs, and the amount. This step provides a comprehensive overview of the transaction for record-keeping and verification purposes.

(17) Transaction status is Approved/Rejected?: This decision point involves determining whether the transaction has been approved or rejected. The criteria for this decision may include verification of fund availability, user authentication, and compliance with regulatory standards. The outcome of this step dictates the subsequent actions in the process.

(18) Get response and gather data to inform entities 607 and 601 about the transaction status: The SmartPass Backend (603) gathers the data from the transaction response, including its status, and prepares to inform the SmartPass Regulator Authority Monitoring (607) and the SmartPass Mobile App (601). This step ensures that all relevant parties are updated about the transaction's outcome.

(20) Inform entity 607 about the transaction (status, timestamps, amount, transaction IDs, Unique Identifier): The SmartPass Backend (603) informs the SmartPass Regulator Authority Monitoring (607) about the transaction details. This includes the transaction status, timestamps, amount, transaction IDs, and the user's unique identifier. This step facilitates regulatory compliance and monitoring purposes.

(22) Transaction report is encrypted using a 2-way encryption algorithm by SmartPass Regulator Authority Monitoring 607 and are stored on DB using User's Unique Identifier: The transaction report, containing all pertinent details, is encrypted by the SmartPass Regulator Authority Monitoring (607) using a two-way encryption algorithm.

This encrypted report is then stored in a database, tagged with the user's unique identifier. This step ensures the security and confidentiality of transaction data.

(24) If Approved at step 17 then inform entity 601 about the transaction and the amount transferred: If the transaction is approved (as determined in step 17), the SmartPass Backend (603) informs the SmartPass Mobile App (601) about the transaction and the amount transferred. This step keeps the user informed and updates the app with the latest transaction status.

(26) If Approved at step 17 then update local balance accordingly: Following approval of the transaction (as determined in step 17), the local balance within the SmartPass system is updated to reflect the transfer. This ensures that the user's account balance is accurate and up-to-date, reflecting the latest transaction activity.

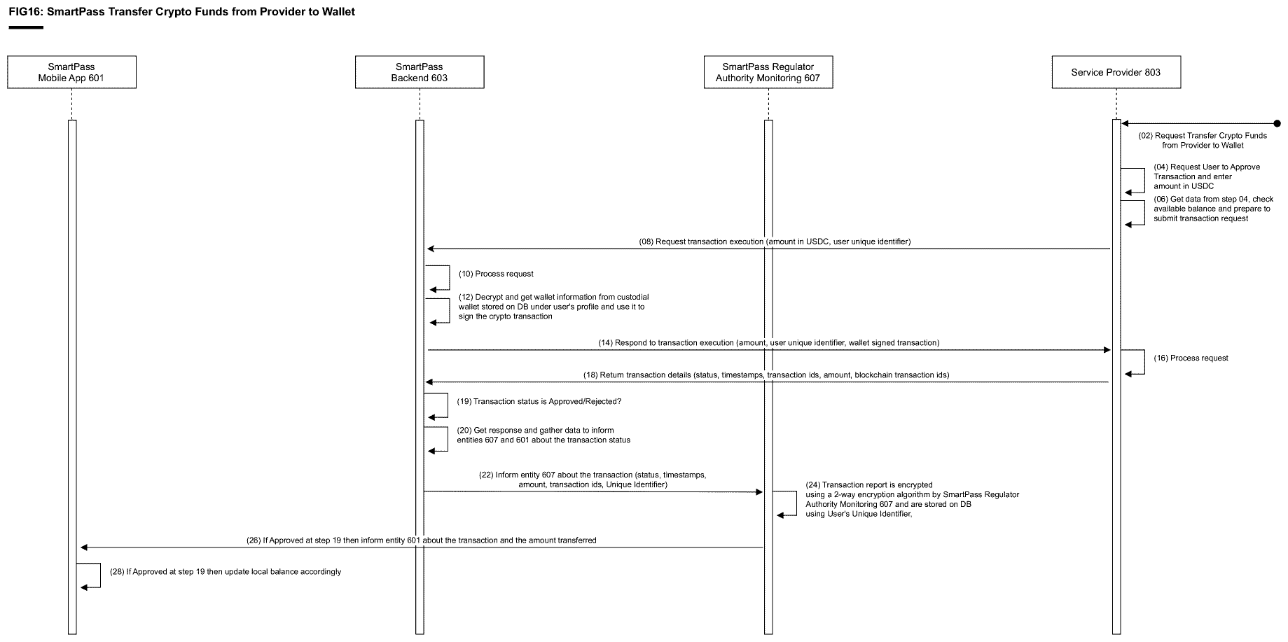

FIG. 16 shows an example systems interaction diagram of a SmartPass Transfer Crypto Funds from Provider to Wallet process, demonstrating a sequence of various actions, communications and data exchanges which are performed between various system entities of a data network as part of the execution of this procedure.

The process illustrated in FIG. 16 outlines an example embodiment the steps involved in transferring cryptocurrency funds from a provider to a user's wallet within the SmartPass ecosystem. It begins with a request from the SmartPass Mobile App (601) and involves various checks and confirmations by the SmartPass Backend (603), including user approval, balance verification, and transaction signing. The service provider (803) plays a role in executing and processing the transaction, with the SmartPass Regulator Authority Monitoring (607) overseeing regulatory compliance and security through encryption and record-keeping. The process ensures user consent, transaction integrity, and regulatory compliance, culminating in the update of the user's account balance to reflect the successful transfer. Below is a description of the processes and procedural flows illustrated in FIG. 16.

(02) Request Transfer Crypto Funds from Provider to Wallet: In this step, the SmartPass Mobile App (601) initiates a request to transfer cryptocurrency funds from a service provider's wallet to the user's wallet. The request involves specifying the type of cryptocurrency (e.g., USDC) and the amount to be transferred. This action facilitates enabling users to receive cryptocurrency payments or earnings from a service provider (803), such as for services rendered or as part of a promotional offer. The request is directed towards the SmartPass Backend (603) for further processing, marking the beginning of the transaction process within the SmartPass ecosystem.

(04) Request User to Approve Transaction and enter amount in USDC: In this step, the SmartPass Mobile App (601) prompts the user to approve the transaction and specify the amount in USDC (a stablecoin pegged to the US dollar). This step ensures user consent and accuracy in the transaction process. The user's input includes the transaction amount, confirming their intention to proceed with the transfer. The approval and specified amount are supportive for maintaining transaction integrity and user control over their funds.

(06) Get data from step 04, check available balance and prepare to submit transaction request: After receiving the user's approval and the transaction amount from the SmartPass Mobile App (601), the SmartPass Backend (603) verifies the user's available crypto balance. This verification is to ensure that the user has sufficient funds to complete the transaction. The system prepares the necessary details, including the amount and user's unique identifier, to proceed with the transaction execution request. This step facilitates maintaining financial accuracy and preventing overdrafts on the user's account.

(08) Request transaction execution (amount in USDC, user unique identifier): The SmartPass Backend (603) requests the execution of the crypto fund transfer. This request includes the transaction amount in USDC and the user's unique identifier, ensuring that the funds are correctly credited to the intended recipient's wallet. This step facilitates initiating the actual transfer of funds from the service provider to the user, involving communication between the SmartPass Backend and the crypto wallet infrastructure.

(10) Process request: At this juncture, the SmartPass Backend (603) processes the transaction request. This involves validating the user's unique identifier, confirming the transaction amount, and preparing a response to be sent back to the service provider (803). The processing ensures that all transaction details align with the user's request and account status, ensuring accuracy and security in the fund transfer process.

(12) Decrypt and get wallet information from custodial wallet stored on DB under user's profile and use it to sign the crypto transaction: The SmartPass Backend (603) retrieves and decrypts the wallet information stored securely in the database under the user's profile. This information includes keys and credentials required to access the user's custodial wallet. The backend then uses this information to sign the crypto transaction, which provides a supportive step to authenticate and secure the transaction within the Blockchain network. This step is integral to maintaining the integrity and security of the transaction.

(12) SmartPass is also capable of operating also with non custodial wallets. In that case the crypto transaction signing process happens in step 12: This variant of step 12 indicates the platform's capability to handle non-custodial wallets. In such cases, the transaction signing process occurs at this stage, where the user has more control over their wallet keys. Unlike custodial wallets, where the platform manages the keys, non-custodial wallet users manage their keys, adding an extra layer of security and autonomy.

(14) Respond to transaction execution (amount, user unique identifier, wallet signed transaction): Following the signing of the transaction, the SmartPass Backend (603) responds to the transaction execution request. This response includes the transaction amount, the user's unique identifier, and the wallet-signed transaction data. This step facilitates confirming that the transaction has been authenticated and is ready for processing by the Blockchain network, moving the transaction closer to completion.

(16) In this step entity 803 proceeds with transaction by depositing funds to user's SmartPass crypto account. Funds are being withdrawn from user's crypto balance on Service Provider's application 803. If transaction is successful user's balance on Service Provider 803 app is being updated accordingly: The Service Provider (803) now proceeds with the transaction, withdrawing the specified funds from the user's crypto balance held within the provider's application. These funds are then deposited into the user's SmartPass crypto account. Upon successful completion of the transaction, the user's balance within the Service Provider's application is updated to reflect the new amount. This step facilitates the actual movement of funds and updating the user's account balance.

(16) Process request: This step, involving the Service Provider (803), is focused on processing the fund transfer request. The provider assesses the transaction details, including the amount and the user's unique identifier, to execute the fund transfer. This processing ensures that the transaction aligns with the provider's records and the user's account status.

(18) Return transaction details (status, timestamps, transaction IDs, amount, Blockchain transaction IDs): Following the processing of the fund transfer, transaction details including the status, timestamps, transaction IDs, amount, and Blockchain transaction IDs are returned. This information is desirable for record-keeping and provides a transparent trail of the transaction, aiding in tracking and verification purposes.

(19) Transaction status is Approved/Rejected?: At this decision point, the status of the transaction is evaluated to determine whether it has been approved or rejected. The criteria for this decision include verification of sufficient funds, user authentication, and compliance with any regulatory requirements. This step facilitates determining the success or failure of the transaction.

(20) Get response and gather data to inform entities 607 and 601 about the transaction status: Upon receiving the transaction status, the SmartPass Backend (603) gathers relevant data to inform the SmartPass Regulator Authority Monitoring (607) and the SmartPass Mobile App (601) about the status. This communication ensures that all parties involved in the transaction are updated about its outcome, maintaining transparency and accountability.

(22) Inform entity 607 about the transaction (status, timestamps, amount, transaction IDs, Unique Identifier): The SmartPass Backend (603) informs the SmartPass Regulator Authority Monitoring (607) about the transaction. This information includes the transaction's status, timestamps, amount, transaction IDs, and the user's Unique Identifier. This step facilitates regulatory compliance and oversight, allowing the regulator to monitor transactions for legality and adherence to guidelines.

(24) Transaction report is encrypted using a 2-way encryption algorithm by SmartPass Regulator Authority Monitoring 607 and are stored on DB using User's Unique Identifier: The transaction report, containing sensitive data, is encrypted using a two-way encryption algorithm by the SmartPass Regulator Authority Monitoring (607). It is then stored securely in the database, tagged with the user's Unique Identifier. This encryption and storage process ensures the confidentiality and security of transaction data, which facilitates protecting user privacy and maintaining trust in the platform.

(26) If Approved at step 19 then inform entity 601 about the transaction and the amount transferred: If the transaction is approved (as determined in step 19), the SmartPass Backend (603) informs the SmartPass Mobile App (601) about the successful transaction and the amount that was transferred. This step is important for updating the user on the status of their transaction, ensuring they are aware of the successful transfer of funds.

(28) If Approved at step 19 then update local balance accordingly: Upon approval of the transaction, the SmartPass Backend (603) updates the user's local balance to reflect the transferred amount. This step ensures that the user's account balance within the SmartPass platform is accurate and up-to-date, reflecting the recent transaction. It's desirable for maintaining financial integrity within the user's account.

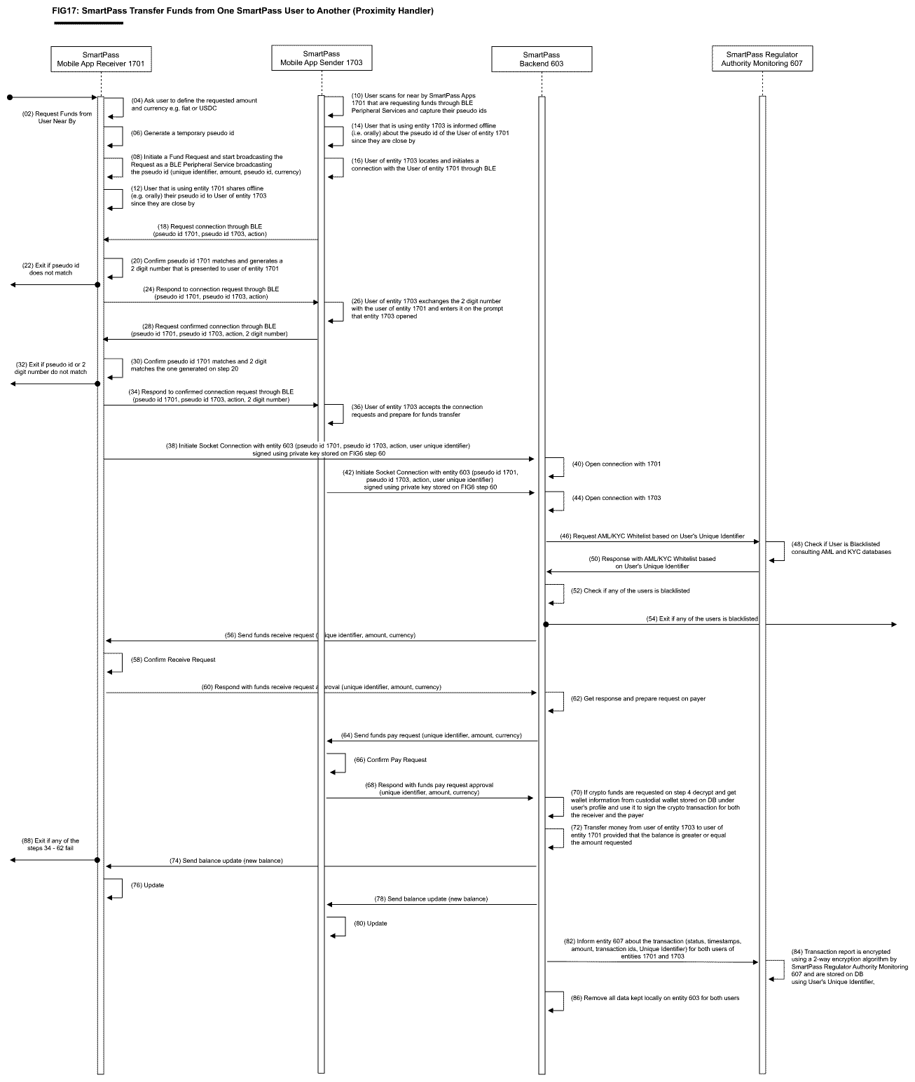

FIG. 17 shows an example systems interaction diagram of a SmartPass Transfer Funds from One SmartPass User to Another (Proximity Handler) process, demonstrating a sequence of various actions, communications and data exchanges which are performed between various system entities of a data network as part of the execution of this procedure.

The process depicted in FIG. 17 of the SmartPass system outlines a comprehensive and secure method for transferring funds between two users in close proximity, utilizing the SmartPass Mobile Apps (1701 and 1703). It begins with one user requesting funds and specifying the amount and currency, followed by the generation of a temporary pseudo ID for transaction security. The users then establish a Bluetooth Low Energy (BLE) connection, confirm at least one other's identity through exchanged pseudo IDs and a two-digit number, and initiate a secure socket connection with the SmartPass Backend (Entity 603). Compliance checks are conducted through AML/KYC whitelist and blacklist verifications to ensure transaction legitimacy. Upon approval, the transaction is executed with the sender transferring the specified amount to the receiver, followed by balance updates for both parties. The transaction details are then encrypted and reported to the SmartPass Regulator Authority Monitoring 607 for regulatory compliance, with all local data subsequently removed to uphold privacy and security standards. This intricate process exemplifies a blend of user-friendly technology and stringent security measures, ensuring a seamless yet secure peer-to-peer transaction experience within the SmartPass ecosystem. Below is a description of the processes and procedural flows illustrated in FIG. 17.

SmartPass Mobile App Receiver 1701 and SmartPass Mobile App Receiver 1703 entities are instances of SmartPass Mobile App 601 introduced on FIG. 6 running at the same time for 2 different users on 2 different mobile devices and are physically located in close physical proximity to at least one other. 1701 is requesting cryptocurrency funds from 1703, and 1703 is paying/sending the requested cryptocurrency funds to 1701.

(02) Request Funds from User Near By: This step initiates the funds transfer process in the SmartPass ecosystem, specifically between two users in close proximity. The SmartPass Mobile App Receiver 1701 issues a request for funds from a nearby user, utilizing the app's interface. This request may involve the user specifying the desired amount and potentially the type of funds (e.g., fiat currency or cryptocurrency like USDC). This step facilitates enabling peer-to-peer transactions, leveraging the SmartPass platform's capabilities to facilitate secure and immediate financial exchanges between users. The use of proximity-based requests implies the utilization of location services or Bluetooth technology to identify nearby users within the SmartPass network.

(04) Ask user to define the requested amount and currency e.g. fiat or USDC: In this step, the SmartPass Mobile App Receiver 1701 prompts the user to specify the amount of funds they wish to request and the type of currency (fiat or USDC). This step facilitates setting the parameters of the transaction. The user's input determines the transaction's scale and ensures both parties are clear about the transaction's nature. This clarity is desirable for maintaining transparency and user satisfaction within the SmartPass ecosystem.

(06) Generate a temporary pseudo ID: The SmartPass Mobile App Receiver 1701 generates a temporary pseudo-identifier (ID) at this stage. This pseudo ID acts as a unique, temporary identifier for the transaction, ensuring security and privacy. It serves as an important element in the transaction process, allowing for the secure and anonymous identification of the transaction parties within the SmartPass network. This ID is to be a randomized or hashed string, providing a layer of security and anonymity to the transaction process.

(08) Initiate a Fund Request and start broadcasting the Request as a BLE Peripheral Service broadcasting the pseudo ID (unique identifier, amount, pseudo ID, currency): The SmartPass Mobile App Receiver 1701 initiates a fund request and starts broadcasting this request as a Bluetooth Low Energy (BLE) Peripheral Service. This broadcasting includes the pseudo ID, the transaction's unique identifier, the requested amount, and the currency type. This step facilitates advertising the fund request to nearby SmartPass users, enabling the discovery and pairing process required for a proximity-based transaction. The use of BLE technology suggests an efficient, low-power method of communication, suitable for short-range financial transactions in a user-friendly manner.

(10) User scans for near by SmartPass Apps 1701 that are requesting funds through BLE Peripheral Services and capture their pseudo IDs: In this step, the SmartPass Mobile App Sender 1703 actively scans for nearby SmartPass applications (specifically App 1701) that are requesting funds through BLE Peripheral Services. During this scanning process, App 1703 captures the pseudo IDs broadcasted by these applications. This step facilitates establishing a connection between the sender and receiver within the proximity-based transaction framework. It involves the sender's application identifying potential receivers (those requesting funds) within its immediate vicinity.

(12) User that is using entity 1701 shares offline (e.g., orally) their pseudo ID to User of entity 1703 since they are close by: In this interpersonal interaction, the user operating the SmartPass Mobile App Receiver 1701 shares their pseudo ID with the user of SmartPass Mobile App Sender 1703, through an offline method such as verbal communication. This step indicates a blend of digital and personal interaction in the SmartPass transaction process, where users in close physical proximity may verbally communicate desirable transaction details. This approach adds a layer of human interaction to the transaction, potentially enhancing the sense of security and trust between the parties.

(14) User that is using entity 1703 is informed offline (e.g., orally) about the pseudo ID of the User of entity 1701 since they are close by: This step involves the user of SmartPass Mobile App Sender 1703 receiving information about the pseudo ID of the user of SmartPass Mobile App Receiver 1701 through offline means, such as verbal communication. This exchange of information, done in person due to the proximity requirement, allows the sender to identify the receiver's request within the SmartPass network. This step facilitates connecting the two users within the transaction process, ensuring that the sender may accurately locate and respond to the specific fund request from the intended receiver.

(16) User of entity 1703 locates and initiates a connection with the User of entity 1701 through BLE: In this step, the user of SmartPass Mobile App Sender 1703 utilizes the previously obtained pseudo ID to locate and initiate a Bluetooth Low Energy (BLE) connection with the user of SmartPass Mobile App Receiver 1701. This step facilitates establishing a digital connection between the two users, facilitating the subsequent stages of the funds transfer process. The use of BLE suggests a secure, efficient, and user-friendly method for establishing this connection, suitable for the transaction's proximity-based nature.

(18) Request connection through BLE (pseudo ID 1701, pseudo ID 1703, action): In this step, SmartPass Mobile App Sender 1703 sends a request to establish a BLE connection with SmartPass Mobile App Receiver 1701. This request includes both pseudo IDs (of entities 1701 and 1703) and specifies the action or intention of the connection, such as initiating a payment flow. This step facilitates the fund transfer process as it represents the digital handshake between the two entities, marking the beginning of a secure transaction channel. The action parameter in the request helps in contextualizing the connection, ensuring that both parties are aware of the intended transaction type.

(20) Confirm pseudo ID 1701 matches and generates a 2 digit number that is presented to user of entity 1701: In this verification step, the SmartPass system confirms that the pseudo ID received from SmartPass Mobile App Sender 1703 matches the one belonging to SmartPass Mobile App Receiver 1701. Upon successful verification, the system generates a two-digit number, which is then presented to the user of entity 1701. This step serves as an additional security measure, ensuring that the connection being established is between the correct parties. The generation and use of a two-digit number may be part of a multi-factor authentication process, adding a layer of security to the transaction.

(22) Exit if pseudo ID does not match: This decision point involves the SmartPass system assessing whether the pseudo ID provided by SmartPass Mobile App Sender 1703 matches the one associated with SmartPass Mobile App Receiver 1701. If there is a mismatch in the pseudo IDs, the system exits the transaction process, terminating the funds transfer attempt. This step facilitates maintaining the integrity and security of transactions within the SmartPass ecosystem, ensuring that funds are only transferred between the intended parties.

(24) Respond to connection request through BLE (pseudo ID 1701, pseudo ID 1703, action): Following the successful verification of the pseudo IDs, SmartPass Mobile App Receiver 1701 responds to the connection request sent by SmartPass Mobile App Sender 1703. This response, transmitted via BLE, reiterates the pseudo IDs of both parties and confirms the action or intention of the connection, such as proceeding with the payment flow. This step solidifies the establishment of a secure communication channel between the two users, paving the way for the actual funds transfer.

(26) User of entity 1703 exchanges the 2 digit number with the user of entity 1701 and enters it on the prompt that entity 1703 opened: In this step, the user of SmartPass Mobile App Sender 1703 exchanges the two-digit number, initially presented to the user of SmartPass Mobile App Receiver 1701, with the latter user. This exchange occurs through offline communication (e.g., verbally). Once received, the sender's user enters this two-digit number into a prompt within their SmartPass application. This step acts as a form of two-factor authentication, further securing the transaction by ensuring both parties are actively engaged and are the correct participants in the transaction.

(28) Request confirmed connection through BLE (pseudo ID 1701, pseudo ID 1703, action, 2 digit number): SmartPass Mobile App Sender 1703 sends a request to SmartPass Mobile App Receiver 1701 to confirm the BLE connection. This request includes both pseudo IDs, the action (indicating the transaction type), and the two-digit number previously exchanged between the users. This step provides a supportive part of the secure connection process, as it involves both users verifying their involvement and consent to proceed with the transaction, thereby enhancing the security and reliability of the peer-to-peer funds transfer.

(30) Confirm pseudo ID 1701 matches and 2 digit matches the one generated on step 20: The system confirms that the pseudo ID from SmartPass Mobile App Receiver 1701 matches the one used in the BLE connection request and that the two-digit number corresponds with the one generated in step 20. This step is desirable for ensuring the authenticity and security of the connection. It acts as a final check before the actual funds transfer may take place, ensuring that the transaction is being conducted between the correct parties and that both have actively confirmed their participation.

(32) Exit if pseudo ID or 2 digit number do not match: This decision point involves the SmartPass system assessing the validity of the pseudo ID and the two-digit number used in the BLE connection confirmation process. If either the pseudo ID or the two-digit number does not match the expected values, the system exits the transaction process. This step facilitates safeguarding the transaction, ensuring that only validated and correctly matched parties may proceed with the funds transfer.

(34) Respond to confirmed connection request through BLE (pseudo ID 1701, pseudo ID 1703, action, 2 digit number): Upon successful validation of the pseudo IDs and the two-digit number, SmartPass Mobile App Receiver 1701 sends a response to the BLE confirmed connection request initiated by SmartPass Mobile App Sender 1703. This response includes the pseudo IDs of both parties, the specified action (indicating the transaction's purpose), and the two-digit number that was verified. This step solidifies the secure BLE connection established between the two users, signaling readiness for the subsequent stages of the funds transfer process.

(36) User of entity 1703 accepts the connection requests and prepare for funds transfer: In this step, the user of SmartPass Mobile App Sender 1703 formally accepts the connection requests, confirming their intention to proceed with the funds transfer to SmartPass Mobile App Receiver 1701. This acceptance is part of the transaction process, indicating the sender's readiness to initiate the actual transfer of funds. The preparation for the transfer involves the user confirming the transaction details and ensuring that the necessary funds are available for transfer.

(38) Initiate Socket Connection with entity 603 (pseudo ID 1701, pseudo ID 1703, action, user unique identifier) signed using private key stored on FIG. 6 step 60: At this stage, a secure socket connection is initiated between the SmartPass Mobile App Sender 1703 and the SmartPass Backend (Entity 603). This connection, involving the transmission of pseudo IDs, the specified action, and the user's unique identifier, is secured through digital signatures using private keys, as referenced in FIG. 6 step 60. This secure connection facilitates the confidential and safe transmission of transaction details and user data to the SmartPass Backend, which plays a central role in processing the funds transfer.

(40) Open connection with 1701: In this step, a connection is opened with SmartPass Mobile App Receiver 1701, presumably by the SmartPass Backend (Entity 603). This action signifies the establishment of a communication channel between the backend system and the receiving app, enabling the exchange of transaction-related information and instructions necessary for the funds transfer process. The opening of this connection marks a supportive step in facilitating the transfer from a technical standpoint.

(42) Initiate Socket Connection with entity 603 (pseudo ID 1701, pseudo ID 1703, action, user unique identifier) signed using private key stored on FIG. 6 step 60: This step involves SmartPass Mobile App Receiver 1701 initiating a secure socket connection with the SmartPass Backend (Entity 603), similar to step 38. This connection includes the exchange of pseudo IDs, the specified action, and the user's unique identifier, all secured using digital signatures with private keys. This mirrored action by the receiver ensures that both parties are securely connected to the backend system, which facilitates coordinating the transaction details and ensuring a secure transfer process.

(44) Open connection with 1703: Similar to step 40, this step involves the SmartPass Backend (Entity 603) opening a connection with SmartPass Mobile App Sender 1703. This step facilitates establishing a two-way communication channel between the backend system and the sender's app, allowing for the secure exchange of transaction-related data and instructions from both the sending and receiving parties.

(46) Request AML/KYC Whitelist based on User's Unique Identifier: The SmartPass Backend (Entity 603) requests an Anti-Money Laundering (AML) and Know Your Customer (KYC) whitelist check based on the unique identifiers of the users involved in the transaction. This step facilitates compliance with financial regulations and ensures that the users participating in the transaction meet the required legal and regulatory standards. The outcome of this check influences whether the transaction may proceed, as users not meeting AML/KYC criteria may be flagged and restricted from completing the transaction.

(48) Check if User is Blacklisted consulting AML and KYC databases: This step involves consulting AML and KYC databases to check if either user involved in the transaction (entities 1701 and 1703) is blacklisted. The SmartPass Backend (Entity 603) performs this check as a part of its compliance and security protocols. This step is desirable for ensuring that the users are not involved in any illicit activities and that the transaction does not pose any legal or regulatory risks. The outcome of this check determines whether the transaction may proceed, with blacklisted users being prevented from conducting transactions within the SmartPass network.

(50) Response with AML/KYC Whitelist based on User's Unique Identifier: Following the AML/KYC whitelist check, the SmartPass Backend (Entity 603) receives a response indicating whether the users (entities 1701 and 1703) meet the required compliance criteria based on their unique identifiers. This response facilitates proceeding with the transaction, as it confirms the legitimacy and compliance status of the users involved. A positive response indicates that the users are cleared and may continue with the transaction, while a negative response may halt the process due to compliance concerns.

(52) Check if any of the users is blacklisted: In this step, the SmartPass Backend (Entity 603) checks if either of the users (entities 1701 and 1703) involved in the transaction is blacklisted, as a follow-up to the initial AML/KYC check in step 48. This step facilitates ensuring that the transaction is not being conducted by or with any individuals who are flagged for legal or regulatory reasons. The presence of a blacklisted user would typically prevent the transaction from proceeding, maintaining the integrity and compliance of the SmartPass platform.

(54) Exit if any of the users is blacklisted: This decision point involves determining whether to proceed with the transaction based on the blacklist status of the users. If either user (entities 1701 or 1703) is found to be blacklisted, as identified in the AML/KYC check, the SmartPass system may exit the transaction process, effectively halting the funds transfer. This step provides a supportive safeguard to prevent the SmartPass platform from being used for unauthorized or illegal transactions.

(56) Send funds receive request (unique identifier, amount, currency): At this stage, the SmartPass Backend (Entity 603) sends a request to process the funds reception. This request includes the unique identifier of the receiving user (entity 1701), the specified amount of funds to be transferred, and the currency type (fiat or cryptocurrency). This step provides a supportive part of the transaction process, as it initiates the backend operations necessary for receiving the funds. It indicates the system's readiness to process the incoming transaction and update the recipient's account balance accordingly.

(58) Confirm Receive Request: Following the funds receive request, the SmartPass Backend (Entity 603) confirms the reception of the request and its readiness to process the transaction. This confirmation is a helpful step in ensuring that the backend system has accurately received the transaction details and is prepared to update the receiver's account balance upon successful completion of the funds transfer.

(60) Respond with funds receive request approval (unique identifier, amount, currency): Upon confirming the receive request, the SmartPass Backend (Entity 603) sends an approval response, indicating that the transaction details have been verified and the system is ready to proceed with the funds reception. This response, sent to both users involved in the transaction (entities 1701 and 1703), includes the unique identifier, the amount to be received, and the currency type. This step facilitates signaling to both parties that the system has validated the transaction details and is proceeding with the funds transfer process.

(62) Get response and prepare request on payer: In this step, SmartPass Backend (Entity 603) receives the response from the receiver (entity 1701) and prepares a request for the payer (entity 1703) to initiate the funds transfer. This preparation involves the backend system processing the transaction details and setting up the necessary parameters for the sender to complete the payment. This step facilitates transitioning from confirming the transaction details to actualizing the funds transfer, requiring the sender to execute the payment.

(64) Send funds pay request (unique identifier, amount, currency): The SmartPass Backend (Entity 603) sends a request to SmartPass Mobile App Sender 1703 to initiate the payment. This request includes the unique identifier of the payer, the amount to be transferred, and the currency type. This step is desirable in the transaction process, as it formally requests the payer to release the specified funds, thereby triggering the actual transfer of money or cryptocurrency from the sender to the receiver.

(66) Confirm Pay Request: Upon receiving the funds pay request, the sender (SmartPass Mobile App Sender 1703) confirms the request, indicating their consent and readiness to proceed with the payment. This confirmation facilitates the transaction process, as it represents the sender's authorization to transfer the specified amount to the receiver. It is a helpful step in ensuring that the sender is fully aware and agreeable to the terms of the transaction.

(68) Respond with funds pay request approval (unique identifier, amount, currency): Following the confirmation of the pay request, the SmartPass Backend (Entity 603) sends an approval response, indicating that the payment request has been accepted and the transaction may proceed. This response, sent to the sender (entity 1703), includes the unique identifier, the amount to be paid, and the currency type. This step signals the sender that the backend system has authorized the transaction and is ready to process the payment upon execution.

(70) If crypto funds are requested on step 4 decrypt and get wallet information from custodial wallet stored on DB under user's profile and use it to sign the crypto transaction for both the receiver and the payer: This step occurs if the transaction involves cryptocurrency. The SmartPass system, upon recognizing a request for crypto funds (as indicated in step 4), retrieves wallet information from the custodial wallet of both users (entities 1701 and 1703), stored in the database under their respective profiles. The SmartPass Application information, encrypted for security, is decrypted, and used to sign the cryptocurrency transaction. This signing process facilitates ensure the authenticity and security of the transaction on the Blockchain network. It involves using cryptographic keys to authorize and validate the transfer of cryptocurrency, ensuring that the transaction is conducted securely and in accordance with the users' intentions.

(72) Transfer money from user of entity 1703 to user of entity 1701 provided that the balance is greater or equal the amount requested: In this supportive step, the actual transfer of funds occurs from the SmartPass Mobile App Sender 1703 to the SmartPass Mobile App Receiver 1701. This transaction is conditional on the sender (entity 1703) having a balance greater than or equal to the requested amount. The SmartPass system ensures that the transfer is only executed if there are sufficient funds in the sender's account, thereby maintaining the integrity and reliability of the transaction. Once this condition is met, the system processes the transfer, updating the respective balances of the sender and receiver accordingly.

(74) Send balance update (new balance): After the successful transfer of funds, the SmartPass Backend (Entity 603) sends a balance update to SmartPass Mobile App Receiver 1701. This update includes the new balance in the receiver's account, reflecting the received funds. This communication confirms the completion of the transaction to the receiver and provides them with the updated financial information, ensuring transparency and up-to-date account status.

(76) Update: Similarly, the SmartPass Backend (Entity 603) sends an update to SmartPass Mobile App Sender 1703, reflecting the new balance after the funds have been deducted. This step facilitates ensuring that the sender is immediately aware of the deduction from their account following the transfer, maintaining accurate and current account information.

(78) Send balance update (new balance): This step involves the SmartPass Backend (Entity 603) once again sending an updated balance notification to the receiver (entity 1701), presumably as a confirmation or further detail following the initial update in step 74. This may be a part of a multi-step verification process to ensure the receiver is fully informed about the transaction's outcome.

(80) Update: In this step, the SmartPass Backend (Entity 603) sends another update to the sender (entity 1703), as a final confirmation of the transaction completion and to ensure that the sender has the most current information regarding their account balance.

(82) Inform entity 607 about the transaction (status, timestamps, amount, transaction IDs, Unique Identifier) for both users of entities 1701 and 1703: The SmartPass Backend (Entity 603) informs the SmartPass Regulator Authority Monitoring 607 about the transaction details. This notification includes the transaction's status, timestamps, amount, transaction IDs, and the unique identifiers of both users involved in the transaction. This step facilitates regulatory compliance and audit purposes, ensuring that all transactions are transparent and traceable within the SmartPass ecosystem.

(84) Transaction report is encrypted using a 2-way encryption algorithm by SmartPass Regulator Authority Monitoring 607 and are stored on DB using User's Unique Identifier: In this step, the transaction report, containing all the details of the funds transfer, is encrypted using a two-way encryption algorithm by the SmartPass Regulator Authority Monitoring 607. This encrypted report is then stored in the database, associated with the unique identifiers of the users involved in the transaction. This encryption ensures the confidentiality and security of the transaction data, safeguarding it from unauthorized access while maintaining its integrity and availability for regulatory review.

(86) Remove all data kept locally on entity 603 for both users: Following the transaction's completion and reporting, the SmartPass Backend (Entity 603) removes all locally stored data related to the transaction for both users (entities 1701 and 1703). This step is a measure to protect user privacy and ensure data security, minimizing the risk of sensitive information being compromised. It reflects the platform's commitment to data privacy and security, adhering to best practices for handling user data.

(88) Exit if any of the steps 34-62 fail: This final decision point in the process allows for the termination of the transaction sequence if any of the steps from 34 to 62 fail. If any part of the transaction process does not complete successfully, the system may exit the sequence to prevent incomplete or erroneous transactions. This safeguard ensures that only fully verified and successful transactions are processed, maintaining the reliability and integrity of the SmartPass platform.

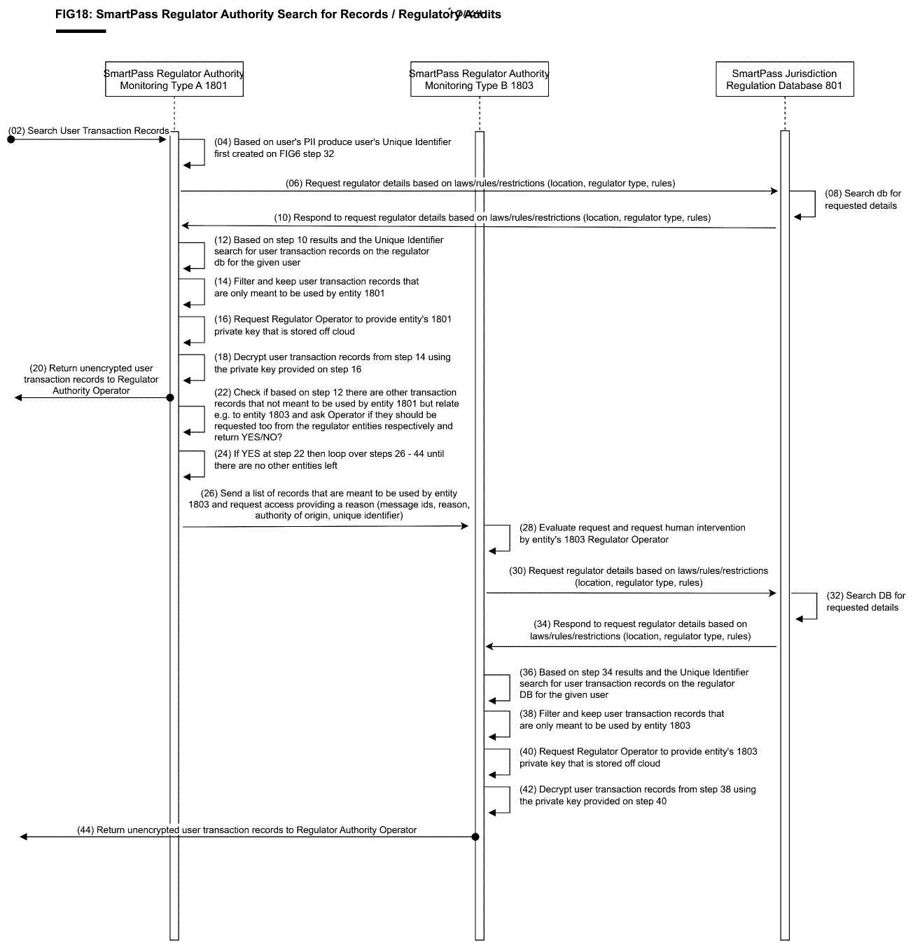

FIG. 18 shows an example systems interaction diagram of a SmartPass Regulator Authority Records Search/Regulatory Audits process, demonstrating a sequence of various actions, communications and data exchanges which are performed between various system entities of a data network as part of the execution of this procedure.

The process depicted in FIG. 18 of the SmartPass system outlines a detailed procedure for regulatory authorities to search and review user transaction records. It begins with a SmartPass Regulator Authority Monitoring entity (Type A or B) initiating a search for encrypted transaction records linked to a user's unique identifier. This entity then requests and receives specific regulatory details from the SmartPass Jurisdiction Regulation Database, ensuring the search aligns with applicable laws and restrictions. Following this, the entity filters and decrypts the relevant transaction records using a securely stored private key. If records relevant to other regulatory domains are identified, the process includes steps for requesting and decrypting these records from respective authorities, ensuring a comprehensive review across jurisdictions. This secure and structured approach ensures that at least one regulator accesses only the data within their purview, maintaining strict data privacy and compliance with regulatory standards. The system is also designed to accommodate higher-level authorities requiring access to a broader range of transaction records across multiple domains. Below is a description of the processes and procedural flows illustrated in FIG. 18.

SmartPass Regulator Authority Monitoring Type A 1801 and SmartPass Regulator Authority Monitoring Type B 1803 are instances of SmartPass Regulator Authority Monitoring 607 first introduced in FIG. 6 and are describing Regulator Authorities that are on different domains or different physical locations. Based on SmartPass design, at least one Regulator Authority may only access user transaction data within their own jurisdiction. To that end, at least one time a transaction is stored the record is encrypted with the specific regulator authority public key, so at least one regulator authority may only decrypt their own data.

SmartPass Regulator Authority Monitoring Type A 1801 and SmartPass Regulator Authority Monitoring Type B 1803: These entities represent different instances of SmartPass Regulator Authority Monitoring (607), distinguished by their distinct domains or physical locations. At least one authority may access only the user transaction data within their respective jurisdictions. The system ensures jurisdiction-specific access by encrypting transaction records with the public key of the relevant regulatory authority, enabling only that authority to decrypt and review the data.

(02) Search User Transaction Records: In this step, the SmartPass Regulator Authority Monitoring Type A (Entity 1801) initiates a search for user transaction records. This process involves querying a database to retrieve transactional data associated with a specific user. The search is based on predefined parameters, potentially including transaction dates, amounts, or other relevant metadata. The aim is to gather comprehensive transactional data for regulatory review or audit purposes. The data retrieved at this stage is still encrypted, ensuring user privacy and data security in compliance with regulatory standards.

(04) Based on user's PI produce user's Unique Identifier first created on FIG. 6 step 32: Here, Entity 1801 processes the user's Personally Identifiable Information (PII) to generate the user's Unique Identifier, as initially established in FIG. 6, step 32. This step involves using a specific algorithm to convert PII into a unique code, ensuring the user's identity remains secure and confidential. The Unique Identifier serves as a key to link the user with their transaction records while maintaining anonymity in the system. Its a supportive step for aligning the records search process with privacy and security regulations.

(06) Request regulator details based on laws/rules/restrictions (location, regulator type, rules): At this juncture, Entity 1801 sends a request to the SmartPass Jurisdiction Regulation Database (Entity 801) for detailed information on the applicable regulator, including their jurisdiction, type, and governing rules. This step ensures that the subsequent search for transaction records aligns with the specific legal and regulatory frameworks relevant to the user's transactions. The request may include specifying the geographical location, the type of regulatory body involved, and particular rules or restrictions that need to be considered during the audit or review process.

(08) Search db for requested details: Following the request in the previous step, the SmartPass Jurisdiction Regulation Database (Entity 801) conducts a database search to gather the requested regulator details. This involves querying the database for information pertinent to the specific regulatory body governing the user's transactions, including their jurisdictional boundaries, regulatory type, and the specific rules they enforce. The output of this search equips Entity 1801 with the necessary context to correctly interpret and handle the user's transaction records.

(10) Respond to request regulator details based on laws/rules/restrictions (location, regulator type, rules): After retrieving the relevant regulator details, Entity 801 responds back to the SmartPass Regulator Authority Monitoring Type A (Entity 1801). This response includes comprehensive information about the regulator, such as their geographical jurisdiction, type of regulatory authority (e.g., financial, gaming, etc.), and specific rules or restrictions that apply. This information is desirable for Entity 1801 to accurately assess the user's transaction records in compliance with the pertinent regulatory framework.

(12) Based on step 10 results and the Unique Identifier search for user transaction records on the regulator db for the given user: Utilizing the regulator details obtained in step 10 and the Unique Identifier generated in step 04, Entity 1801 conducts a targeted search in the regulator's database for the user's transaction records. This search is refined and specific, focusing on records that fall within the purview of the identified regulatory authority and are linked to the user via their Unique Identifier. This step facilitates isolating relevant transaction data for regulatory scrutiny or audits.

(14) Filter and keep user transaction records that are only meant to be used by entity 1801: In this step, Entity 1801 filters the retrieved transaction records, retaining only those relevant to its regulatory domain. This involves sifting through the data to separate records that fall under its jurisdiction and authority from those that do not. The objective is to isolate records pertinent to Entity 1801's regulatory responsibilities, ensuring focus and compliance with its specific regulatory mandates.

(16) private keys are stored off cloud e.g., on a removable disk on a safe place under regulator authority's responsibility: This step emphasizes the security measures in place for handling cryptographic keys. The private keys, desirable for decrypting transaction records, are stored securely off-cloud, typically on removable disks kept in a safe location. This measure, under the direct responsibility of the regulatory authority, ensures the keys are protected from unauthorized access and cyber threats, maintaining the integrity and confidentiality of the encrypted data.

(16) Request Regulator Operator to provide entity's 1801 private key that is stored off cloud: Concurrently with step 16, Entity 1801 requests the regulatory operator to provide the off-cloud stored private key. This key is necessary for decrypting the user's transaction records that Entity 1801 has filtered for its use. The request signifies a high-security protocol where the private key, supportive for accessing sensitive data, is strictly controlled and only made available when required for legitimate regulatory purposes.

(18) Decrypt user transaction records from step 14 using the private key provided on step 16: Upon receiving the private key, Entity 1801 proceeds to decrypt the user transaction records that were filtered in step 14. This decryption process transforms the encrypted data into a readable format, making it possible for Entity 1801 to review and analyze the transaction records. The decryption is performed securely, ensuring that the confidentiality of sensitive data is maintained throughout the process.

(20) Return unencrypted user transaction records to Regulator Authority Operator: After decrypting the records, Entity 1801 provides the now unencrypted user transaction records to the Regulator Authority Operator. This step facilitates further analysis or auditing of the records by the regulatory body. The transfer of unencrypted data at this stage underscores the trust and authority vested in the Regulator Authority Operator, signifying their role in overseeing and ensuring regulatory compliance.

(22) Check if based on step 12 there are other transaction records that not meant to be used by entity 1801 but relate e.g., to entity 1803 and ask Operator if they may be requested too from the regulator entities respectively and return YES/NO?: Entity 1801 now evaluates whether there are transaction records relevant to other regulatory entities, such as Entity 1803. If such records exist, Entity 1801 consults with the Regulator Authority Operator to determine if a request may be made to those other entities for access to these records. This step involves a decision-making process where the necessity and appropriateness of accessing additional records are assessed, ensuring regulatory actions are comprehensive yet respectful of jurisdictional boundaries.

(24) If YES at step 22 then loop over steps 26-44 until there are no other entities left: If the decision in step 22 is affirmative, Entity 1801 initiates a process to request and access additional transaction records from other regulatory entities, such as Entity 1803. This looping process involves repeating a series of steps, from requesting access to decrypting records, for at least one relevant regulatory entity until all necessary data has been gathered. This step ensures a thorough and exhaustive review of all pertinent transaction records across different regulatory domains.

(24) Same scenario may run with only one SmartPass Regulator Authority Monitoring if there is no need to do a global search about user's transactions in other domains too. In that case, the scenario may be simpler and may end on step 20: In scenarios where a global search of the user's transactions across multiple domains is not required, the process may be simplified. In such cases, only one SmartPass Regulator Authority Monitoring entity, such as Entity 1801, is involved, and the process concludes at step 20 with the return of unencrypted transaction records. This approach is adopted when the regulatory review is confined to a single jurisdiction or regulatory domain.

(26) Send a list of records that are meant to be used by entity 1803 and request access providing a reason (message IDs, reason, authority of origin, unique identifier): If a broader regulatory review is necessary, Entity 1801 sends a request to Entity 1803, providing a list of transaction records that fall under Entity 1803's jurisdiction. This request includes specifics such as message identifiers, the reason for access, the authority of origin, and the user's unique identifier. This step ensures that the regulatory review is comprehensive, covering all relevant jurisdictions while maintaining clear communication and justification for the access requested.

(28) Evaluate request and request human intervention by entity's 1803 Regulator Operator: Upon receiving the request from Entity 1801, Entity 1803 evaluates the need for accessing the specified transaction records. This step may involve human intervention by Entity 1803's Regulator Operator to assess the validity and necessity of the request. The operator's decision may be based on the relevance and appropriateness of the requested data in relation to Entity 1803's regulatory responsibilities and jurisdiction.

(30) Request regulator details based on laws/rules/restrictions (location, regulator type, rules): In this step, Entity 1803, following its own regulatory protocols, requests specific details from the SmartPass Jurisdiction Regulation Database (Entity 801) related to laws, rules, and restrictions that apply to its domain. This request includes seeking information about the location-specific regulations, the type of regulatory authority (Entity 1803) represents, and any particular rules or restrictions that are pertinent to the transaction records requested by Entity 1801.

(32) Search DB for requested details: Following the request in step 30, the SmartPass Jurisdiction Regulation Database (Entity 801) conducts a search in its database to provide Entity 1803 with the requested regulator details. This search is aimed at retrieving specific information that may assist Entity 1803 in understanding the legal and regulatory context of the transaction records they are about to review.

(34) Respond to request regulator details based on laws/rules/restrictions (location, regulator type, rules): After conducting the search, the SmartPass Jurisdiction Regulation Database (Entity 801) provides a detailed response to Entity 1803's request. This response includes supportive regulatory information such as the specific laws, rules, and restrictions relevant to Entity 1803's domain, the geographical jurisdiction, and the type of regulatory authority Entity 1803 represents. This data is desirable for Entity 1803 to align its regulatory activities with the applicable legal framework and to understand the context of the transaction records they are about to access.

(36) Based on step 34 results and the Unique Identifier search for user transaction records on the regulator DB for the given user: Leveraging the regulatory details obtained in step 34 and the Unique Identifier, Entity 1803 conducts a targeted search in its regulatory database for the user's transaction records. This search is focused on records that fall within Entity 1803's jurisdictional authority and are linked to the user via their Unique Identifier. The objective is to isolate records relevant to Entity 1803's regulatory mandate for further review or audit.

(38) Filter and keep user transaction records that are only meant to be used by entity 1803: Entity 1803 filters the retrieved transaction records, retaining only those within its regulatory scope. This step involves sifting through the data to separate records that fall under Entity 1803's jurisdiction from those that don't. The goal is to focus on records pertinent to Entity 1803's regulatory duties, ensuring efficiency and compliance with its specific regulatory responsibilities.

(40) Request Regulator Operator to provide entity's 1803 private key that is stored off cloud: In this step, Entity 1803 requests the provision of its private key from the Regulator Operator. This key, securely stored off-cloud, is necessary for decrypting the transaction records relevant to Entity 1803. The request indicates a strict security protocol where access to the key is restricted and managed carefully to ensure data confidentiality and integrity.

(42) Decrypt user transaction records from step 38 using the private key provided on step 40: Once the private key is provided, Entity 1803 proceeds to decrypt the user transaction records filtered in step 38. This decryption transforms the encrypted data into a readable format, enabling Entity 1803 to analyze the transaction records. The decryption process is conducted securely, ensuring that data privacy is upheld.

(44) Return unencrypted user transaction records to Regulator Authority Operator: After decrypting the records, Entity 1803 provides the now unencrypted user transaction records to its Regulator Authority Operator. This enables the regulatory body to conduct further analysis, review, or audit of the records. The unencrypted data is handled with the utmost care to maintain confidentiality and integrity.

Involvement of Higher-Level Authorities: In certain cases, such as for investigations by higher-level authorities like the FBI, there is a provision to access user transaction records across multiple domains (e.g., gambling, gaming, adult content services). This is facilitated by the various Regulator Authority Monitoring entities described, allowing a comprehensive search of transaction records across different service domains. This capability reflects the system's adaptability to different levels of regulatory requirements and investigations.

In at least one embodiment, a more powerful authority e.g. the FBI may search user's transaction records in all domains e.g. gambling, gaming, adult content services, etc by using the multiple regulator authority engines described here.

FIG. 19 shows an example systems interaction diagram of a SmartPass Location Pattern Engine process, demonstrating a sequence of various actions, communications and data exchanges which are performed between various system entities of a data network as part of the execution of this procedure.

The SmartPass Location Pattern Engine, as illustrated in FIG. 19, employs a comprehensive process to evaluate the authenticity of user location data. This engine integrates a sophisticated model that meticulously analyzes the sequence and timing of users' locations. It is trained to discern between normal and abnormal movement patterns by considering realistic travel times and known transportation methods. For example, a typical journey from Athens to Rome, adhering to plausible transportation timelines, is identified as legitimate. In contrast, implausible scenarios like rapidly traversing from Athens to California are flagged as suspicious. The model's evaluation results in either a ‘Success’ for genuine patterns or a ‘Fail’ for irregular ones, thereby playing a supportive role in detecting potential fraud, ensuring regulatory compliance, and safeguarding the integrity of the system. This process facilitates the platform, as it ensures users' location data is authentic and aligns with logical travel patterns, reflecting the SmartPass Platform's commitment to security and accuracy in user data handling. Below is a description of the processes and procedural flows illustrated in FIG. 19.

(02) Init: The initial step in the SmartPass Location Pattern Engine process involves initializing the system for subsequent operations. This step is fundamental to prepare the system's environment for data processing and analysis. It involves setting up necessary parameters, initializing variables, and ensuring that all system components are ready for the location pattern analysis. This step facilitates the seamless execution of the subsequent steps and typically involves system checks to ensure all components are functioning correctly.

(02) This model is trained to provide the probability that user's subsequent locations are following a normal pattern or not: This step involves a model that has been trained to evaluate the likelihood of a user's movement patterns being normal or anomalous. The model uses historical data and machine learning algorithms to distinguish between regular and irregular movement patterns. For instance, a user's typical daily movements within a city may be recognized as normal, whereas sudden changes in location to distant places in an unrealistic time frame may be flagged as irregular. This step facilitates identifying potentially fraudulent or suspicious activities based on location data.

(04) ULD, UAL, Unique Identifier, timestamps: In this step, selected data elements including User Location Data (ULD), User Approximate Location (UAL), a Unique Identifier for the user, and relevant timestamps are gathered. The ULD and UAL provide specific and general location information about the user, respectively, while the Unique Identifier is a specific code or number that uniquely identifies the user within the system. Timestamps are supportive for establishing the sequence and timing of the user's movements. This combination of data is desirable for accurate and detailed analysis of the user's movement patterns.

(04) User Location Data, User Approximate Location, timestamps and Unique Identifier is passed to feed the model: Here, the gathered data—User Location Data (ULD), User Approximate Location (UAL), Unique Identifier, and timestamps—are fed into the analytical model. This step facilitates providing the model with the necessary input to analyze the user's movement patterns. The ULD offers precise location details, while the UAL offers a broader location context. The Unique Identifier ensures that the data is associated with the correct user, and the timestamps provide the temporal context for the movements.

(06) Load Location Pattern Monitor Model: At this stage, the Location Pattern Monitor Model is loaded into the system. This model is a sophisticated component of the SmartPass Platform, designed to analyze and interpret user location data. It incorporates machine learning or other advanced analytical techniques to assess patterns in the user's movements. The loading of this model is a preparatory step that enables the system to process the incoming data effectively.

(06) Location Pattern Monitor Model: This step refers to the core analytical component of the system—the Location Pattern Monitor Model. This model is a complex algorithm or set of algorithms designed to analyze location data and identify patterns. It processes the input data (ULD, UAL, Unique Identifier, and timestamps) to determine whether the user's location history follows a logical and expected pattern, or if there are anomalies that may suggest fraudulent or suspicious activity.

(08) Feed User's ULD, UAL, Unique Identifier history from step 04 to model 06: During this step, the user's location data, including the ULD, UAL, and Unique Identifier collected in step 04, are fed into the Location Pattern Monitor Model loaded in step 06. This process involves the transfer of data to the model for analysis. The model uses this information to assess the user's movement patterns, comparing the current data to historical patterns or known logical movements.

(08) Query Model: In this step, the Location Pattern Monitor Model is queried or activated to analyze the input data. This involves processing the user's location data (ULD, UAL) and their unique identifier through the model to interpret and understand their movement patterns. The model examines this data to determine if the user's location history aligns with expected patterns or if there are any deviations that suggest abnormal or suspicious behavior.

(10) Locations matching pattern verified?: This is a decision point where the model assesses if the locations fed into it match expected patterns. The decision is based on the algorithm's analysis of whether the sequence and timing of the user's locations are consistent with normal behavior. This step facilitates determining whether the user's movement pattern is regular or if there are anomalies that may require further attention.

(10) The model is trained to provide the probability of a fake declaration of a location when his/her subsequent locations and points in time cannot construct a normal pattern. Below some examples of matching and non matching patterns: This step involves the model's capability to determine the likelihood of a user's location being falsely declared, based on the coherence of their movement patterns over time. The model uses various examples and data patterns to differentiate between normal and abnormal movement behaviors. For example, realistic travel times and routes would be identified as normal, whereas impossible travel scenarios (like being in two distant locations within a short timeframe) would be flagged as abnormal.

(12) Fail means that user's subsequent locations do not follow a normal pattern. If the model determines that the user's location data does not follow a normal pattern, the result of this decision point is ‘Fail’. This means that the user's movement patterns are inconsistent with what the model considers to be logical or expected based on historical data or known travel patterns. This may trigger alerts or further investigation within the SmartPass system.

(12) Fake: The ‘Fake’ label in this step indicates that the model has identified the user's location data as potentially fraudulent or deceptive. This conclusion is drawn when the user's movement patterns do not align with logical or expected patterns, suggesting that the location data may be inaccurate, manipulated, or falsified.

(14) Real: This step indicates a positive outcome from the model's analysis, where the user's location data is deemed to be authentic and follows expected patterns. The ‘Real’ label signifies that the user's movement behavior aligns with logical travel patterns and does not raise any red flags regarding the authenticity of the location data.

(14) Success means that user's subsequent locations do follow a normal pattern. In this decision point, if the model confirms that the user's location history is consistent with expected and logical patterns, the result is marked as ‘Success’. This indicates that there is a high probability that the user's movement is genuine and aligns with typical behavior, suggesting no irregularities or suspicious activities in their location data.

The SmartPass Location Pattern Engine employs a sophisticated model to assess the authenticity of user location data. This model facilitates distinguishing between genuine and fraudulent location declarations, which facilitates contexts like regulatory compliance, fraud detection, and ensuring user safety.

The model is trained on extensive datasets that include numerous examples of both normal and abnormal user location patterns. These patterns are derived from real-world scenarios, considering various factors such as transportation modes, geographical distances, and realistic travel times. The model's training enables it to understand and predict the likelihood of a user being at a certain location at a certain time based on known transportation methods and realistic travel durations.

In at least one embodiment, one function of the model is to scrutinize the order of locations and their corresponding timestamps. The following examples illustrate how it differentiates between plausible and implausible travel patterns.

Example 1: User is Physically Located in the Center of Athens/Greece, after 1 h User is Captured Near Athens international airport, 2.5 hours later user is located in Rome/Italy airport and 30 mins later somewhere in Rome historical center. This movement pattern aligns with what is feasible via common modes of transport, such as planes and cars, and adheres to realistic travel durations. The model is trained to recognize anomalies. However, in this first example the model identifies this pattern as typical and authentic, leading to a ‘Success’ designation at Step (14).

Example 2: User is physically located in the center of Athens/Greece, after 1 h user is captured near Athens international airport and 2 hours later user is located in California/USA. This trajectory is not feasible considering the vast geographical distance and the limitations of current transportation technologies. The model, recognizing the implausibility of such rapid transcontinental travel, marks this pattern as abnormal, resulting in a ‘Fail’ at Step (12). This efficient identification of improbable travel patterns facilitates flagging potential system misuse or fraudulent activities.

In regulatory compliance, accurately identifying a user's location is desirable to ensure adherence to laws and regulations that may vary by jurisdiction. For instance, certain services may be legal in one country but not in another. The SmartPass Platform, by verifying the authenticity of location data, ensures that users access services only in regions where they are legally permitted.

In fraud detection, identifying anomalous location patterns may be indicative of deceptive behavior. For example, if a user's account shows signs of being accessed from geographically distant locations within a short period, it may signal account compromise or identity theft. Alternatively, it may indicate that the user is using a VPN or other technology to mask or alter their actual geographic location.

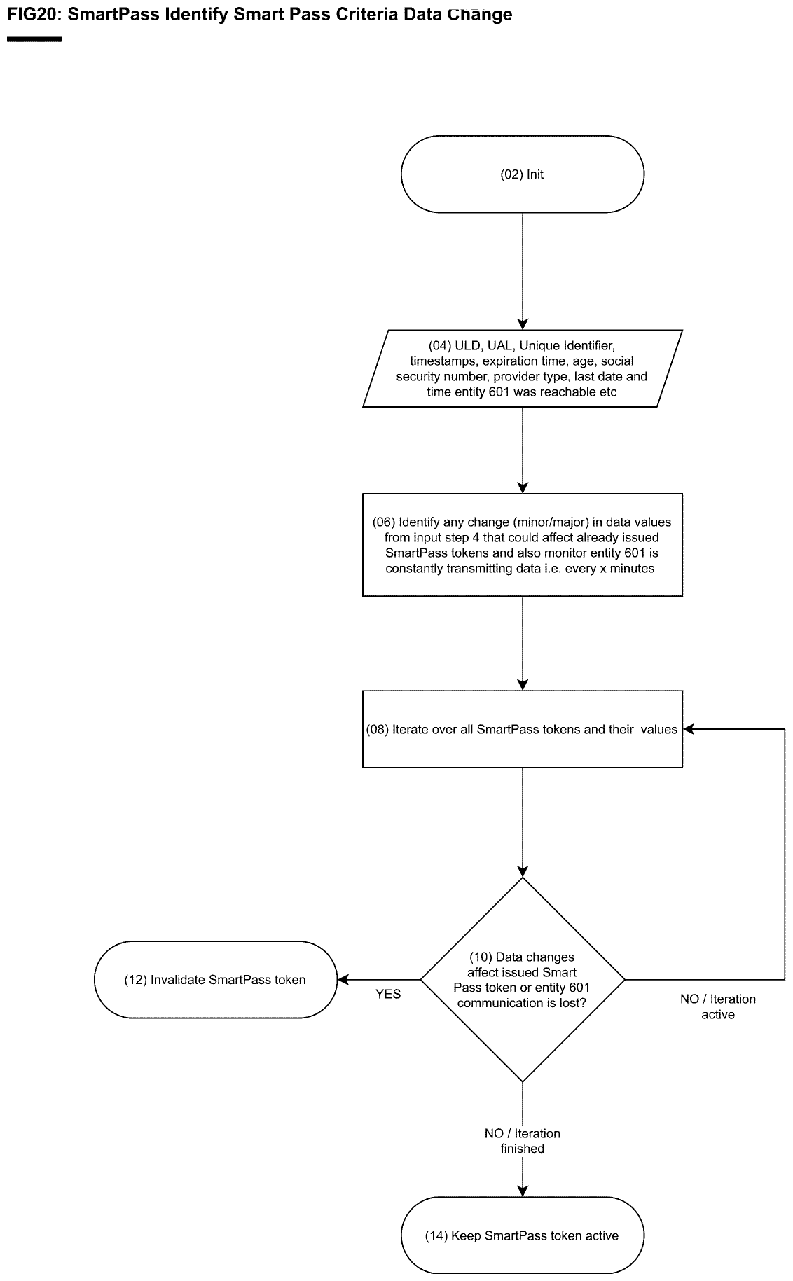

FIG. 20 shows an example systems interaction diagram of a SmartPass Identify SmartPass Criteria Data Change process, demonstrating a sequence of various actions, communications and data exchanges which are performed between various system entities of a data network as part of the execution of this procedure.

FIG. 20 outlines a comprehensive process within the SmartPass platform, focusing on the continuous monitoring and validation of SmartPass tokens. The procedure begins with an initialization step, setting up the system for data analysis. It then collects a wide range of data including user location, unique identifiers, and token-specific information such as expiration time and user demographics. The core of the process involves identifying any changes, minor or major, in this data that may impact the validity of issued SmartPass tokens. This includes evaluating updates in user details, token expiration, and the status of communication with the user's device. The system methodically iterates over all SmartPass token values, determining whether any detected changes necessitate the invalidation of a token or if it may remain active. This mechanism facilitates maintaining the integrity and security of the SmartPass system, ensuring that only valid and up-to-date tokens are active, thereby preserving the platform's reliability and user trust.

FIG. 20 presents a useful security mechanism within the SmartPass platform, focusing on the integrity and validity of SmartPass tokens. This process involves a thorough evaluation of data changes and their impact on tokens. Any change, be it minor or major, triggers this mechanism, ensuring that all active SmartPass tokens stored in the SmartPass Backend (Entity 603) are periodically and/or continually evaluated for their validity. This process facilitates the secure and efficient operation of the SmartPass system, as it maintains the trustworthiness of the tokens which are central to the platform's functionality. In one embodiment, any time a change in data is detected in connection with a given SmartPass token and/or a given user, this process may be triggered and applied on all active SmartPass tokens associated with that user, which are stored/managed by the SmartPass Backend 603. Below is a description of the processes and procedural flows illustrated in FIG. 20.

(02) Init: This step, marked as (02) Init, initiates the SmartPass Identify SmartPass Criteria Data Change process. It involves initializing the system and preparing it to analyze and process data related to SmartPass tokens. This initialization may include loading relevant software modules, setting up necessary variables, and ensuring that all system components are operational and ready to process the subsequent steps. This step sets the stage for the entire process, ensuring that the system is correctly configured and ready to handle the data and decisions that follow.

(04) ULD, UAL, Unique Identifier, timestamps, expiration time, age, social security number, provider type, last date and time entity 601 was reachable etc: In this step, a comprehensive set of data is gathered and input into the system. This data includes User Location Data (ULD), User Approximate Location (UAL), Unique Identifier, timestamps, expiration time of tokens, age, social security number, provider type, and the last date and time the SmartPass Mobile App (Entity 601) was reachable. This diverse range of data points allows for a thorough evaluation of the SmartPass token's status and is desirable for determining if any changes have occurred that may impact the token's validity.

(06) Identify any change (minor/major) in data values from input step 4 that may affect already issued SmartPass tokens and also monitor entity 601 is constantly transmitting data e.g. one or more x minutes: This step involves monitoring and identifying any changes in the data values provided in step (04). The SmartPass Backend (Entity 603) scrutinizes the data for any minor or major alterations, such as updates in user information or token details. This continuous monitoring helps ensure the integrity and accuracy of SmartPass tokens. Changes may include modifications in user demographics, token expiry, or communication status with the SmartPass Mobile App (Entity 601). This step is desirable for maintaining the reliability and security of the SmartPass system.

In at least one embodiment, any change in data, minor or major may be captured by the system, such as, for example, one or more of the following:
user updated his/her date of birth;
location change;
token expiration time;
user account status (active, blocked, pending verification, under regulator authority control etc);
provider update;
social security number update;
timestamp mismatch;
last communication with the device above x minutes;
any other change on any kind of data minor or major.

(08) Iterate over all SmartPass payload values: In this step, the system methodically reviews at least one value within the SmartPass token's payload. This detailed examination, conducted by the SmartPass Backend (Entity 603), facilitates identifying any discrepancies or changes in the token's data. The iteration process involves checking at least one payload element against expected values or previous records to ensure consistency and accuracy. This step is foundational for determining the subsequent action regarding the SmartPass token's validity.

(10) Data changes affect issued SmartPass token or entity 601 communication is lost?: This step represents a decision point where the system evaluates whether changes in data, identified in previous steps, affect the validity of the issued SmartPass tokens. Additionally, it checks if there has been a loss of communication with the SmartPass Mobile App (Entity 601). This decision-making process involves analyzing the nature and extent of data changes and their potential impact on the SmartPass tokens' status. The outcome of this evaluation dictates whether to maintain the token's active status or invalidate it.

(12) Invalidate SmartPass token: If the evaluation in the previous step determines that changes in data critically affect the SmartPass token, this step involves invalidating the token. The SmartPass Backend (Entity 603) executes this action, marking the token as no longer valid. This invalidation facilitates maintaining the security and integrity of the SmartPass system, ensuring that tokens compromised by significant data changes are promptly deactivated.

(14) Keep SmartPass token active: Conversely, if the evaluation in step (10) concludes that the changes in data do not critically affect the SmartPass token, this step involves maintaining the token's active status. The SmartPass Backend (Entity 603) continues to recognize the token as valid, allowing continued usage under the existing parameters. This decision ensures that tokens are not unnecessarily invalidated, maintaining user convenience and system efficiency.

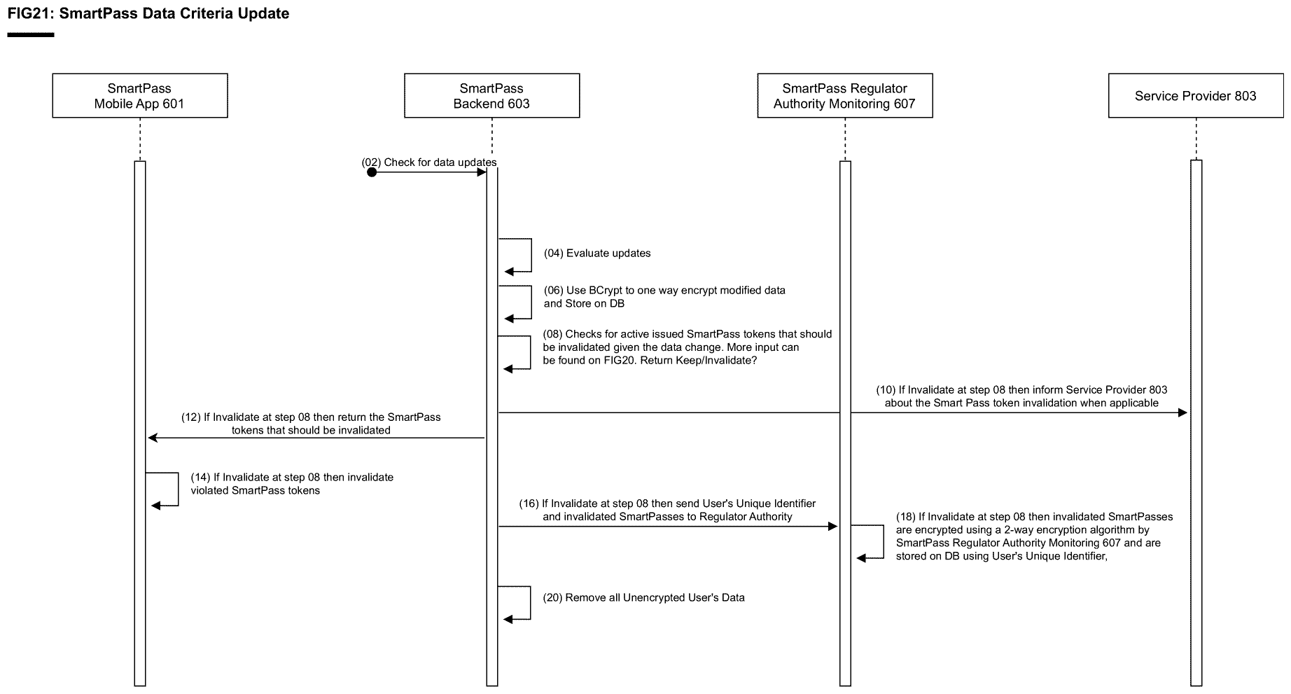

FIG. 21 shows an example systems interaction diagram of a SmartPass Data Criteria Update process, demonstrating a sequence of various actions, communications and data exchanges which are performed between various system entities of a data network as part of the execution of this procedure. In at least one embodiment, this procedure begins with the SmartPass Backend (603) constantly monitoring for any data changes, whether minor or major, and then evaluating these updates. Modified data is secured using BCrypt encryption before storage in the database. The system then assesses active SmartPass tokens to decide if any may be invalidated due to these updates. If invalidation is necessary, the relevant Service Providers (803) and Regulator Authorities (607) are informed, and the invalidated tokens are securely encrypted and stored. This process underscores the platform's commitment to maintaining up-to-date, secure, and compliant token management in response to changing user data and system settings. Below is a description of the processes and procedural flows illustrated in FIG. 21.

(02) Check for data updates: This step involves the SmartPass Backend (603) continuously monitoring for any changes in data. This process includes scanning for modifications, whether minor or major, in user-related information or system settings. In at least one embodiment, this step may include checking for updates in user profiles, regulatory requirements, or system configurations. The backend system may employ algorithms to detect changes in data sets, ensuring that the SmartPass Platform remains current and compliant with relevant regulations and user settings.

(02) 603 constantly checks all data for minor or major changes: In this step, the SmartPass Backend (603) may be configured or designed to include functionality for maintaining the integrity and relevance of the SmartPass system. It actively scans all available data, vigilantly looking for any variations, either minor or significant. This continuous surveillance may involve examining user data for updated personal details, changes in regulatory norms, or any other relevant data shifts. This process is desirable for ensuring that the system's responses and actions remain accurate and timely in the dynamic environment it operates within.

(04) Evaluate updates: The SmartPass Backend (603) evaluates the updates identified in the previous steps. This evaluation involves analyzing the nature and implications of the changes detected. For instance, an update in a user's location data may trigger different regulatory requirements, or a change in a user's personal information may necessitate updates to their profile. The evaluation step facilitates deciding the subsequent actions in the SmartPass system, ensuring that the system's responses are appropriate and compliant with the current data context.

(06) Use BCrypt to one way encrypt modified data and Store on DB: After evaluating the updates, the SmartPass Backend (603) employs the BCrypt hashing algorithm to securely encrypt any modified data. This step ensures the confidentiality and integrity of sensitive information like user personal details or transaction records. Once encrypted, this data is then stored in the database, reinforcing the system's security measures. The use of BCrypt, known for its robustness, adds an additional layer of protection against unauthorized access and data breaches.

(08) Checks for active issued SmartPass tokens that may be invalidated given the data change. More input may be found on FIG. 20. Return Keep/Invalidate?: This decision point, executed by the SmartPass Backend (603), involves scrutinizing the currently active SmartPass tokens to determine if any may be invalidated due to the recent data changes. The backend system reviews at least one token against the updated criteria and decides whether to keep it active or invalidate it. This step facilitates maintaining the accuracy and relevance of the SmartPass tokens in circulation, ensuring they reflect the latest user data and system configurations.

(10) If Invalidate at step 08 then inform Service Provider 803 about the SmartPass token invalidation when applicable: In scenarios where SmartPass tokens are invalidated (as determined in step 08), the SmartPass Backend (603) communicates this invalidation to the concerned Service Provider (803). This communication is desirable to ensure that the service provider is aware of the changes and may accordingly update their records or take necessary actions. The information transmitted typically includes details of the invalidated tokens and the reasons for their invalidation, enabling the service provider to maintain alignment with the current status of user access and permissions.

(12) If Invalidate at step 08 then return the SmartPass tokens that may be invalidated: Following the decision to invalidate certain SmartPass tokens (in step 08), the SmartPass Backend (603) identifies and lists these specific tokens. This step involves the backend system processing and retrieving the details of all tokens that no longer meet the requisite criteria and are, therefore, subject to invalidation. This list facilitates further processing and communication to relevant entities, like regulatory authorities or service providers, about the status of these tokens.

(14) If Invalidate at step 08 then invalidate violated SmartPass tokens: In this step, the SmartPass Backend (603) actively invalidates the SmartPass tokens identified in the previous step (12). This action renders the specified tokens non-functional and unable to provide access or permissions previously associated with them. This step provides a supportive measure to ensure that only valid and compliant tokens are in use, maintaining the security and regulatory compliance of the SmartPass system.

(16) If Invalidate at step 08 then send User's Unique Identifier and invalidated SmartPass tokens to Regulator Authority: After invalidating specific SmartPass tokens, the SmartPass Backend (603) communicates this information, along with the user's Unique Identifier, to the Regulator Authority (607). This communication serves as a desirable update to the authority, ensuring they are informed about the changes in the status of tokens linked to a specific user. This step is integral to maintaining transparency and compliance with regulatory oversight.

(18) If Invalidate at step 08 then invalidated SmartPass tokens are encrypted using a 2-way encryption algorithm by SmartPass Regulator Authority Monitoring 607 and are stored on DB using User's Unique Identifier: Once the decision to invalidate certain SmartPass tokens is made and communicated to the Regulator Authority (607), this step involves the use of a 2-way encryption algorithm to secure the data concerning these invalidated tokens. The Regulator Authority uses this encryption to ensure the confidentiality and security of the information, which is then stored in the database. The encryption and storage are associated with the user's Unique Identifier, allowing for secure and organized record-keeping.

(20) Remove All Unencrypted User's Data: In this final step, the SmartPass Backend (603) undertakes a supportive data protection action by removing all unencrypted user data from its system. This step is taken to ensure that sensitive user information is not left vulnerable in an unencrypted state, thereby safeguarding user privacy and complying with data protection regulations. This measure is particularly important in scenarios where data has been updated or when tokens have been invalidated, necessitating the purging of outdated or redundant unencrypted data.

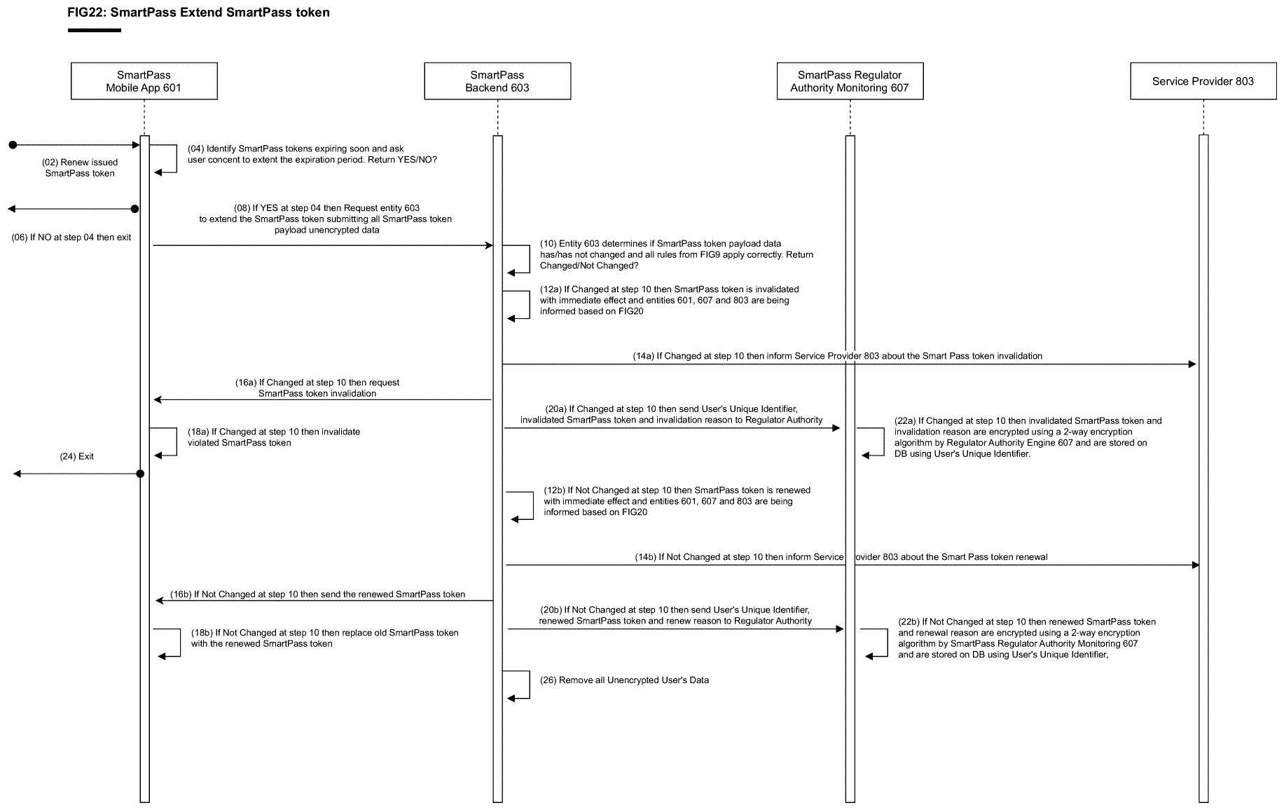

FIG. 22 shows an example systems interaction diagram of a Extend SmartPass Token Expiration process, demonstrating a sequence of various actions, communications and data exchanges which are performed between various system entities of a data network as part of the execution of this procedure. This process involves a series of steps to manage the renewal or invalidation of SmartPass tokens. It starts with the identification of expiring tokens and seeks user consent for renewal. Based on the user's response and subsequent checks for any changes in the token's data, the token is either renewed or invalidated. This decision impacts various entities within the SmartPass ecosystem, including the mobile app, backend, service providers, and the regulatory authority. The process emphasizes security, user consent, and regulatory compliance, ensuring that at least one SmartPass token is accurately managed to reflect its current status. Below is a description of the processes and procedural flows illustrated in FIG. 22.

(02) Renew issued SmartPass token: This step involves the SmartPass Mobile App (601) initiating the process to renew an issued SmartPass token. The application identifies the need for renewal based on the token's expiration criteria and sends a renewal request to the SmartPass Backend (603). This action ensures that the user's access to services via the SmartPass token remains uninterrupted.

(04) Identify SmartPass tokens expiring soon and ask user consent to extend the expiration period. Return YES/NO?: In this step, the SmartPass Backend (603) identifies SmartPass tokens that are nearing their expiration. It then sends a notification to the user via the SmartPass Mobile App (601), requesting their consent to extend the token's validity. The user's response (YES or NO) determines the subsequent actions. This step facilitates maintaining continuous service access and user autonomy in managing their tokens.

(06) If NO at step 04 then exit: If the user's response to the token renewal request is NO, the process is terminated. This decision point, executed by the SmartPass Mobile App (601), respects the user's choice and avoids any unauthorized extension of the SmartPass token. This step emphasizes the importance of user consent in the token management process.

(08) If YES at step 04 then Request entity 603 to extend the SmartPass token submitting all SmartPass token payload unencrypted data: When the user consents to extend the token's expiration (via the SmartPass Mobile App 601), this step involves sending a request along with the SmartPass token's unencrypted payload data to the SmartPass Backend (603). The backend then processes this request, ensuring the token's validity is extended as per the user's consent.

(10) Entity 603 determines if SmartPass token payload data has/has not changed and all rules from FIG. 9 apply correctly. Return Changed/Not Changed?: At this juncture, the SmartPass Backend (603) examines the payload data of the SmartPass token to determine if any changes have occurred since its last renewal. It also assesses whether all applicable rules (as outlined in FIG. 9) are met. Based on this evaluation, the backend decides whether the token has changed or remains unchanged, guiding the subsequent steps in the token management process.

(12a) If Changed at step 10 then SmartPass token is invalidated with immediate effect and entities 601, 607, and 803 are being informed based on FIG. 20: If the SmartPass token has undergone changes (as identified by Entity 603), it is immediately invalidated to maintain security and compliance. Entities involved in the SmartPass ecosystem, namely SmartPass Mobile App (601), SmartPass Regulator Authority Monitoring (607), and Service Provider (803), are promptly notified about this invalidation, following the protocol outlined in FIG. 20. This step ensures all stakeholders are aware of the token's status and may act accordingly.

(12b) If Not Changed at step 10 then SmartPass token is renewed with immediate effect and entities 601, 607, and 803 are being informed based on FIG. 20: If Entity 603 determines that the SmartPass token remains unchanged, it is renewed immediately. This renewal is communicated to the SmartPass Mobile App (601), SmartPass Regulator Authority Monitoring (607), and the Service Provider (803), as per the procedures in FIG. 20. This step ensures that the token remains active and valid for continued use by the user.

(14a) If Changed at step 10 then inform Service Provider 803 about the SmartPass token invalidation: In the event that the SmartPass token is invalidated (due to changes identified in step 10 by Entity 603), the Service Provider (803) is informed of this invalidation. This communication ensures that the service provider is aware of the change in the user's access status and may adjust their services accordingly.

(14b) If Not Changed at step 10 then inform Service Provider 803 about the cryptographically signed SmartPass token renewal: When the cryptographically signed SmartPass token is successfully renewed without any changes (as determined in step 10 by Entity 603), the Service Provider (803) is notified about this renewal. This step keeps the service provider updated about the continued validity of the user's cryptographically signed SmartPass token, ensuring uninterrupted service provision.

(16a) If Changed at step 10 then request SmartPass token invalidation: In case of changes to the SmartPass token (identified by Entity 603), a request for the token's invalidation is initiated. This step facilitates maintaining the security and integrity of the SmartPass system, ensuring that tokens reflecting outdated or incorrect information are promptly invalidated.

(16b) If Not Changed at step 10 then send the renewed SmartPass token: If Entity 603 finds no changes in the SmartPass token, the renewed token is sent to the relevant entities. This step signifies the successful extension of the token's validity, allowing the user continued access to services linked with the SmartPass.

(18a) If Changed at step 10 then invalidate violated SmartPass token: Upon detection of changes in the SmartPass token by Entity 603, any token that violates the established criteria is invalidated. This action is a safeguard to prevent unauthorized or compromised tokens from being used, thereby protecting the integrity of the SmartPass ecosystem.

(18b) If Not Changed at step 10 then replace old SmartPass token with the renewed SmartPass token: In the absence of changes (as verified by Entity 603), the old SmartPass token is replaced with the newly renewed one. This step ensures that the user's SmartPass remains up-to-date and valid, facilitating uninterrupted access to associated services.

(20a) If Changed at step 10 then send User's Unique Identifier, invalidated SmartPass token and invalidation reason to Regulator Authority: Following the invalidation of a SmartPass token due to changes (identified by Entity 603), the user's unique identifier, details of the invalidated token, and the reason for invalidation are sent to the Regulator Authority. This step is desirable for regulatory compliance and record-keeping, ensuring that the authority is apprised of all relevant token status changes.

(20b) If Not Changed at step 10 then send User's Unique Identifier, renewed SmartPass token and renew reason to Regulator Authority: When a SmartPass token is renewed without changes (as determined by Entity 603), the user's unique identifier, the renewed token, and the reason for its renewal are communicated to the Regulator Authority. This step keeps the authority informed about the token's status and the rationale behind its extension.

(22a) If Changed at step 10 then invalidated SmartPass token and invalidation reason are encrypted using a 2-way encryption algorithm by Regulator Authority Engine 607 and are stored on DB using User's Unique Identifier: For invalidated tokens (due to changes identified by Entity 603), the token details and invalidation reasons are encrypted using a two-way encryption algorithm by the Regulator Authority Engine (607). The encrypted information is then securely stored in a database, tagged with the user's unique identifier. This process ensures that sensitive information related to token invalidation is securely handled and stored.

(22b) If Not Changed at step 10 then renewed SmartPass token and renewal reason are encrypted using a 2-way encryption algorithm by SmartPass Regulator Authority Monitoring 607 and are stored on DB using User's Unique Identifier: In cases where the SmartPass token is renewed without changes (as assessed by Entity 603), the token and its renewal reason are encrypted using a two-way encryption algorithm by SmartPass Regulator Authority Monitoring (607). This encrypted data is then stored in a database, linked to the user's unique identifier, ensuring secure and traceable record-keeping of token renewals.

(24) Exit: This step marks the conclusion of the SmartPass token extension process. Once all the necessary actions are taken and communications made as per the previous steps, the process is formally closed.

(26) Remove all Unencrypted User's Data: The final step in the SmartPass token extension process involves the removal of all unencrypted user data from the system. This action, carried out by the SmartPass Backend (603), provides a supportive security measure to ensure that sensitive user information is not left vulnerable to unauthorized access or breaches.

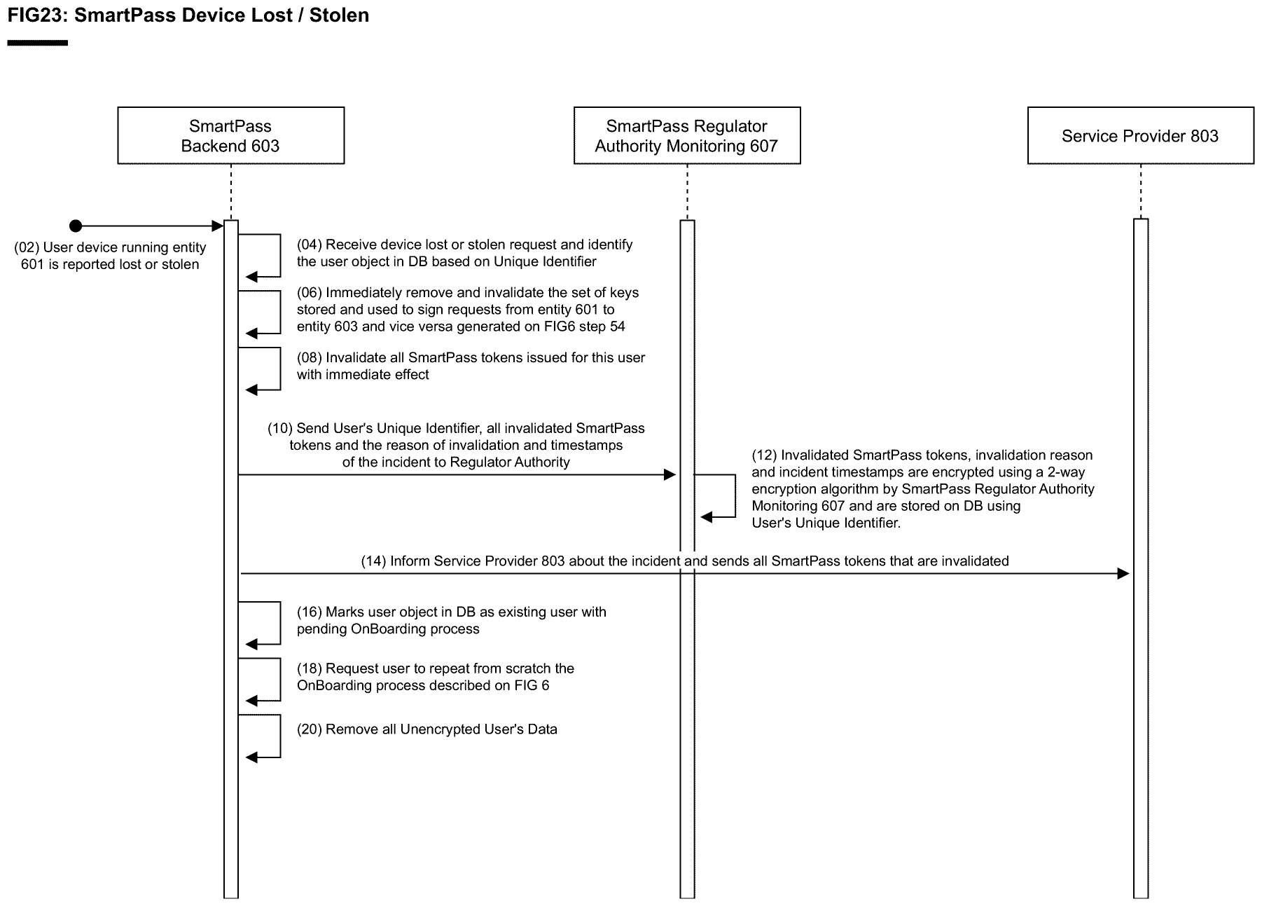

FIG. 23 shows an example systems interaction diagram of a SmartPass Device Lost/Stolen process, demonstrating a sequence of various actions, communications and data exchanges which are performed between various system entities of a data network as part of the execution of this procedure.

The procedure depicted in FIG. 23 outlines the comprehensive steps taken by the SmartPass Platform in response to a user's device (running the SmartPass Mobile App) being reported lost or stolen. This process involves multiple entities within the SmartPass ecosystem, including the SmartPass Backend, Regulator Authority Monitoring, and Service Providers. The primary focus is on swiftly securing the user's account by invalidating access keys and SmartPass tokens, updating regulatory authorities and service providers, and ensuring the user undergoes a secure onboarding process again. This protocol ensures that the user's data and access privileges are safeguarded against unauthorized use or exposure. Below is a description of the processes and procedural flows illustrated in FIG. 23.

(02) User device running entity 601 is reported lost or stolen: In this step, the SmartPass Mobile App (Entity 601) is reported as either lost or stolen. This notification may be initiated by the user through another device or a web interface, informing the SmartPass Backend (Entity 603). This report triggers a security protocol to safeguard the user's data and access privileges. The report includes details such as the time of the incident, the last known location of the device, and any other relevant information that may assist in the recovery or security measures.

(04) Receive device lost or stolen request and identify the user object in DB based on Unique Identifier: Upon receiving the notification of the lost or stolen device (Entity 601), the SmartPass Backend (Entity 603) processes this request. It involves identifying the specific user account associated with the reported device using the unique identifier assigned to the user. This unique identifier provides a supportive piece of data, as it allows the system to precisely locate the user's data within the database, ensuring that subsequent steps are applied to the correct account.

(06) Immediately remove and invalidate the set of keys stored and used to sign requests from entity 601 to entity 603 and vice versa generated on FIG. 6 step 54: Following the identification of the user's account, the SmartPass Backend (Entity 603) promptly invalidates the cryptographic keys previously generated (as per FIG. 6, step 54) for secure communication between the user's mobile app (Entity 601) and the backend. This provides a supportive security measure, rendering any intercepted or residual data from the lost/stolen device unusable and safeguarding against unauthorized access.

(08) Invalidate all SmartPass tokens issued for this user with immediate effect: The SmartPass Backend (Entity 603) proceeds to invalidate all SmartPass tokens that were issued for the user. This step facilitates prevent any misuse of services or access to restricted areas that the tokens may have granted. The invalidation is implemented immediately, ensuring that there is minimal window for any potential unauthorized use of these tokens.

(10) Send User's Unique Identifier, all invalidated SmartPass tokens and the reason of invalidation and timestamps of the incident to Regulator Authority: In this step, the SmartPass Backend (Entity 603) communicates with the SmartPass Regulator Authority Monitoring (Entity 607). It sends the user's unique identifier, a list of all the invalidated SmartPass tokens, the reason for their invalidation, and the timestamps of the incident. This step ensures regulatory compliance and allows for an audit trail in case of further investigation or recovery attempts.

(12) Invalidated SmartPass tokens, invalidation reason and incident timestamps are encrypted using a 2-way encryption algorithm by SmartPass Regulator Authority Monitoring 607 and are stored on DB using User's Unique Identifier: The SmartPass Regulator Authority Monitoring (Entity 607) takes the information received from the Backend (Entity 603) and encrypts it using a robust two-way encryption algorithm. The encrypted data, along with the user's unique identifier, is then securely stored in the database. This process ensures that the sensitive information related to the incident is kept confidential and secure, accessible only to authorized personnel.

(14) Inform Service Provider 803 about the incident and sends all SmartPass tokens that are invalidated: The SmartPass Backend (Entity 603) notifies the relevant Service Provider (Entity 803) about the incident. It provides details about the invalidated SmartPass tokens, ensuring that the service provider is aware of the change in the user's access rights. This communication is desirable to maintain the integrity and security of the services offered by the provider, preventing unauthorized access.

(16) Marks user object in DB as existing user with pending OnBoarding process: The SmartPass Backend (Entity 603) updates the status of the user's account in the database, marking it as an existing user but with a pending onboarding process. This status implies that the user may need to undergo the onboarding process again, as described in FIG. 6. This measure is particularly important in scenarios where the user's device is lost or stolen, but also applies if the user switches devices and does not use a backup and restore process.

(18) Request user to repeat from scratch the OnBoarding process described on FIG. 6: The SmartPass Backend (Entity 603) prompts the user to restart the onboarding process from scratch, as detailed in FIG. 6. This step facilitates re-establish the user's credentials and access rights in the system securely. It involves re-verifying the user's identity, setting up new authentication keys, and reissuing SmartPass tokens as needed.

(20) Remove all Unencrypted User's Data: As a final step in this security protocol, the SmartPass Backend (Entity 603) ensures the removal of all unencrypted user data from its systems. This step provides a supportive data protection measure, especially in the context of a lost or stolen device, to prevent any potential data breach or unauthorized access to sensitive user information.

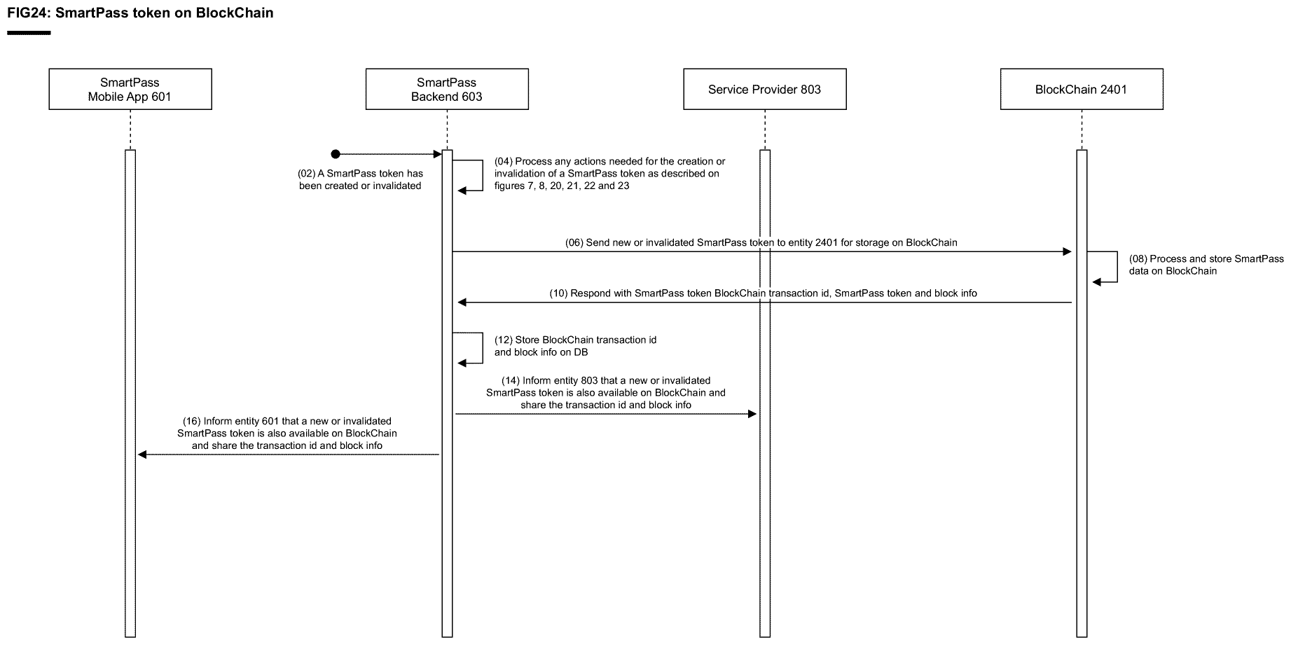

FIG. 24 shows an example systems interaction diagram of a SmartPass Token Issuance on Blockchain process, demonstrating a sequence of various actions, communications and data exchanges which are performed between various system entities of a data network as part of the execution of this procedure.

FIG. 24 outlines the process of managing SmartPass tokens on a Blockchain. This process includes creating or invalidating tokens, processing these actions, and securely storing token data on a Blockchain (Entity 2401). The Blockchain serves as a secondary, immutable record of all token transactions, enhancing the system's security and reliability. Various entities within the SmartPass ecosystem, including the mobile app (601), backend (603), and service providers (803), interact to ensure the tokens' integrity and status are accurately managed and communicated. The Blockchain's role as a reliable and tamper-proof ledger is central to this process, providing a fallback mechanism and an independent source of verification for SmartPass tokens.

In one embodiment, this process is an extension of FIG. 8 and aims to describe a sub-process that takes place when a SmartPass token is being created. It is also an extension of FIGS. 7, 20, 21, 22 and 23 when a SmartPass token is being invalidated. SmartPass tokens are typically stored on entity's 603 DB but may also be stored on any Blockchain that supports contracts e.g. Ethereum, Polygon etc. The goal is to be able to persistently and immutably store SmartPass tokens and their status e.g. active invalidated etc on a public chain. Storing SmartPass tokens on Blockchain increases security because chain contents cannot be disputed and is very hard or impossible to amend without having the proper permissions which practically means having access to SmartPass wallet encryption keys. Blockchain entity 2401 introduced on FIG. 24 is an entity that allows writing and reading SmartPass tokens from to Blockchain and may be chain agnostic which practically means it may connect on any chain supporting contracts. Below is a description of the processes and procedural flows illustrated in FIG. 24.

(02) A SmartPass token has been created or invalidated: This step marks the initiation or conclusion of a SmartPass token's lifecycle. When a SmartPass token is created or invalidated, this triggers a sequence of processes within the SmartPass ecosystem. The creation of a token may be due to a new user registration or issuance of a new token for existing users. Invalidation typically occurs when a token expires, is reported lost or stolen, or when a user's account status changes (e.g., due to regulatory compliance issues). This step facilitates maintaining the integrity and security of the SmartPass system, ensuring that tokens in circulation are valid and up-to-date.

(04) Process any actions needed for the creation or invalidation of a SmartPass token as described on FIGS. 7, 8, 20, 21, 22 and 23: This step involves a series of actions required for either issuing a new SmartPass token or invalidating an existing one. These actions are guided by the protocols and processes outlined in FIGS. 7, 8, 20, 21, 22, and 23 of the SmartPass documentation. The actions may include verifying user identity and compliance with regulations (KYC/AML), updating the SmartPass database (Entity 603), and communicating with relevant external entities such as Identity Validators (605) and Regulator Authority Engines (607). This step ensures that the token issuance or invalidation is processed in accordance with established SmartPass protocols and regulatory requirements.

(06) Send new or invalidated SmartPass token to entity 2401 for storage on Blockchain: Once a SmartPass token is either created or invalidated, it is sent to the Blockchain entity (2401) for storage. This step facilitates ensuring the immutability and security of the token data. The Blockchain entity records the token status (active or invalidated) on a public ledger, providing a transparent and tamper-proof record. This action enhances the trustworthiness and reliability of the SmartPass system, as the Blockchain serves as a decentralized and secure repository for token information.

(08) Process and store SmartPass data on Blockchain: In this step, the Blockchain entity (2401) processes and stores the SmartPass token data received from the SmartPass Backend (603). This involves adding the token data to the Blockchain ledger, which may include the token's unique identifier, status (active or invalidated), and other relevant metadata. The Blockchain's cryptographic mechanisms ensure that once the data is stored, it cannot be altered or deleted, providing a secure and immutable record of the SmartPass token's history and status.

(10) Respond with SmartPass token Blockchain transaction ID, SmartPass token and block info: After storing the SmartPass token data on the Blockchain, the Blockchain entity (2401) responds back to the SmartPass Backend (603) with the transaction ID, the SmartPass token, and block information. This information serves as proof of the transaction on the Blockchain, providing traceability and accountability. The transaction ID and block info may be used for future reference, audits, or verification purposes, ensuring transparency and integrity in the SmartPass system's operations.

(12) Store Blockchain transaction ID and block info on DB: The SmartPass Backend (603) stores the Blockchain transaction ID and block information in its database. This step is desirable for maintaining a comprehensive record of all SmartPass token transactions on the Blockchain. By storing this information, the SmartPass system may easily retrieve and verify the history and status of any token, enhancing the system's ability to conduct audits, comply with regulatory requirements, and ensure overall system integrity.

(14) Any external or internal party may verify the validity and status of a SmartPass token that is stored on the Blockchain. This includes entities 601, 603 and 803. Entity 2401 is a second source of truth and/or a fall back mechanism in case SmartPass platform is out of service: This step highlights the Blockchain's role as a secondary source of truth for verifying SmartPass tokens. Both internal entities (like the SmartPass Mobile App 601 and Backend 603) and external entities (like Service Provider 803) may verify a token's validity and status directly from the Blockchain (Entity 2401). This is especially important if the primary SmartPass platform is offline or compromised, ensuring that token validation may still be performed independently, thus maintaining the integrity and continuity of the SmartPass ecosystem.

(14) Inform entity 803 that a new or invalidated cryptographically signed SmartPass token is also available on Blockchain and share the transaction ID and block info: The SmartPass Backend (603) informs the Service Provider (803) that a new or invalidated cryptographically signed SmartPass token has been recorded on the Blockchain. This communication includes sharing the transaction ID and block information. This step ensures that the service provider is updated about the status of SmartPass tokens, which facilitates them to manage access to their services based on the validity of these tokens.

(16) Inform entity 601 that a new or invalidated SmartPass token is also available on Blockchain and share the transaction ID and block info: In this step, the SmartPass Backend (603) informs the SmartPass Mobile App (601) about the new or invalidated token's status on the Blockchain, sharing the transaction ID and block info. This ensures that the user-facing component of the SmartPass system, the mobile app, has the latest information on the token status, enabling it to provide accurate and up-to-date information to the users about their SmartPass tokens.

Blockchain Network 2401: Blockchain Network 2401 may be configured or designed to include functionality for the SmartPass ecosystem. It acts as a decentralized ledger for storing and verifying SmartPass token data. Being chain agnostic, it may interface with various Blockchain platforms like Ethereum or Polygon, which support smart contracts. This flexibility allows for a wide range of Blockchain technologies to be utilized for storing SmartPass tokens. The use of Blockchain technology ensures enhanced security and immutability of token data, which facilitates maintaining the integrity and trustworthiness of the SmartPass system.

### Non-Online Use Cases of SmartPass Platform Technology

According to different embodiments, the SmartPass platform technology may also be adapted for use in a variety of non-online use cases. Below are illustrative examples of different non-online use case scenarios utilizing the SmartPass platform technology.

### Scenario 1: Participation in Restricted Retail Purchases

John Doe, a 25-year-old, wishes to purchase alcohol from a local retail store. The store mandates age verification for such purchases, adhering to local legal age requirements for alcohol consumption. John, having his age and identity verified through the SmartPass Mobile App, uses it to facilitate this purchase while maintaining his privacy and compliance with regulatory requirements.

### Specific Regulatory Compliance Restrictions

The purchaser must meet the legal drinking age requirement as per local jurisdiction.
Identity verification is mandatory to ensure the purchaser is of legal age.

### Example Step-by-Step Implementation

1. Integration at Retail Store: The retail store integrates SmartPass technology into its sales system. When a customer selects an age-restricted product like alcohol, the system prompts for age verification. This integration allows the store to comply with local age restrictions without directly accessing customers' personal information.
2. Initial Communication: John's SmartPass Mobile Application receives a request from the retail store's system when he attempts to purchase alcohol. The request includes details of the product, emphasizing the need for age verification as per regulatory compliance for alcohol sales.
3. Determining Compliance Restrictions: The SmartPass System uses the product details and John's current location to determine the specific regional and legal age requirements for alcohol purchase. It assesses local laws to ensure all regulatory compliances are considered.
4. Regulatory Compliance Verification: The SmartPass System then verifies John's compliance with these regulations. It uses his encrypted Personal Identifiable Information (PII) and geolocation data to confirm that he meets the legal age requirement for purchasing alcohol in his region.
5. Generating SmartPass Token: Upon successful verification, the SmartPass Backend generates a customized SmartPass token for this event and securely transmits a representation of the SmartPass token to the SmartPass App. This token certifies John's eligibility to purchase alcohol without revealing his exact age or other PII, ensuring privacy.
6. Transmitting Computer Readable Code: John's SmartPass App presents a computer readable code representing the SmartPass token. He presents this code to the retail store cashier for scanning/reading, initiating the verification process.
7. Backend Verification by Retailer: The retail store's system communicates with the SmartPass Backend to validate the SmartPass token. The backend confirms the token's authenticity and its compliance with age verification requirements.
8. Access Approval: After successful verification, the retail store processes John's alcohol purchase. The system approves the transaction based on the validated SmartPass token, ensuring a smooth and compliant purchasing experience.
9. Regulatory Reporting: The usage event of John's SmartPass token, along with the transaction details, is reported to the Regulator Authority database and is stored using a 2-way encryption using Regulator Authority's public key. This data is used for regulatory monitoring and ensuring adherence to legal age requirements in retail purchases.
   Scenario 2: Voting in Public Elections with Specific Restrictions

Alice, a resident of a city with precinct voting, intends to participate in local elections. To comply with stringent voter eligibility criteria, including citizenship, age, residency in the voting precinct, and absence of recent felony convictions, the election authority has implemented SmartPass technology. Alice uses her SmartPass Mobile App for a secure and private verification of her eligibility to vote, aligning with regulatory requirements and maintaining the integrity of the electoral process.

### Specific Regulatory Compliance Restrictions

Voters must be citizens and meet the minimum age requirement as per electoral laws.
Voters at that voting location must have a registered address within the local voting precinct.
Voters must not have been convicted of a felony within the past 10 years.
Verification of identity and voter eligibility without compromising voter privacy.

### Example Step-by-Step Implementation

1. Integration with Electoral System: The electoral authority integrates SmartPass technology into their voting system to ensure only eligible voters participate. This integration verifies citizenship, age, local precinct residency, and felony conviction status, maintaining the integrity of the electoral process. In one embodiment, precinct workers may be given mobile devices integrated with SmartPass technology, which they may use to verify voter eligibility of in person voters.
2. Initial Communication: When Alice initiates her voting process, her SmartPass Mobile Application communicates with the electoral system via a precinct worker's mobile device. The system sends details about the election, emphasizing the need for comprehensive verification of voter eligibility per regulatory requirements.
3. Determining Compliance Restrictions: The SmartPass System assesses specific electoral regulations, including age, citizenship, local precinct residency, and felony conviction status, based on the election's nature and Alice's location. It ensures compliance with broad electoral laws and guidelines.
4. Regulatory Compliance Verification: Alice's eligibility is verified through the SmartPass System. It uses her verified PII, residency data, and background check information to confirm she meets all regulatory requirements for voting, including being of legal voting age, a citizen, a resident of the precinct, and having a clear felony record for the past 10 years.
5. Generating SmartPass Token: Upon successful verification, the SmartPass Backend generates a customized SmartPass token for this event and securely transmits a representation of the SmartPass token to the SmartPass App. This token certifies Alice's eligibility to vote in the election while maintaining her privacy and security, ensuring no sensitive personal details are disclosed.
6. Transmitting Computer Readable Code: Alice's SmartPass App presents a computer readable code representing the SmartPass token, which she presents at her voting station for scanning/reading. The code initiates the verification process.
7. Backend Verification by Electoral Authority: The electoral system communicates with the SmartPass Backend to validate the SmartPass token. The backend confirms the token's authenticity and its compliance with voter eligibility requirements, including the absence of recent felonies.
8. Access Approval for Voting: After successful token verification, Alice is allowed to access the voting system. She can cast her vote securely, with the assurance that her participation aligns with stringent regulatory standards.
9. Regulatory Reporting: The use of Alice's SmartPass token, along with anonymized voting activity data, is reported to the Regulator Authority database for regulatory oversight. This ensures transparency and adherence to electoral laws, including residency and felony-related restrictions, without compromising voter privacy.

### Scenario 3: Vending Machines Selling Age-Restricted Products

Tom, a 30-year-old, wishes to purchase cigarettes from an automated vending machine in a public area. The vending machine is equipped with SmartPass technology to comply with the legal age requirement for tobacco purchases. Tom uses his SmartPass Mobile App to verify his age discreetly, enabling him to make the purchase while ensuring both his privacy and adherence to regulatory age restrictions for tobacco sales.

### Specific Regulatory Compliance Restrictions

The buyer must meet the legal age requirement for purchasing tobacco.
Automated verification is required to ensure compliance without manual oversight.

### Example Step-by-Step Implementation

1. Integration at Vending Machine: The vending machine is equipped with SmartPass technology, enabling it to verify the age of customers attempting to purchase age-restricted products like tobacco, ensuring compliance with legal age restrictions.
2. Initial Communication: When Tom selects cigarettes from the vending machine, his SmartPass Mobile Application communicates with the machine. It receives details about the product and the necessity of age verification as per tobacco sale regulations.
3. Determining Compliance Restrictions: The SmartPass System assesses the specific regional and legal age requirements for tobacco purchase based on his location and the product details, ensuring adherence to local laws.
4. Regulatory Compliance Verification: The SmartPass App verifies Tom's age using his verified PII and geolocation data. It confirms that he meets the legal age requirement for purchasing tobacco, maintaining his privacy throughout the process.
5. Generating SmartPass Token: Upon successful verification, the SmartPass Backend generates a customized SmartPass token for this event and securely transmits a representation of the SmartPass token to the SmartPass App, certifying Tom's eligibility for the purchase without revealing his personal details.
6. Transmitting Computer Readable Code: The SmartPass App presents a computer readable code representing the SmartPass token. Tom presents this code to the vending machine's reader to proceed with the purchase.
7. Backend Verification by Vending Machine: The vending machine communicates with the SmartPass Backend to validate the SmartPass token. The backend confirms the token's validity and compliance with age verification requirements.
8. Access Approval: After the successful verification of the SmartPass token, the vending machine processes Tom's purchase, dispensing the cigarettes. This ensures a seamless transaction that adheres to age restriction compliance.
9. Regulatory Reporting: The transaction involving Tom's SmartPass token, along with details of the purchase, is reported to the Regulator Authority database and is stored using a 2-way encryption using Regulator Authority's public key for regulatory monitoring, ensuring legal compliance in age-restricted product sales.

### Scenario 4: Casino Slot Machines—Access to Gambling Services

Emily, a tourist in Las Vegas, decides to try her luck at a casino's slot machines. The casino, adhering to strict gambling age laws, uses SmartPass technology for age verification. Emily uses her SmartPass Mobile App to prove she is of legal gambling age. This allows her to enjoy the casino services securely and privately, ensuring the casino complies with regulatory age restrictions for gambling.

### Specific Regulatory Compliance Restrictions

Patrons must meet the legal gambling age requirement set by the jurisdiction.
Identity and age verification is mandatory for access to gambling services.

### Example Step-by-Step Implementation

1. Integration with Casino System: The casino integrates SmartPass technology into their slot machines and gambling systems. This integration ensures that only patrons who meet the legal age requirements can access gambling services, maintaining regulatory compliance.
2. Initial Communication: Upon Emily's attempt to use a slot machine, her SmartPass Mobile Application communicates with the casino's system. The system sends a request for age verification, identifying the need for compliance with gambling age laws.
3. Determining Compliance Restrictions: The SmartPass System assesses the specific gambling regulations, including age requirements, based on the casino's location. It ensures that Emily's access to gambling services complies with local legal standards.
4. Regulatory Compliance Verification: Emily's eligibility for gambling is verified through the SmartPass System. It uses her verified PII and geolocation data to confirm she meets the legal gambling age, maintaining her privacy.
5. Generating SmartPass Token: After successful verification, the SmartPass Backend generates a customized SmartPass token for this event and securely transmits a representation of the SmartPass token to the SmartPass App, certifying Emily's eligibility for gambling without disclosing her exact age or other PII.
6. Transmitting Computer Readable Code: The SmartPass App presents a computer readable code representing the SmartPass token, which Emily presents to the slot machine. The machine scans the code to begin the verification process.
7. Backend Verification by Casino: The slot machine communicates with the SmartPass Backend to validate the SmartPass token. The backend confirms the token's authenticity and compliance with age verification requirements.
8. Access Approval for Gambling: Following successful token verification, the slot machine allows Emily to engage in gambling activities. This ensures a secure and compliant gambling experience.
9. Regulatory Reporting: The use of Emily's SmartPass token, along with anonymized gambling activity data, is reported to the Regulator Authority database. This ensures regulatory oversight and compliance with gambling laws, while protecting patron privacy.

### Scenario 5: Access to Cannabis Dispensaries

Alex, residing in a state where cannabis is legally sold, decides to visit a local dispensary. The dispensary uses SmartPass technology to ensure compliance with state laws regarding the sale of cannabis, which includes verifying the customer's age and residency. Alex uses his SmartPass Mobile App to validate his eligibility to purchase cannabis, ensuring a secure transaction that respects both his privacy and the regulatory requirements.

### Specific Regulatory Compliance Restrictions

Customers must meet the legal age requirement for purchasing cannabis.
Verification of residency may be required, depending on state laws.

### Example Step-by-Step Implementation

1. Integration at Cannabis Dispensary: The dispensary integrates SmartPass technology to validate customers' age and, if required, residency. This system ensures that only legally eligible individuals can purchase cannabis, adhering to state regulations.
2. Initial Communication: When Alex selects cannabis products for purchase, his SmartPass Mobile Application communicates with the dispensary's system. It receives product details and the requirement for age and potentially residency verification as per state cannabis regulations.
3. Determining Compliance Restrictions: The SmartPass App identifies the specific regional requirements for cannabis purchase based on Alex's location and the product details. It ensures compliance with the state's cannabis laws, including age and residency restrictions.
4. Regulatory Compliance Verification: Alex's eligibility for purchasing cannabis is verified through the SmartPass System. It uses his verified PII and geolocation data to confirm that he meets the legal age and, if applicable, residency requirements, maintaining his privacy.
5. Generating SmartPass Token: Upon successful verification, the SmartPass Backend generates a customized SmartPass token for this event and securely transmits a representation of the SmartPass token to the SmartPass App. This token certifies Alex's eligibility to purchase cannabis without revealing his personal details.
6. Transmitting Computer Readable Code: The SmartPass App presents a computer readable code representing the SmartPass token. Alex presents this code to the dispensary staff for scanning/reading, initiating the verification process.
7. Backend Verification by Dispensary: The dispensary system communicates with the SmartPass Backend to validate the SmartPass token. The backend confirms the token's validity and compliance with age and residency verification requirements.
8. Access Approval: After successful verification, the dispensary processes Alex's cannabis purchase. This system approval ensures a transaction that is both compliant with state regulations and respectful of customer privacy.
9. Regulatory Reporting: The transaction involving Alex's SmartPass token, along with details of the cannabis purchase, is reported to the Regulator Authority database and is stored using a 2-way encryption using Regulator Authority's public key. This data assists in regulatory monitoring, ensuring adherence to state laws for cannabis sales.

### Scenario 6: Secure Pharmaceutical Pickups

Sarah, who has a prescription for a specific medication, visits a pharmacy for pickup. The pharmacy, adhering to strict regulations on prescription drug distribution, employs SmartPass technology for verifying patient identity and prescription validity. Sarah utilizes her SmartPass Mobile App to confirm her identity and prescription authorization securely, facilitating a compliant and private transaction, ensuring that she receives the correct medication as per her healthcare provider's prescription.

### Specific Regulatory Compliance Restrictions

Patients must verify their identity to receive prescription medications.
Confirmation of valid prescriptions as per healthcare regulations.

### Example Step-by-Step Implementation

1. Integration with Pharmacy System: The pharmacy integrates SmartPass technology into their system to verify patient identity and prescription validity. This ensures that prescription medications are dispensed only to verified patients, in compliance with healthcare regulations.
2. Initial Communication: Upon Sarah's arrival at the pharmacy, her SmartPass Mobile Application communicates with the pharmacy's system. The system requests verification of her identity and prescription details, emphasizing compliance with pharmaceutical regulations.
3. Determining Compliance Restrictions: The SmartPass System assesses the specific healthcare and pharmaceutical regulations based on the pharmacy's location and Sarah's prescription details, ensuring adherence to legal and ethical standards.
4. Regulatory Compliance Verification: The App verifies Sarah's identity and confirms the validity of her prescription using her verified PII and prescription data. This process ensures that she is the rightful recipient of the medication, maintaining her privacy.
5. Generating SmartPass Token: After successful verification, the SmartPass Backend generates a customized SmartPass token for this event and securely transmits a representation of the SmartPass token to the SmartPass App, certifying Sarah's identity and prescription authorization without disclosing sensitive health information.
6. Transmitting Computer Readable Code: Sarah's SmartPass App presents a computer readable code representing the SmartPass token, which she presents to the pharmacy staff. The pharmacy system scans this code to initiate the verification process.
7. Backend Verification by Pharmacy: The pharmacy system communicates with the SmartPass Backend to validate the SmartPass token. The backend confirms the token's authenticity and compliance with regulatory requirements for prescription medication dispensing.
8. Access Approval for Medication Pickup: Following successful verification, the pharmacy dispenses the prescribed medication to Sarah. This ensures a secure and compliant pharmaceutical transaction.
9. Regulatory Reporting: The use of Sarah's SmartPass token, along with anonymized prescription pickup data, is reported to the Regulator database. This ensures regulatory oversight and adherence to healthcare laws, while protecting patient privacy.

### Scenario 7: Age-Limited Sports Event Participation

Lucas, a high school student, wishes to participate in a local marathon that requires participants to be at least 16 years old. The event organizers use SmartPass technology to ensure participants meet the age requirement. Lucas uses his SmartPass Mobile App to verify his age, enabling him to register for the marathon while maintaining his privacy and ensuring the event's compliance with age-related regulatory requirements.

### Specific Regulatory Compliance Restrictions

Participants must meet the minimum age requirement set by the event organizers.
Verification of age is required without disclosing additional personal information.

### Example Step-by-Step Implementation

1. Integration with Event Registration System: The marathon's registration system integrates SmartPass technology to verify participants' ages. This ensures that all participants meet the event's age criteria, aligning with the event's policies and legal requirements.
2. Initial Communication: When Lucas attempts to register for the marathon, his SmartPass Mobile Application communicates with the event's registration system. It receives a request for age verification, identifying the need for compliance with the event's age restrictions.
3. Determining Compliance Restrictions: The SmartPass System assesses the specific age requirements for marathon participation based on the event's guidelines and Lucas's location, ensuring compliance with the event's policies.
4. Regulatory Compliance Verification: Lucas's age is verified through the SmartPass System assesses using his verified PII. It confirms that he meets the minimum age requirement for the marathon, maintaining his privacy throughout the process.
5. Generating SmartPass Token: Upon successful verification, the SmartPass Backend generates a customized SmartPass token for this event and securely transmits a representation of the SmartPass token to the SmartPass App, certifying Lucas's eligibility to participate in the marathon without revealing his exact age or other PII.
6. Transmitting Computer Readable Code: The SmartPass App presents a computer readable code representing the SmartPass token. Lucas presents this code to the event organizers during registration for scanning/reading, initiating the verification process.
7. Backend Verification by Event Organizers: The event registration system communicates with the SmartPass Backend to validate the SmartPass token. The backend confirms the token's authenticity and compliance with age verification requirements.
8. Access Approval for Participation: Following successful verification, Lucas is registered for the marathon. This process ensures a secure and compliant registration experience, adhering to age restrictions.
9. Regulatory Reporting: The registration involving Lucas's SmartPass token, along with details of the event participation, is reported to the Regulator Authority database and is stored using a 2-way encryption using Regulator Authority's public key for regulatory monitoring, ensuring adherence to age policies in sports events.

### Scenario 8: Restricted Library Material Access

Mia, a university student, needs to access a section of her college library that contains materials restricted to students over 18 years old. The library uses SmartPass technology to manage access to these materials. Mia utilizes her SmartPass Mobile App to verify her age and student status, enabling her to access the restricted materials while ensuring compliance with the library's regulatory requirements and maintaining her privacy.

### Specific Regulatory Compliance Restrictions

Access to certain library materials is limited to individuals who meet specific age or academic criteria.
Verification of age and student status without revealing additional personal details.

### Example Step-by-Step Implementation

1. Integration with Library System: The library integrates SmartPass technology into its access control system for restricted materials. This ensures that only eligible individuals, such as students of a certain age or academic level, can access these materials.
2. Initial Communication: When Mia attempts to access the restricted section, her SmartPass Mobile Application communicates with the library's system. The system requests verification of her age and student status.
3. Determining Compliance Restrictions: The SmartPass System assesses the specific regulations and policies of the library regarding access to restricted materials, based on Mia's location and the library's criteria.
4. Regulatory Compliance Verification: Mia's eligibility for accessing the restricted materials is verified through the SmartPass System. It uses her verified PII to confirm she meets the age and student status requirements, maintaining her privacy.
5. Generating SmartPass Token: Upon successful verification, the SmartPass Backend generates a customized SmartPass token for this event and securely transmits a representation of the SmartPass token to the SmartPass App, certifying Mia's eligibility to access the restricted library materials without disclosing her personal details.
6. Transmitting Computer Readable Code: The SmartPass App presents a computer readable code representing the SmartPass token. Mia presents this code to the library's access control system for scanning/reading.
7. Backend Verification by Library: The library system communicates with the SmartPass Backend to validate the SmartPass token. The backend confirms the token's validity and compliance with the library's access criteria.
8. Access Approval: Following successful verification, Mia is granted access to the restricted section of the library. This process ensures a secure and compliant access experience, adhering to the library's policies.
9. Regulatory Reporting: The access event involving Mia's SmartPass token, along with details of the restricted material access, is reported to the Regulator Authority database and is stored using a 2-way encryption using Regulator Authority's public key. This ensures regulatory oversight and adherence to the library's access policies.

### Scenario 9: Adult Education Course Enrollment

Mark, eager to enhance his professional skills, decides to enroll in an adult education course that requires participants to be over 21 years old. The educational institution uses SmartPass technology to verify the age of applicants. Mark uses his SmartPass Mobile App for a seamless enrollment process, validating his age while ensuring his privacy and the institution's compliance with age-related enrollment policies.

### Specific Regulatory Compliance Restrictions

Participants enrolling in the course must meet a minimum age requirement.
Verification of age is required without disclosing additional personal information.

### Example Step-by-Step Implementation

1. Integration with Educational Institution System: The institution integrates SmartPass technology into their enrollment system. This integration ensures that only individuals meeting the age requirement can enroll in adult education courses.
2. Initial Communication: When Mark begins the enrollment process, his SmartPass Mobile Application communicates with the institution's system. It receives a request for age verification, identifying the need for compliance with the course's age restrictions.
3. Determining Compliance Restrictions: The SmartPass System assesses the specific age requirements for the course based on the institution's policies and Mark's location, ensuring adherence to the educational standards.
4. Regulatory Compliance Verification: Mark's eligibility for the course is verified through the SmartPass System assesses using his verified PII. It confirms that he meets the minimum age requirement, maintaining his privacy throughout the process.
5. Generating SmartPass Token: After successful verification, the SmartPass Backend generates a customized SmartPass token for this event and securely transmits a representation of the SmartPass token to the SmartPass App, certifying Mark's eligibility to enroll in the course without revealing his exact age or other PII.
6. Transmitting Computer Readable Code: The SmartPass App presents a computer readable code representing the SmartPass token. Mark presents this code to the institution's enrollment system for scanning/reading, initiating the verification process.
7. Backend Verification by Educational Institution: The institution's system communicates with the SmartPass Backend to validate the SmartPass token. The backend confirms the token's authenticity and compliance with age verification requirements.
8. Access Approval for Enrollment: Following successful verification, Mark is registered for the adult education course. This system approval ensures a transaction that is both compliant with age restrictions and respectful of applicant privacy.
9. Regulatory Reporting: The enrollment involving Mark's SmartPass token, along with details of the course registration, is reported to the Regulator Authority database and is stored using a 2-way encryption using Regulator Authority's public key for regulatory monitoring, ensuring adherence to educational policies.

### Scenario 10: Age-Verified Public Transport Concessions

Elena, a senior citizen, wishes to avail of age-specific concessions on public transportation. The transport authority employs SmartPass technology to verify the age of passengers for concession eligibility. Elena uses her SmartPass Mobile App to securely validate her age, enabling her to access discounted fares while maintaining her privacy and ensuring the transport authority's compliance with concessionary policies.

### Specific Regulatory Compliance Restrictions

Concessions are available only to individuals who meet specific age criteria, such as seniors.
Verification of age is required to access age-specific concessions.

### Example Step-by-Step Implementation

1. Integration with Public Transport System: The public transport system integrates SmartPass technology to verify the age of passengers for concession eligibility. This ensures that age-specific concessions are provided only to eligible passengers.
2. Initial Communication: When Elena requests a concessionary fare, her SmartPass Mobile Application communicates with the transport system. It receives a request for age verification to determine concession eligibility.
3. Determining Compliance Restrictions: The SmartPass System assesses the specific age requirements for transport concessions based on Elena's location and the transport authority's policies.
4. Regulatory Compliance Verification: Elena's eligibility for the concession is verified through the SmartPass System. It uses her verified PII to confirm she meets the age criteria for the concession, maintaining her privacy.
5. Generating SmartPass Token: Upon successful verification, the SmartPass Backend generates a customized SmartPass token for this event and securely transmits a representation of the SmartPass token to the SmartPass App, certifying Elena's eligibility for the concession without disclosing her exact age.
6. Transmitting Computer Readable Code: The SmartPass App presents a computer readable code representing the SmartPass token. Elena presents this code to the transport system's ticketing machine or staff for scanning/reading.
7. Backend Verification by Transport Authority: The transport system communicates with the SmartPass Backend to validate the SmartPass token. The backend confirms the token's validity and eligibility for the concession.
8. Access Approval for Concession: Following successful verification, Elena is granted access to the concessionary fare. This process ensures a secure and compliant transaction, adhering to age-specific concession policies.
9. Regulatory Reporting: The transaction involving Elena's SmartPass token, along with details of the concessionary fare access, is reported to the Regulator Authority database and is stored using a 2-way encryption using Regulator Authority's public key. This ensures regulatory oversight and adherence to concessionary policies in public transportation.

### Scenario 11: Private Club Memberships

Robert, interested in joining a prestigious golf club that requires members to be over 30 years old, approaches the club for membership. The club, ensuring adherence to its age policy, uses SmartPass technology for verifying applicants' ages. Robert uses his SmartPass Mobile App to discreetly confirm his age, streamlining his membership process while maintaining privacy and aligning with the club's regulatory age requirements.

### Specific Regulatory Compliance Restrictions

Club membership is restricted to individuals who meet the minimum age requirement.
Verification of age is required without revealing additional personal details.

### Example Step-by-Step Implementation

1. Integration with Club's Membership System: The golf club integrates SmartPass technology into its membership application system. This ensures that new members meet the club's age criteria, maintaining the club's standards and policies.
2. Initial Communication: When Robert applies for membership, his SmartPass Mobile Application communicates with the club's system. It receives a request for age verification, critical for adhering to the club's age policy for membership.
3. Determining Compliance Restrictions: The SmartPass System assesses the specific age requirement for membership based on the club's policies and Robert's application details, ensuring adherence to the club's standards.
4. Regulatory Compliance Verification: Robert's eligibility for membership is verified through the SmartPass System. It uses his verified PII to confirm he meets the club's age requirement for membership, ensuring his privacy.
5. Generating SmartPass Token: Upon successful verification, the SmartPass Backend generates a customized SmartPass token for this event and securely transmits a representation of the SmartPass token to the SmartPass App, certifying Robert's age eligibility for the club membership without revealing his exact age or other PII.
6. Transmitting Computer Readable Code: The SmartPass App presents a computer readable code representing the SmartPass token. Robert presents this code to the club's membership officer for scanning/reading, initiating the verification process.
7. Backend Verification by Club: The club's system communicates with the SmartPass Backend to validate the SmartPass token. The backend confirms the token's authenticity and compliance with the age requirement for membership.
8. Access Approval for Membership: Following successful token verification, Robert is granted membership to the golf club. This process ensures a secure and compliant membership experience, adhering to the club's age policy.
9. Regulatory Reporting: The membership application involving Robert's SmartPass token, along with details of the membership approval, is reported to the Regulator Authority database and is stored using a 2-way encryption using Regulator Authority's public key for regulatory monitoring, ensuring adherence to the club's policies.

### Scenario 12: Senior Citizen Discounts

Grace, a 65-year-old retiree, wishes to avail of senior citizen discounts at a local grocery store. The store, complying with policies offering discounts to seniors, employs SmartPass technology for age verification. Grace uses her SmartPass Mobile App to effortlessly confirm her age eligibility for the discounts, ensuring a respectful and privacy-maintaining transaction that adheres to the store's discount policies for senior citizens.

### Specific Regulatory Compliance Restrictions

Discounts are available only to senior citizens who meet the specified age criterion.
Verification of age is required to avail of the discounts without revealing additional personal details.

### Example Step-by-Step Implementation

1. Integration with Retail Store System: The grocery store integrates SmartPass technology into their sales system. This integration ensures that senior citizen discounts are provided only to eligible customers, in line with store policies.
2. Initial Communication: When Grace requests a senior citizen discount, her SmartPass Mobile Application communicates with the store's system. It receives a request for age verification to determine eligibility for the discount.
3. Determining Compliance Restrictions: The SmartPass System assesses the specific age requirements for senior citizen discounts based on the store's policies and Grace's location, ensuring compliance with the store's discount criteria.
4. Regulatory Compliance Verification: Grace's eligibility for the discount is verified through the SmartPass System. It uses her verified PII to confirm she meets the age criteria for the discount, maintaining her privacy.
5. Generating SmartPass Token: Upon successful verification, the SmartPass Backend generates a customized SmartPass token for this event and securely transmits a representation of the SmartPass token to the SmartPass App, certifying Grace's eligibility for the senior citizen discount without disclosing her exact age.
6. Transmitting Computer Readable Code: The SmartPass App presents a computer readable code representing the SmartPass token. Grace presents this code to the store cashier for scanning/reading, initiating the verification process.
7. Backend Verification by Retail Store: The store's system communicates with the SmartPass Backend to validate the SmartPass token. The backend confirms the token's authenticity and compliance with the senior citizen discount policy.
8. Access Approval for Discount: Following successful verification, Grace is granted the senior citizen discount on her purchases. This process ensures a secure and compliant transaction, adhering to the store's policies.
9. Regulatory Reporting: The transaction involving Grace's SmartPass token, along with details of the discount granted, is reported to the Regulator Authority database and is stored using a 2-way encryption using Regulator Authority's public key. This ensures regulatory oversight and adherence to discount policies for senior citizens.

### Scenario 13: Rental of Age-Restricted Equipment

Daniel, an avid adventurer, wants to rent a high-powered jet ski at a beach resort. The resort, adhering to safety regulations, restricts the rental of such equipment to individuals over 21 years old. To comply with these regulations, the resort utilizes SmartPass technology. Daniel uses his SmartPass Mobile App to verify his age, ensuring a smooth rental process that respects both safety regulations and his privacy.

### Specific Regulatory Compliance Restrictions

Equipment rental is restricted to individuals who meet the minimum age requirement.
Verification of age is required without disclosing additional personal details.

### Example Step-by-Step Implementation

1. Integration with Resort's Rental System: The resort integrates SmartPass technology into their equipment rental system. This ensures that high-powered equipment like jet skis is rented only to individuals who meet the age criteria, maintaining safety standards.
2. Initial Communication: When Daniel expresses interest in renting a jet ski, his SmartPass Mobile Application communicates with the resort's rental system. It receives a request for age verification, identifying the need for compliance with the resort's safety policies.
3. Determining Compliance Restrictions: The SmartPass System assesses the specific age requirements for equipment rental based on the resort's policies and Daniel's location, ensuring adherence to safety regulations.
4. Regulatory Compliance Verification: Daniel's eligibility for equipment rental is verified through the SmartPass System. It uses his verified PII to confirm he meets the minimum age requirement, ensuring his privacy.
5. Generating SmartPass Token: Upon successful verification, the SmartPass Backend generates a customized SmartPass token for this event and securely transmits a representation of the SmartPass token to the SmartPass App, certifying Daniel's age eligibility for the jet ski rental without revealing his exact age or other PII.
6. Transmitting Computer Readable Code: The SmartPass App presents a computer readable code representing the SmartPass token. Daniel presents this code to the resort's rental desk for scanning/reading, initiating the verification process.
7. Backend Verification by Resort: The resort's system communicates with the SmartPass Backend to validate the SmartPass token. The backend confirms the token's authenticity and compliance with age verification requirements.
8. Access Approval for Rental: Following successful verification, Daniel is allowed to rent the jet ski. This ensures a secure and compliant rental process, adhering to the resort's safety and age policies.
9. Regulatory Reporting: The rental involving Daniel's SmartPass token, along with details of the equipment rental, is reported to the Regulator Authority database and is stored using a 2-way encryption using Regulator Authority's public key This ensures regulatory oversight and adherence to safety regulations in equipment rentals.

### Scenario 14: Participation in Age-Restricted Contests

Lily, a talented singer, wants to participate in a music contest that is restricted to participants between the ages of 18 and 25. The contest organizers use SmartPass technology to ensure participants meet this age criterion. Lily uses her SmartPass Mobile App to verify her age, streamlining the registration process while maintaining her privacy and ensuring the contest's adherence to its age-specific participation rules.

### Specific Regulatory Compliance Restrictions

Contest participation is limited to individuals within a specific age range.
Verification of age is required to ensure eligibility without disclosing additional personal information.

### Example Step-by-Step Implementation

1. Integration with Contest Registration System: The contest organizers integrate SmartPass technology into their registration system. This ensures that only participants within the specified age range can enter the contest, adhering to the contest's rules.
2. Initial Communication: When Lily attempts to register, her SmartPass Mobile Application communicates with the contest's system. It receives a request for age verification, critical for adhering to the contest's age restriction policies.
3. Determining Compliance Restrictions: The SmartPass System assesses the specific age requirements for contest participation based on the contest's guidelines and Lily's application details, ensuring compliance with the contest rules.
4. Regulatory Compliance Verification: Lily's eligibility for the contest is verified through the SmartPass System. It uses her verified PII to confirm she falls within the age range for participation, maintaining her privacy.
5. Generating SmartPass Token: Upon successful verification, the SmartPass Backend generates a customized SmartPass token for this event and securely transmits a representation of the SmartPass token to the SmartPass App, certifying Lily's age eligibility for the contest without revealing her exact age or other PI.
6. Transmitting Computer Readable Code: The SmartPass App presents a computer readable code representing the SmartPass token. Lily presents this code to the contest organizers during registration for scanning/reading.
7. Backend Verification by Contest Organizers: The contest's system communicates with the SmartPass Backend to validate the SmartPass token. The backend confirms the token's authenticity and compliance with the age restriction.
8. Access Approval for Participation: Following successful token verification, Lily is registered for the contest. This process ensures a secure and compliant registration experience, adhering to the contest's age policies.
9. Regulatory Reporting: The registration involving Lily's SmartPass token, along with details of the contest participation, is reported to the Regulator Authority database and is stored using a 2-way encryption using Regulator Authority's public key. This ensures regulatory oversight and adherence to the contest's age-restricted policies.

### Scenario 15: Access to Age-Gated Community Services

James, a resident of a gated community that offers certain amenities exclusively to adults, wishes to use the community's adult-only fitness center. To enforce this age restriction, the community management employs SmartPass technology. James uses his SmartPass Mobile App to verify his age eligibility, allowing him seamless access to the fitness center while respecting the community's age-based access policies and maintaining his privacy.

### Specific Regulatory Compliance Restrictions

Access to certain community amenities is limited to residents who meet the age requirement.
Verification of age is required to access these services without revealing additional personal details.

### Example Step-by-Step Implementation

1. Integration with Community Management System: The community management integrates SmartPass technology into their access control system for age-restricted amenities. This ensures that only residents meeting the age criteria can access these services.
2. Initial Communication: When James attempts to access the fitness center, his SmartPass Mobile Application communicates with the community's access system. It receives a request for age verification, aligning with the community's age-based access policy.
3. Determining Compliance Restrictions: The SmartPass System assesses the specific age requirements for accessing the fitness center based on the community's policies and James's location, ensuring adherence to the community rules.
4. Regulatory Compliance Verification: James's eligibility for accessing the fitness center is verified through the SmartPass System. It uses his verified PII to confirm he meets the age criteria, ensuring his privacy.
5. Generating SmartPass Token: Upon successful verification, the SmartPass Backend generates a customized SmartPass token for this event and securely transmits a representation of the SmartPass token to the SmartPass App, certifying James's age eligibility for accessing the fitness center without revealing his personal details.
6. Transmitting Computer Readable Code: The SmartPass App presents a computer readable code representing the SmartPass token. James presents this code to the fitness center's access control for scanning/reading.
7. Backend Verification by Community Management: The community's system communicates with the SmartPass Backend to validate the SmartPass token. The backend confirms the token's authenticity and compliance with age verification requirements.
8. Access Approval for Amenities: Following successful verification, James is granted access to the fitness center. This process ensures a secure and compliant access experience, adhering to the community's age restriction policy.
9. Regulatory Reporting: The access event involving James's SmartPass token, along with details of the amenities access, is reported to the Regulator Authority database and is stored using a 2-way encryption using Regulator Authority's public key. This ensures regulatory oversight and adherence to the community's age-based access policies.

### Scenario 16: Restricted Access to Certain Medicinal Products

Emma, suffering from a chronic condition, requires access to specific medicinal products that are restricted to patients with certain medical conditions. The pharmacy, adhering to healthcare regulations, utilizes SmartPass technology for patient verification. Emma uses her SmartPass Mobile App to securely confirm her medical condition eligibility for these products, facilitating a compliant transaction that respects her privacy and aligns with the pharmacy's regulatory requirements for restricted medication access.

### Specific Regulatory Compliance Restrictions

Access to certain medicinal products is restricted to individuals with specific medical conditions.
Verification of medical condition eligibility is required without revealing sensitive health information.

### Example Step-by-Step Implementation

1. Integration with Pharmacy System: The pharmacy integrates SmartPass technology to verify the eligibility of patients for restricted medicinal products. This ensures that only patients with specific medical conditions can access these products, in compliance with healthcare regulations.
2. Initial Communication: When Emma requests the restricted medicinal products, her SmartPass Mobile Application communicates with the pharmacy's system. It receives a request for verification of her medical condition eligibility.
3. Determining Compliance Restrictions: The SmartPass System assesses the specific healthcare regulations regarding access to the restricted medicinal products based on the pharmacy's policies and Emma's medical profile.
4. Regulatory Compliance Verification: Emma's eligibility for the medicinal products is verified through the SmartPass System. It uses her encrypted medical condition information to confirm she meets the criteria for access, maintaining her privacy.
5. Generating SmartPass Token: Upon successful verification, the SmartPass Backend generates a customized SmartPass token for this event and securely transmits a representation of the SmartPass token to the SmartPass App, certifying Emma's eligibility for the restricted products without disclosing her sensitive health information.
6. Transmitting Computer Readable Code: The SmartPass App presents a computer readable code representing the SmartPass token. Emma presents this code to the pharmacy staff for scanning/reading, initiating the verification process.
7. Backend Verification by Pharmacy: The pharmacy system communicates with the SmartPass Backend to validate the SmartPass token. The backend confirms the token's authenticity and compliance with medical condition eligibility requirements.
8. Access Approval for Medication: Following successful verification, Emma is allowed to purchase the restricted medicinal products. This ensures a secure and compliant transaction, adhering to healthcare regulations.
9. Regulatory Reporting: The transaction involving Emma's SmartPass token, along with details of the restricted medicinal product access, is reported to the Regulator Authority database and is stored using a 2-way encryption using Regulator Authority's public key. This ensures regulatory oversight and adherence to healthcare laws governing restricted medication access.

### Scenario 17: Entry to Age-Specific Events or Expos

Hannah, a young professional interested in attending a tech expo that is exclusive to individuals over the age of 25, approaches the event venue. The expo organizers, to ensure compliance with their age-specific admission policy, utilize SmartPass technology. Hannah uses her SmartPass Mobile App to verify her age, facilitating a smooth entry process while maintaining her privacy and ensuring the event's adherence to its age restriction policies.

### Specific Regulatory Compliance Restrictions

Admission to the event is restricted to individuals who meet the minimum age requirement.
Verification of age is required for entry without disclosing additional personal details.

### Example Step-by-Step Implementation

1. Integration with Event Admission System: The expo organizers integrate SmartPass technology into their admission system. This ensures that attendees meet the age criteria set for the event, maintaining the event's professional standards.
2. Initial Communication: When Hannah arrives at the expo, her SmartPass Mobile Application communicates with the event's admission system. It receives a request for age verification, critical for adhering to the expo's age restriction policy.
3. Determining Compliance Restrictions: The SmartPass System assesses the specific age requirement for the expo based on the event's guidelines and Hannah's location, ensuring adherence to the event's admission criteria.
4. Regulatory Compliance Verification: Hannah's eligibility for the expo is verified through the SmartPass System. It uses her verified PII to confirm she meets the minimum age requirement, ensuring her privacy.
5. Generating SmartPass Token: Upon successful verification, the SmartPass Backend generates a customized SmartPass token for this event and securely transmits a representation of the SmartPass token to the SmartPass App, certifying Hannah's age eligibility for the expo without revealing her exact age or other PII.
6. Transmitting Computer Readable Code: The SmartPass App presents a computer readable code representing the SmartPass token. Hannah presents this code to the expo's admission staff for scanning/reading, initiating the verification process.
7. Backend Verification by Expo Organizers: The expo's system communicates with the SmartPass Backend to validate the SmartPass token. The backend confirms the token's authenticity and compliance with the age restriction.
8. Access Approval for Entry: Following successful token verification, Hannah is granted entry to the expo.

This process ensures a secure and compliant admission experience, adhering to the expo's age policies.
9. Regulatory Reporting: The entry involving Hannah's SmartPass token, along with details of the expo attendance, is reported to the Regulator Authority database and is stored using a 2-way encryption using Regulator Authority's public key. This ensures regulatory oversight and adherence to the event's age-specific admission policies.

### Scenario 18: Purchase of Firearms

Jack, a responsible citizen interested in purchasing a firearm for self-defense, visits a licensed gun store. The store, adhering to strict firearms sale regulations, uses SmartPass technology to ensure buyers meet legal age and background requirements. Jack uses his SmartPass Mobile App to verify his age and background eligibility, enabling a secure and compliant purchase process that respects legal requirements and maintains his privacy.

### Specific Regulatory Compliance Restrictions

The buyer must meet the legal age requirement and pass background checks for purchasing firearms.
Verification of age and background eligibility is required without revealing additional personal details.

### Example Step-by-Step Implementation

1. Integration with Gun Store System: The gun store integrates SmartPass technology into their sales system. This ensures that firearms are sold only to individuals who meet legal age and background check criteria, in compliance with firearms regulations.
2. Initial Communication: When Jack selects a firearm for purchase, his SmartPass Mobile Application communicates with the gun store's system. It receives a request for age and background verification, aligning with firearms sale regulations.
3. Determining Compliance Restrictions: The SmartPass System assesses specific legal requirements for firearm purchases based on the store's location and regulatory guidelines, ensuring adherence to firearms laws.
4. Regulatory Compliance Verification: Jack's eligibility to purchase a firearm is verified through the SmartPass System. It uses his verified PII and background information to confirm he meets the age and background criteria, maintaining his privacy.
5. Generating SmartPass Token: Upon successful verification, the SmartPass Backend generates a customized SmartPass token for this event and securely transmits a representation of the SmartPass token to the SmartPass App, certifying Jack's eligibility for the firearm purchase without revealing sensitive details.
6. Transmitting Computer Readable Code: The SmartPass App presents a computer readable code representing the SmartPass token. Jack presents this code to the gun store for scanning/reading, initiating the verification process.
7. Backend Verification by Gun Store: The gun store's system communicates with the SmartPass Backend to validate the SmartPass token. The backend confirms the token's authenticity and compliance with firearms purchase requirements.
8. Access Approval for Purchase: Following successful verification, Jack is allowed to complete the purchase of the firearm. This ensures a secure and compliant transaction, adhering to firearms sale regulations.
9. Regulatory Reporting: The transaction involving Jack's SmartPass token, along with details of the firearm purchase, is reported to the Regulator Authority database and is stored using a 2-way encryption using Regulator Authority's public key. This ensures regulatory oversight and adherence to firearms sale laws.
   Scenario 19: Travel Visa for Entry into an Administratively Restricted Region

Sophia, planning to travel to an administratively restricted region for a business conference, needs to obtain a travel visa. The region enforces stringent entry requirements, including specific citizenship, identity, and background check verifications. To facilitate her application, the regional visa authority employs SmartPass technology. Sophia uses her SmartPass Mobile App to seamlessly validate her eligibility for the travel visa, ensuring compliance with the region's entry regulations while maintaining her privacy.

### Specific Regulatory Compliance Restrictions

Travelers must meet specific citizenship requirements.
Travelers must have successfully completed required Identity verification.
Travelers must have successfully completed required background check verification.

### Example Step-by-Step Implementation

1. Integration with Visa Authority System: The visa authority of the restricted region integrates SmartPass technology into their visa processing system. This integration ensures that visas are issued only to individuals who meet all the specified entry criteria, maintaining regional security and compliance.
2. Initial Communication: When Sophia applies for the travel visa, her SmartPass Mobile Application communicates with the visa authority's system. It receives a request for comprehensive verification of citizenship, identity, and background as per the region's entry requirements.
3. Determining Compliance Restrictions: The SmartPass System assesses the specific citizenship, identity, and background check requirements based on the region's entry regulations and Sophia's application details, ensuring adherence to the strict entry criteria.
4. Regulatory Compliance Verification: Sophia's eligibility for the travel visa is verified through the SmartPass System. It uses her verified PII and background information to confirm she meets the citizenship, identity, and background check requirements, ensuring her privacy.
5. Generating SmartPass Token: Upon successful verification, the SmartPass Backend generates a customized SmartPass token for this event and securely transmits a representation of the SmartPass token to the SmartPass App, certifying Sophia's eligibility for the travel visa without revealing sensitive personal details.
6. Transmitting Computer Readable Code: The SmartPass App presents a computer readable code representing the SmartPass token. Sophia presents this code to the visa authority during her application process for scanning/reading.
7. Backend Verification by Visa Authority: The visa authority's system communicates with the SmartPass Backend to validate the SmartPass token. The backend confirms the token's authenticity and compliance with the stringent entry requirements.
8. Visa Approval for Travel: Following successful token verification, Sophia's travel visa is processed and granted. This ensures a secure and compliant visa issuance process, adhering to the region's entry regulations.
9. Regulatory Reporting: The visa issuance involving Sophia's SmartPass token, along with details of the eligibility verification, is reported to the Regulator Authority database and is stored using a 2-way encryption using Regulator Authority's public key. This ensures regulatory oversight and adherence to the administratively restricted region's entry policies.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A computer-implemented method implemented via a data network, the method comprising causing at least one processor to execute a plurality of instructions stored in a non-transient memory for facilitating regulatory compliant anonymous user access to a first regulated service provided by a first service provider, the method comprising:
Accessing, by a first server system, a first portion of validated Personal Identifiable Information (PII) data relating to a first user;
Receiving, by the first server system, a first user request to authorize the first users access to the first regulated service;
Identifying, by the first server system, a first set of regulatory compliance requirements for permitting user access to the first regulated service;
Analyzing, by the first server system, the first portion of validated PII data and the first set of regulatory compliance requirements to determine if the first user satisfies the regulatory compliance requirements for permitting first user access to the first regulated service;
Generating, by the first server system in response to determining that the first user satisfies the regulatory compliance requirements, a first unique digital SmartPass token certifying that the first user satisfies the regulatory compliance requirements for permitting first user access to the first regulated service, wherein the first SmartPass token does not include unencrypted PII data relating to the first user;
Transmitting, by the first server system, a cryptographically signed version of the first SmartPass token to the first service provider certifying that the first user satisfies the regulatory compliance requirements for permitting first user access to the first regulated service; and
Facilitating, by the first server system using the first SmartPass token, the first user with regulatory compliant access to the first regulated service.

2. The method of claim 1, further comprising causing the at least one processor to execute additional instructions for generating and transmitting, by the first server system, a first user certification message to the first service provider, certifying that the user associated with a first anonymized identifier satisfies the regulatory compliance requirements for permitting first user access to the first regulated service of the first service provider; wherein the certification is achieved in a manner which obfuscates or hides the first user's PII data from the first service provider; and wherein the certification is achieved without providing first user's PII data to the first service provider.

3. The method of claim 1, further comprising causing the at least one processor to execute additional instructions for generating and transmitting, by the first server system, a first user certification message to the first service provider, certifying that the first user's age satisfies the minimum regulatory age requirements for permitting first user access to the first regulated service without disclosing the user's age or birth date to the first service provider.

4. The method of claim 1, further comprising causing the at least one processor to execute additional instructions for generating and transmitting, by the first server system, a first user certification message to the first service provider, certifying that the first user's nationality satisfies the regulatory nationality requirements for permitting first user access to the first regulated service without disclosing the user's nationality to the first service provider.

5. The method of claim 1, further comprising causing the at least one processor to execute additional instructions for generating and transmitting, by the first server system, a first user certification message to the first service provider, certifying that the first user's current geographic location satisfies the regulatory requirements for permitting first user access to the first regulated service without disclosing the user's current location to the first service provider.

6. The method of claim 1, further comprising causing the at least one processor to execute additional instructions for generating and transmitting, by the first server system, a first user certification message to the first service provider, certifying that the first user's identity satisfies the regulatory KYC requirements for permitting first user access to the first regulated service, without disclosing the user's identity to the first service provider, and assigning a first anonymized identifier to represent the identity of the first user; wherein the certification is achieved in a manner which anonymizes first user's PI data from the first service provider.

7. A computerized system implemented in a data network, the system comprising:
At least one processor;
Memory containing instructions;
The at least one processor being operable to execute the instructions stored in the memory for facilitating regulatory compliant anonymous user access to a first regulated service provided by a first service provider, the system operable to:
Access, by a first server system, a first portion of validated Personal Identifiable Information (PI) data relating to a first user;
Receive, by the first server system, a first user request to authorize the first user's access to the first regulated service;
Identify, by the first server system, a first set of regulatory compliance requirements for permitting user access to the first regulated service;
Analyze, by the first server system, the first portion of validated PI data and the first set of regulatory compliance requirements to determine if the first user satisfies the regulatory compliance requirements for permitting first user access to the first regulated service;
Generate, by the first server system in response to determining that the first user satisfies the regulatory compliance requirements, a first unique digital SmartPass token certifying that the first user satisfies the regulatory compliance requirements for permitting first user access to the first regulated service, wherein the first SmartPass token does not include unencrypted PII data relating to the first user;
Transmit, by the first server system, a cryptographically signed version of the first SmartPass token to the first service provider certifying that the first user satisfies the regulatory compliance requirements for permitting first user access to the first regulated service; and
Facilitate, by the first server system using the first SmartPass token, the first user with regulatory compliant access to the first regulated service.

8. The system of claim 7, being further operable to cause the at least one processor to execute additional instructions for generating and transmitting, by the first server system, a first user certification message to the first service provider, certifying that the user associated with a first anonymized identifier satisfies the regulatory compliance requirements for permitting first user access to the first regulated service of the first service provider; wherein the certification is achieved in a manner which obfuscates or hides the first user's PII data from the first service provider, wherein the certification is achieved without providing first user's PI data to the first service provider; and wherein the certification is achieved in a manner which anonymizes first user's PII data from the first service provider.

9. The system of claim 7, being further operable to cause the at least one processor to execute additional instructions for generating and transmitting, by the first server system, a first user certification message to the first service provider, certifying that the first user's age satisfies the minimum regulatory age requirements for permitting first user access to the first regulated service without disclosing the user's age or birth date to the first service provider.

10. The system of claim 7, being further operable to cause the at least one processor to execute additional instructions for generating and transmitting, by the first server system, a first user certification message to the first service provider, certifying that the first user's nationality satisfies the regulatory nationality requirements for permitting first user access to the first regulated service without disclosing the user's nationality to the first service provider.

11. The system of claim 7, being further operable to cause the at least one processor to execute additional instructions for generating and transmitting, by the first server system, a first user certification message to the first service provider, certifying that the first user's current geographic location satisfies the regulatory requirements for permitting first user access to the first regulated service without disclosing the user's current location to the first service provider.

12. The system of claim 7, being further operable to cause the at least one processor to execute additional instructions for generating and transmitting, by the first server system, a first user certification message to the first service provider, certifying that the first user's identity satisfies the regulatory KYC requirements for permitting first user access to the first regulated service, without disclosing the user's identity to the first service provider, and assigning a first anonymized identifier to represent the identity of the first user.

13. The method of claim 1 further comprising causing the at least one processor to execute additional instructions for facilitating age-restricted retail purchases while maintaining user privacy and adhering to regulatory compliance, the method further comprising:
Integrating, by the first server system, SmartPass technology with a retail store's sales system to prompt for age verification upon selection of age-restricted products like alcohol;
Receiving, by the first server system, an initial communication from a user's SmartPass Mobile Application when attempting to purchase an age-restricted product, the communication including details of the product and the need for age verification;
Determining, by the first server system, compliance restrictions based on the product details and the user's current location to ascertain regional and legal age requirements for the purchase;
Verifying, by the first server system, the user's compliance with these regulations using encrypted Personal Identifiable Information (PII) and geolocation data to confirm legal age requirement satisfaction;
Generating, by the first server system, a SmartPass token upon successful verification, certifying the user's eligibility for the purchase without revealing exact age or other PII;
Transmitting, by the first server system, a computer-readable code representing the SmartPass token to the user's SmartPass App;
Presenting, by the user through the SmartPass App, the computer-readable code to the retail store cashier for scanning and initiating the verification process;
Validating, by the first server system, the SmartPass token in communication with the retail store's system to confirm the token's authenticity and compliance with age verification requirements;
Approving, by the first server system, the user's transaction based on the validated SmartPass token for a smooth purchasing experience; and
Reporting, by the first server system, the usage event of the SmartPass token and transaction details to the Regulator Authority database, storing the data using two-way encryption with the Regulator Authority's public key for regulatory monitoring and legal age requirement adherence.

14. The method of claim 1 further comprising causing the at least one processor to execute additional instructions for enabling automated vending machine transactions involving age-restricted products while ensuring regulatory compliance and user privacy, the method further comprising:
Integrating, by the first server system, SmartPass technology into an automated vending machine to enable age verification for the purchase of age-restricted products like tobacco, ensuring compliance with legal age restrictions;
Receiving, by the first server system, initial communication from a user's SmartPass Mobile Application when the user selects an age-restricted product from the vending machine, the communication including product details and the necessity of age verification as per tobacco sale regulations;
Determining, by the first server system, specific regional and legal age requirements for the tobacco purchase based on the user's location and product details to ensure adherence to local laws;
Verifying, by the first server system, the user's compliance with regulatory age requirements using verified Personal Identifiable Information (PII) and geolocation data, confirming the user's legal age for purchasing tobacco while maintaining user privacy,
Generating, by the first server system, a customized SmartPass token upon successful age verification and securely transmitting a representation of the SmartPass token to the SmartPass Mobile Application, thereby certifying the user's eligibility for the purchase without revealing personal details;
Presenting, by the user through the SmartPass Mobile Application, a computer-readable code representing the SmartPass token to the vending machine's reader for proceeding with the purchase;
Validating, by the first server system, the SmartPass token in communication with the vending machine to confirm the token's validity and compliance with age verification requirements;
Approving, by the first server system, the user's transaction post successful verification of the SmartPass token, enabling the vending machine to process the purchase and dispense the cigarettes; and
Reporting, by the first server system, the transaction involving the user's SmartPass token, along with the purchase details, to the Regulator Authority database, storing the data using two-way encryption with the Regulator Authority's public key for regulatory monitoring and ensuring legal compliance in age-restricted product sales.

15. The method of claim 1 further comprising causing the at least one processor to execute additional instructions for facilitating access to gambling services in compliance with regulatory age restrictions while maintaining user privacy, the method further comprising:
Integrating, by the first server system, SmartPass technology into a casino's slot machines and gambling systems to ensure that only patrons meeting legal age requirements can access gambling services;
Receiving, by the first server system, an initial communication from a user's SmartPass Mobile Application when the user attempts to use a slot machine, the communication requesting age verification to comply with gambling age laws;
Assessing, by the first server system, specific gambling regulations including age requirements based on the casino's location to ensure compliance with local legal standards for gambling access;
Verifying, by the first server system, the user's eligibility for gambling using verified Personal Identifiable Information (PII) and geolocation data, confirming the user meets the legal gambling age while maintaining user privacy,
Generating, by the first server system, a customized SmartPass token upon successful age verification, and securely transmitting a representation of the SmartPass token to the SmartPass Mobile Application, certifying the user's eligibility for gambling without disclosing exact age or other PII;
Presenting, by the user through the SmartPass Mobile Application, a computer-readable code representing the SmartPass token to the slot machine for scanning and initiating the verification process;
Validating, by the first server system, the SmartPass token in communication with the slot machine to confirm the token's authenticity and compliance with age verification requirements;
Approving, by the first server system, the user's access to gambling services following successful token verification, enabling the slot machine to allow the user to engage in gambling activities; and
Reporting, by the first server system, the use of the user's SmartPass token along with anonymized gambling activity data to the Regulator Authority database, ensuring regulatory oversight and compliance with gambling laws, while protecting patron privacy.

16. A computer-implemented method implemented via a data network, the method comprising causing at least one processor to execute a plurality of instructions stored in a non-transient memory for facilitating user login and pairing with a service provider app, the method comprising:
Receiving, by a first server system, a user login or registration request from a SmartPass mobile application;
Sending, by the first server system, a provider authentication request including a timestamp, provider ID, and signature to a service provider;
Generating, by the service provider, a time-limited token for initiating pairing including a timestamp, expiration, provider ID, session ID, and signature;
Responding, by the service provider, to the provider authentication request and sending the time-limited token to the SmartPass mobile application;
Initiating, by the first server system, a secure WebSocket connection between the first server system and the service provider;
Publishing, by the service provider, a QR code generated for pairing, displaying it to the SmartPass mobile application for scanning;
Scanning, by the SmartPass mobile application, the QR code and reading the data contained within, including a unique token;
Requesting, by the SmartPass mobile application, pairing by sending user's Personal Identifiable Information (PII), User Location Data (ULD), User Approximate Location (UAL), Unique Identifier, and the scanned token to the first server system, all unencrypted and signed using a private key;
Matching, by the first server system, session ID with the authentication request and user pairing request;
Requesting, by the first server system, regulatory compliance regulations based on provider ID and UAL from a SmartPass Jurisdiction Regulation Database;
Processing, by the Jurisdiction Regulation Database, the request and retrieving regulatory compliance regulations based on provider ID and UAL;
Returning, by the Jurisdiction Regulation Database, requested regulatory compliance regulations;
Determining, by the first server system, if the user's pairing request is approved or rejected based on validity checks;
If approved, generating, by the first server system, a SmartPass token and storing it in a database under the user's account; and
Informing, by the first server system, the service provider and the SmartPass Regulator Authority Monitoring of the approval or rejection, with details of the pairing request and the user's unique identifier.

17. The method of claim 16, further comprising causing the at least one processor to execute additional instructions for generating and transmitting, by the first server system, a first user certification message to the first service provider, certifying that the user associated with a first anonymized identifier satisfies the regulatory compliance requirements for permitting first user access to the first regulated service of the first service provider; wherein the certification is achieved in a manner which obfuscates or hides the first user's PII data from the first service provider, and wherein the certification is achieved without providing first user's PII data to the first service provider.

18. The method of claim 16, further comprising causing the at least one processor to execute additional instructions for generating and transmitting, by the first server system, a first user certification message to the first service provider, certifying that the first user's age satisfies the minimum regulatory age requirements for permitting first user access to the first regulated service without disclosing the user's age or birth date to the first service provider.

19. The method of claim 16, further comprising causing the at least one processor to execute additional instructions for generating and transmitting, by the first server system, a first user certification message to the first service provider, certifying that the first user's nationality satisfies the regulatory nationality requirements for permitting first user access to the first regulated service without disclosing the user's nationality to the first service provider.

20. The method of claim 16, further comprising causing the at least one processor to execute additional instructions for generating and transmitting, by the first server system, a first user certification message to the first service provider, certifying that the first user's current geographic location satisfies the regulatory requirements for permitting first user access to the first regulated service without disclosing the user's current location to the first service provider.
